(19) United States
(12) Patent Application Publication
(10) Pub. No.: US 2005/0246240 A1
(43) Pub. Date: Nov. 3, 2005

(54) System and method for business-to-business buying, selling, sourcing and matching of proudcts and services across multiple business partners over the internet

(76) Inventor: Raymund Marcos Padilla, Metro Manila (PH)

Correspondence Address: RAYMUND MARCOS S. PADIUA, 442 COOPER ST. MOONWALK VILLAGE PARANNAQUE, METRO MANILA, 1700, PH

(21) Appl. No.: 10/836,229

(22) Filed: May 3, 2004

(51) Int. Cl. G06F 17/60

(52) U.S. Cl. 705/26

(57) ABSTRACT

This invention relates in general to a system and method for business-to-business buying, selling, sourcing and matching of products and services across multiple business partners over the Internet. The invention covers an internet based solution comprise of: 1) business partner registration, 2) buying and selling processing, 3) matching of codes, 4) conversion of EDI transactions, 5) sourcing/offering of products/services and 6) electronic documents processing.

The invention provides: 1) support on EDI technology conversion into Rosettanet technology, 2) enhancements to Rosettanet technology so that code matching is possible for companies with or without support on GTIN, DUNS, ISO, UN/SPSC and other globally set codes, 3) an intermediary infrastructure for consolidation and standardization of business data across multiple electronic business applications (EBAs) and platforms with or without manufacturer part number (MPN) and customer part number (CPN) support, 4) a conversion mechanism where internet published auctions and reverse auctions are converted into sales quotations (SQs) and request for quotations (RFQ) respectively, 5) a solution to extract data from various EBAs, interface, update, match and store codes such as company codes, product/service codes, currency code, unit of measure code, country code and class code from globally defined codes and business partner defined codes and 7) a sourcing/offering mechanism where it detects potential suppliers and buyers based on the calculation logic described on FIGS. 21 and 22.

### CROSS-REFERENCE TO RELATED APPLICATIONS

References
1. Functions in Detail—R/3 Materials Management SAP AG May 1998
2. Functions in Detail—R/3 Sales and Distribution SAP AG May 1996
3. Introduction to Department of Defense Electronic Commerce Version 2, Electronic Commerce Information Center, Electronic Commerce Office, U.S. Department of Defense, USA
4. EDI: A Total Management Guide, Second Edition, 1992 Margaret A. Emmelhainz, Ph.D.
5. www.rosettanet.org

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

1. Field of Invention

This invention relates in general to business-to-business applications that cover business partner registration, buying, selling, sourcing and matching of products and services across multiple business partners over the Internet.

2. Description of Prior Art

Prior art provided ways to improve the traditional procurement process. Many of these improvements are in the process of automating or electronic conversion of the manual and traditional procurement process. Before we discuss these improvements, let us first describe the traditional procurement process. This process includes: 1) purchase requisition; 2) supplier selection; 3) request for quotations; 4) maintain quotations; 5) granting of purchase order to the selected supplier; 6) purchase order updates 7) follow-up of outstanding orders and order deliveries; 8) acceptance and validation of invoices; and 9) payment to supplier.

Here's a description of the traditional procurement process:

Phase 1: Purchase Requisition

A purchase requisition is used by requesting departments for items such as direct and indirect materials and services that they need for their operations or production needs and have to be ordered from suppliers. These items include but not limited to 1) raw and packaging materials; 2) semi-finished goods or assemblies; 3) maintenance, repair and operating items; 4) finished goods; 5) labor and other professional services. The requisitioning person from the requesting department triggers a purchase requisition that reflects the following; 1) item code and description of items requested 2) required quantity or amount 3) unit of measurement and 4) date items are needed. This request or purchase requisition is forwarded to the purchasing department for further processing.

Phase 2: Supplier Selection

At this phase, the purchasing department receives the purchase requisition from the requisitioning department. The buyer from the purchasing department identifies and selects potential suppliers for requirement sourcing. The buyer extracts the supplier listing from the filing cabinet and determine manually if these suppliers are capable of providing the requested item. To further extend this manual process, purchase requisitions are segmented by material type so that it can be assigned to each buyer responsible for the material types therefore reducing the time to sort the suppliers. The disadvantage is that it incurs additional purchase requisitions instead of having one purchase requisition for all requested items. Purchase requisitions are converted into request for quotations (RFQs).

Phase 3: Request for Quotations

A request for quotation (RFQ) is created and forwarded to the identified suppliers. This RFQ contains the following details; 1) code and description of items requested; 2) required quantity or amount; 3) unit of measurement; 4) date items are needed; 5) request for price and conditions; 6) validity and expiration date of the RFQ and 7) supplier name and contact details.

Phase 4: Maintain Quotations

Upon receipt of the RFQ, the supplier responds by providing information on; 1) conformance to item to be procured; 2) committed quantity in response to required quantity or amount; 3) conformance to unit of measurement; 4) date items can be delivered; 5) offered price, discounts, surcharges, other fix and variable conditions and effective date and 6) submission date. This supplier accomplished RFQ or corresponding Sales Quotation (SQ) is submitted to the buying company for evaluation and grant of purchase order.

Phase 5: Granting of Purchase Order to the Identified Supplier

Upon receipt of RFQ, the buying company evaluates the best RFQ based on compliance to requirements. The buying company informs the supplier with the winning proposal and sends a purchase order. The supplier accepts the purchase order and responds by issuance of sales order to the buying company. This serves as a purchase order acknowledgment.

If there is a requirement for deferred or scheduled deliveries, the supplier provides a shipping schedule in response to the buyer's request.

Phase 6: Purchase Order Updates

Any modifications/changes on purchase order details are transmitted to and from buyer and supplier to be used for purchase order updates. These changes are accompanied with P.O. change and P.O. change acknowledgment documents.

Phase 7: Follow-Up of Outstanding Orders and Order Deliveries

Upon receipt of updated purchase order from buying company by supplier, goods and services are delivered in compliance to the purchase order. Transactions between buying company and supplier are effected through the actual delivery of goods and services and validated by supplier issuance of ship notices and buying company's acknowledgment of delivery by providing an actual receipt advice. Actual deliveries are validated versus the purchase order for monitoring purpose by buying company. At the supplier's end, the acknowledged deliveries are monitored versus the sales order. Both buying company and supplier conduct their own manual reconciliation of purchase order and sales order respectively to avoid over or under delivery. Both parties exchange order status inquiries and reports.

Phase 8: Acceptance and Validation of Invoices

Upon confirmation of actual deliveries by buying company, the supplier prepares an invoice to reflect the amount for payment of all goods and services that was rendered. This invoice is sent to the buying company for verification and payment. The buying company receives this invoice and manually counterchecks with actual deliveries and purchase order. If correct, the invoice is sent to the Finance Department for payment preparation.

Phase 9: Payment to Supplier

Upon receipt of the supplier invoices, the Finance Department double checks accuracy and completeness of the invoice versus purchase order and actual receipt reports. Afterwards, the Finance Department prepares the final payment order to the supplier. Most payments are in the form of checks or cash. Accounts payable entry at buying company and accounts receivable entry at supplier are both adjusted upon realization of payment.

A graphical representation of this traditional process is shown in FIG. 1.

The common modes of communication and document transfer between the buyer and seller are made thru telephone, fax or mail as shown in FIG. 2.

Most of the intra and inter enterprise processes involved are paper based. It is tedious, time consuming, labor intensive, error prone and causes delay for buyers and sellers to conduct these business transactions if it is purely paper based. Due to the business need to improve this process, electronic and computer based systems were introduced. We will simply define this as electronic business applications (EBAs).

There are three significant electronic business applications (EBAs) that address the process improvement on the traditional procurement process. These are; 1) enterprise resource planning systems (ERP), 2) electronic data interchange (EDI) and 3) electronic marketplaces using extensible markup language (XML) based technology.

Each electronic business application will be discussed on how it contributed to the improvement and automation of the traditional procurement process.

The enterprise resource planning (ERP) system provides a sophisticated system that address data processing solutions across all areas of business within the organization. With the use of ERP systems, buyers are able to automate their procurement process to increase efficiency within the corporation. Also, sellers with ERP systems are able automate their sales process to counteract with the buying corporate entities.

These are the automated phases of the traditional procurement processes that are made possible with the use of ERP system.

1. Purchase Requisition

Purchase requisitions are entered into the purchasing system of the computerized business application. These requisitions are subjected to automated electronic approvals. Once a requisition has passed through electronic approvals, it can be converted automatically into a request for quotation or a purchase order without a need to reenter all data found on the purchase requisition. Advance ERP systems are also capable of converting multiple purchase requisitions into a consolidated RFQ. The ERP system are capable of converting a purchase requisition into a request for quotation (RFQ) if it needs to source a new supplier or convert it into a purchase order if there is already a source of supply.

2. Selection of Suppliers/Sellers

All approved purchase requisitions are subjected to source identification or selection of suppliers. The ERP system identifies if the requisition has; 1) a fix supplier, 2) an outstanding (longer-term) purchase agreement and 3) purchasing info record. The selection process is made possible through data storage of these records in the automated system.

A “fix supplier” is defined as a relevant source that is regarded as “preferred” source over a period of time. In this case, requisitions found with this kind of source are converted into a purchase order with automatic awarding of purchase order to the fix supplier. There is no need for the buyer to issue a request for quotation for a fix supplier since it is already the identified supplier unless the buyer wishes to change supplier for valid business reasons.

An outstanding (longer-term) purchase agreement defines a negotiated agreement with supplier concerning the supply of materials or the rendering of services subject to specific conditions. The conditions apply for a defined period of time and to a defined total quantity or a certain total value of goods/services to be supplied. The date on which a delivery of materials is to take effect (or work is to be performed or services rendered) must be specified in a separate process (by the subsequent issue of release orders or delivery schedules referring to the basic agreement). These are two types of outline agreement; 1) contracts, 2) scheduling agreements.

Contracts can take one of two basic forms: the value contract and the quantity contract. (Note that this concept is referred to by a wide variety of different terms in the literature and in practice, including “blanket order”, “blanket contract”, “period contract”, “bulk contract” and “master agreement/contract”).

In the case of the value contract, the purchase of materials or services up to a certain total value is agreed.

With the quantity contract, the purchase of a certain total quantity of materials or services is agreed.

The scheduling agreement is a longer-term purchasing arrangement between a supplier and a buyer that involves the subsequent creation and regular updating of schedules (supplier schedules) for the delivery of the materials specified in each item of the agreement. The agreement specifies the total (target) quantities to be supplied during the validity period of the agreement.

Where procurement is carried out on the basis of scheduling agreement, the buyer does not subsequently issue individual purchase orders (or release orders) to the supplier. Instead, the vendor receives a delivery schedule that is periodically updated. Each line of the delivery schedule represents an individual shipment, indicating the quantity to be delivered, the delivery date and, if required, the delivery time-spot (for JIT deliveries). These lines are equivalent to orders which, in turn, can be regarded as firm, semi-firm or planned, depending on whether the schedule line in question falls within the firm, trade-off, or planning zone of the delivery schedule.

Automated procurement based on these scheduling agreements provides the following advantages; 1) reduced processing time and fewer paper transactions, as delivery schedules can take the place of a larger number of individual purchase orders or release orders; 2) stockless, or near-stockless, purchasing, since the option of specifying a precise delivery time-spot facilitates the delivery of ordered goods or materials on the Just-In-Time (JIT) principle; 3) shorter supplier lead times for the individual shipments. The supplier does not have to make available the total order quantity set out in the agreement “in one go”, but can deliver bit-by-bit over a period as schedules. The supplier is also better able to plan the use of production resources.

There is no need for the buyer to issue a request for quotation for approved requisitions that are subjected for outline agreements since supplier is already identified.

The purchasing info record establishes the relationship between a supplier and a material or service. It contains data such as a vendor's prices and conditions with regard to a material and is therefore an important source of information for purchasing. This record identifies all suppliers with the capability to produce the required material or service. Therefore, this automation eliminates the manual process of maintaining price index cards for each supplier for each supplied goods or services.

The purchasing info records can be updated automatically when the buyer creates a purchase order. When a PO item is created, data (such as valid conditions) is copied from the info record.

At this point, the buyer determines whether all conditions are favorable in the purchasing info record before requisitions are to be converted into a purchase order to be awarded to the supplier with the selected purchasing info record.

The approved purchase requisition will only be subjected for quotation (RFQ) if; 1) there is no available sources of supply, 2) buyer is not satisfied with the existing sources of supply, 3) buyer is subjected to audit requirements in compliance to corporate purchasing guidelines.

3. Request for Quotations

Quotations are solicited from vendors through the issue of RFQs. RFQs can be generated from a requisition with all requisition details automatically converted into RFQs without a need for data reentry. Purchase requisitions are consolidated for bulk buying therefore reducing paperwork and document volume. RFQs are sent to a number of different suppliers.

The ERP system automatically determines whether the transmission or output will occur by post, fax, or electronically. The output includes both electronic output via electronic data interchange (EDI) and printed documents to be sent via fax or mail as the preferred mode. At this point, this is first engagement with external partners to provide business information. The concept of EDI will be discussed later as another development in automating the traditional procurement process.

4. Maintain Quotations

Suppliers respond to the buyer issued RFQs within a given time frame via the RFQ itself or issuance of a sales quotation (SQ). Requested information on; 1) fulfillment capability to provide the required material or service based on required specifications and quality as provided by buyer, 2) capability to delivery on or before the required delivery date, 3) pricing and other conditions, 4) other information relevant to buyer's selection are encoded in the quotation.

After all quotations are returned by the suppliers and encoded by the buyer in ERP, buyers can carry out a comparative analysis of quoted prices and conditions using the price comparison list provided by the ERP system. The price comparison list permits determination of the most favorable quotation. This data is automatically stored in a purchasing info record, while rejection letters can be generated for vendors whose quotations were deemed unsatisfactory.

The most favorable quotation is then identified for further processing into a purchase order.

The sales quotation is the corresponding document provided by the seller in response to the buyer's RFQ. EDI technology is used to transmit these documents.

A supplier-updated quotation contains a supplier's prices and conditions for the specified materials or services. It may also include additional information.

5. Granting of Purchase Order to the Identified Supplier

In the ordering phase, the buyer's goal is to process purchase orders with a minimum of time and effort. For this reason, when creating purchase orders, the buyer will normally reference data that already exists in the ERP system. Apart from the benefit of a reduced workload in terms of data entry, the ERP referencing functions minimize the likelihood of errors and ensure data consistency.

When creating a purchase order, for instance, the buyer can reference a requisition. The buyer selects requisitions from a list and generates purchase order items from them.

If a contract (longer-term buying arrangement) exists for the requested material, the buyer can reference the contract item in order to create a release order. In the case of a release order, only the order quantity and the delivery date need be entered; other details, such as texts, prices and conditions, is copied from the contract.

For favorable RFQs, the RFQ line items are automatically converted into a purchase order and sent to the supplier. The purchase order is sent in printed form via fax or mail or electronic form via EDI. At this point, this is another engagement that buyer provides business information to external partner/supplier.

The sales order is the corresponding document provided by the seller in confirmation to the buyer's purchase order.

6. Purchase Order Updates

Any modifications, changes and cancellations on purchase order details are transmitted to and from buyer and supplier to be used for purchase order updates. These changes are accompanied with P.O. change, P.O. cancel and P.O. change acknowledgment documents.

7. Follow-Up of Outstanding Orders and Order Deliveries

Goods are delivered by supplier with corresponding delivery documents (e.g. delivery report, delivery notice, shipping notification, etc.). These documents are sent via printed form or EDI to the receiving person at the buying company.

When goods are delivered for a purchase order, data entry of the goods receipt is always related to the purchase order. This has the following advantages; 1) when the goods receipt is entered, the system proposes default data from the purchase order (e.g. materials ordered, quantities). This simplifies both the data entry itself and the monitoring of the goods received (over deliveries, under deliveries); 2) the goods receipt data is updated in both the purchase order history and supplier evaluation records of the ERP system. This allows purchasing to follow the purchase order history and, in the event of non-delivery, institute the necessary reminder procedures. The goods receipt data also enables supplier evaluation to determine the supplier's reliability regarding adherence to delivery dates and the accuracy of quantities delivered; 3) the supplier invoice is verified on the basis of the quantity ordered and delivered; 4) valuation of the goods receipt is based on the price stated in the purchase order and/or invoice.

The buyer will automatically be notified of the goods receipt via the ERP system. The ERP system also is configurable to allow or disallow under deliveries and over deliveries.

The acknowledged delivery documents are sent back to the supplier via printed or electronic means for updating of sales records and preparation of sales invoice. The sales invoice is sent to supplier for payment processing.

8. Acceptance and Validation of Invoices

The buying company receives a sales invoice in printed or electronic form after the goods and services are delivered. When an invoice is posted, the accounting records are updated due to the high degree of integration between the procurement system and the financial system found in the ERP system.

In the case of an invoice with reference to a purchase order, the authorized person in the buying company is required to enter the order number only. The system automatically proposes the vendor with tax rate, terms of cash discount, and the individual quantities and values based on agreed purchase order. All these defaults can be changed since the invoice can display variances.

Invoices with reference to goods receipts are a special form of order-based invoices. The accounts payable clerk enters the reference number found on the delivery document. This reference number should also be the same number that was used during the goods receipt entry process. The ERP system determines, retrieves and proposes the required data. Individual deliveries can be settled in this way.

The ERP system informs the buying company of variances via system messages. The buying company can set tolerance limits for variances in the individual invoice items. If the variances are within the limits, they are accepted by the system; if they exceed, the authorized person of the buying company will receive a message indicating that they must be corrected. If the upper limit is exceeded, the document can be posted but it is blocked for payment. The blocked invoice can only be settled by financial accounting once the document is electronically released in a separate translation.

9. Payment to Supplier

Invoices that are entered and validated in the ERP system are processed further for payment. The ERP system provides an effective and efficient way of validating all purchase orders and goods receipts versus the sales invoice. If there are no more unqualified and unauthorized tolerable variances, the sales invoice is process for payment and relevant supplier payables are cleared from the ERP system.

FIG. 3 provides an understanding of the ERP system coverage on both buyer and seller.

ERP systems cover business process automation within the company who owns the ERP system. Extending the business process automation to cover electronic business exchange among business partners was made possible thru the introduction of electronic data interchange (EDI) as illustrated on FIG. 3.

Electronic Data Interchange (EDI) is the computer-to-computer exchange of business information using a public standard. EDI is a part of Electronic Commerce, because it enables businesses to exchange business information electronically much faster, cheaper and more accurately than is possible using paper based systems.

In EDI, the electronic equivalents of common business documents, such as Requests for Quotations, Purchase Orders and Invoices are transmitted electronically between the computers of Trading Partners. A Trading Partner is “a business that has agreed to exchange business information electronically.” These electronic documents are given standardized electronic formats and numbers (referred to as ANSI X12 or EDIFACT standards), so everyone involved can correctly interpret the information that is sent to them. Value Added Networks (VANs), companies similar to long-distance phone companies, provide telecommunications connectivity between Trading Partners. Translation software is used by each Trading Partner to translate the business data from common ASCII (or other) format to ANSI X12 or EDIFACT format, and vice-versa.

EDI happens between companies, it is cross-enterprise. While the last 30 years have been seen a significant growth in the use of computers and advanced technologies within companies, the same trend did not occur between companies. It is only recently that a focus on inter-organizational communications has taken place. While the technology of EDI can be used internally within an organization, by definition EDI is organization-to-organization.

While an ERP system takes care of automating and integrating business process within an enterprise (intra-enterprise), EDI complements this system by extending the automation towards the enterprise business partners (inter-enterprise) who are using different ERP systems. In such a way, EDI provides the technology that connects trading partners' different ERPs or other electronic business systems (EBAS) to allow computer-to-computer exchange of business documentation in a standard, machine-readable format.

Although EDI technology was able to address the electronic conversion and exchange of business documents across business partners, there are still a lot of limitations on why EDI technology was not used by other companies.

These are some of the limitations of EDI technology.

First, EDI technology requires companies to conform to EDI standards and infrastructure requirements. The company and its business partners need to get a DUNS number as the company code required for Interchange ID qualifiers. ERP systems of participating companies need to maintain DUNS numbers to comply with EDI technology.

Second, EDI technology only allows the maintenance of two kinds of item codes. These are the BP—Buyer Part Number and VP—vendor part number. There is no EDI field that allows the maintenance of global trade identification number (GTIN) and other item code standards.

In the succeeding sections, buyer defined item code (BDIC), BP—buyer part number and customer part number (CPN) are all the same codes referring to the buyer defined proprietary item code. Likewise, seller defined item code (SDIC), VP—vendor part number and manufacturer part number (MPN) are all the same codes referring to the seller defined proprietary item code.

Third, EDI technology only allows the maintenance of ANSI code for country code. Therefore, it will only support EBAs capable of maintaining ANSI code for country code. EBAs using company defined country codes need to convert this to comply with ANSI code required by EDI technology.

Fourth, EDI technology has a predefined list of packaging code or unit of measure code (UOM). This list is limited and not all are compliant to ISO defined unit of measure. Also, EBA need to comply to these unit of measure codes predefined by EDI technology.

Fifth, EDI technology does not support the processing of item code descriptions and classifications.

Sixth, EDI technology does not support electronic auctions and reverse auctions.

Seventh, EDI technology does not support processing of currency codes and descriptions.

Eight, EDI technology allows sending of RFQs to prequalified suppliers known to the buyer. It does not address the automated sourcing capability that allows buyers to automatically source suppliers (whether these suppliers are known or not to the buying company) capable of fulfilling the goods/services required.

Ninth, EDI technology does not address the automated offering capability that allows supplier to automatically offer their products and services to potential buyers (whether these buyers are known or not by the supplier).

Tenth, EDI technology does not allow storage of business partners and product codes and details that can be shared to other interested buyers and sellers. There is no entity or intermediary that provides the infrastructure to handle business partner registration, product details, and transaction details that can be shared for sourcing and offering of goods and services.

By definition, sellers will be referred to by this invention as the seller, supplier, selling company, manufacturer, source of supply or source entity. Buyers will be referred to by this invention as the buyer, customer or buying company.

A graphical representation of ERP—EDI system between a buyer and a seller is shown in FIG. 4. A selected list of EDI standards is shown if FIG. 5. FIG. 6 represents the EDI standards required for each business process. FIG. 7 represents the EBA—EDI set up. FIG. 8 represents the EBA—XML set up where business data and transactions can be transmitted electronically via Internet using XML technology as another alternative for companies using EDI technology. FIG. 9 lists the major data for electronic transmission. These data include trading partner profile, item/product details and transaction details that are matched and exchanged among business partners. FIG. 10 represent the invention's infrastructure coverage.

Due the EDI's infrastructure limitation to handle sourcing and offering requirement of business partners and the emergence of Internet, another Internet-based technology was introduced. This third significant electronic business application that address the process improvement on the traditional procurement and selling process is thru Internet based electronic business exchanges or marketplaces using XML technology.

These digital marketplaces act as a central hub to allow business partner registration, product registration, and for buyers and sellers to meet and conduct business in an environment as vast as the Internet. These electronic marketplaces allow buyers and sellers to transact business via two ways: 1) electronic catalogs and 2) auctions/reverse auctions. Electronic marketplaces are owned and operated by either individual companies or industry consortiums.

Electronic marketplaces use electronic catalogs for fixed priced and negotiated commodities. Buyers use these catalogs to search for items based on their descriptions and compare items based on its competitive pricing before buying. The catalog prices are pre-negotiated by the consortium members of a digital marketplace and provided to participants. Suppliers register their products on these catalogs via these electronic marketplaces thru fix and/or variable subscription fees.

There are also supplier-hosted catalogs that are offered to potential buyers via the Internet. These catalogs can be customized to adhere on buyer specific pricing.

Most electronic catalogs found on electronic marketplaces cater to maintenance, repair and operating (MRO) items requirements of enterprises. Deeper understanding of MRO items pertains to items that are not inventory valuated. A good example is engine oil. This is an indirect material that is chargeable as an operating expense to a freight forwarding company where its' company fleet of cargo vehicles use this oil as an operating and maintenance item. This item now becomes an indirect item that is chargeable to operating expenses of the company. This case is not true for an automobile manufacturer that uses the engine oil as a direct material for the manufacture of an automobile engine. In this case, the engine oil is incorporated as part of the product cost in the manufacture of the final finished product—the automobile engine. Therefore, the item is valuated as an inventory of the company and not an expense item.

It is simple to maintain and use electronic marketplaces if buying companies 1) prefer a common and cheaper bulk price that can be negotiated from suppliers supplying MRO items to be offered to all buyers registered in the marketplace; 2) does not require product codes for MRO expense items; 3) does not require seamless electronic transmission of business documents for ERP systems being interfaced to the electronic marketplaces or catalogues.

Problems arise when buying companies require 1) extended functionality to cover competitive sourcing of direct materials from reliable list of potential suppliers (whether these suppliers are know to them or not); and 2) seamless electronic transmission of business documents for ERP systems being interface to the electronic marketplaces or catalogues.

Stop gap solutions such as electronic auctions and reverse auctions were introduced as enhancements for these electronic marketplaces. This solves a portion of the business requirement for competitive sourcing. It only solves the business requirement of allowing suppliers to offer their goods and services but does not solve the transactional requirement of allowing electronic documents to be seamlessly transmitted from the buyer's ERP to the seller's ERP via the marketplace where item codes, company codes and other codes are matched by the system necessary for ERP systems to understand that these codes are referring to the same item, company, unit of measure, country, class and currency.

ERP systems and electronic marketplaces were enhanced to be capable of conducting 1) auctions to post seller offerings over the Internet and 2) reverse auctions to post buyer requirement over the Internet. Some electronic marketplaces even provide a hosted electronic procurement and sales systems to allow buyer and seller registrants respectively to use this service in the absence of ERP functionality required. By understanding extensively the capability of current systems, it was noticed that buyers could select a potential source from a list of suppliers posted by the auction system. Once the selection process has been made, there was no clear process to automate the transaction to allow the product and company code match which is essential for inter company electronic business document and transaction exchange. Company ERP systems should first understand that this supplier defined supplier company code (SSCC) is referring to the buyer defined supplier company code (BSCC) and Data Universal Numbering System of the supplier (SCCDUNS) as one and the same entity. The same is true for supplier defined buyer company code (SBCC) that is referred to as the buyer defined buyer company code (BBCC) and Data Universal Numbering System of the buyer (BCCDUNS).

The same is true for item codes wherein the supplier defined item code is referring to the buyer defined item code and corresponding Global Trade Identification Number (GTIN) as one and the same item. The same applies for country codes, unit of measure codes, currency code and other codes needed for standardization and matching required for electronic business document and transaction exchange.

In summary, electronic marketplaces and catalogues allow strategic sourcing and offering over the internet. But the major problem lies on how companies will be able to interface their ERP systems via this electronic marketplaces and catalogues in such a way that it will allow seamless transmission of electronic documents using matched company codes, item codes, unit of measure codes and other codes. There is no intermediary electronic marketplace today that offers a service to match these codes as a vital requirement so that buyer and seller systems can transmit electronic documents.

To address some of EDI and electronic marketplace limitations, the Rosettanet organization was created to drive a collaborative development and rapid deployment of Internet-based business standards, creating a common language and open e-business processes.

RosettaNet dictionaries provide a common set of properties for business transactions and products. The RNIF provides common exchange protocols. Together, they form the basis for the implementation of RosettaNet Partner Interface Processes (PIPs), which define business processes between trading partners.

RosettaNet was the venue for companies to standardize and agree on common business practice, terminology and standards to use over the Internet using XML technology to allow the electronic business document and transaction exchange among business partners.

RosettaNet based technology attempts to solve the problem of electronic business document and transaction exchange by leveraging on existing open e-business standards, guidelines and specifications for cross-platform, -application and -network communication. We assume that the primary mission of RosettaNet is similar to what EDI technology has accomplished over the past years except that RosettaNet will use XML over Internet as the medium.

These are some of the limitations of Rosettanet technology:

First, Rosettanet technology requires companies to conform to Rosettanet standards and infrastructure requirements. The company and its business partners need to get a DUNS number as the company code required for GlobalBusinessIdentifier, a fundamental business data element of Rosettanet PIP. ERP systems of participating companies need to maintain DUNS numbers to comply with RosettaNet technology. This is a mandatory requirement so that companies can participate.

Second, Rosettanet technology identified only one proprietary company code. Therefore, we can assign the buyer defined company code to ProprietaryBusinessIdentifier, another fundamental business data element of Rosettanet PIP. There is no fundamental business data element defined in Rosettanet PIP where we can assign and store the seller defined company code.

Third, Rosettanet technology allows the maintenance of two kinds of item codes. These are the 1) GlobalProductIdentifier, the fundamental business data element of Rosettanet PIP for GTIN and 2) ProprietaryProductIdentifier, the fundamental business data element of Rosettanet PIP where we can assign the buyer defined item code. There is no Rosettanet fundamental business data element where we can assign and store the seller defined item code. At the very least, buyer and seller EBAs should support maintenance of manufacturer part numbers (MPNs) and customer part numbers (CPN) respectively for the extraction of these item codes to be used by the Rosettanet PIP.

Fourth, Rosettanet technology allows the maintenance of ISO code for country code. Therefore, it will only support EBAs capable of maintaining ISO code for country code. EBAs using company defined country codes need to convert this to comply with ISO code required by Rosettanet technology. There is no fundamental business data element defined in Rosettanet PIP where we can assign and store the buyer and seller defined country codes so that non-compliant to ISO EBAs can still use Rosettanet technology.

Fifth, Rosettanet technology allows the maintenance of ISO code for unit of measure code (UOM). Therefore, it will only support EBAs capable of maintaining ISO code for unit of measure code. EBAs using company defined unit of measure codes need to convert this to comply with ISO code required by Rosettanet technology. There is no fundamental business data element defined in Rosettanet PIP where we can assign and store the buyer and seller defined unit of measure codes so that non-compliant to ISO EBAs can still use Rosettanet technology.

Sixth, Rosettanet technology allows the maintenance of ISO code for currency. Therefore, it will only support EBAs capable of maintaining ISO code for currency. EBAs using company defined currency code need to convert this to comply with ISO code required by Rosettanet technology. There is no fundamental business data element defined in Rosettanet PIP where we can assign and store the buyer and seller defined currency codes so that non-compliant to ISO EBAs can still use Rosettanet technology.

Seventh, Rosettanet technology does not support electronic auctions and reverse auctions.

Eight, Rosettanet technology allows sending of RFQs to prequalified suppliers known to the buyer. It does not address the automated sourcing capability that allows buyers to automatically source suppliers (whether these suppliers are known or not to the buying company) capable of fulfilling the goods/services required.

Ninth, Rosettanet technology does not address the automated offering capability that allows supplier to automatically offer their products and services to potential buyers (whether these buyers are known or not by the supplier).

Tenth, Rosettanet technology does not allow storage of business partners and product codes and details that can be shared to other interested buyers and sellers. There is no entity or intermediary that provides the infrastructure to handle business partner registration, product details, and transaction details that can be shared for sourcing and offering of goods and services.

To summarize it all; 1) ERP systems were able to automate the buying and selling processes within the company, 2) EDI provided the technology to allow the transfer and exchange of electronic documents related to the buying and selling processes via value added networks and 3) electronic marketplaces used XML technology to allow the transfer and exchange of documents via Internet, as the cheaper alternative. RosettaNet technology was activated to standardize and agree on common business practice, terminology and standards to use over the Internet using XML technology to allow the electronic business document and transaction exchange among business partners.

Even though all of these aforementioned systems attempt to solve the business requirements related to the total procurement and selling process among business partners in a fragmented manner, there is still no available total solution in the market that covers the most important capabilities to provide; 1) an Internet based registration system and repository for business partners and products/services being sourced/offered from/to the market; 2) a matching engine where codes (i.e. company code, item code, currency code, unit of measure code, country code, etc) are extracted, stored and matched versus the business partner defined codes and global standards body defined codes therefore making it possible to electronically exchange business documents and transactions in a seamless fashion; 3) electronic sourcing/offering of products/services; 4) support for EDI technology; 5) interface to various EBAs with or without GTIN, DUNS and ISO standards support; 5) interface to various EBAs with or without CPN and MPN support; and 5) a total solution to cover registration of business partners, automation of buying and selling process, exchange of electronic documents, match of codes, EDI and Rosettanet support and sourcing/offering of products and services over the Internet.

### BRIEF SUMMARY OF THE INVENTION

This invention relates in general to a system and method for business-to-business buying, selling, sourcing and matching of products and services across multiple business partners over the Internet.

The invention covers an internet based solution comprise of: 1) business partner registration, 2) buying and selling processing, 3) matching of codes, 4) conversion of EDI transactions, 5) sourcing/offering of products/services and 6) electronic documents processing. This covers point-to-point and many-to-many business partner and transactions set up. The invention's coverage and set-up are both illustrated on FIG. 11 and FIG. 12.

This invention covers an infrastructure that includes computer hardware, computer software, interfaces, translators, connectors, programs, development tolls, hosted applications, database, networks and standards as illustrated in FIG. 19.

This invention covers the hosting and interfacing of various electronic business applications (EBAs). Such EBAs include enterprise resource planning (ERP) systems, customer relationship management (CRM) software, online stores, desktops based applications, legacy systems, electronic marketplaces, supply chain systems, e-procurement and other buying and selling applications as illustrated in FIG. 19.

This invention supports EBAs with or without support on EDI and Rosettanet technology.

This invention supports EBAs with or without support on customer part number (CPN) and manufacturer part number (MPN) maintenance.

This invention supports EBAs with or without support on DUNS, GTIN, ISO and other globally set standards for item codes, company codes, unit of measure, currency, class and country codes.

This invention provides a solution to extract, interface, match and store codes such as company codes, product/service codes, currency code, unit of measure code, country code and class code from globally defined codes and business partner defined codes.

This invention is deployed on a global scale involving interconnection between various electronic business applications (EBAs) over the Internet.

This invention allows public and private auctions and reverse auctions where electronic business documents are generated and transmitted electronically across buyer and seller EBAs. This invention is capable of converting these confirmed transactions related to auctions and reverse auctions into request for quotations (RFQ) and sales quotations (SQ).

This invention allows many-to-many business partner electronic documents transmission instead of point-to-point transaction that is a characteristic of EDI and RosettaNet based transactions.

### BRIEF DESCRIPTION OF THE SEVERAL VIEWS OF THE DRAWING

FIG. 1 is a diagram illustrating the typical buying and selling processes conducted between business partners.

FIG. 2 is a diagram illustrating the traditional modes of communication being used by companies to transmit business documents.

FIG. 3 is a diagram illustrating electronic data interchange (EDI) as the technology used to electronically transmit purchasing and sales documents among business partners.

FIG. 4 is a diagram illustrating the infrastructure required to conduct electronic data interchange (EDI) to connect the electronic business application (EBA) of business partners.

FIG. 5 is a summary of the most commonly used ANSI X12 standards.

FIG. 6 is a diagram illustrating the corresponding EDI X12 standards being used in the typical buying and selling processes conducted between business partners.

FIG. 7 is a diagram illustrating the electronic business applications (EBAs) being interfaced to EDI infrastructure. Value Added Networks (VANs) are required to connect EDI applications.

FIG. 8 is a diagram illustrating the electronic business applications (EBAs) being interfaced to XML infrastructure. Internet is required as the medium for XML based transactions.

FIG. 9 is a diagram illustrating that trading partner profile, item/product details and transaction details are being matched and exchanged electronically using EDI and/or XML technology.

FIG. 10 is a diagram illustrating the infrastructure coverage of the invention.

FIG. 11 is a diagram illustrating the major process coverage of the invention.

FIG. 12 is a diagram illustrating that the major coverage of the invention is extended to multiple business partners.

FIG. 13 is a diagram describing that the buyer-defined seller's company code is extracted from the buyer's electronic business application (EBA) and matched via EDI to the seller-defined seller's company code which is extracted from the seller's electronic business application (EBA) system. DUNS number is required by EDI so that matching of company codes is possible.

FIG. 14 is a diagram describing that the buyer-defined buyer's company code is extracted from the buyer's electronic business application (EBA) and matched via EDI to the seller-defined buyer's company code which is extracted from the seller's electronic business application (EBA) system. DUNS number is required by EDI so that matching of company codes is possible.

FIG. 15 is a diagram describing that the buyer defined item code is extracted from the buyer's electronic business application (EBA) and matched via EDI to the seller defined item code, which is extracted from the seller's electronic business application (EBA). This is only possible if buyer's EBA is capable of maintaining and assigning manufacturer/vendor part numbers (MPN) to the buyer defined item code. Also, seller's EBA should be capable of maintaining and assigning customer part numbers (CPN) to its seller defined item code.

FIG. 16 is a diagram illustrating the buyer defined seller company code, buyer defined buyer's company code and buyer defined item code are matched respectively to the seller defined seller's company code, seller defined buyer's company code and seller defined item code. Matching is done via EDI-VAN or XML-Internet. This is possible if EBAs are capable of maintaining and assigning DUNS, Manufacturer Part Numbers (MPN) and Customer Part Numbers (CPN).

FIG. 17 is a diagram extending FIG. 16 to cover multiple buyers and sellers doing buyer-to-seller matching of codes.

FIG. 18 is a diagram extending FIG. 17 to describe the invention's coverage. The invention covers an Internet based engine for processing of multiple buyer and seller registration, buying and selling processing, converting EDI-XML transactions, exchanging electronic documents, matching, sourcing, interfacing business systems, storing and processing of data and hosting business applications.

FIG. 19 is a diagram extending FIG. 18 where it highlights the technology to use by the invention, business systems to interface the invention and standards to adapt by the invention.

FIG. 20 is a diagram showing multiple buyer and seller defined item codes being matched and stored by the invention.

FIG. 21 is a diagram extending FIG. 20 where seller defined item code 1 (SDIC1) can be declared by the invention as a new source for buyer defined item code 2 (BDIC2) if the invention detects that seller defined item code 2 (SDIC2) is equal to buyer defined item code 1 (BDIC1), SDIC1 equal to BDIC1 and SDIC2 equal to BDIC2.

FIG. 22 is a diagram similar to FIG. 21 where this time the seller defined item code 1 (SDIC2) can be declared by the invention as a new source for buyer defined item code 2 (BDIC1) if the invention detects that seller defined item code 1 (SDIC1) is equal to buyer defined item code 2 (BDIC2), SDIC1 equal to BDIC1 and SDIC2 equal to BDIC2.

FIG. 23 is a diagram describing the respective electronic business applications (EBAs) being used by buyers and sellers to connect to the invention.

FIG. 24 is a diagram illustrating the RosettaNet Partner Interface Programs (PIPs) used to connect buyers and sellers.

FIG. 25 is a diagram illustrating the capability of the invention to extract other sources of item codes and match it with seller and buyer defined item codes. The invention provides the extraction of item codes from electronic business applications and other sources, match and storage of these codes.

FIG. 26 is a diagram illustrating the capability of the invention to extract other sources of company codes and match it with seller and buyer company codes. The invention provides the extraction of company codes from electronic business applications and other sources, match and storage of these codes.

FIG. 27 is a diagram illustrating the capability of the invention to extract other sources of class codes and match it with seller and buyer class codes. The invention provides the extraction of class codes from electronic business applications and other sources, match and storage of these codes.

FIG. 28 is a diagram illustrating the ideal configuration of sellers' electronic business applications to handle the matching of item codes. Ideal EBAs require the storage and maintenance of buyer and seller defined item code, GTIN and UCC/EAN codes. This diagram displays the seller engaged to multiple buyers.

FIG. 29 is a diagram illustrating the existing configuration of sellers' electronic business applications to handle the matching of item codes. Existing EBAs maintain the storage and assignment of multiple customer product numbers (CPNs) to each seller defined item code. These CPNs are the buyer defined item codes. This diagram displays the seller being engaged to multiple buyers.

FIG. 30 is a diagram illustrating the invention's capability to extract these item codes from electronic business applications whether these have GTIN/UCC/EAN support or not. The invention's universal trade exchange (UNITE) will use XML technology to extract these item codes from the EBAs and other sources. The invention will extract these codes from seller and its multiple buyers' EBAs, match and store these codes.

FIG. 31 is a diagram illustrating the ideal configuration of buyers' electronic business applications to handle the matching of item codes. Ideal EBAs require the storage and maintenance of buyer defined item code, GTIN and UCC/EAN codes. This diagram displays the buyer engaged to multiple sellers.

FIG. 32 is a diagram illustrating the existing configuration of buyers' electronic business applications to handle the matching of item codes. Existing EBAs maintain the storage and assignment of multiple manufacturer part numbers (MPNs) to each buyer defined item code. These MPNs are the seller defined item codes. This diagram displays the buyer being engaged to multiple sellers.

FIG. 33 is a diagram illustrating the invention's capability to extract these item codes from electronic business applications whether these have GTIN/UCC/EAN support or not. The invention's universal trade exchange (UNITE) will use XML technology to extract these item codes from the EBAs and other sources. The invention will extract these codes from buyer and its multiple sellers' EBAs, match and store these codes.

FIG. 34 is a diagram illustrating the ideal requirements of an EBA to support all item code standards.

FIG. 35 is a diagram illustrating the invention's capability to extract these item codes from electronic business applications whether these have extended GTIN/UCC/EAN support or not. The invention's universal trade exchange (UNITE) will use XML technology to extract these item codes from the EBAs and other sources. The invention will extract these codes from buyers and sellers' EBAs, match and store these codes.

FIG. 36 is a diagram illustrating that DUNS is a primary code to match company codes. This is a mandatory requirement for companies using EDI and Rosettanet technology.

FIG. 37 is a diagram illustrating the ideal configuration for matching of company codes done via XML on condition that EBAs support the storage of DUNS.

FIG. 38 is a diagram illustrating the invention's capability to handle matching of company codes irregardless of whether EBAs support DUNS capture or not.

FIG. 39 is a diagram illustrating the standards used for class, country, currency and unit of measure codes.

FIG. 40 is a diagram illustrating the ideal configurations of EBAs supporting the capture of these class, country, currency and unit of measure codes.

FIG. 41 is a diagram illustrating the proposed configuration of the invention to support the matching of class codes irregardless of whether EBAs support UN/SPSC class code capture or not.

FIG. 42 is a diagram illustrating the proposed configuration of the invention to support the matching of country codes irregardless of whether EBAs support ISO code capture or not.

FIG. 43 is a diagram illustrating the proposed configuration of the invention to support the matching of currency codes irregardless of whether EBAs support currency code capture or not.

FIG. 44 is a diagram illustrating the proposed configuration of the invention to support the matching of unit of measure (UOM) codes irregardless of whether EBAs support unit of measure code capture or not.

FIG. 45 is a summary diagram showing the capability of the invention to capture, match and store these codes from EBAs and non-EBA sources.

FIG. 46 is a selected list of RosettaNet's Partner Interface Programs (PIPs).

FIG. 47 illustrates RosettaNet's 1A1 Account Request PIP covering SECTION 1—Account Information Resource and SECTION 2—Account Payable Details. Corresponding generic EBA field counterparts are provided.

FIG. 48 illustrates RosettaNet's 1A1 Account Request PIP covering SECTION 3—Accounts Receivable Details. Corresponding generic EBA field counterparts are provided.

FIG. 49 illustrates RosettaNet's 1A1 Account Request PIP covering SECTION 4—Buyer's Bill To Company Details, SECTION 5—Bill To Address Identifier, SECTION 6—Global Account Classification Code, SECTION 7—Global Payment Method Code and SECTION 8—Global Payment Terms Code. Corresponding generic EBA field counterparts are provided.

FIG. 50 illustrates RosettaNet's 1A1 Account Request PIP covering SECTION 9—Lessor Details. Corresponding generic EBA field counterparts are provided.

FIG. 51 illustrates RosettaNet's 1A1 Account Request PIP covering SECTION 10—Partner Role Description. Corresponding generic EBA field counterparts are provided.

FIG. 52 illustrates RosettaNet's 1A1 Account Request PIP covering SECTION 11—Remit To Details. Corresponding generic EBA field counterparts

FIG. 53 illustrates RosettaNet's 1A1 Account Request PIP covering SECTION 12—Ship To Details. Corresponding generic EBA field counterparts are provided.

FIG. 54 illustrates RosettaNet's 1A1 Account Request PIP covering SECTION 13—Sold to Details. Corresponding generic EBA field counterparts are provided.

FIG. 55 illustrates RosettaNet's 1A1 Account Request PIP covering SECTION 14—Submit Purchase Order To Details. Corresponding generic EBA field counterparts are provided.

FIG. 56 illustrates RosettaNet's 1A1 Account Request PIP covering SECTION 15—Submit Returns To Details, SECTION 16—Contract Identifier Details, SECTION 17—Financial Institution Details and SECTION 18—Global Account Code Details. Corresponding generic EBA field counterparts are provided.

FIG. 57 illustrates RosettaNet's 1A1 Account Request PIP covering SECTION 19—Partner Description, SECTION 20—Preferred Currency Details and SECTION 21—Shipping Requirements Resource. Corresponding generic EBA field counterparts are provided.

FIG. 58 illustrates RosettaNet's 1A1 Account Request PIP covering SECTION 22—From Role Details, SECTION 23—Document Details and SECTION 24—To Role Details. Corresponding generic EBA field counterparts are provided.

FIG. 59 provides a summary of all sections covered under RosettaNet's 1A1 Account Request PIP.

FIG. 60 illustrates RosettaNet's 1A1 Account Acknowledgment PIP covering SECTION 1—Account Information Acknowledgment, SECTION 2—From Role Details, SECTION 3—Requesting Document Details and SECTION 4—Document Details. Corresponding generic EBA field counterparts are provided.

FIG. 61 illustrates RosettaNet's 1A1 Account Acknowledgment PIP covering SECTION 05—To Role Details. Corresponding generic EBA field counterparts are provided.

FIG. 62 provides a summary of all sections covered under RosettaNet's 1A1 Account Acknowledgment PIP.

FIG. 63 illustrates RosettaNet's 3A1 Quote Request PIP covering SECTION 1—From Role Details, SECTION 2—Global Document Function Code, SECTION 3—Carrier Information and SECTION 4—Quote Header Comments. Corresponding generic EBA field counterparts are provided.

FIG. 64 illustrates RosettaNet's 3A1 Quote Request PIP covering SECTION 05—Distributed By Company Details. Corresponding generic EBA field counterparts are provided.

FIG. 65 illustrates RosettaNet's 3A1 Quote Request PIP covering SECTION 6—Quote Document Reference Details, SECTION 7—Financed By Company Details, SECTION 8—Government Contract Details and SECTION 9—Pricing Condition. Corresponding generic EBA field counterparts are provided.

FIG. 66 illustrates RosettaNet's 3A1 Quote Request PIP covering SECTION 10—End Customer Contact. Corresponding generic EBA field counterparts are provided.

FIG. 67 illustrates RosettaNet's 3A1 Quote Request PIP covering SECTION 11—Quote Line Item Comments, SECTION 12—Design Registration Details, SECTION 13—Quote Line Item Reference Details, SECTION 14—Government Contract Details, SECTION 15—ISO UOM Code, SECTION 16—Stock Indicator, SECTION 17—Product Substitution Indicator and SECTION 18—Product Details. Corresponding generic EBA field counterparts are provided.

FIG. 68 illustrates RosettaNet's 3A1 Quote Request PIP covering SECTION 19—Competitor's Contact Details. Corresponding generic EBA field counterparts are provided.

FIG. 69 illustrates RosettaNet's 3A1 Quote Request PIP covering SECTION 20—Competitor's Product Details and SECTION 21—Competitor's Product Pricing Details. Corresponding generic EBA field counterparts are provided.

FIG. 70 illustrates RosettaNet's 3A1 Quote Request PIP covering SECTION 22—End Customer Contact Details. Corresponding generic EBA field counterparts are provided.

FIG. 71 illustrates RosettaNet's 3A1 Quote Request PIP covering SECTION 23—Requested Product Quantity and Schedule. Corresponding generic EBA field counterparts are provided.

FIG. 72 illustrates RosettaNet's 3A1 Quote Request PIP covering SECTION 24—Requested Ship From Company Details. Corresponding generic EBA field counterparts are provided.

FIG. 73 illustrates RosettaNet's 3A1 Quote Request PIP covering SECTION 25—Requested Product Pricing Details and SECTION 26—Requote Reference Details. Corresponding generic EBA field counterparts are provided.

FIG. 74 illustrates RosettaNet's 3A1 Quote Request PIP covering SECTION 27—Ship To Company Details. Corresponding generic EBA field counterparts are provided.

FIG. 75 illustrates RosettaNet's 3A1 Quote Request PIP covering SECTION 28—Tax Exempt Details, SECTION 29—Requested Response Period and SECTION 30—Requote Reference Details. Corresponding generic EBA field counterparts are provided.

FIG. 76 illustrates RosettaNet's 3A1 Quote Request PIP covering SECTION 31—Respond To Company Details. Corresponding generic EBA field counterparts are provided.

FIG. 77 illustrates RosettaNet's 3A1 Quote Request PIP covering SECTION 32—Tax Exempt Details, SECTION 33—Quote Request Document Date and Number SECTION 34—To Role Details. Corresponding generic EBA field counterparts are provided.

FIG. 78 provides a summary of all sections covered under RosettaNet's 3A1 Quote Request PIP.

FIG. 79 illustrates RosettaNet's 3A1 Quote Confirmation covering SECTION 1—From Role Details, SECTION 2—Global Document Function Code, SECTION 3—Carrier Information and SECTION 4—Quote Header Comments. Corresponding generic EBA field counterparts are provided.

FIG. 80 illustrates RosettaNet's 3A1 Quote Confirmation covering SECTION 5—Distributed By Company Details. Corresponding generic EBA field counterparts are provided.

FIG. 81 illustrates RosettaNet's 3A1 Quote Confirmation covering SECTION 6—Quote Document Reference Details, SECTION 7—Effective Date of Quote Response and SECTION 8—Financed By Company Details. Corresponding generic EBA field counterparts are provided.

FIG. 82 illustrates RosettaNet's 3A1 Quote Confirmation covering SECTION 9—Freight Charges, SECTION 10—Government Contract Details, SECTION 11—Handling Charges, SECTION 12—Pending Items Indicator and SECTION 13—Pricing Condition. Corresponding generic EBA field counterparts are provided.

FIG. 83 illustrates RosettaNet's 3A1 Quote Confirmation covering SECTION 14—End Customer Contact Details. Corresponding generic EBA field counterparts are provided.

FIG. 84 illustrates RosettaNet's 3A1 Quote Confirmation covering SECTION 15—Quote Line Item Comments, SECTION 16—Country of Origin, SECTION 17—Design Registration Details, SECTION 18—Quote Line Items Reference Details and SECTION 19—Estimated Available Product Quantity and Schedule. Corresponding generic EBA field counterparts are provided.

FIG. 85 illustrates RosettaNet's 3A1 Quote Confirmation covering SECTION 20—Government Contract Details, SECTION 21—Product Terms Code, SECTION 22—ISO UOM Code, SECTION 23—Quote Line Item Status Code, SECTION 24—Stock Indicator, SECTION 25—Product Details and SECTION 26—Order Lead Time Global Document Function Code. Corresponding generic EBA field counterparts are provided.

FIG. 86 illustrates RosettaNet's 3A1 Quote Confirmation covering SECTION 27—Competitor Contact Details. Corresponding generic EBA field counterparts are provided.

FIG. 87 illustrates RosettaNet's 3A1 Quote Confirmation covering SECTION 28—Competitor's Product Details and SECTION 29—Competitor's Product Pricing Details. Corresponding generic EBA field counterparts are provided.

FIG. 88 illustrates RosettaNet's 3A1 Quote Confirmation covering SECTION 30—End Customer Contact Details. Corresponding generic EBA field counterparts are provided.

FIG. 89 illustrates RosettaNet's 3A1 Quote Confirmation covering SECTION 31—Quote Package Details and SECTION 32—Requested Product Quantity and Schedule. Corresponding generic EBA field counterparts are provided.

FIG. 90 illustrates RosettaNet's 3A1 Quote Confirmation covering SECTION 33—Requested Ship From Company Details. Corresponding generic EBA field counterparts are provided.

FIG. 91 illustrates RosettaNet's 3A1 Quote Confirmation covering SECTION 34—Product Pricing Details, SECTION 35—Requote Reference Details and SECTION 36—Quote Reservation Product Quantity and Schedule. Corresponding generic EBA field counterparts are provided.

FIG. 92 illustrates RosettaNet's 3A1 Quote Confirmation covering SECTION 37—Ship From Company Details. Corresponding generic EBA field counterparts are provided.

FIG. 93 illustrates RosettaNet's 3A1 Quote Confirmation covering SECTION 38—Ship To Company Details. Corresponding generic EBA field counterparts are provided.

FIG. 94 illustrates RosettaNet's 3A1 Quote Confirmation covering SECTION 39—Step Pricing and SECTION 40—Substitute Product Details. Corresponding generic EBA field counterparts are provided.

FIG. 95 illustrates RosettaNet's 3A1 Quote Confirmation covering SECTION 41—Tax Exempt Details. Corresponding generic EBA field counterparts are provided.

FIG. 96 illustrates RosettaNet's 3A1 Quote Confirmation covering SECTION 42—Tax Summary Details. Corresponding generic EBA field counterparts are provided.

FIG. 97 illustrates RosettaNet's 3A1 Quote Confirmation covering SECTION 43—Tax Total Amount Details, SECTION 44—Product Unit Price and SECTION 45—Quote Package Amount Details. Corresponding generic EBA field counterparts are provided.

FIG. 98 illustrates RosettaNet's 3A1 Quote Confirmation covering SECTION 46—Refer Quote To Company Details, SECTION 47—Quote Response Period and SECTION 48—Requote Reference Details. Corresponding generic EBA field counterparts are provided.

FIG. 99 illustrates RosettaNet's 3A1 Quote Confirmation covering SECTION 49—Respond To Company Details. Corresponding generic EBA field counterparts are provided.

FIG. 100 illustrates RosettaNet's 3A1 Quote Confirmation covering SECTION 50—Tax Exempt Details, SECTION 51—Terms and Conditions, SECTION 52—Total Quote Price and SECTION 53—Requesting Document Date and Number. Corresponding generic EBA field counterparts are provided.

FIG. 101 illustrates RosettaNet's 3A1 Quote Confirmation covering SECTION 54—Quote Confirmation Document Date and Number and SECTION 55—To Role Company Details. Corresponding generic EBA field counterparts are provided.

FIG. 102 provides a summary of Sections 1-30 covered under RosettaNet's 3A1 Quote Confirmation PIP.

FIG. 103 provides a summary of Sections 31-55 covered under RosettaNet's 3A1 Quote Confirmation PIP.

FIG. 104 illustrates RosettaNet's 3A4 Purchase Order Request covering SECTION 1—From Role Details, SECTION 2—Global Document Function Code and SECTION 3—Bank Account Details. Corresponding generic EBA field counterparts are provided.

FIG. 105 illustrates RosettaNet's 3A4 Purchase Order Request covering SECTION 4—Bill To Company Details. Corresponding generic EBA field counterparts are provided.

FIG. 106 illustrates RosettaNet's 3A4 Purchase Order Request covering SECTION 5—Credit Card Details. Corresponding generic EBA field counterparts are provided.

FIG. 107 illustrates RosettaNet's 3A4 Purchase Order Request covering SECTION 7—Financed By Company and Contact Details. Corresponding generic EBA field counterparts are provided.

FIG. 108 illustrates RosettaNet's 3A4 Purchase Order Request covering SECTION 7—Mode of Payment Details, SECTION 8—P.O. Header Comments and SECTION 9—Contract Partner Details. Corresponding generic EBA field counterparts are provided.

FIG. 109 illustrates RosettaNet's 3A4 Purchase Order Request covering SECTION 10—Purchase Order Document Reference Details, SECTION 11—Financing Terms and SECTION 12—End User Pricing Agreement. Corresponding generic EBA field counterparts are provided.

FIG. 110 illustrates RosettaNet's 3A4 Purchase Order Request covering SECTION 13—Government Contract Details, SECTION 14—Purchase Order Priority Code and SECTION 15—Purchase Order Type Code. Corresponding generic EBA field counterparts are provided.

FIG. 111 illustrates RosettaNet's 3A4 Purchase Order Request covering SECTION 16—Install At Company and Contact Details. Corresponding generic EBA field counterparts are provided.

FIG. 112 illustrates RosettaNet's 3A4 Purchase Order Request covering SECTION 17—Shipment Details. Corresponding generic EBA field counterparts are provided.

FIG. 113 illustrates RosettaNet's 3A4 Purchase Order Request covering SECTION 18—Contract Partner Details for Product Line Items. Corresponding generic EBA field counterparts are provided.

FIG. 114 illustrates RosettaNet's 3A4 Purchase Order Request covering SECTION 19—End Customer Contact Details. Corresponding generic EBA field counterparts are provided.

FIG. 115 illustrates RosettaNet's 3A4 Purchase Order Request covering SECTION 20—P.O. Request Document Reference Details, SECTION 21—Expedite Clause, SECTION 22—ISO UOM Code and SECTION 23—P.O. Priority Code. Corresponding generic EBA field counterparts are provided.

FIG. 116 illustrates RosettaNet's 3A4 Purchase Order Request covering SECTION 24—Install At Company and Contact Details for Product Line Items. Corresponding generic EBA field counterparts are provided.

FIG. 117 illustrates RosettaNet's 3A4 Purchase Order Request covering SECTION 25—Product Line Item Shipment Details. Corresponding generic EBA field counterparts are provided.

FIG. 118 illustrates RosettaNet's 3A4 Purchase Order Request covering SECTION 26—Product Details and SECTION 27—Contract Partner Details for Product Sub Line Items. Corresponding generic EBA field counterparts are provided.

FIG. 119 illustrates RosettaNet's 3A4 Purchase Order Request covering SECTION 28—End Customer Contact Details for Product Sub Line Items. Corresponding generic EBA field counterparts are provided.

FIG. 120 illustrates RosettaNet's 3A4 Purchase Order Request covering SECTION 29—Expedite Clause for Product Sub Line Item, SECTION 30—ISO UOM code for Product Sub Line Item, SECTION 31—P.O. Priority Code for Product Sub Line Item and SECTION 32—Install At Company and Contact Details for Product Sub Line Items. Corresponding generic EBA field counterparts are provided.

FIG. 121 illustrates RosettaNet's 3A4 Purchase Order Request covering SECTION 33—Shipment Details for Product Sub Line Items. Corresponding generic EBA field counterparts are provided.

FIG. 122 illustrates RosettaNet's 3A4 Purchase Order Request covering SECTION 34—Requested Product Pricing Details for Product Sub Line Items. Corresponding generic EBA field counterparts are provided.

FIG. 123 illustrates RosettaNet's 3A4 Purchase Order Request covering SECTION 35—Ship To Company Details for Product Sub Line Items. Corresponding generic EBA field counterparts are provided.

FIG. 124 illustrates RosettaNet's 3A4 Purchase Order Request covering SECTION 36—Sub Line Item Number, SECTION 37—Trading Partner Agreement for Product Sub Line Item, SECTION 38—Requested Transport Event for Product Line, SECTION 39—Requested Ship From Company Details for Product Line Items and SECTION 40—Requested Product Pricing Details for Product Line Items. Corresponding generic EBA field counterparts are provided.

FIG. 125 illustrates RosettaNet's 3A4 Purchase Order Request covering SECTION 41—Ship To Company Details for Product Line Items.

FIG. 126 illustrates RosettaNet's 3A4 Purchase Order Request covering SECTION 42—Tax Exempt Details, SECTION 43—Total Line Item Amount, SECTION 44—Trading Partner Agreement for Product Line Item, SECTION 45—Requested Transport Event for Purchase Order Request and SECTION 46—Requested Ship From Company Details for Purchase Order Request. Corresponding generic EBA field counterparts are provided.

FIG. 127 illustrates RosettaNet's 3A4 Purchase Order Request covering SECTION 47—Secondary Buyer Company Details. Corresponding generic EBA field counterparts are provided.

FIG. 128 illustrates RosettaNet's 3A4 Purchase Order Request covering SECTION 48—Ship To Company Details for Purchase Order Request. Corresponding generic EBA field counterparts are provided.

FIG. 129 illustrates RosettaNet's 3A4 Purchase Order Request covering SECTION 49—Tax Exempt Details for Purchase Order Request, SECTION 50—Total Amount of Purchase Order Request, SECTION 51—Purchase Order Request Document Data and Number and SECTION 52—To Role Details. Corresponding generic EBA field counterparts are provided.

FIG. 130 provides a summary of Sections 1-26 covered under RosettaNet's 3A4 Purchase Order Request PIP.

FIG. 131 provides a summary of Sections 27-52 covered under RosettaNet's 3A4 Purchase Order Request PIP.

FIG. 132 illustrates RosettaNet's 3A4 Purchase Order Confirmation covering SECTION 1—From Role Details, SECTION 2—Global Document Function Code and SECTION 3—Bank Account Details. Corresponding generic EBA field counterparts are provided.

FIG. 133 illustrates RosettaNet's 3A4 Purchase Order Confirmation covering SECTION 4—Bill To Company Details. Corresponding generic EBA field counterparts are provided.

FIG. 134 illustrates RosettaNet's 3A4 Purchase Order Confirmation covering SECTION 5—Credit Card Details. Corresponding generic EBA field counterparts are provided.

FIG. 135 illustrates RosettaNet's 3A4 Purchase Order Confirmation covering SECTION 6—Financed By Company and Contact Details. Corresponding generic EBA field counterparts are provided.

FIG. 136 illustrates RosettaNet's 3A4 Purchase Order Confirmation covering SECTION 7—Mode of Payment Details, SECTION 8—P.O. Header Comments and SECTION 9—Contract Partner Details. Corresponding generic EBA field counterparts are provided.

FIG. 137 illustrates RosettaNet's 3A4 Purchase Order Confirmation covering SECTION 10—Purchase Order Document Reference Details, SECTION 11—Financing Terms and SECTION 12—End User Pricing Agreement. Corresponding generic EBA field counterparts are provided.

FIG. 138 illustrates RosettaNet's 3A4 Purchase Order Confirmation covering SECTION 13—Government Contract Details, SECTION 14—Purchase Order Priority Code, SECTION 15—Purchase Order Type Code, SECTION 16—Purchase Order Confirmation Type Code, SECTION 17—Purchase Order Acknowledgment Reason Code and SECTION 18—Purchase Order Status Code. Corresponding generic EBA field counterparts are provided.

FIG. 139 illustrates RosettaNet's 3A4 Purchase Order Confirmation covering SECTION 19—Install At Company and Contact Details. Corresponding generic EBA field counterparts are provided.

FIG. 140 illustrates RosettaNet's 3A4 Purchase Order Confirmation covering SECTION 20—Shipment Details. Corresponding generic EBA field counterparts are provided.

FIG. 141 illustrates RosettaNet's 3A4 Purchase Order Confirmation covering SECTION 21—Contract Partner Details for Product Line Items. Corresponding generic EBA field counterparts are provided.

FIG. 142 illustrates RosettaNet's 3A4 Purchase Order Confirmation covering SECTION 22—End Customer Contact Details. Corresponding generic EBA field counterparts are provided.

FIG. 143 illustrates RosettaNet's 3A4 Purchase Order Confirmation covering SECTION 23—Product Line Item P.O. Confirmation Document Reference Details, SECTION 24—Expedite Clause, SECTION 25—ISO UOM Code, SECTION 26—P.O. Product Line Priority Code, SECTION 27—Purchase Order Line Item Acknowledgment Reason Code and SECTION 28—Purchase Order Line Item Status Code. Corresponding generic EBA field counterparts are provided.

FIG. 144 illustrates RosettaNet's 3A4 Purchase Order Confirmation covering SECTION 29—Install At Company And Contact Details For Product Line Items. Corresponding generic EBA field counterparts are provided.

FIG. 145 illustrates RosettaNet's 3A4 Purchase Order Confirmation covering SECTION 30—Product Line Item Shipment Details. Corresponding generic EBA field counterparts are provided.

FIG. 146 illustrates RosettaNet's 3A4 Purchase Order Confirmation covering SECTION 31—Product Details and SECTION 32—Contract Partner Details for Product Sub Line Items. Corresponding generic EBA field counterparts are provided.

FIG. 147 illustrates RosettaNet's 3A4 Purchase Order Confirmation covering SECTION 33—End Customer Contact Details for Product Sub Line Items. Corresponding generic EBA field counterparts are provided.

FIG. 148 illustrates RosettaNet's 3A4 Purchase Order Confirmation covering SECTION 34—Expedite Clause for Product Sub Line Item, SECTION 35—ISO UOM Code for Product Sub Line Item, SECTION 36—P.O. Priority Code for Product Sub Line Item, SECTION 37—Purchase Order Acknowledgment Reason Code for Product Sub Line Item, SECTION 38—Purchase Order Status Code for Product Sub Line Item and SECTION 39—Install At Company and Contact Details for Product Sub Line Items. Corresponding generic EBA field counterparts are provided.

FIG. 149 illustrates RosettaNet's 3A4 Purchase Order Confirmation covering SECTION 40—Shipment Details for Product Sub Line Items. Corresponding generic EBA field counterparts are provided.

FIG. 150 illustrates RosettaNet's 3A4 Purchase Order Confirmation covering SECTION 41—Requested Product Pricing Details for Product Sub Line Items, SECTION 42—Transport Event for Product Sub Line Items and SECTION 43—Ship From Company Details for Product Sub Line Items. Corresponding generic EBA field counterparts are provided.

FIG. 151 illustrates RosettaNet's 3A4 Purchase Order Confirmation covering SECTION 44—Shipped Quantity Information for Product Sub Line Items. Corresponding generic EBA field counterparts are provided.

FIG. 152 illustrates RosettaNet's 3A4 Purchase Order Confirmation covering SECTION 45—Ship To Company Details for Product Sub Line Items. Corresponding generic EBA field counterparts are provided.

FIG. 153 illustrates RosettaNet's 3A4 Purchase Order Confirmation covering SECTION 46—Sub Line Item Number, SECTION 47—Product Pricing Details for Product Sub Line Items, SECTION 48—Trading Partner Agreement for Product Sub Line Item, SECTION 49—Requested Transport Event for Product Line SECTION 50—Requested Ship From Company Details for Product Line Items and SECTION 51—Requested Product Pricing Details for Product Line Items. Corresponding generic EBA field counterparts are provided.

FIG. 154 illustrates RosettaNet's 3A4 Purchase Order Confirmation covering SECTION 52—Scheduled Transport Event for Purchase Order Confirmation, SECTION 53—Ship From Company Details for Purchase Order Confirmation and SECTION 54—Shipped Quantity Information. Corresponding generic EBA field counterparts are provided.

FIG. 155 illustrates RosettaNet's 3A4 Purchase Order Confirmation covering SECTION 55—Ship To Company Details for Product Line Items. Corresponding generic EBA field counterparts are provided.

FIG. 156 illustrates RosettaNet's 3A4 Purchase Order Confirmation covering SECTION 56—Substitute Product Details and SECTION 57—Tax Exempt Details. Corresponding generic EBA field counterparts are provided.

FIG. 157 illustrates RosettaNet's 3A4 Purchase Order Confirmation covering SECTION 58—Tax Summary Details. Corresponding generic EBA field counterparts are provided.

FIG. 158 illustrates RosettaNet's 3A4 Purchase Order Confirmation covering SECTION 59—Tax Total Amount Details, SECTION 60—Total Line Item Amount, SECTION 61—Unit Price Amount, SECTION 62—Trading Partner Agreement for Product Line Item and SECTION 63—Requested Transport Event for Purchase Order. Corresponding generic EBA field counterparts are provided.

FIG. 159 illustrates RosettaNet's 3A4 Purchase Order Confirmation covering SECTION 64—Requested Ship From Company Details for Purchase Order and SECTION 65—Scheduled Transport Event for Purchase Order. Corresponding generic EBA field counterparts are provided.

FIG. 160 illustrates RosettaNet's 3A4 Purchase Order Confirmation covering SECTION 66—Secondary Buyer Company Details. Corresponding generic EBA field counterparts are provided.

FIG. 161 illustrates RosettaNet's 3A4 Purchase Order Confirmation covering SECTION 67—Ship From Company Details for Purchase Order Confirmation. Corresponding generic EBA field counterparts are provided.

FIG. 162 illustrates RosettaNet's 3A4 Purchase Order Confirmation covering SECTION 68—Ship To Company Details for Purchase Order Confirmation. Corresponding generic EBA field counterparts are provided.

FIG. 163 illustrates RosettaNet's 3A4 Purchase Order Confirmation covering SECTION 69—Tax Exempt Details for Purchase Order Confirmation. Corresponding generic EBA field counterparts are provided.

FIG. 164 illustrates RosettaNet's 3A4 Purchase Order Confirmation covering SECTION 70—Tax Summary Details for Purchase Order Confirmation. Corresponding generic EBA field counterparts are provided.

FIG. 165 illustrates RosettaNet's 3A4 Purchase Order Confirmation covering SECTION 71—Tax Total Amount Details, SECTION 72—Total Amount of Purchase Order, SECTION 73—Requesting Document Date and Number and SECTION 74—Purchase Order Confirmation Document Date and Number. Corresponding generic EBA field counterparts are provided.

FIG. 166 illustrates RosettaNet's 3A4 Purchase Order Confirmation covering SECTION 75—To Role Details. Corresponding generic EBA field counterparts are provided.

FIG. 167 provides a summary of Sections 1-25 covered under RosettaNet's 3A4 Purchase Order Confirmation PIP.

FIG. 168 provides a summary of Sections 26-50 covered under RosettaNet's 3A4 Purchase Order Confirmation PIP.

FIG. 169 provides a summary of Sections 51-75 covered under RosettaNet's 3A4 Purchase Order Confirmation PIP.

FIGS. 170 and 171 provide a table where fields are matched between EDI X12's 840—Request for Quotation and Rosettanet's PIP 3A1—Quote Request.

FIGS. 172 and 173 provide a table where fields are matched between EDI X12's 843—Response to RFQ and Rosettanet's PIP 3A1—Quote Confirm.

FIGS. 174 and 175 provide a table where fields are matched between EDI X12's 850—Purchase Order and Rosettanet's PIP 3A4—Purchase Order Request.

FIGS. 176 and 177 provide a table where fields are matched between EDI X12's 855—Purchase Order Acknowledgment and Rosettanet's PIP 3A4—Purchase Order Confirmation.

FIGS. 178 and 179 provide a table where fields are matched between EDI X12's 860—Purchase Order Change and Rosettanet's PIP 3A8—Purchase Order Change Request.

FIGS. 180 and 181 provide a table where fields are matched between EDI X12's 865—Purchase Order Change Acknowledgment and Rosettanet's PIP 3A8—Purchase Order Change Confirmation.

FIG. 182 provides a table where fields are matched between EDI X12's 860—Purchase Order Change and Rosettanet's PIP 3A9—Purchase Order Cancellation Request.

FIG. 183 provides a table where fields are matched between EDI X12's 860—Purchase Order Change and Rosettanet's PIP 3A9—Purchase Order Cancellation Confirmation.

FIG. 184 provides a table where fields are matched between EDI X12's 865—Ship Notice and Rosettanet's PIP 3B2—Advance Shipment Notification.

FIGS. 185 and 186 provide a table where fields are matched between EDI X12's 810—Invoice and Rosettanet's PIP 3C3—Invoice Notification.

FIGS. 187 and 188 provide a table where fields are matched between EDI X12's 820—Payment Order and Rosettanet's PIP 3C6—Remittance Advice Notification.

FIG. 189 illustrates the major sections of the invention's Internet portal.

FIG. 190 illustrates the registration data required by the invention.

FIGS. 191 and 192 illustrate the registration data for the administrator.

FIG. 193 provides a predefined list of entries for grouping, country, region name and EBA where the user selects an entry.

FIG. 194 represents the code to be used to extract EBA information on buyer contact details. These data are extracted via XML and captured by the invention on the buyer's registration information.

FIG. 195 represents the code to be used to extract EBA information on seller contact details. These data are extracted via XML and captured by the invention on the seller's registration information.

FIG. 196 represents the code to be used to extract EBA information on administrator contact details. These data are extracted via XML and captured by the invention on the administrator's registration information.

FIG. 197 represents the code to be used to extract EBA information on executive contact details. These data are extracted via XML and captured by the invention on the executive's registration information.

FIG. 198 represents the code to be used to extract EBA information on vendor contact details. These data are extracted via XML, captured by the invention and stored on vendor master records.

FIG. 199 represents the code to be used to extract EBA information on customer contact details. These data are extracted via XML, captured by the invention and stored on customer master records.

FIG. 200 represents the code to be used to extract EBA information on item master records for products and services to be bought by the buying company. These data are extracted via XML, captured by the invention and stored on buy item master records of the buying company.

FIG. 201 represents the code to be used to extract EBA information on item master records for products and services to be sold by the selling company. These data are extracted via XML, captured by the invention and stored on sell item master records of the selling company.

FIG. 202 represents the code to be used to extract EBA information on unit of measure, currency and item classification records. These data are extracted via XML, captured by the invention and stored on unit of measure, currency and item classification records.

FIG. 203 represents the area where the approved for public listing of non-supplier assigned request for quotations (RFQ) are published.

FIG. 204 represents the calculation formulation for search proximity based on the search and match criteria defined by buyers.

FIG. 205 illustrates the fields of the response portion of the public reverse auction of the invention.

FIG. 206 illustrates the fields displayed on the buyers' RFQ portion of the invention.

FIGS. 207 and 208 illustrate the fields displayed on the sellers' RFQ portion of the invention.

FIGS. 209 and 210 represent the buyers' RFQ portion of the invention where supplier responded RFQs are reflected.

FIG. 211 illustrates the fields displayed on Buyers' PO/PO change/cancel portion of the invention.

FIGS. 212 and 213 illustrate the fields displayed on Sellers' PO confirmation portion of the invention.

FIGS. 214 and 215 illustrate the fields displayed on advance shipment notification (ASN) portion of the invention.

FIGS. 216 and 217 illustrates the fields displayed on Invoice portion of the invention.

FIG. 218 illustrates the fields displayed on Payment Order portion of the invention.

### DETAILED DESCRIPTION OF THE INVENTION

This invention relates in general to a system and method for business-to-business buying, selling, sourcing and matching of products and services across multiple business partners over the Internet.

The invention covers an internet based solution comprise of: 1) business partner registration, 2) buying and selling processing, 3) matching of codes, 4) conversion of EDI transactions, 5) sourcing/offering of products/services and 6) electronic documents processing.

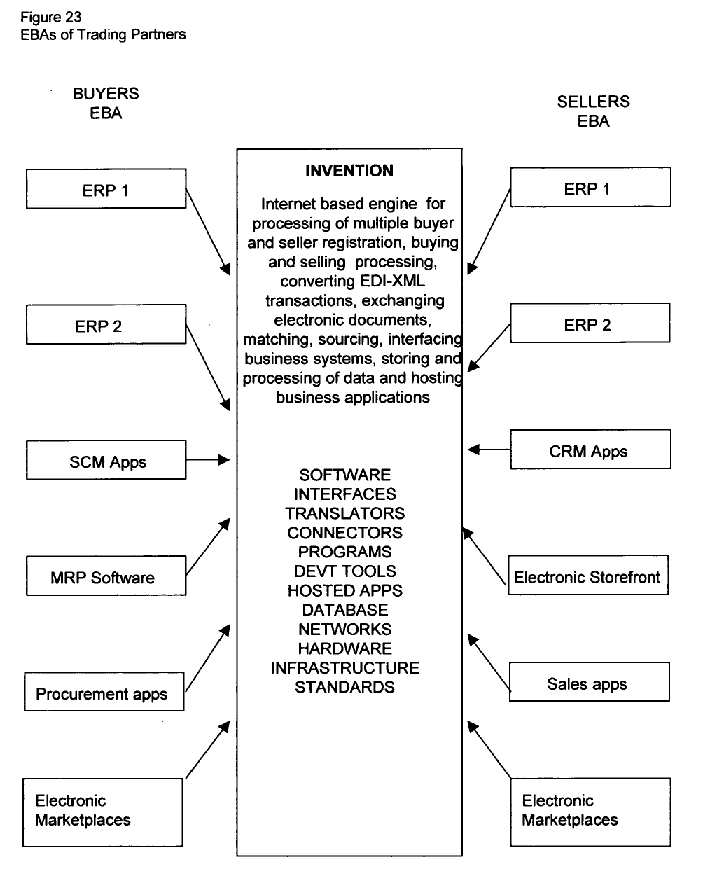

This invention covers an infrastructure that includes computer hardware, computer software, interfaces, translators, connectors, programs, development tolls, hosted applications, database, networks and standards as illustrated in FIG. 23.

This invention covers the hosting and interfacing of various electronic business applications (EBAs). Such EBAs include enterprise resource planning (ERP) systems, customer relationship management (CRM) software, online stores, desktops based applications, legacy systems, electronic marketplaces, supply chain systems, e-procurement and other buying and selling applications as illustrated in FIG. 23.

This invention supports EBAs with or without support on EDI and Rosettanet technology.

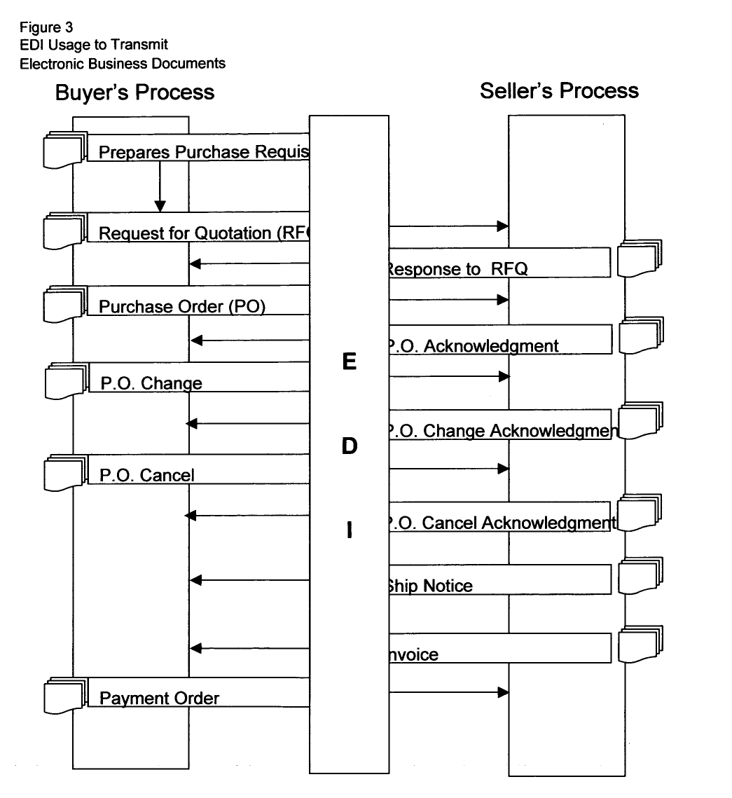

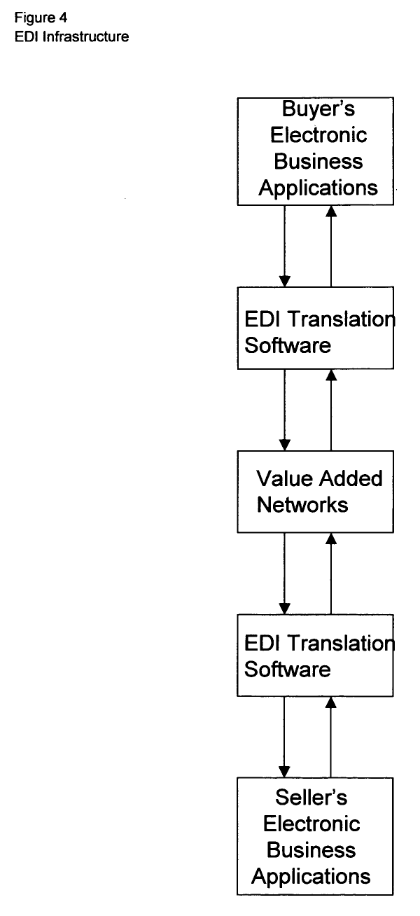

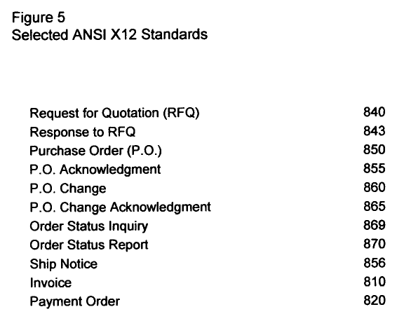

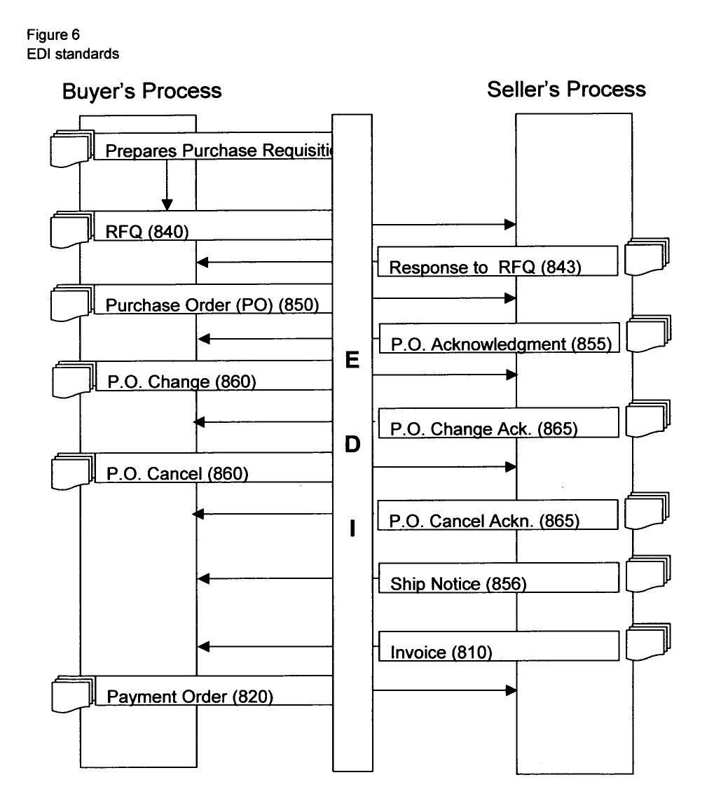

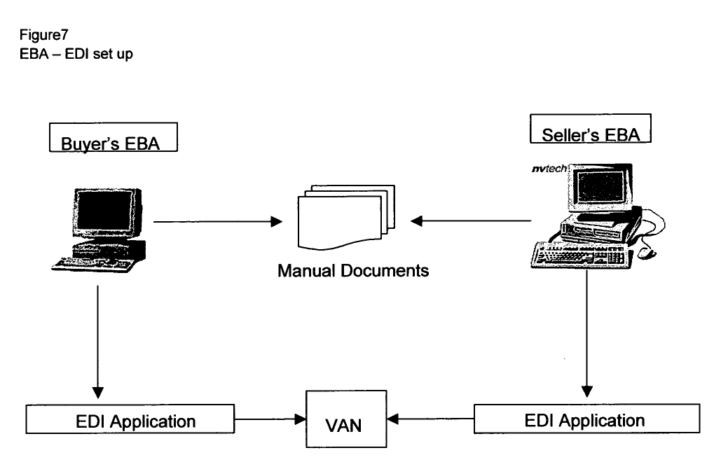

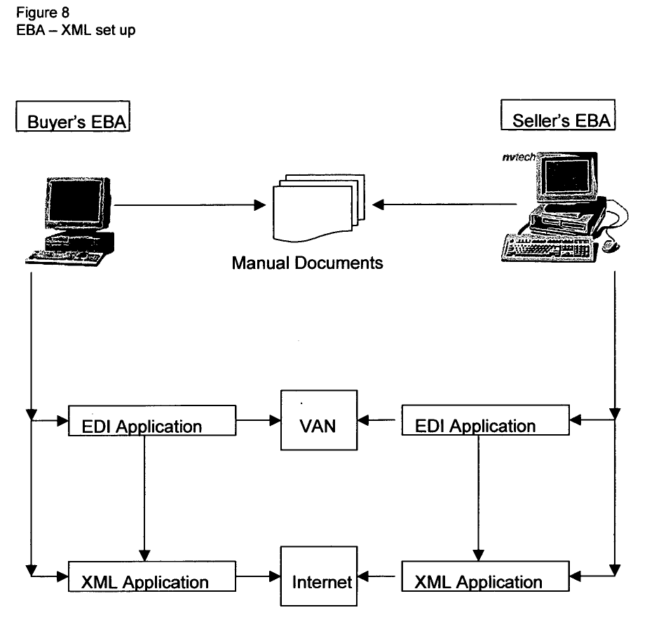

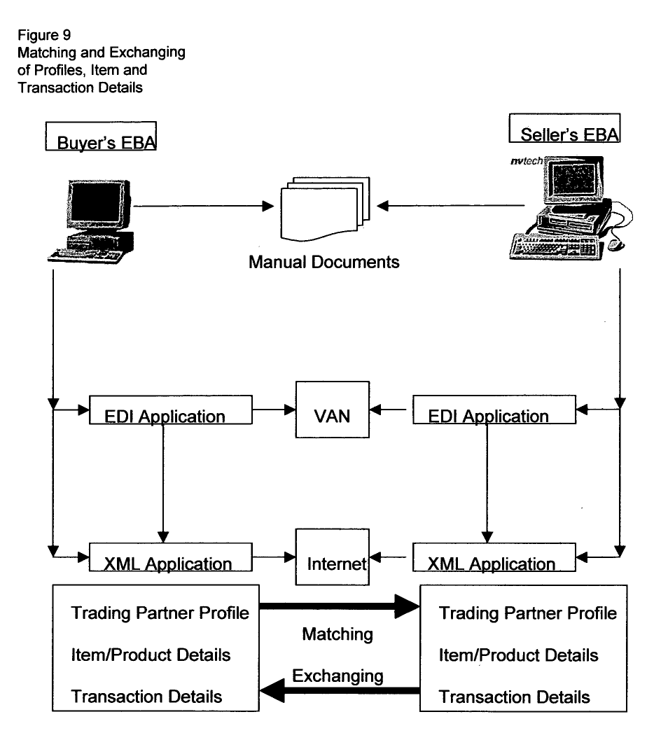

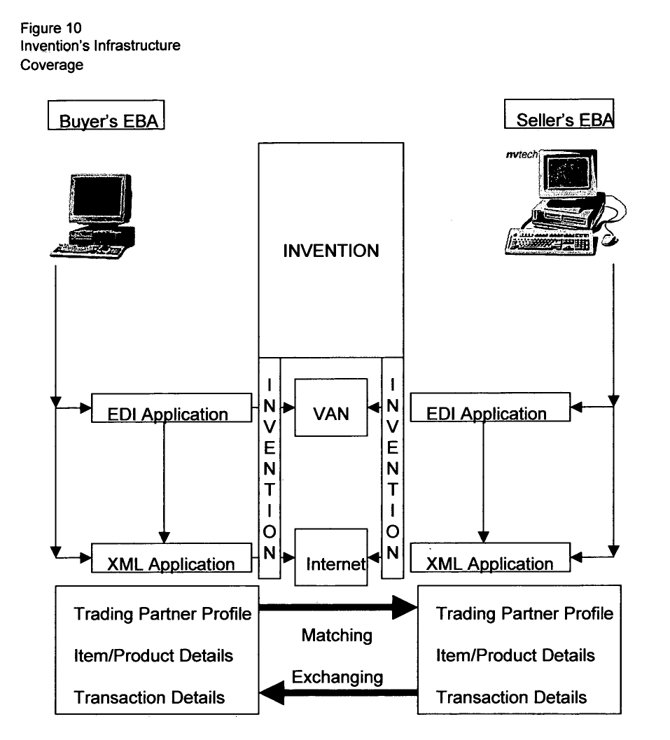

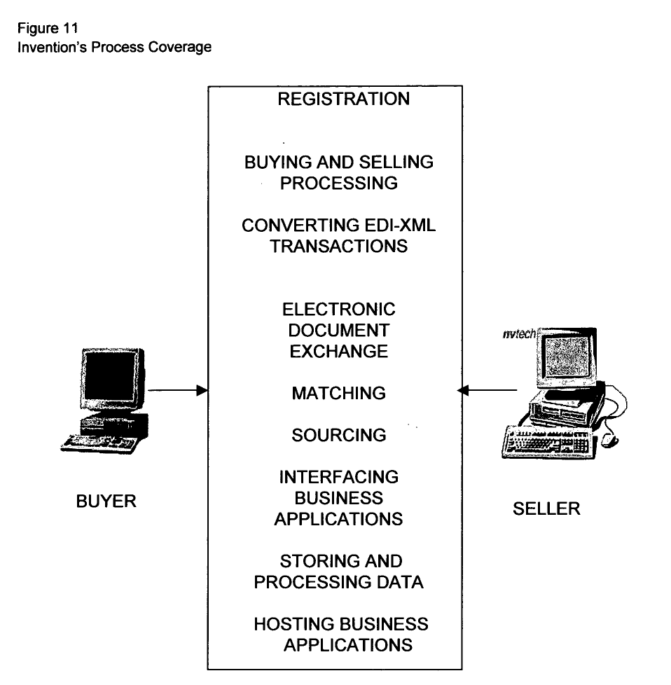

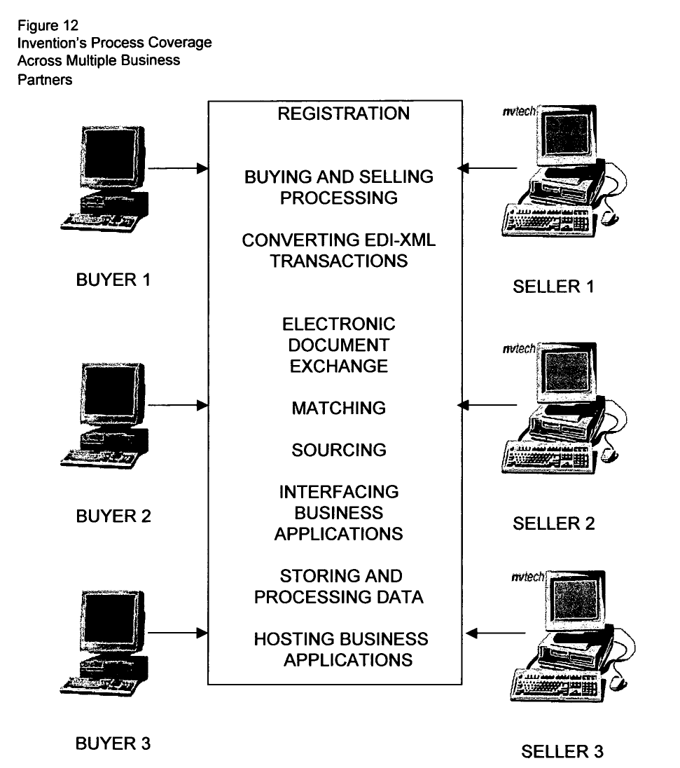

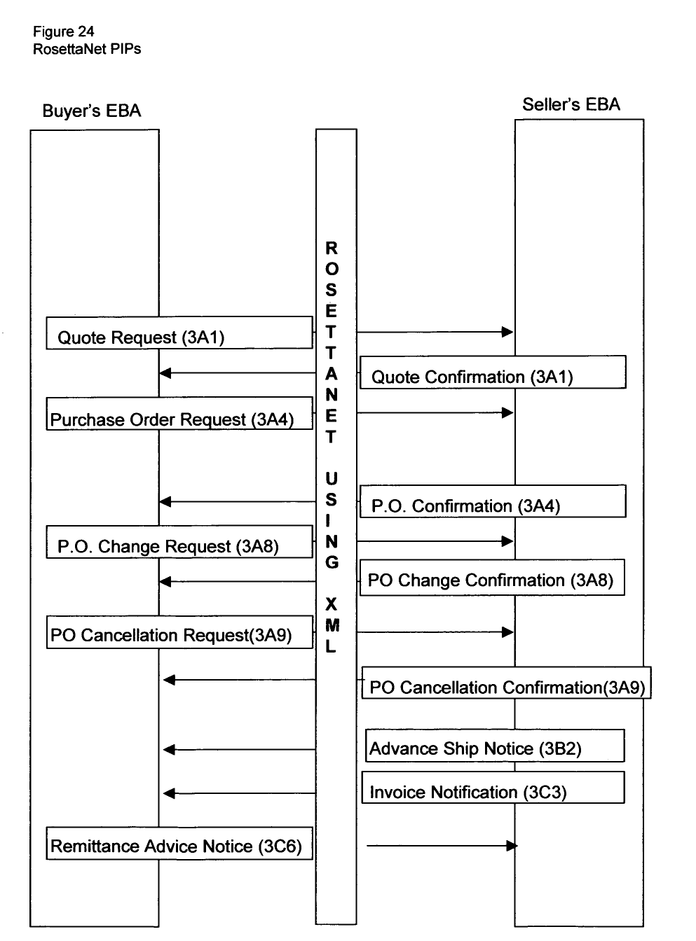

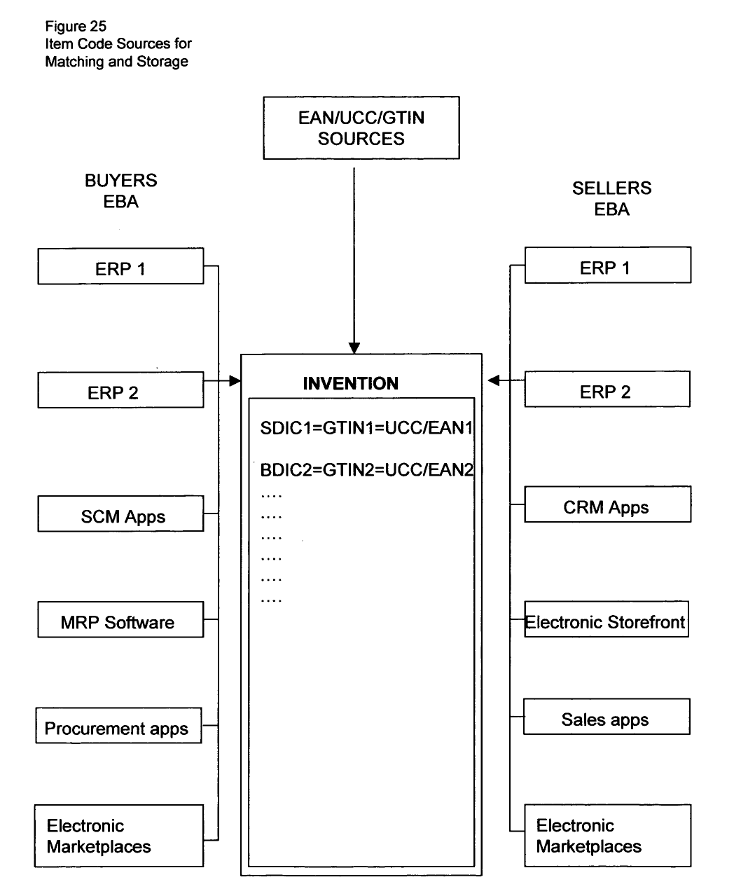

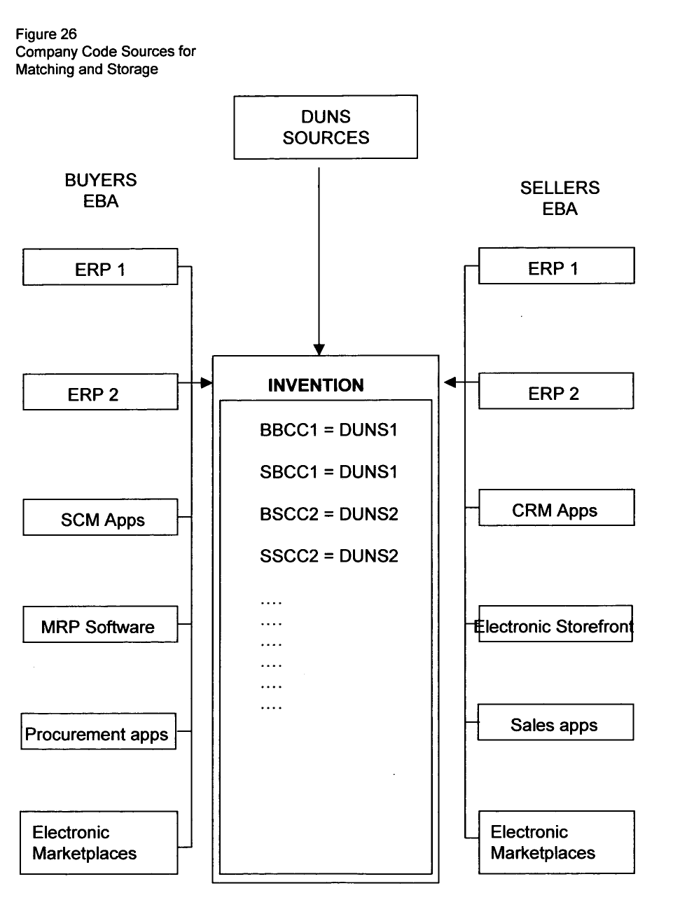

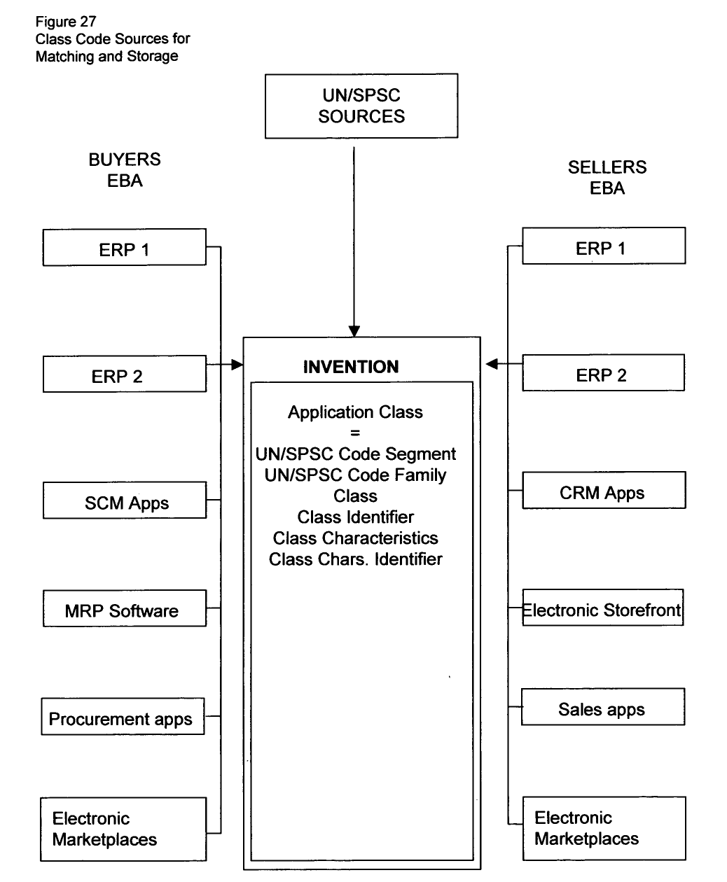

The invention is capable of processing all Rosettanet and EDI standards. An illustration of Rosettanet and EDI standards application on business processes is provided in FIGS. 24 and 3 respectively. There are certain portions in these standards that are enhanced or processed further in order to address the limitations of these standards and existing EBAs.

We used a generic EBA field counterpart to represent all similar fields found in each kind of EBA. The invention's technology will take care of extracting these different termed but similar function fields from each kind of EBA and matched with the common field found in each Rosettanet PIP or EDI terms.

This invention supports EBAs with or without support on customer part number (CPN) and manufacturer part number (MPN) maintenance.

This invention supports EBAs with or without support on DUNS, GTIN, ISO, UN/SPSC and other globally set standards for item codes, company codes, unit of measure, currency, class and country codes.

This invention is deployed on a global scale involving interconnection between various electronic business applications (EBAs) over the Internet.

This invention allows public and private auctions and reverse auctions where electronic business documents are generated and transmitted electronically across buyer and seller EBAs. This invention is capable of converting these confirmed transactions related to auctions and reverse auctions into request for quotations (RFQ) and sales quotations (SQ).

This invention allows many-to-many business partner electronic documents transmission instead of point-to-point transaction that is a characteristic of EDI and RosettaNet based transactions.

This invention provides a solution to extract, interface, match and store codes such as company codes, product/service codes, currency code, unit of measure code, country code and class code from globally defined codes and business partner defined codes.

The invention extracts all data found from each kind of EBA, matches these with RosettaNet fields, stores, retrieves, sends, processes all necessary data needed by business partners to complete business transactions.

EBAs supporting RosettaNet require the capability to handle storage of RosettaNet Building Blocks. Building blocks are the data elements used to build the RosettaNet business messages.

Here's a brief definition of these building blocks:
GTIN—Global Trade Information Number
DUNS—Data Universal Numbering System. A sequentially generated nine-digit number that is assigned and maintained only by Dun and Bradstreet, which identifies unique trading partner in each RosettaNet PIP.
UN/SPSC code—United Nations/Standard Product and Services Code
Class—A group of commodities sharing a common use or function

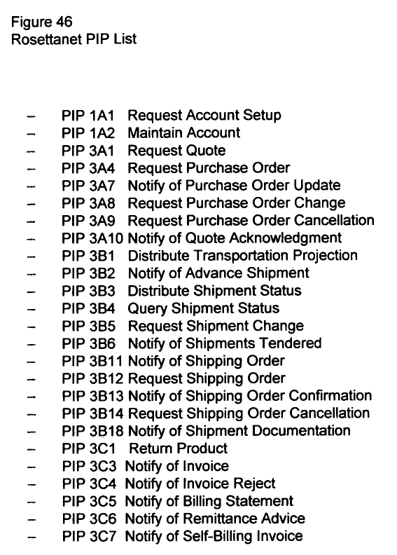

These building blocks are located as fundamental business data entities in Rosettanet's PIP. FIG. 46 provides a sample list of these Rosettanet's PIPs. These are:
GlobalCountryCode—Two character country code specified in ISO 3166-1993
GlobalLocationIdentifier—Location uniquely identified by the DUNS+4 Number.
GlobalBusinessIdentifier—A unique business identifier in DUNS number.
GlobalCurrencyCode—Three character currency code specified in ISO 4217-1995.
GlobalProductUnitOfMeasureCode Code identifying a product unit of measure.
GlobalProductIdentifier—Global unique product identifier. RosettaNet has adopted the Global Trade Identification Number (GTIN).

If the aforementioned fundamental business data entities are not maintained in the EBA, the invention will extract their existing proprietary codes and convert these to comply on Rosettanet's building block. The conversion facility resides in the invention and not on the EBA. The ISO codes reside as an entity instance in the invention. DUNS and GTIN numbers are either extracted from an external entity providing the DUNS and GTIN numbers or provided as a prompt for entry by the company.

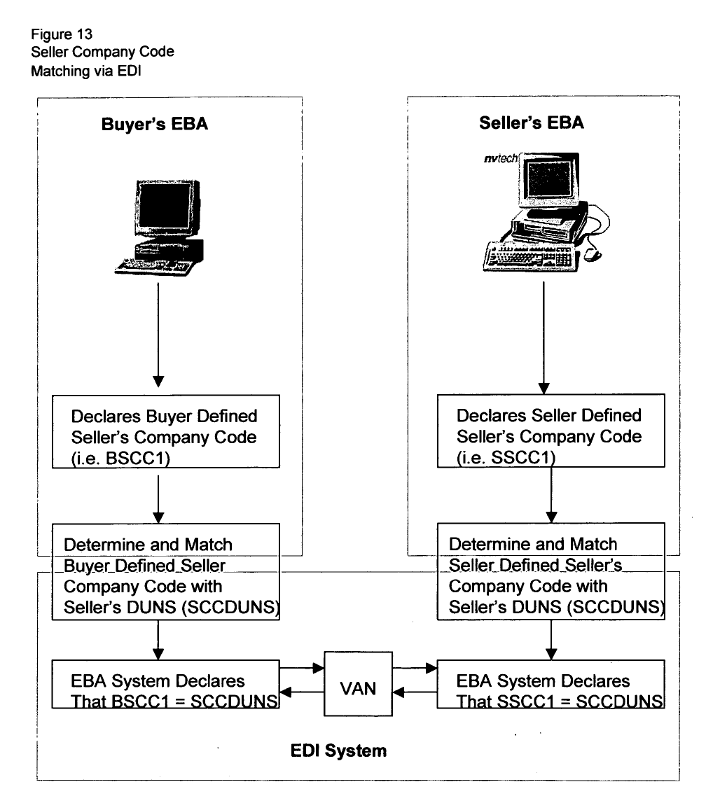

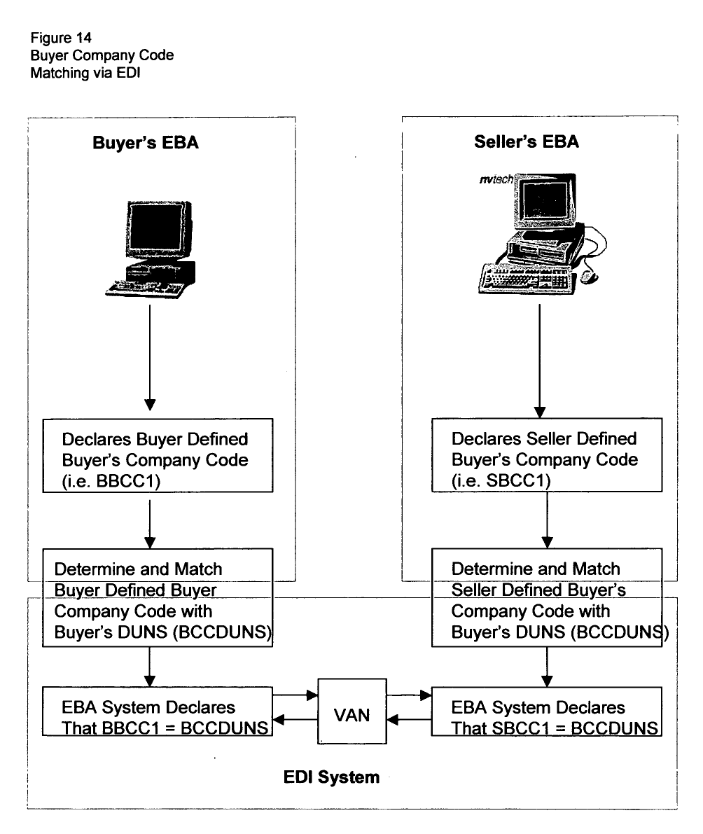

EDI compliant companies support DUNS storage. FIGS. 13 and 14 illustrate EDI compliant companies where their proprietary defined company codes are matched to DUNS as a mandatory requirement for EDI technology. If this is the case, the invention will just extract the proprietary and DUNS codes from EBAs of these companies and store it in the invention.

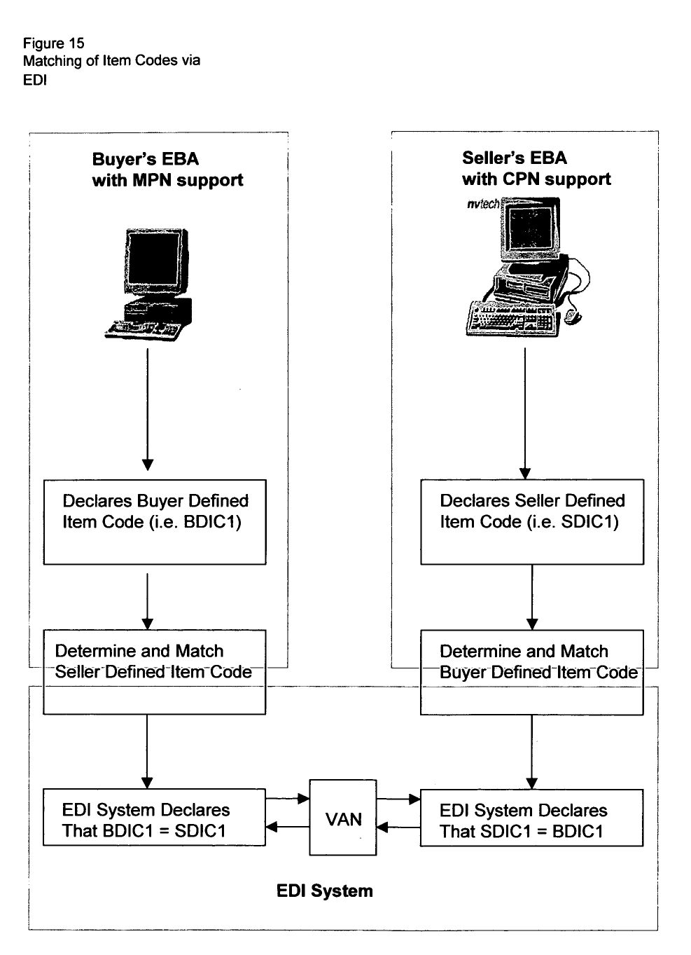

EDI compliant companies support proprietary item code storage but not GTIN. FIG. 15 illustrates EDI compliant companies where their proprietary defined item codes are matched without the need for GTIN. The difference between Rosettanet and EDI technology lies on the maintenance of these item codes. EDI requires the buyer and seller defined proprietary item codes while Rosettanet requires GTIN and one proprietary item code. The invention acts as an intermediary to allow the extraction and storage of these proprietary codes, GTIN and other company and standards body defined item codes. The invention is robust to allow storage of multiple item codes.

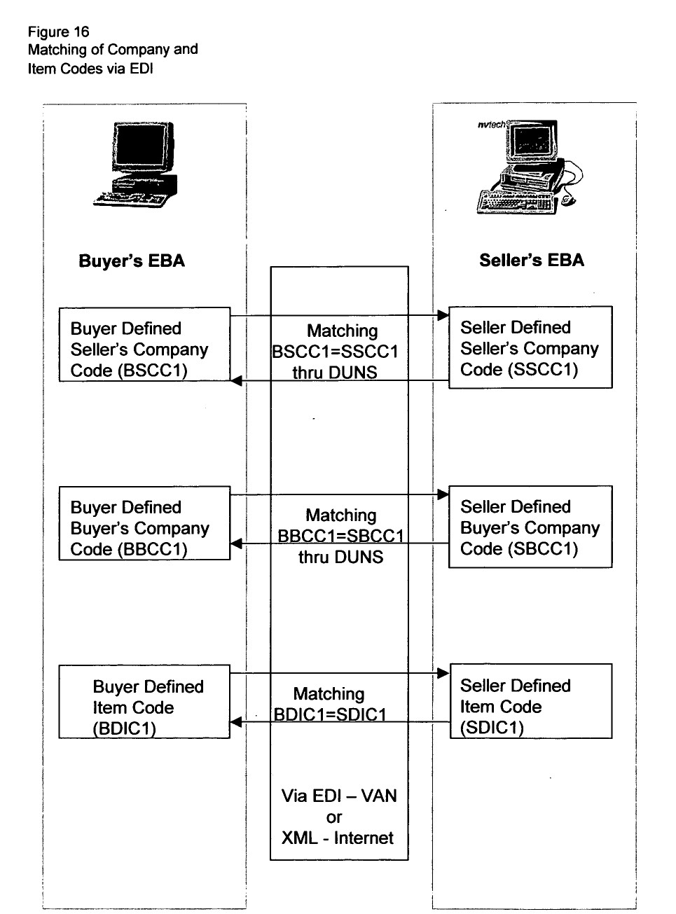

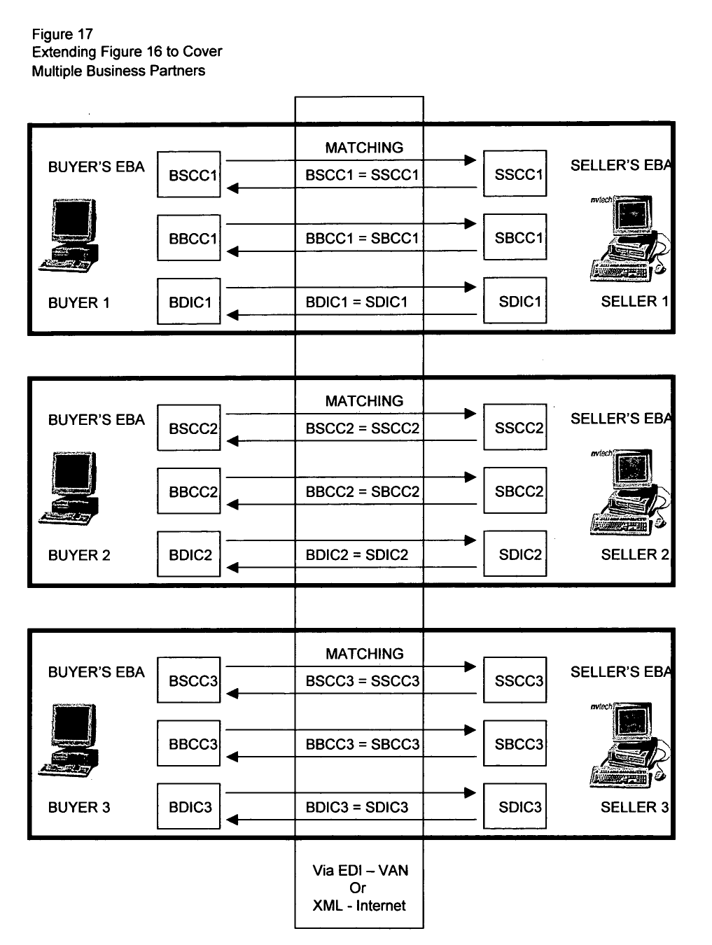

FIG. 16 displays the minimum required codes in order to make it possible to electronically transmit business documents. At the very least, the buyer defined codes should be matched to the seller defined codes to let the system understand that it is referring to the same company and item before it will allow transmission of electronic documents. FIG. 17 expands FIG. 16 to provide a scenario where the system is applied to multiple buyers and sellers.

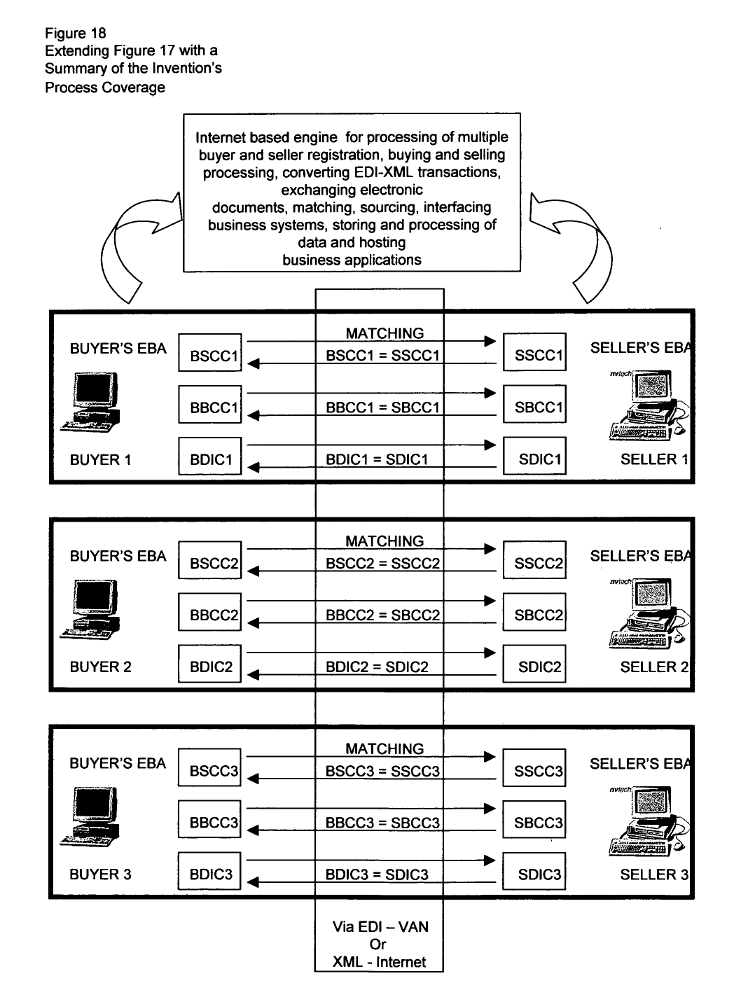

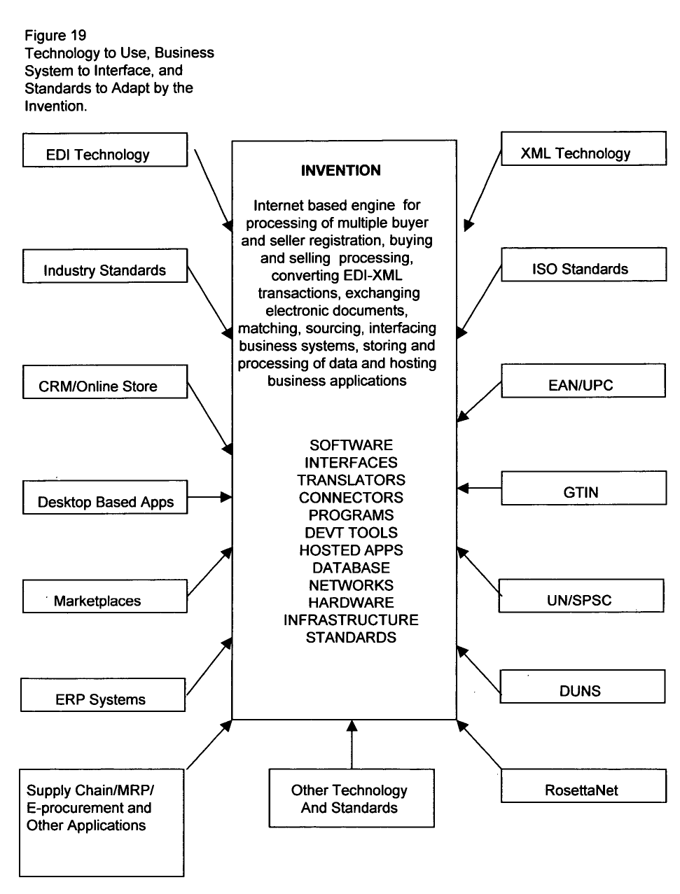

FIG. 18 provides a holistic view of the invention's coverage.

Since the invention supports Rosettanet non-compliant companies, there is a possibility that they are not DUNS and GTIN compliant. If this is the case, the invention will allow usage of proprietary company identifier and proprietary product identifier as soon as the company answers a prompt to allow this. There is an available DUNS field attached to this proprietary company identifier for future usage if ever the company is already DUNS compliant. The same is applied for the GTIN where a GTIN field is attached to the proprietary product identifier for future usage if ever the company is already GTIN compliant. The same process is applied to UN/SPSC and ISO codes.

There are certain fundamental business data entities found in the PIP with no EBA field counterparts. This means that the field is either not available in current EBA or the field is not processed further by the invention.

By default, all data required by RosettaNet PIP's are extracted from the source EBA, matched with the corresponding fundamental business data entities, stored, updated, processed, retrieved and sent to destination EBA by the invention.

These are the detailed capabilities of the invention:

1. Business Partner Registration:

The process starts when business partners register thru the invention and ends when all data are extracted, matched, stored, updated, processed, retrieved and sent by the invention.

We define electronic business applications (EBAs) as applications supporting the automation of business processes. EBAs to be supported by the invention include enterprise resource planning systems (ERP), supply chain management systems (SCM), customer relationship management systems (CRM), electronic procurement systems (E-procurement), online stores, Internet based auction systems, electronic marketplaces, electronic catalogues, procurement systems, sales systems and any systems with main capability of supporting the corporate buying and selling processes.

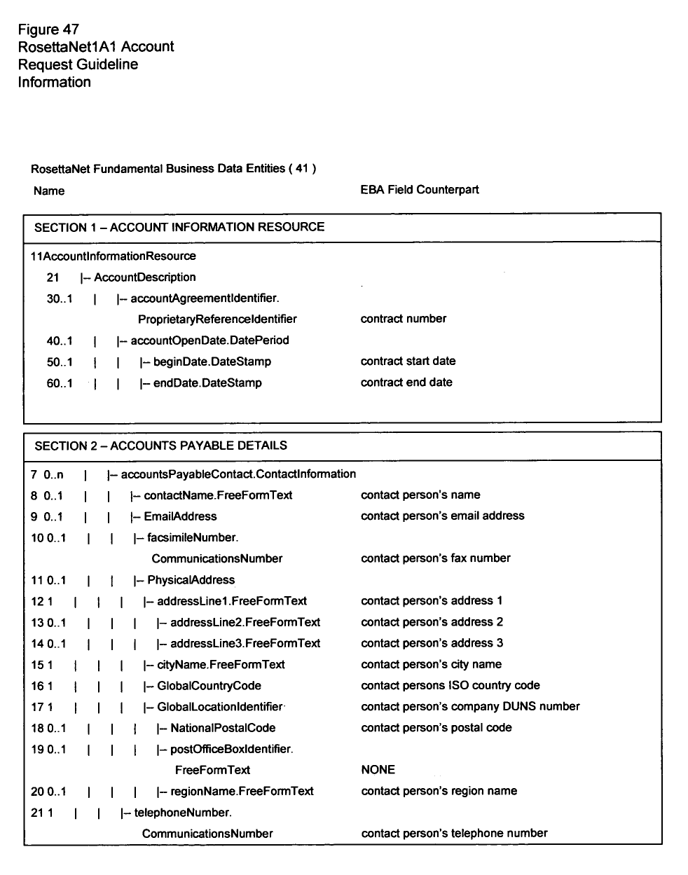

RosettaNet PIP 1A1 Account Set-up is the standard to be used by the invention for the business partner registration for companies with EBAs. FIGS. 47-58 provide a listing of RosettaNet's PIP 1A1 Account Set-up with corresponding EBA field counterpart.

FIG. 47 illustrates RosettaNet's 1A1 Account Request PIP covering SECTION 1—Account Information Resource and SECTION 2—Account Payable Details. Corresponding generic EBA field counterparts are provided. The GlobalLocationIdentifier is the fundamental business data entity required by 1A1 SECTION 2. This is where the location's DUNS+4 number is stored. The invention will introduce an enhanced code to include ProprietaryLocationIdentifier and ProprietaryLocationIdentifier2 as additional fundamental business data entities under SECTION 2.

If the GlobalLocationIdentifier is a source entity location, then the source entity defined source entity location code will be extracted from source entity EBA and matched to ProprietaryLocationIdentifer. The destination entity defined source entity location code will be extracted from the destination entity EBA and matched to ProprietaryLocationIdentifier2.

If the GlobalLocationIdentifier is a destination entity location, then the destination entity defined destination entity location code will be extracted from destination entity EBA and matched to ProprietaryLocationIdentifer. The source entity defined destination entity location code will be extracted from the source entity EBA and matched to ProprietaryLocationIdentifier2.

In summary, there will be three different kinds of location codes that will be extracted, matched and stored in the invention. These fundamental business data entities are GlobalLocationIdentifier, ProprietaryLocationIdentifier and ProprietaryLocationIdentifier2 where these entities are grouped by the invention. The ProprietaryLocationIdentifier2 is introduced as a new fundamental business data entity by the invention. We will call this as CLAIM A for easy reference on other PIPs requiring this CLAIM. This is applied to all RosettaNet's PIP.

The GlobalCountryCode is the fundamental business data entity required by 1A1 SECTION 2 of FIG. 47. This is where the two-character country code specified in ISO 3166-1993 is found. The invention will introduce an enhanced code to include ProprietaryCountryCode as an additional fundamental business data entity under SECTION 2. This will be used to store the company defined country code if ever they didn't comply with the ISO country code. The invention will extract this company defined country code, store it under the ProprietaryCountryCode fundamental business data entity and match it with the ISO country code stored as a database in the invention. This will be applied to all RosettaNet's PIP. We will call this as CLAIM B for easy reference on other PIPs requiring this CLAIM.

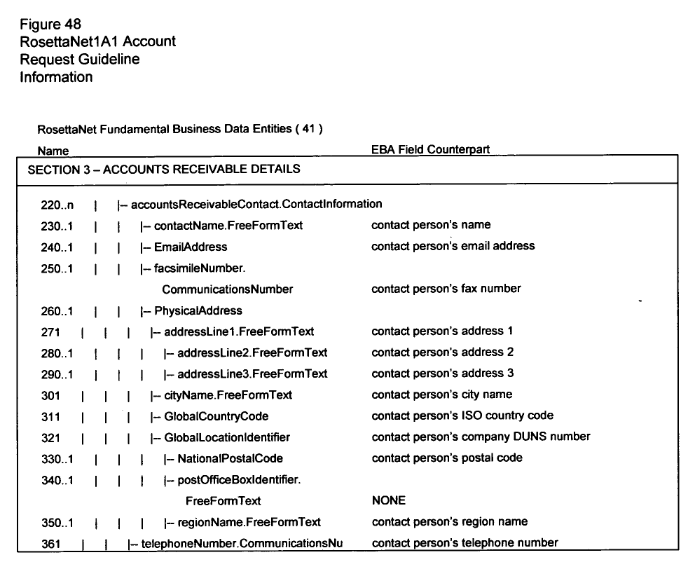

FIG. 48 illustrates RosettaNet's 1A1 Account Request PIP covering SECTION 3—Accounts Receivable Details. Corresponding generic EBA field counterparts are provided. CLAIMS A and B are applied to this SECTION.

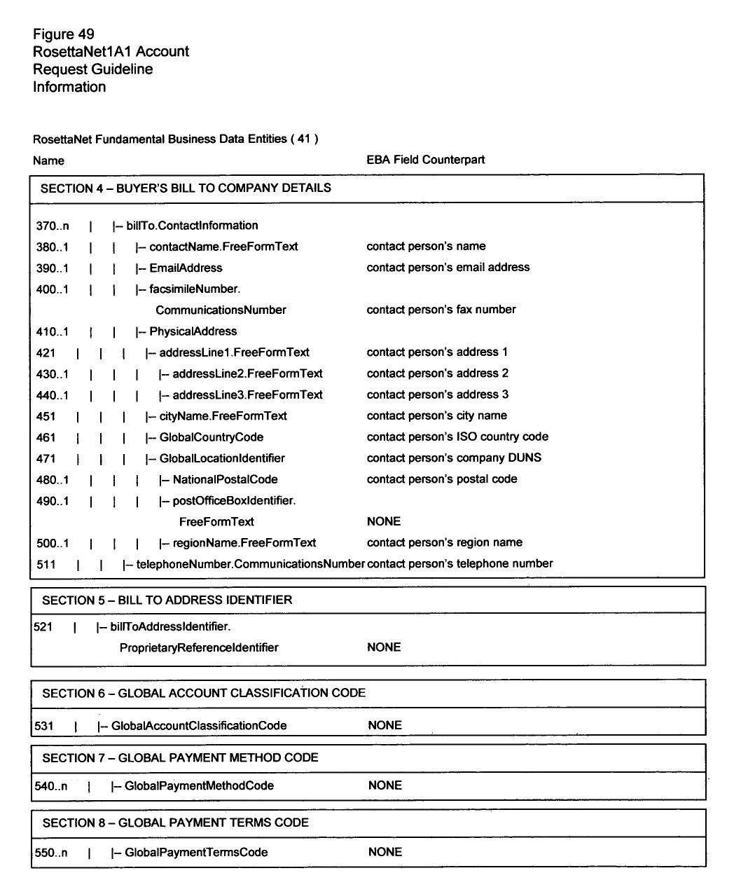

FIG. 49 illustrates RosettaNet's 1A1 Account Request PIP covering SECTION 4—Buyer's Bill To Company Details, SECTION 5—Bill To Address Identifier, SECTION 6—Global Account Classification Code, SECTION 7—Global Payment Method Code and SECTION 8—Global Payment Terms Code. Corresponding generic EBA field counterparts are provided. CLAIMS A and B are applied to SECTION 4.

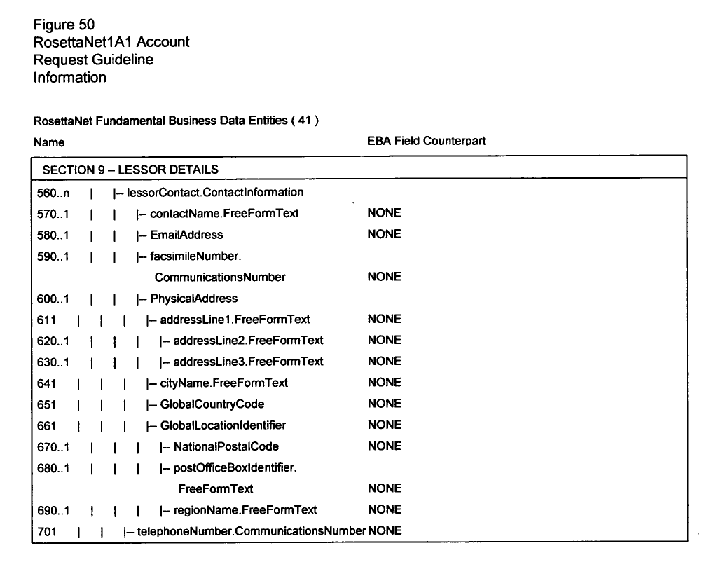

FIG. 50 illustrates RosettaNet's 1A1 Account Request PIP covering SECTION 9—Lessor Details. Corresponding generic EBA field counterparts are provided. CLAIMS A and B are applied to this SECTION.

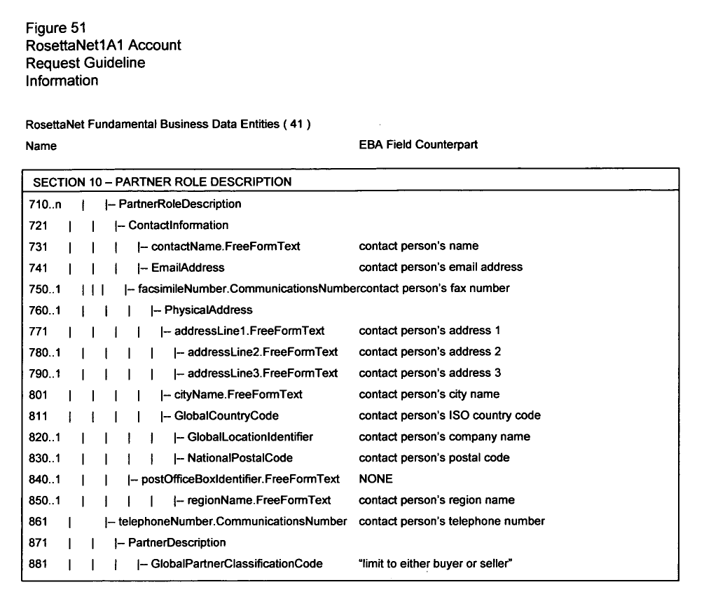

FIG. 51 illustrates RosettaNet's 1A1 Account Request PIP covering SECTION 10—Partner Role Description. Corresponding generic EBA field counterparts are provided. CLAIMS A and B are applied to this SECTION. The invention will limit the entity instance of GlobalPartnerClassificationCode found on LINE 88 to buyer or seller instead of using the predefined list set forth by Rosettanet. This is CLAIM C.

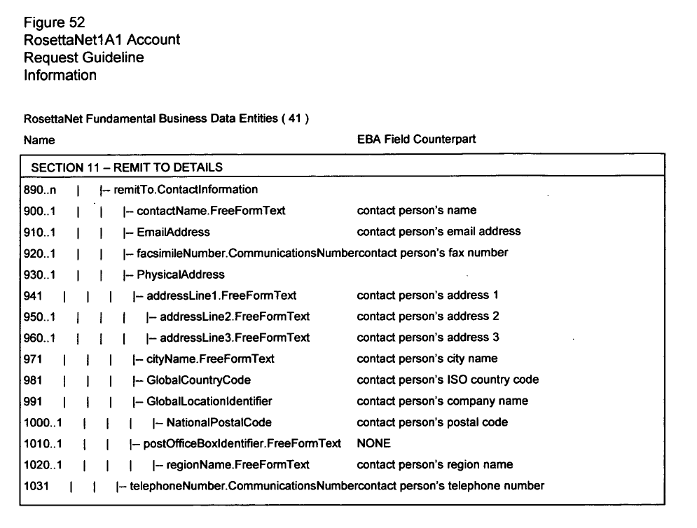

FIG. 52 illustrates RosettaNet's 1A1 Account Request PIP covering SECTION 11—Remit To Details. Corresponding generic EBA field counterparts. CLAIMS A and B are applied to this SECTION.

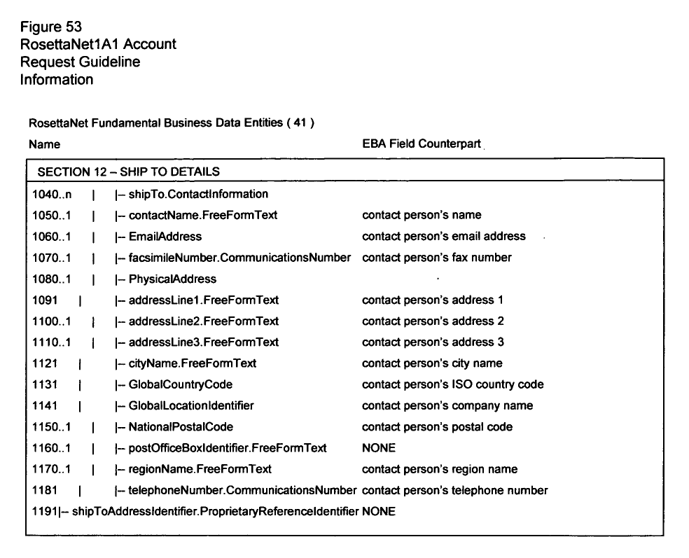

FIG. 53 illustrates RosettaNet's 1A1 Account Request PIP covering SECTION 12—Ship To Details. Corresponding generic EBA field counterparts are provided. CLAIMS A and B are applied to this SECTION.

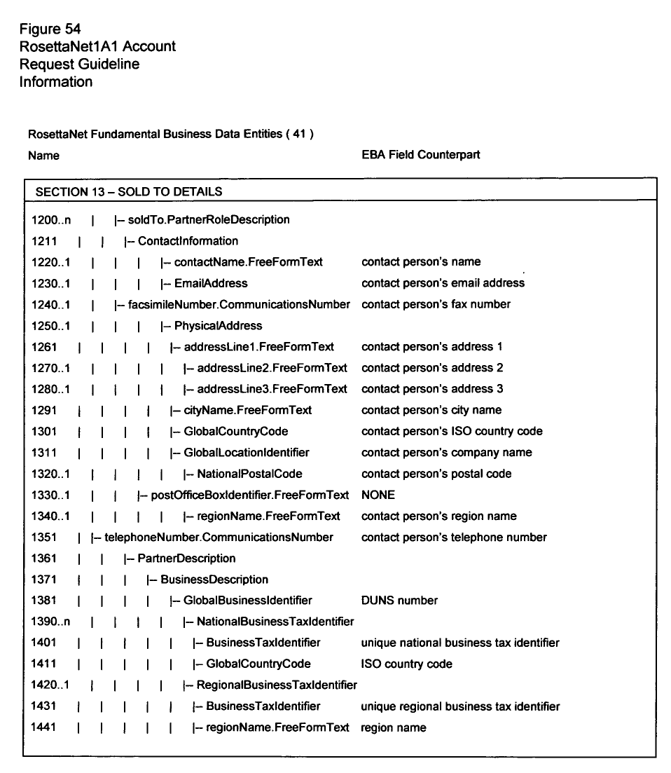

FIG. 54 illustrates RosettaNet's 1A1 Account Request PIP covering SECTION 13—Sold to Details. Corresponding generic EBA field counterparts are provided. CLAIMS A and B are applied to this SECTION. The GlobalBusinessIdentifier is the fundamental business data entity required by 1A1 SECTION 13. This is where the company's DUNS number is stored. The invention will introduce an enhanced code to include ProprietaryBusinessIdentifier and ProprietaryBusinessIdentifier2 as additional fundamental business data entities under SECTION 13.

The source and destination entities will use these fundamental business data entities to store their company defined business or company code if ever they didn't comply with the DUNS company code. The invention will extract these proprietary company codes from source and destination entities' EBAs and match it with the DUNS company code stored as a database in the invention. If ever the company has not applied for a DUNS code, the invention will allow no entry of data on the GlobalBusinessIdentifier. It will leave this blank to be filled up if ever the company will apply for a DUNS code in the future.

The source entity defined source entity company code (ie. source=buyer) will be extracted from source entity EBA and matched to ProprietaryBusinessIdentifier. The destination entity (i.e. destination=seller) defined source entity company code will be extracted from the destination entity EBA and matched to ProprietaryCountryCode2. There is a high likelihood that one source entity defined source entity company code will be matched and assigned to multiple destination entity defined source entity company code since each entity or participating company defines their own set of company codes for their business partners. This is one of the invention's capability where it can allow the matching of one source entity defined source entity company code equal to one DUNS company code which can be both equal to multiple destination entity defined source entity company codes.

The source entity defined source entity company code can be equated to the buyer defined buyer company code. If the source entity is the buyer then the destination entity is the seller for the naming convention being used in FIGS. 13, 14 and 16.

The same is true for the destination entity defined destination entity code where it can be assigned to one DUNS defined company code of which both are assigned to multiple source entity defined destination entity codes thru the usage of these three kinds of company codes represented as fundamental business data entities entitled ProprietaryBusinessIdentifier, GlobalBusinessIdentifier and ProprietaryBusinessIdentifier2. We will call this as CLAIM D for easy reference on other PIPs requiring this CLAIM. This is applied to all RosettaNet's PIP.

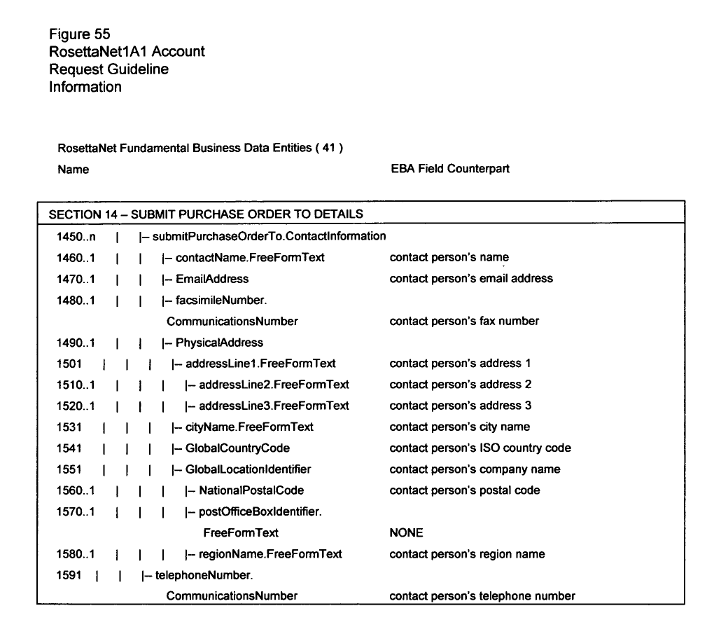

FIG. 55 illustrates RosettaNet's 1A1 Account Request PIP covering SECTION 14—Submit Purchase Order To Details. Corresponding generic EBA field counterparts are provided. CLAIMS A and B are applied to this SECTION.

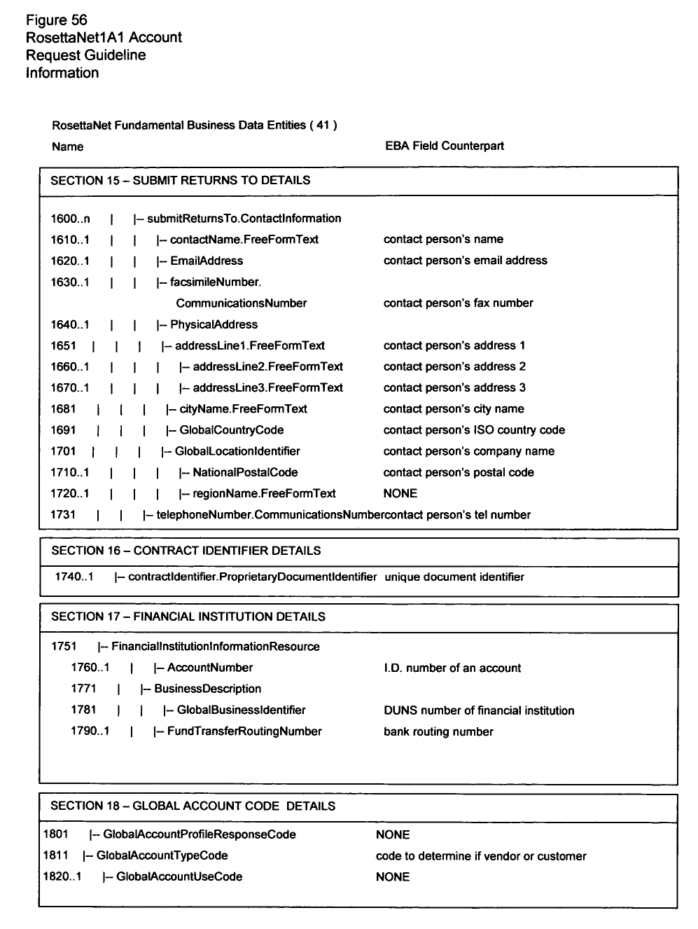

FIG. 56 illustrates RosettaNet's 1A1 Account Request PIP covering SECTION 15—Submit Returns To Details, SECTION 16—Contract Identifier Details, SECTION 17—Financial Institution Details and SECTION 18—Global Account Code Details. Corresponding generic EBA field counterparts are provided. Claims 1 and 2 are applied to this SECTION 15. CLAIM C is applied to SECTION 17.

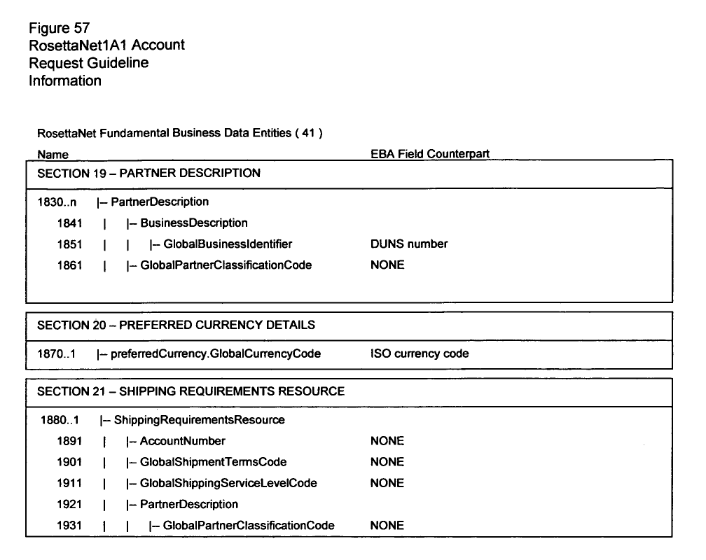

FIG. 57 illustrates RosettaNet's 1A1 Account Request PIP covering SECTION 19—Partner Description, SECTION 20—Preferred Currency Details and SECTION 21—Shipping Requirements Resource. Corresponding generic EBA field counterparts are provided. CLAIM C is applied to SECTION 19.

The GlobalCurrencyCode is the fundamental business data entity required by 1A1 SECTION 20. This is where the three character currency code specified in ISO 4217-1995 is found. The invention will introduce an enhanced code to include ProprietaryCurrencyCode as additional fundamental business data entities under SECTION 20. This will be used to store the company defined currency code if ever they didn't comply with the ISO currency code. The invention will extract this company defined currency code, store it under the ProprietaryCurrencyCode fundamental business data entity and match it with the ISO currency code stored as a database in the invention. This will be applied to all RosettaNet's PIP. We will call this as CLAIM E for easy reference on other PIPs requiring this CLAIM.

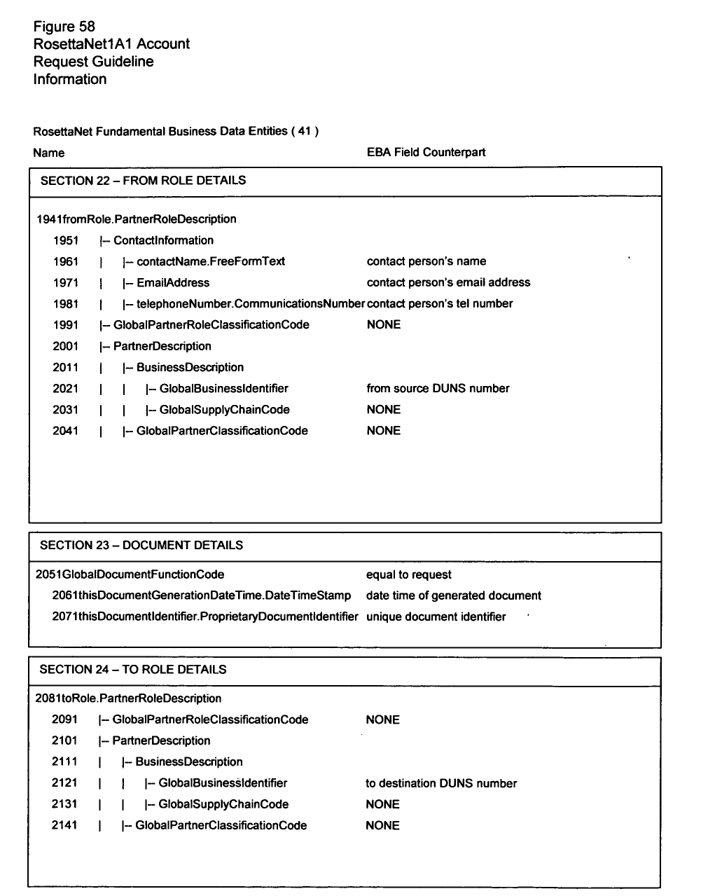

FIG. 58 illustrates RosettaNet's 1A1 Account Request PIP covering SECTION 22—From Role Details, SECTION 23—Document Details and SECTION 24—To Role Details. Corresponding generic EBA field counterparts are provided. CLAIM D is applied to SECTION 22 and 24.

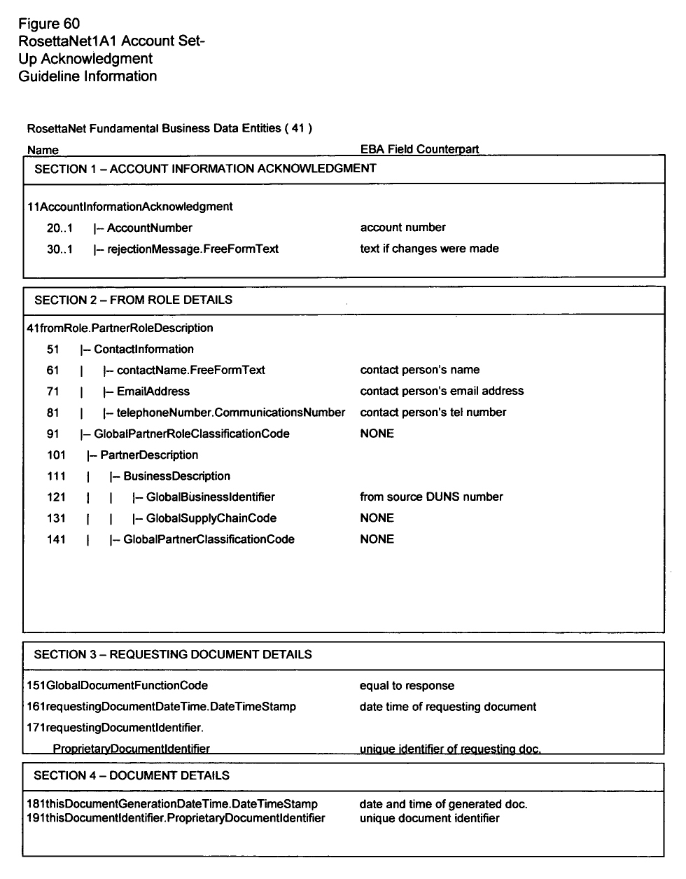

FIG. 60 illustrates RosettaNet's 1A1 Account Acknowledgment PIP covering SECTION 1—Account Information Acknowledgment, SECTION 2—From Role Details, SECTION 3—Requesting Document Details and SECTION 4—Document Details. Corresponding generic EBA field counterparts are provided. CLAIMs C and D are applied to SECTION 2.

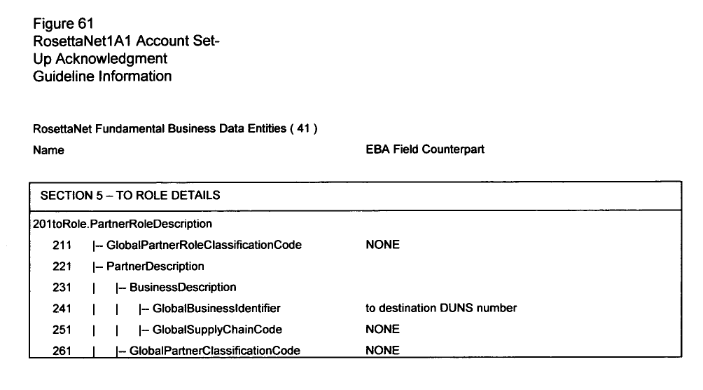

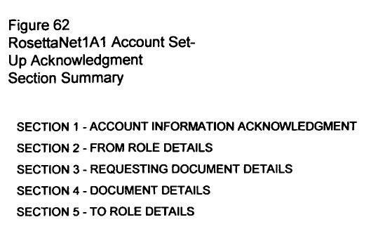

FIG. 61 illustrates RosettaNet's 1A1 Account Acknowledgment PIP covering SECTION 05—To Role Details. Corresponding generic EBA field counterparts are provided. CLAIMs C and D are applied to SECTION 5.

2. Buying and Selling Processing

2.1. Request for Quotation

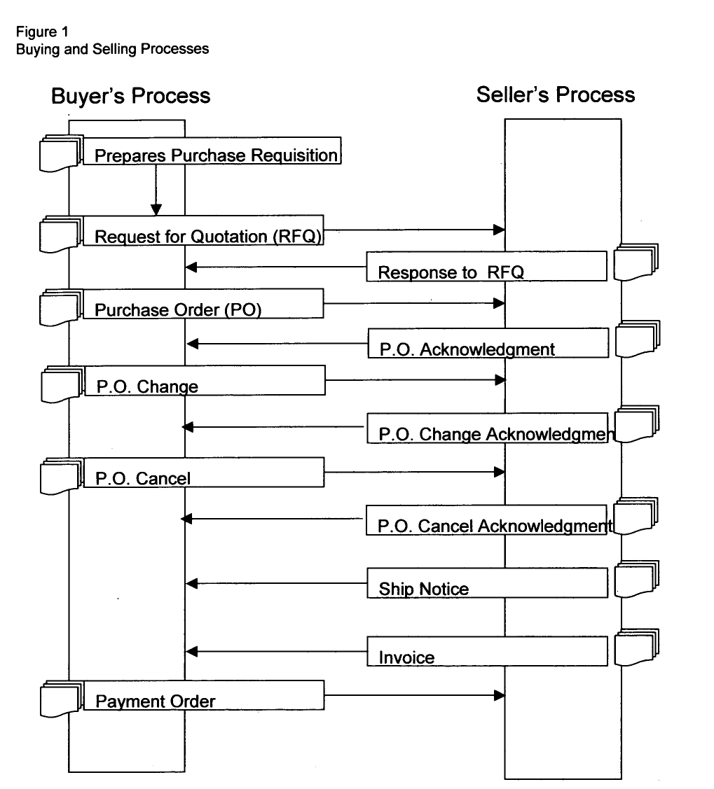

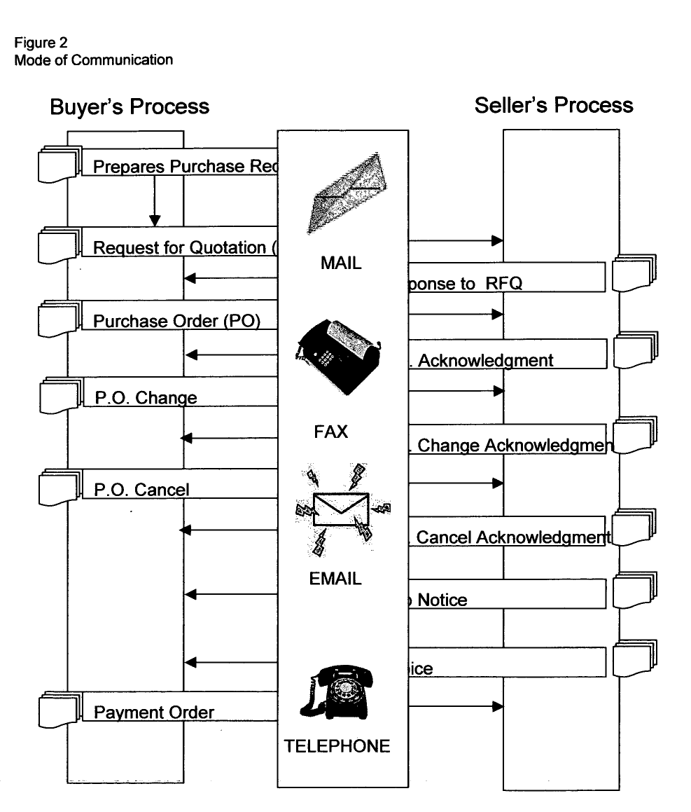

FIG. 1 illustrates the buying and selling processes covered by the invention. The buyer initiates a request for quotation (RFQ) and sends this to seller. The process ends when the seller receives the electronic form of the request for quotation.

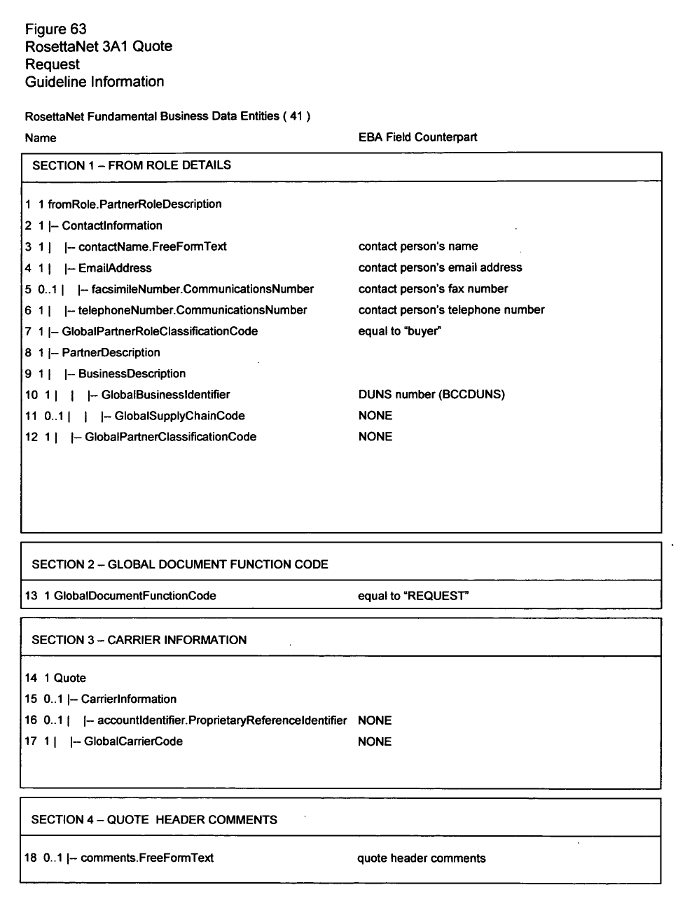

RosettaNet PIP 3A1 Quote Request is the standard to be used by the invention for Request for Quotation. FIGS. 63-77 provide a listing of RosettaNet's PIP 3A1 Quote Request with corresponding EBA field counterpart.

FIG. 63 illustrates RosettaNet's 3A1 Quote Request PIP covering SECTION 1—From Role Details, SECTION 2—Global Document Function Code, SECTION 3—Carrier Information and SECTION 4—Quote Header Comments. Corresponding generic EBA field counterparts are provided. CLAIMs C and D are applied to SECTION 1.

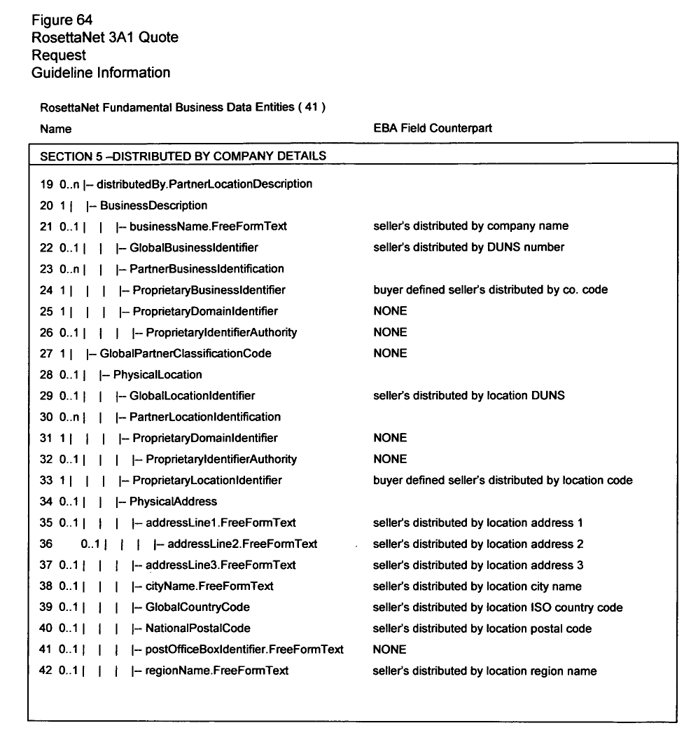

FIG. 64 illustrates RosettaNet's 3A1 Quote Request PIP covering SECTION 05—Distributed By Company Details. Corresponding generic EBA field counterparts are provided. CLAIMs A, B and D are applied to SECTION 5.

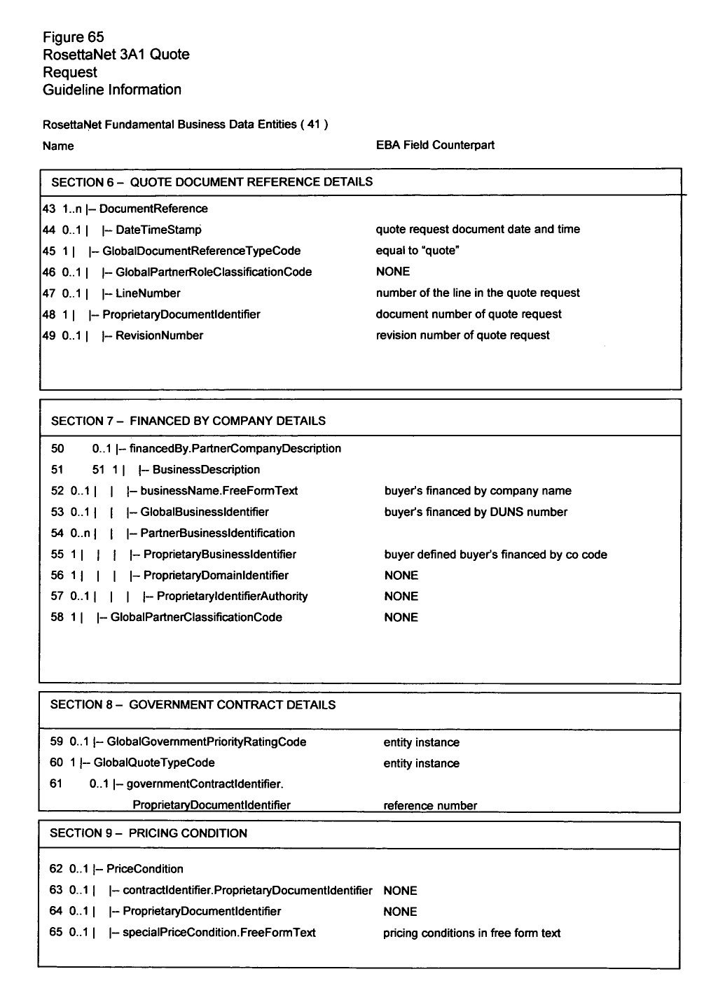

FIG. 65 illustrates RosettaNet's 3A1 Quote Request PIP covering SECTION 6—Quote Document Reference Details, SECTION 7—Financed By Company Details, SECTION 8—Government Contract Details and SECTION 9—Pricing Condition. Corresponding generic EBA field counterparts are provided. CLAIM D is applied to SECTION 7.

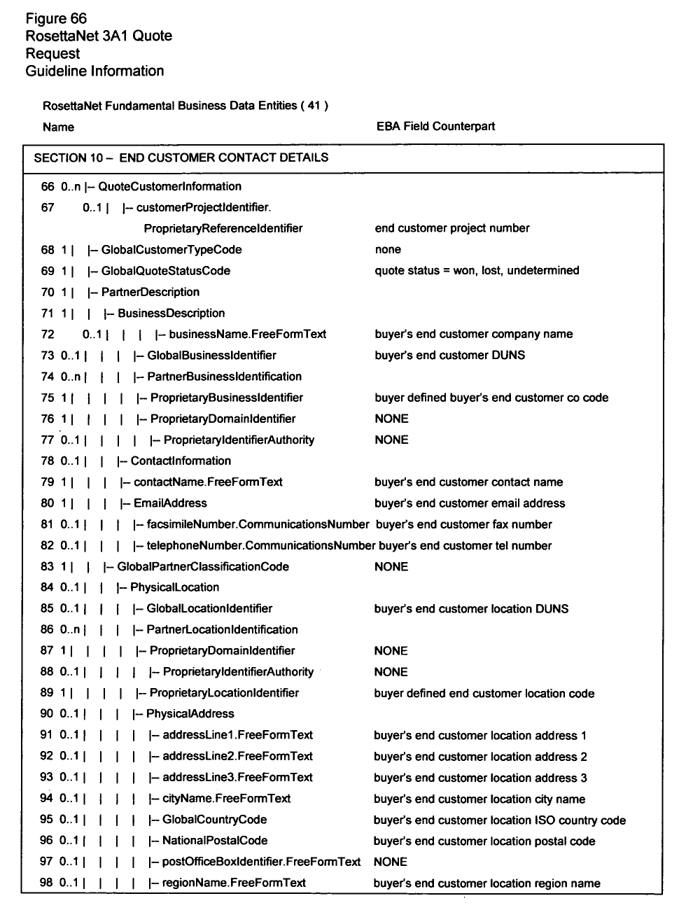

FIG. 66 illustrates RosettaNet's 3A1 Quote Request PIP covering SECTION 10—End Customer Contact. Corresponding generic EBA field counterparts are provided. CLAIMs A, B and D are applied to SECTION 10.

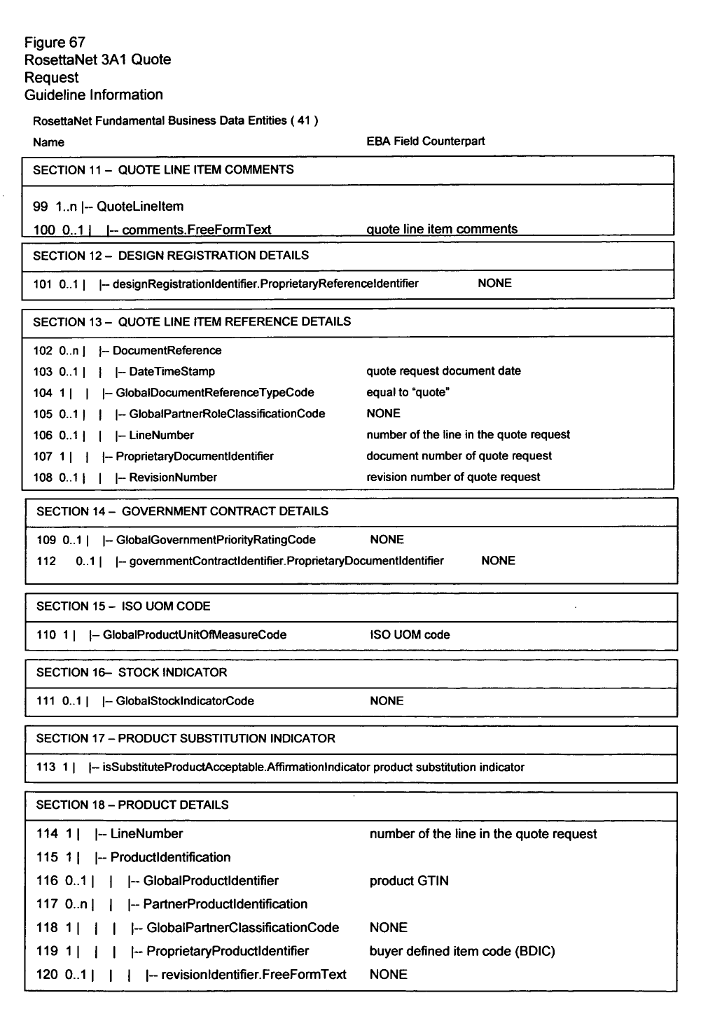

FIG. 67 illustrates RosettaNet's 3A1 Quote Request PIP covering SECTION 11—Quote Line Item Comments, SECTION 12—Design Registration Details, SECTION 13—Quote Line Item Reference Details, SECTION 14—Government Contract Details, SECTION 15—ISO UOM Code, SECTION 16—Stock Indicator, SECTION 17—Product Substitution Indicator and SECTION 18—Product Details. Corresponding generic EBA field counterparts are provided.

The GlobalProductUnitofMeasureCode is the fundamental business data entity required by 3A1 SECTION 15. The invention will introduce an enhanced code to include ProprietaryProductUnitofMeasureCode as an additional fundamental business data entity under SECTION 15. This will be used to store the company defined product unit of measure code if ever they didn't comply with the entity instances found under the GlobalProductUnitofMeasureCode. The invention will extract the company defined unit of measure code, store it under the ProprietaryProductUnitofMeasureCode and match it with the corresponding entity instance of GlobalProductUnitofMeasureCode stored as a database in the invention. This will be applied to all RosettaNet's PIP. We will call this as CLAIM F for easy reference on other PIPs requiring this CLAIM.

The GlobalProductIdentifier is the fundamental business data entity required by 3A1 SECTION 18. The GlobalProductIdentifier and ProprietaryProductIdentifier will be used to store the product GTIN and buyer defined item code respectively. The invention will introduce an enhanced code to include ProprietaryProductIdentier2 as an additional fundamental business data entity under SECTION 18 where the seller defined item code will be stored. There are certain buyer EBAs that support the maintenance of seller defined item codes via the manufacturer part number (MPN) field. If the seller defined item code is available in the MPN, then the invention will extract this and store it under ProprietaryProductIdentifer2. If not available, it will be left blank to be filled up by the seller during the completion of the quote confirmation. Also, certain sellers EBAs support the maintenance of buyer defined item codes via the customer part number (CPN) field. If the buyer defined item code is available in the CPN, then the invention will extract this and store it under ProprietaryProductIdentifer. We call this as CLAIM G for easy reference on other PIPs requiring this claim.

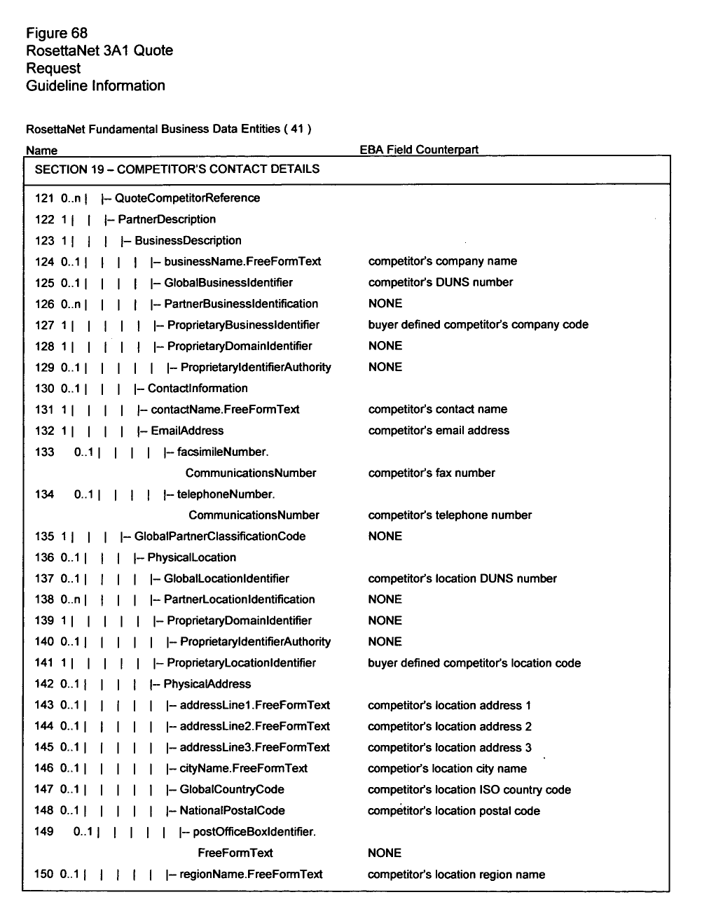

FIG. 68 illustrates RosettaNet's 3A1 Quote Request PIP covering SECTION 19—Competitor's Contact Details. Corresponding generic EBA field counterparts are provided. CLAIMs A, B and D are applied to SECTION 19.

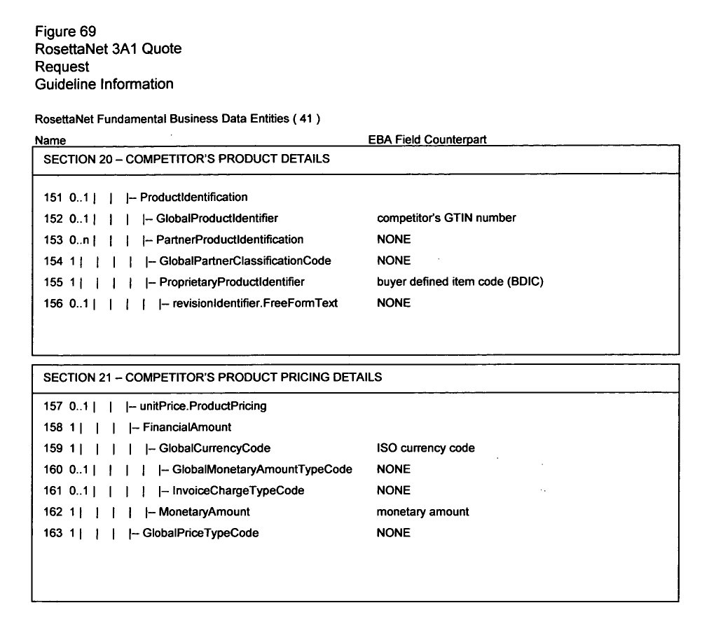

FIG. 69 illustrates RosettaNet's 3A1 Quote Request PIP covering SECTION 20—Competitor's Product Details and SECTION 21—Competitor's Product Pricing Details. Corresponding generic EBA field counterparts are provided. CLAIM G is applied to SECTION 20. CLAIM E is applied to SECTION 21.

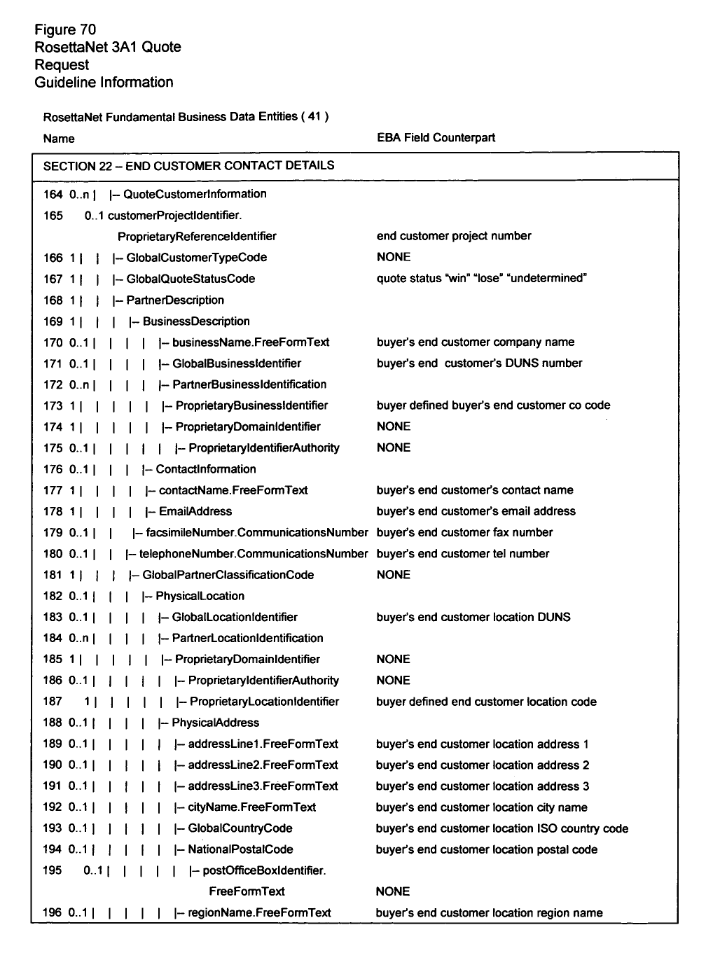

FIG. 70 illustrates RosettaNet's 3A1 Quote Request PIP covering SECTION 22—End Customer Contact Details. Corresponding generic EBA field counterparts are provided. CLAIMs A, B and D are applied to SECTION 22.

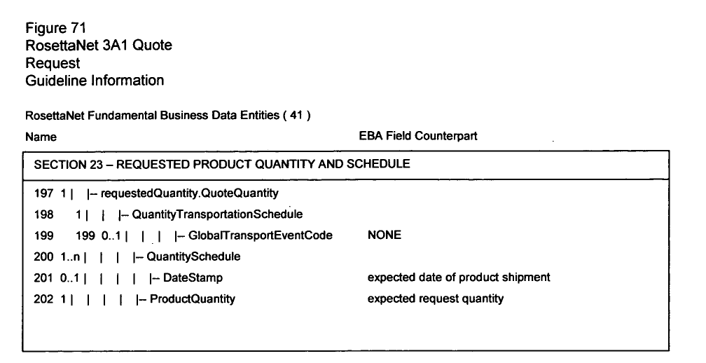

FIG. 71 illustrates RosettaNet's 3A1 Quote Request PIP covering SECTION 23—Requested Product Quantity and Schedule. Corresponding generic EBA field counterparts are provided.

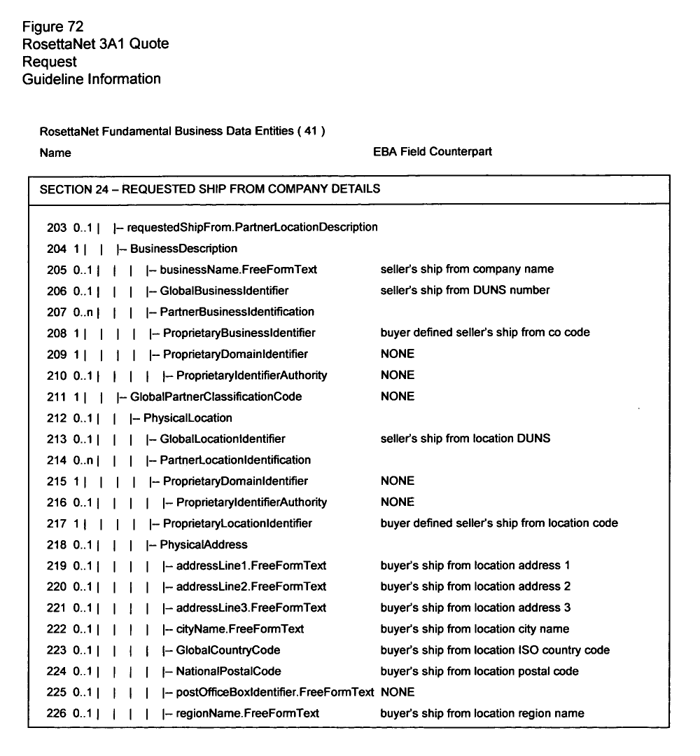

FIG. 72 illustrates RosettaNet's 3A1 Quote Request PIP covering SECTION 24—Requested Ship From Company Details. Corresponding generic EBA field counterparts are provided. CLAIMs A, B and D are applied to SECTION 24.

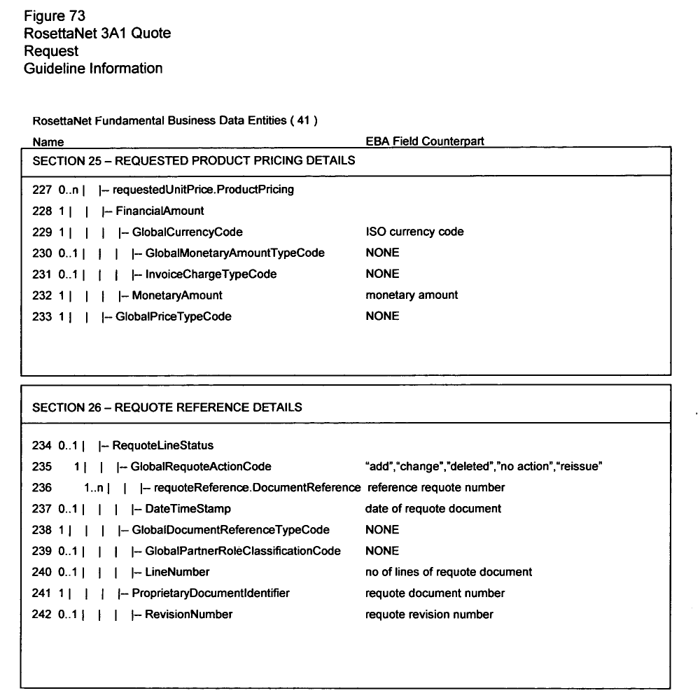

FIG. 73 illustrates RosettaNet's 3A1 Quote Request PIP covering SECTION 25—Requested Product Pricing Details and SECTION 26—Requote Reference Details. Corresponding generic EBA field counterparts are provided. CLAIM E is applied to SECTION 25.

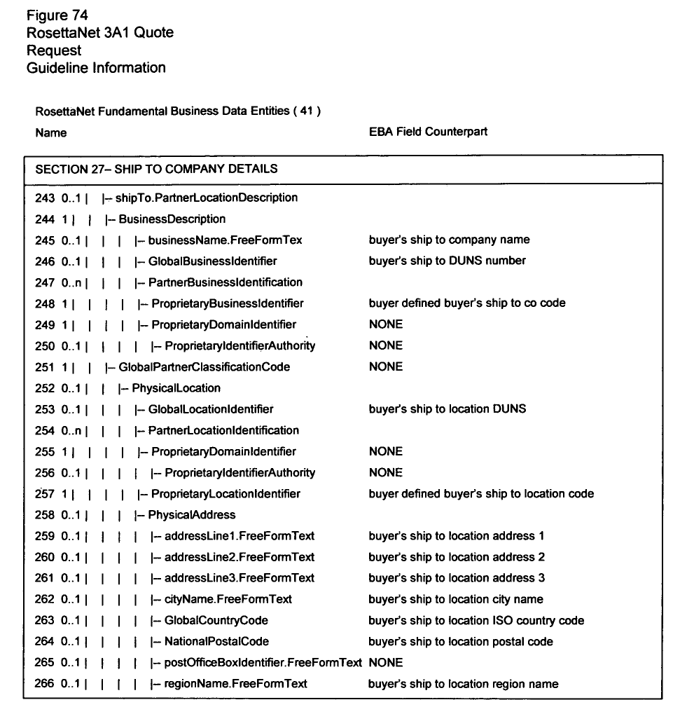

FIG. 74 illustrates RosettaNet's 3A1 Quote Request PIP covering SECTION 27—Ship To Company Details. Corresponding generic EBA field counterparts are provided. CLAIMs A, B and D are applied to SECTION 27.

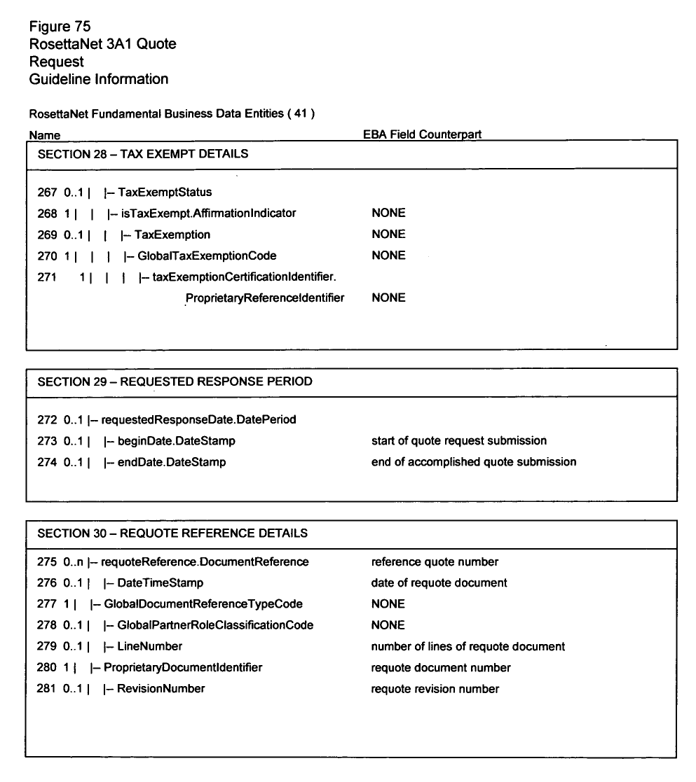

FIG. 75 illustrates RosettaNet's 3A1 Quote Request PIP covering SECTION 28—Tax Exempt Details, SECTION 29—Requested Response Period and SECTION 30—Requote Reference Details. Corresponding generic EBA field counterparts are provided.

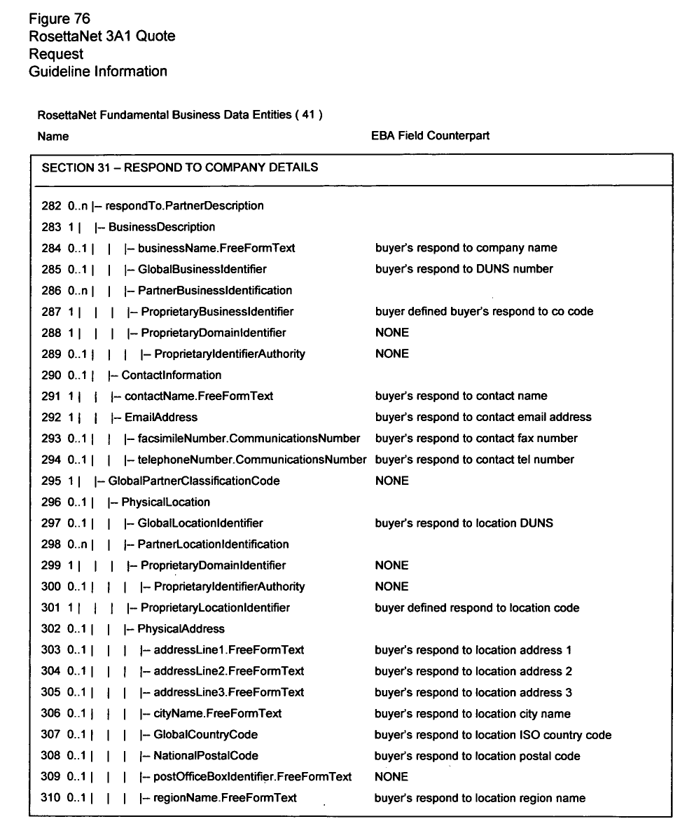

FIG. 76 illustrates RosettaNet's 3A1 Quote Request PIP covering SECTION 31—Respond To Company Details. Corresponding generic EBA field counterparts are provided. CLAIMs A, B and D are applied to SECTION 31.

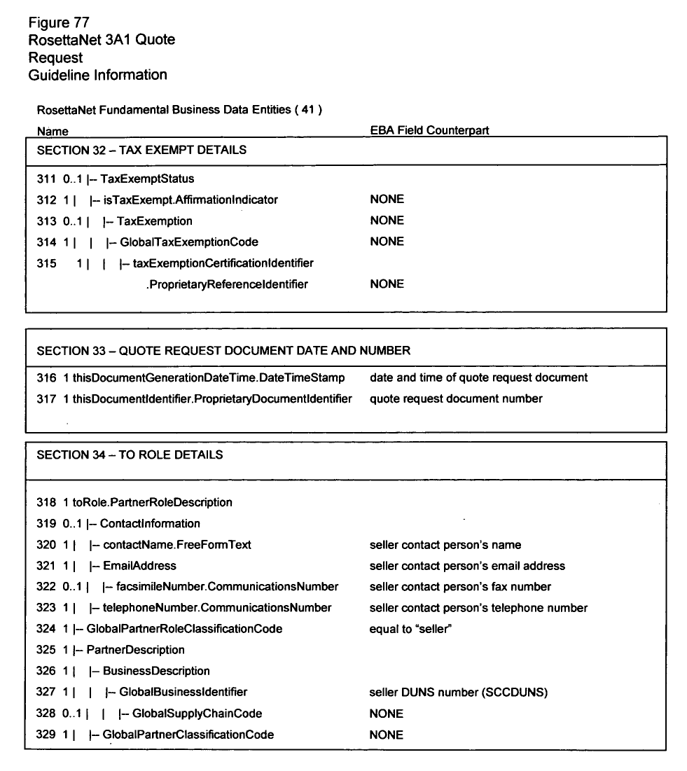

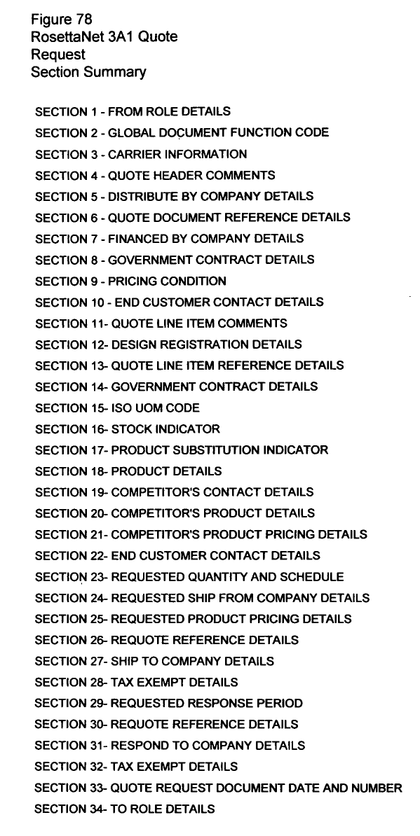

FIG. 77 illustrates RosettaNet's 3A1 Quote Request PIP covering SECTION 32—Tax Exempt Details, SECTION 33—Quote Request Document Date and Number SECTION 34—To Role Details. Corresponding generic EBA field counterparts are provided. CLAIMs C and D are applied to SECTION 34.

This quote request is sent buy the potential buyer and received by candidate sellers via the invention that is interfaced to their EBAs. The mode of transmission is electronic via internet using XML technology.

2.2. Response to RFQ

FIG. 1 illustrates the buying and selling processes covered by the invention. The process starts when the candidate seller receives the quote request. Candidate seller fills up the quote request. The process ends when the candidate seller returns the accomplished quote or confirmed quote via the invention to the potential buyer.

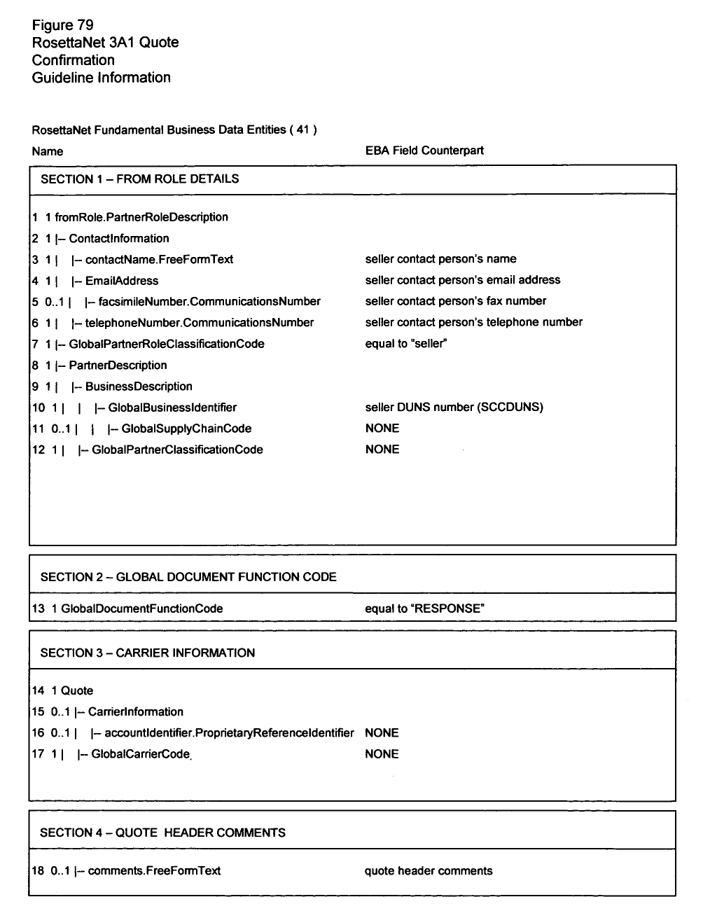

RosettaNet PIP 3A1 Quote Confirmation is the standard to be used by the invention for Quote Confirmation. FIGS. 79-101 provide a listing of RosettaNet's PIP 3A1 Quote Confirmation with corresponding EBA field counterpart.

FIG. 79 illustrates RosettaNet's 3A1 Quote Confirmation covering SECTION 1—From Role Details, SECTION 2—Global Document Function Code, SECTION 3—Carrier Information and SECTION 4—Quote Header Comments. Corresponding generic EBA field counterparts are provided. CLAIMs C and D are applied to SECTION 1.

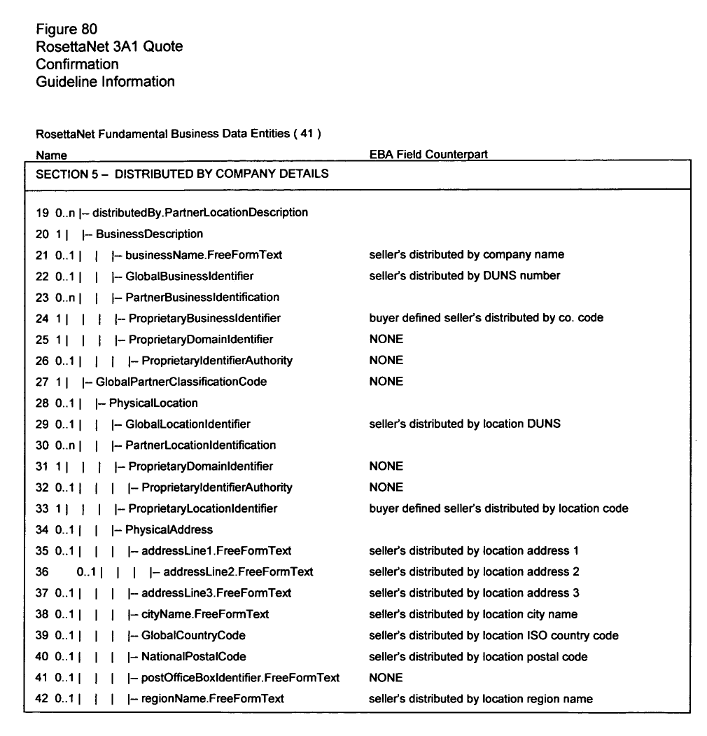

FIG. 80 illustrates RosettaNet's 3A1 Quote Confirmation covering SECTION 5—Distributed By Company Details. Corresponding generic EBA field counterparts are provided. CLAIMs A, B and D are applied to SECTION 5.

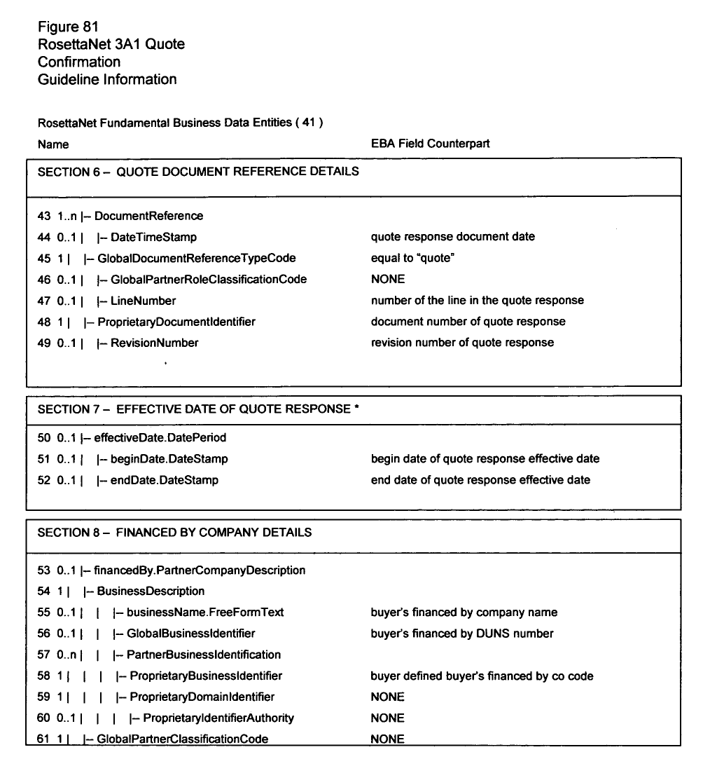

FIG. 81 illustrates RosettaNet's 3A1 Quote Confirmation covering SECTION 6—Quote Document Reference Details, SECTION 7—Effective Date of Quote Response and SECTION 8—Financed By Company Details. Corresponding generic EBA field counterparts are provided. CLAIM D is applied to SECTION 8.

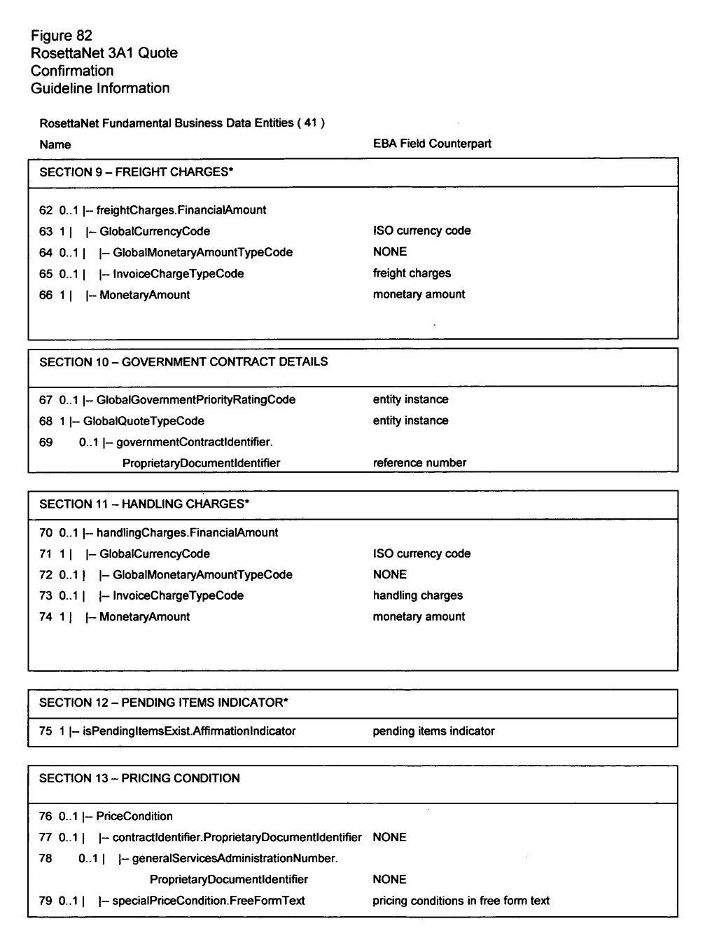

FIG. 82 illustrates RosettaNet's 3A1 Quote Confirmation covering SECTION 9—Freight Charges, SECTION 10—Government Contract Details, SECTION 11—Handling Charges, SECTION 12—Pending Items Indicator and SECTION 13—Pricing Condition. Corresponding generic EBA field counterparts are provided. CLAIM E is applied to SECTION 9 and 11.

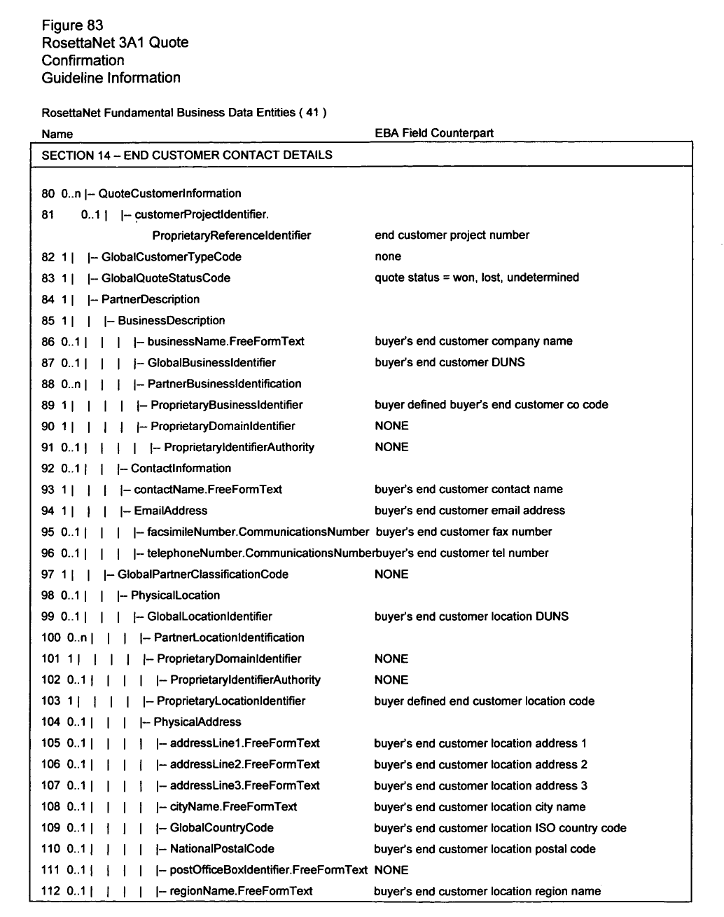

FIG. 83 illustrates RosettaNet's 3A1 Quote Confirmation covering SECTION 14—End Customer Contact Details. Corresponding generic EBA field counterparts are provided. CLAIMs A, B and D are applied to SECTION 14.

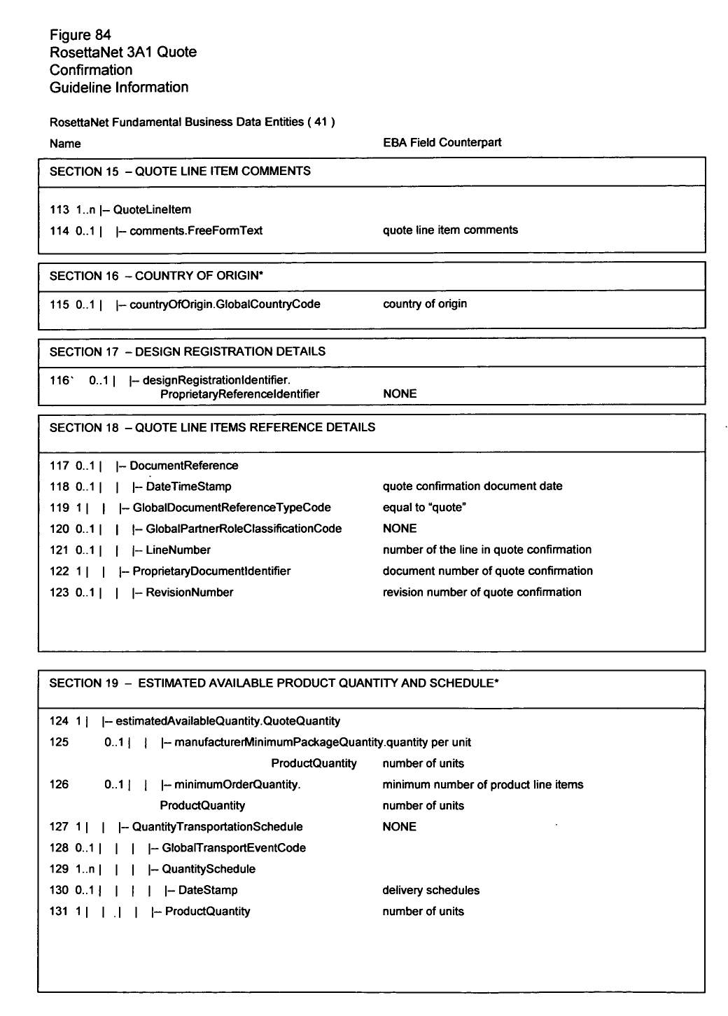

FIG. 84 illustrates RosettaNet's 3A1 Quote Confirmation covering SECTION 15—Quote Line Item Comments, SECTION 16—Country of Origin, SECTION 17—Design Registration Details, SECTION 18—Quote Line Items Reference Details and SECTION 19—Estimated Available Product Quantity and Schedule. Corresponding generic EBA field counterparts are provided. CLAIM B is applied to SECTION 16.

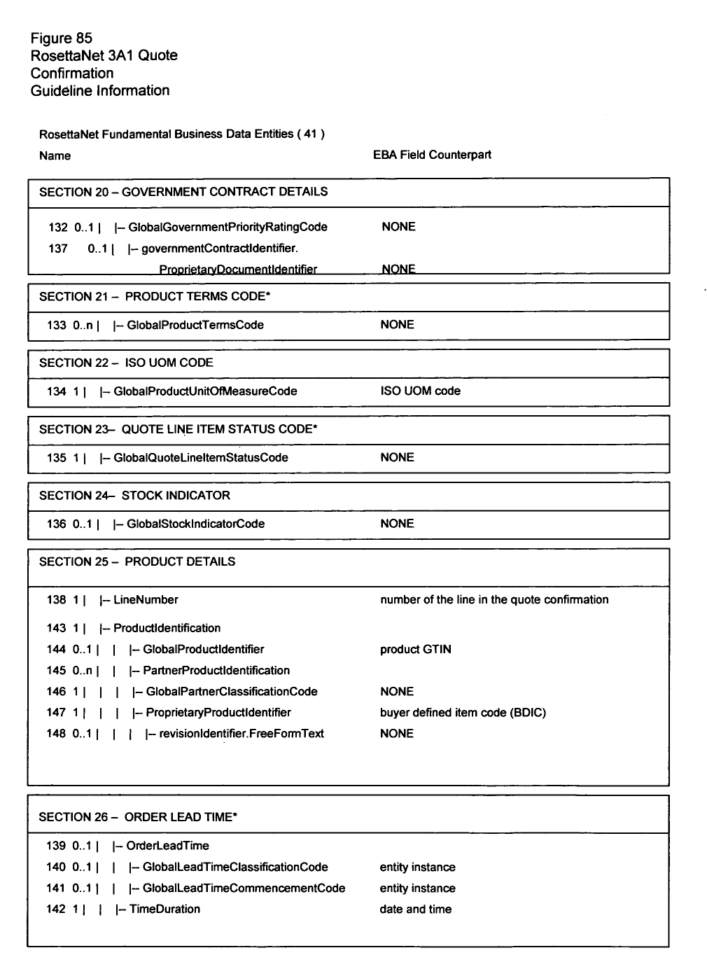

FIG. 85 illustrates RosettaNet's 3A1 Quote Confirmation covering SECTION 20—Government Contract Details, SECTION 21—Product Terms Code, SECTION 22—ISO UOM Code, SECTION 23—Quote Line Item Status Code, SECTION 24—Stock Indicator, SECTION 25—Product Details and SECTION 26—Order Lead Time Global Document Function Code. Corresponding generic EBA field counterparts are provided. CLAIM F is applied to SECTION 22. CLAIM G is applied to SECTION 25.

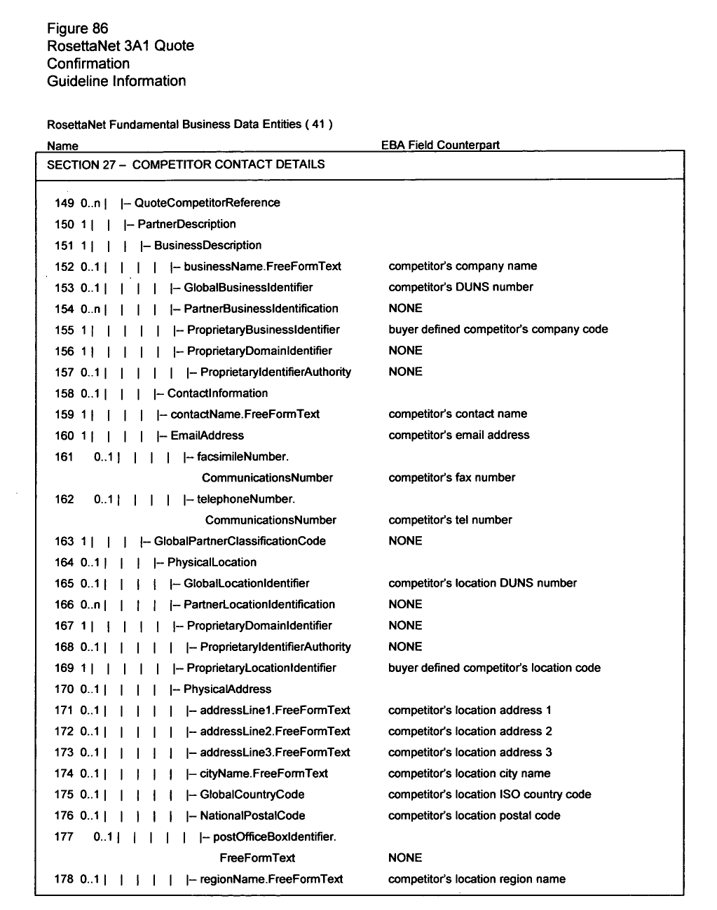

FIG. 86 illustrates RosettaNet's 3A1 Quote Confirmation covering SECTION 27—Competitor Contact Details. Corresponding generic EBA field counterparts are provided. CLAIMs A, B and D are applied to SECTION 27.

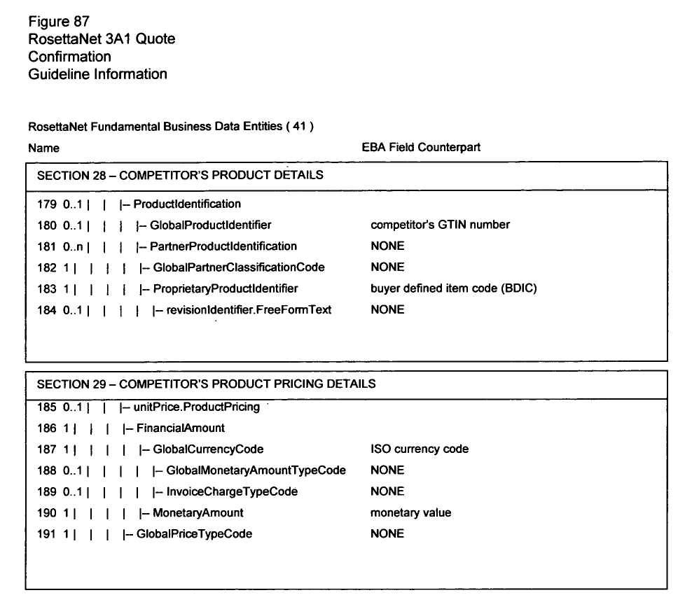

FIG. 87 illustrates RosettaNet's 3A1 Quote Confirmation covering SECTION 28—Competitor's Product Details and SECTION 29—Competitor's Product Pricing Details. Corresponding generic EBA field counterparts are provided. CLAIM G is applied to SECTION 28. CLAIM E is applied to SECTION 29.

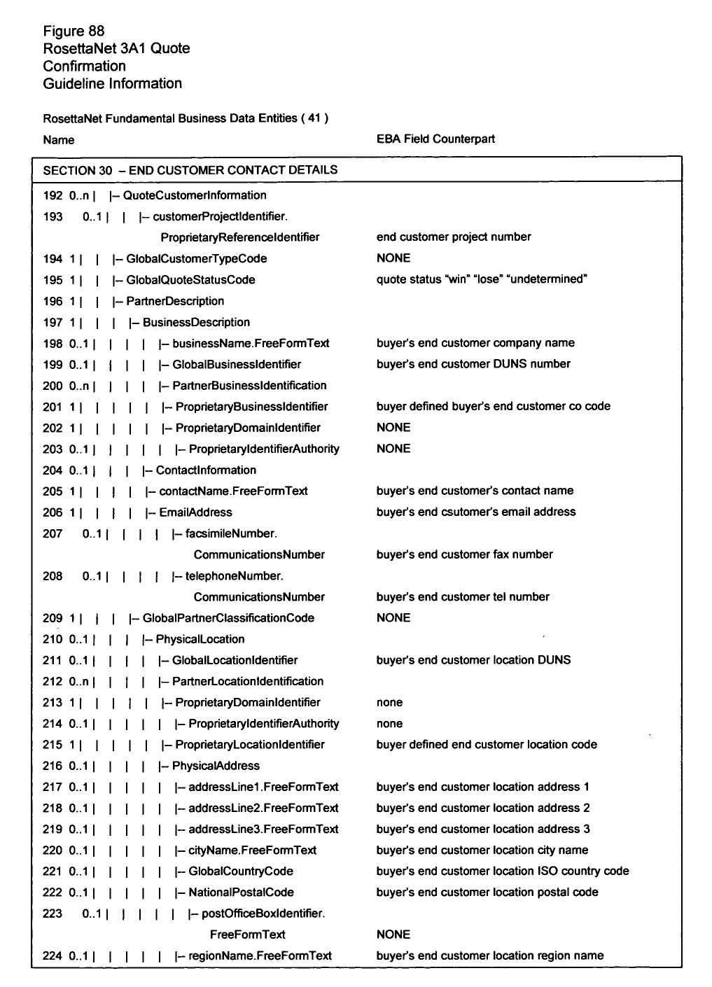

FIG. 88 illustrates RosettaNet's 3A1 Quote Confirmation covering SECTION 30—End Customer Contact Details. Corresponding generic EBA field counterparts are provided. CLAIMs A, B and D are applied to SECTION 30.

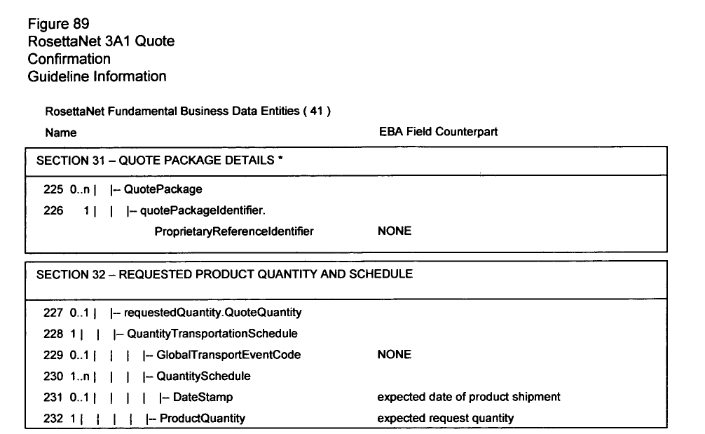

FIG. 89 illustrates RosettaNet's 3A1 Quote Confirmation covering SECTION 31—Quote Package Details and SECTION 32—Requested Product Quantity and Schedule. Corresponding generic EBA field counterparts are provided.

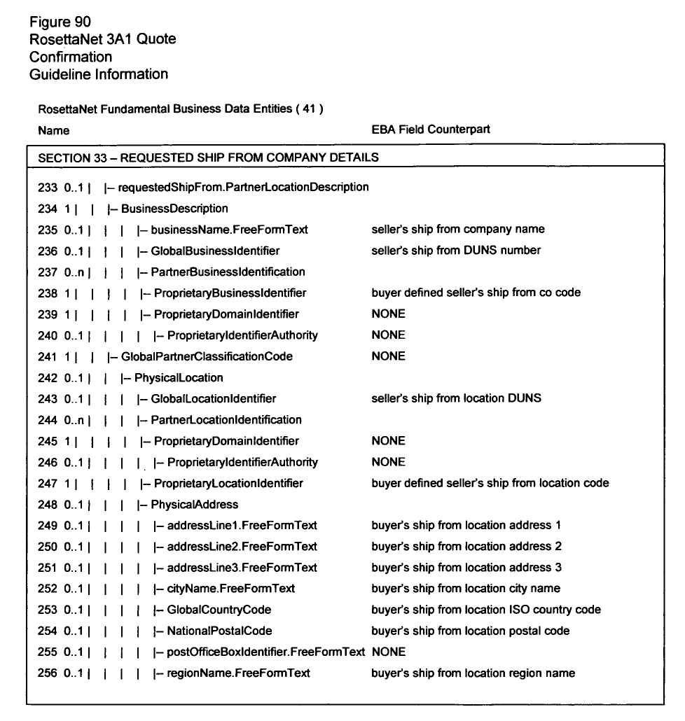

FIG. 90 illustrates RosettaNet's 3A1 Quote Confirmation covering SECTION 33—Requested Ship From Company Details. Corresponding generic EBA field counterparts are provided. CLAIMs A, B and D are applied to SECTION 27.

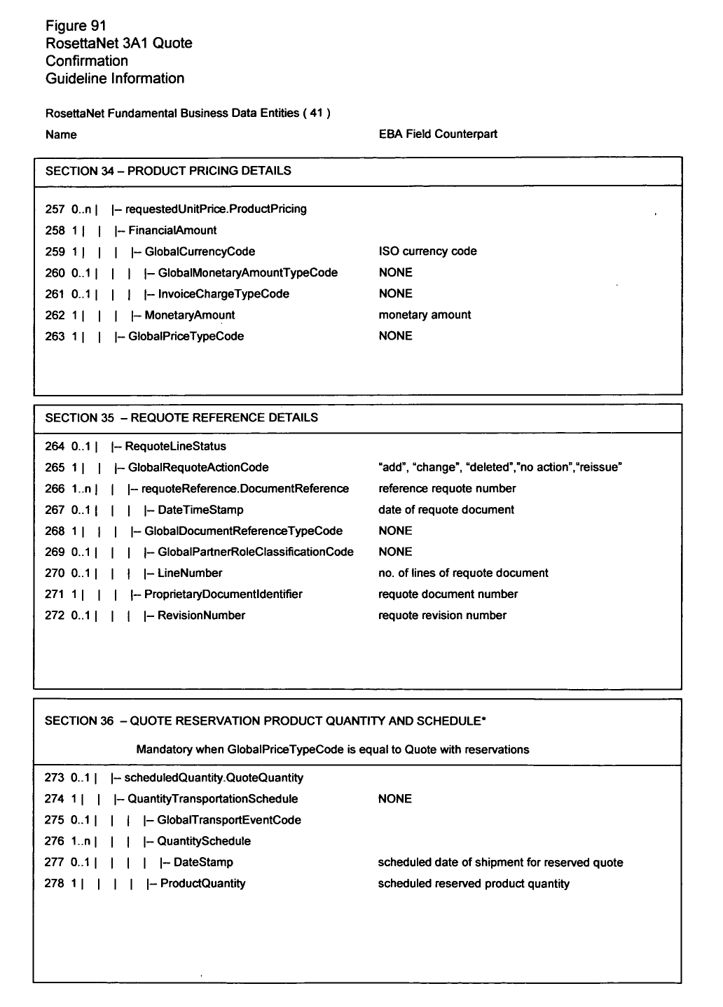

FIG. 91 illustrates RosettaNet's 3A1 Quote Confirmation covering SECTION 34—Product Pricing Details, SECTION 35—Requote Reference Details and SECTION 36—Quote Reservation Product Quantity and Schedule. Corresponding generic EBA field counterparts are provided. CLAIM E is applied to SECTION 34.

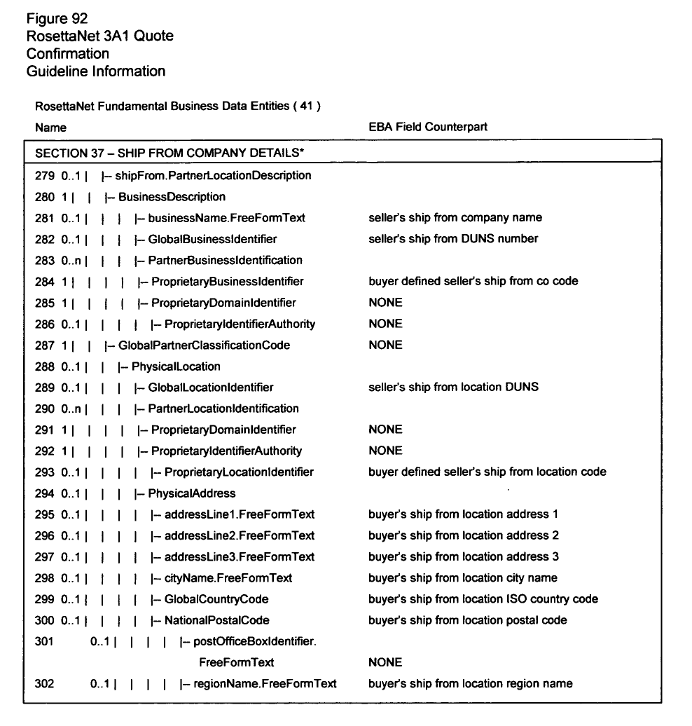

FIG. 92 illustrates RosettaNet's 3A1 Quote Confirmation covering SECTION 37—Ship From Company Details. Corresponding generic EBA field counterparts are provided. CLAIMs A, B and D are applied to SECTION 37.

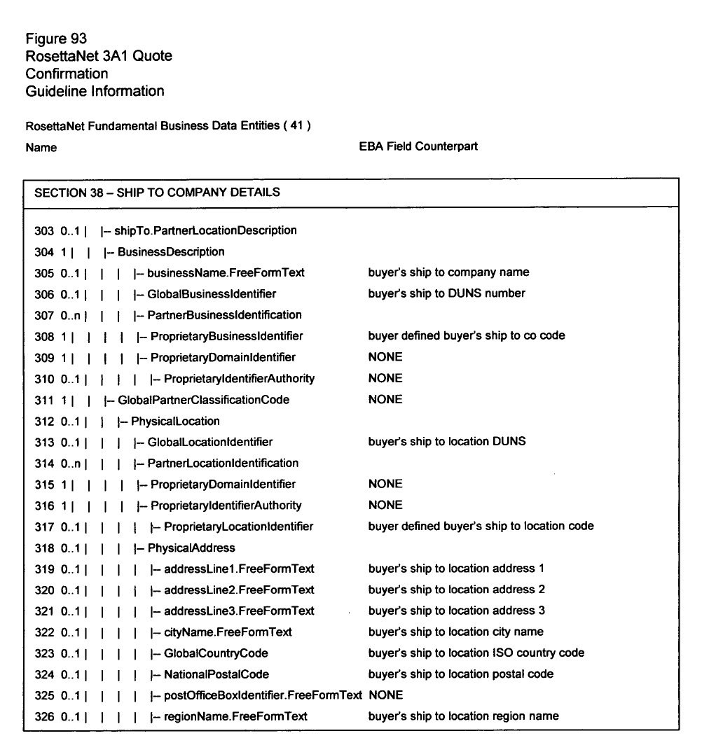

FIG. 93 illustrates RosettaNet's 3A1 Quote Confirmation covering SECTION 38—Ship To Company Details. Corresponding generic EBA field counterparts are provided. CLAIMs A, B and D are applied to SECTION 38.

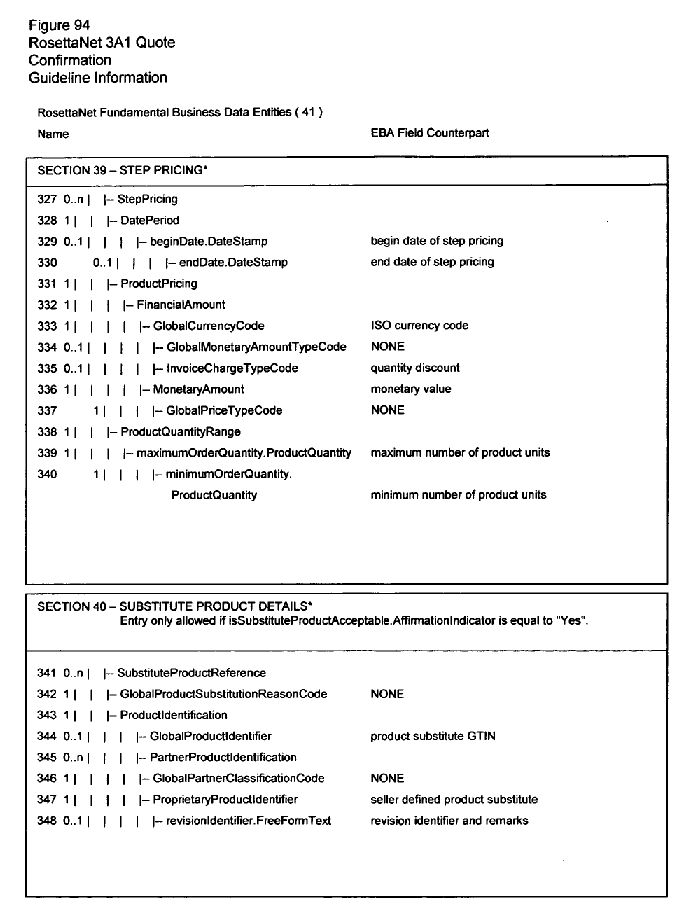

FIG. 94 illustrates RosettaNet's 3A1 Quote Confirmation covering SECTION 39—Step Pricing and SECTION 40—Substitute Product Details. Corresponding generic EBA field counterparts are provided. CLAIM E is applied to SECTION 39. CLAIM G is applied to SECTION 40.

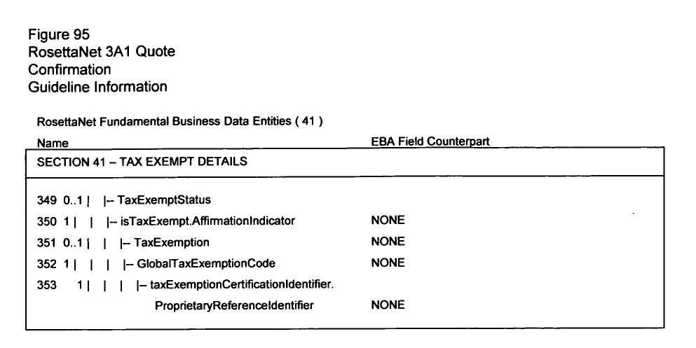

FIG. 95 illustrates RosettaNet's 3A1 Quote Confirmation covering SECTION 41—Tax Exempt Details. Corresponding generic EBA field counterparts are provided.

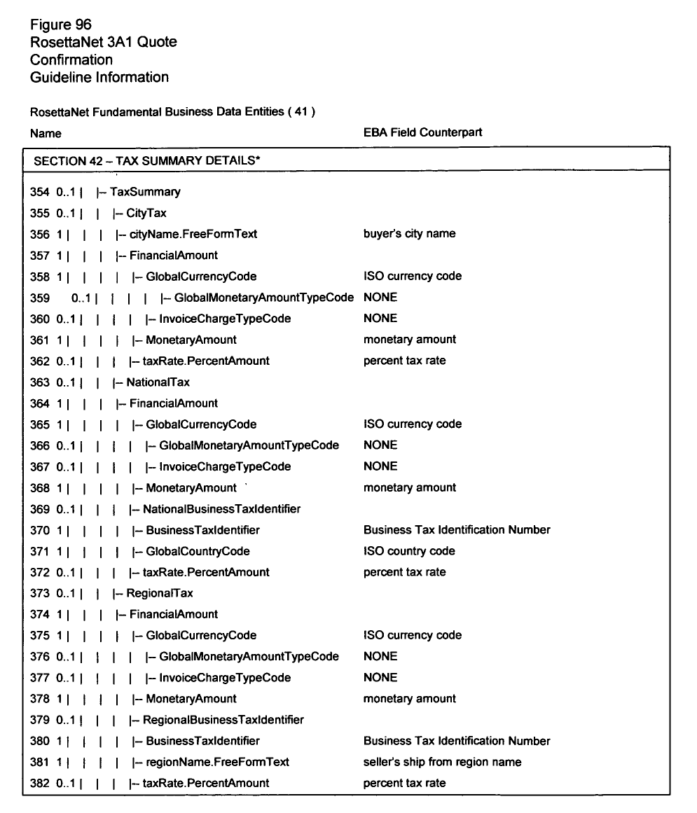

FIG. 96 illustrates RosettaNet's 3A1 Quote Confirmation covering SECTION 42—Tax Summary Details. Corresponding generic EBA field counterparts are provided. CLAIMs B and E are applied to SECTION 42.

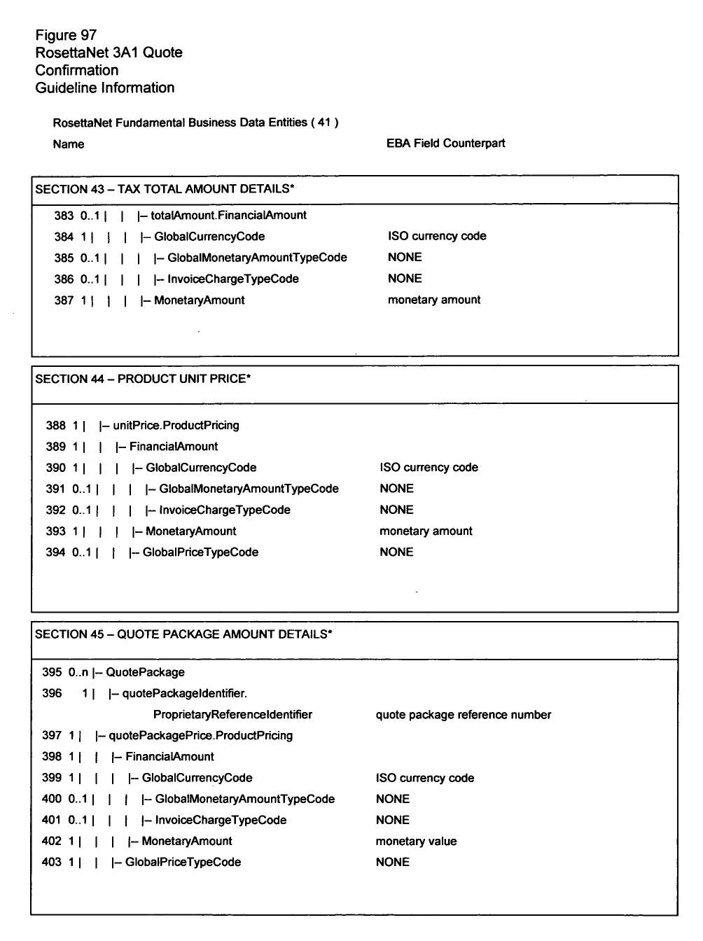

FIG. 97 illustrates RosettaNet's 3A1 Quote Confirmation covering SECTION 43—Tax Total Amount Details, SECTION 44—Product Unit Price and SECTION 45—Quote Package Amount Details. Corresponding generic EBA field counterparts are provided. CLAIM E is applied to SECTION 43, 44 and 45.

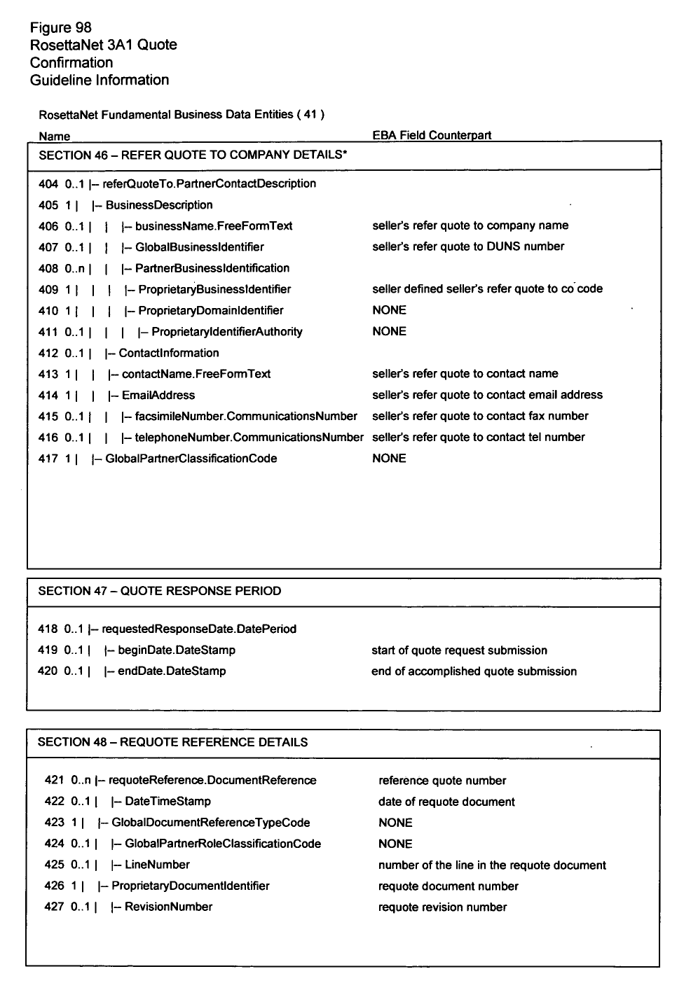

FIG. 98 illustrates RosettaNet's 3A1 Quote Confirmation covering SECTION 46—Refer Quote To Company Details, SECTION 47—Quote Response Period and SECTION 48—Requote Reference Details. Corresponding generic EBA field counterparts are provided. CLAIM D is applied to SECTION 46.

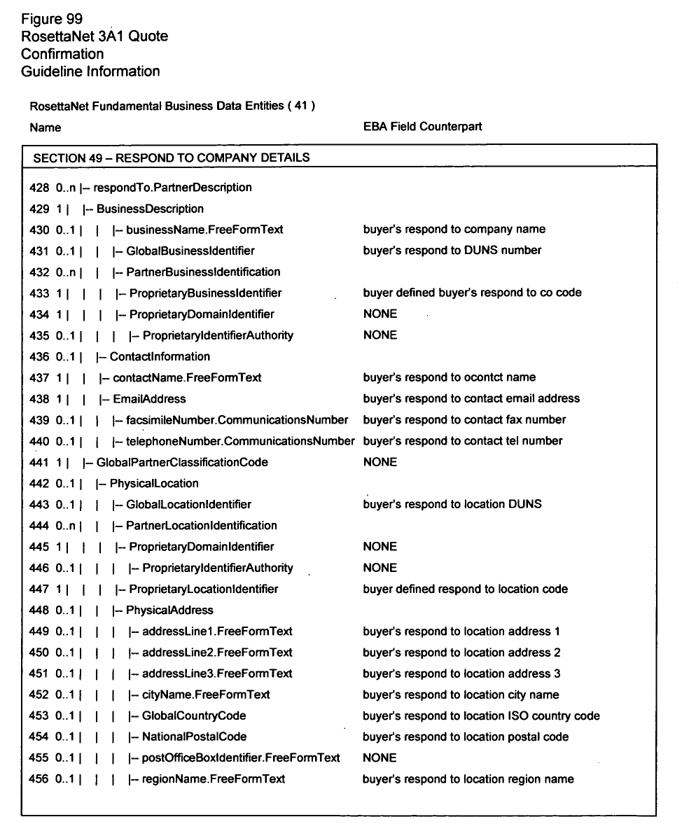

FIG. 99 illustrates RosettaNet's 3A1 Quote Confirmation covering SECTION 49—Respond To Company Details. Corresponding generic EBA field counterparts are provided. CLAIMs A, B and D are applied to SECTION 49.

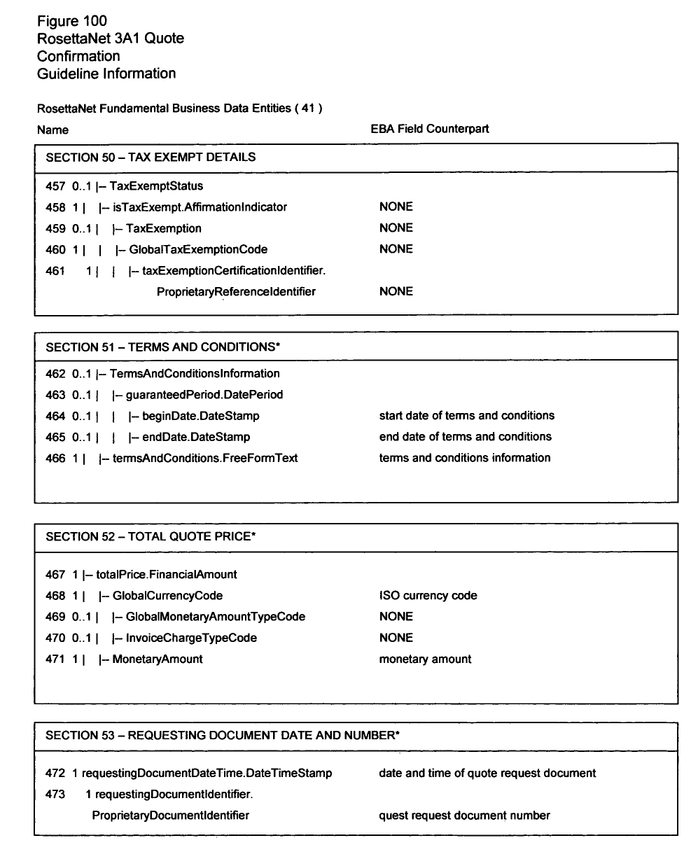

FIG. 100 illustrates RosettaNet's 3A1 Quote Confirmation covering SECTION 50—Tax Exempt Details, SECTION 51—Terms and Conditions, SECTION 52—Total Quote Price and SECTION 53—Requesting Document Date and Number. Corresponding generic EBA field counterparts are provided. CLAIM E is applied to SECTION 52.

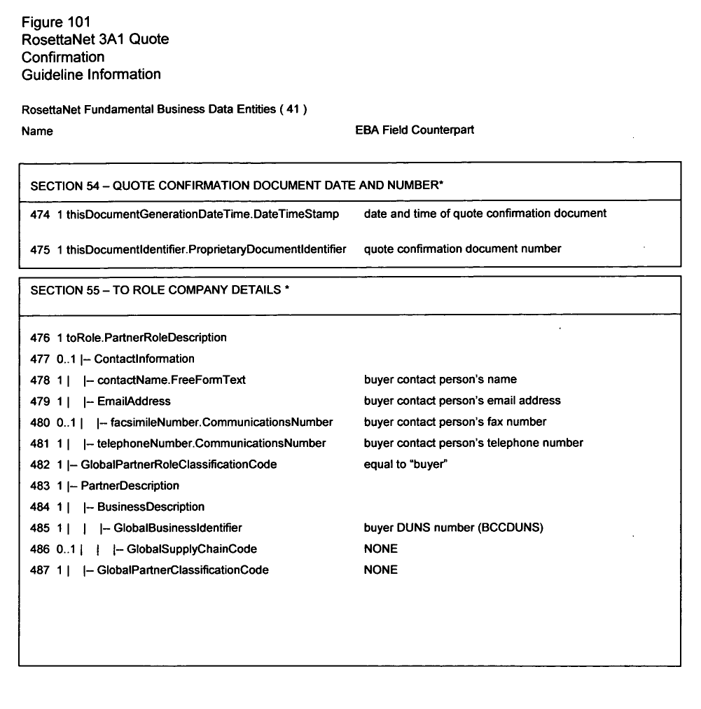

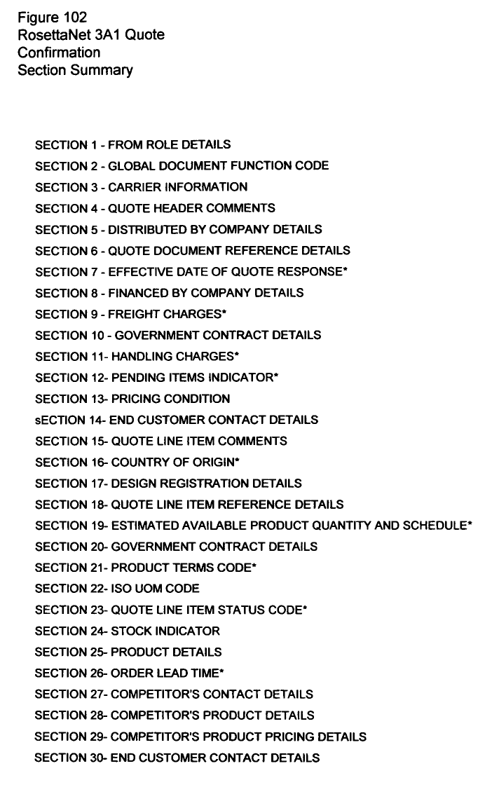

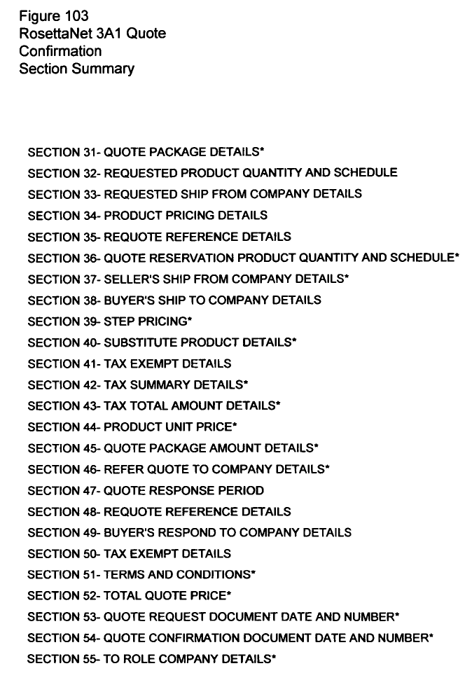

FIG. 101 illustrates RosettaNet's 3A1 Quote Confirmation covering SECTION 54—Quote Confirmation Document Date and Number and SECTION 55—To Role Company Details. Corresponding generic EBA field counterparts are provided. CLAIMs C and D are applied to SECTION 55.

This process ends when the candidate seller send the quote confirmation to the invention. The potential buyer receives the quote confirmation from the invention. The mode of transmission is electronic via internet using XML technology.

2.3. Purchase Order (PO) Request

The buyer initiates a purchase order request and sends this to seller. The process ends when the seller receives the electronic form of the purchase order request.

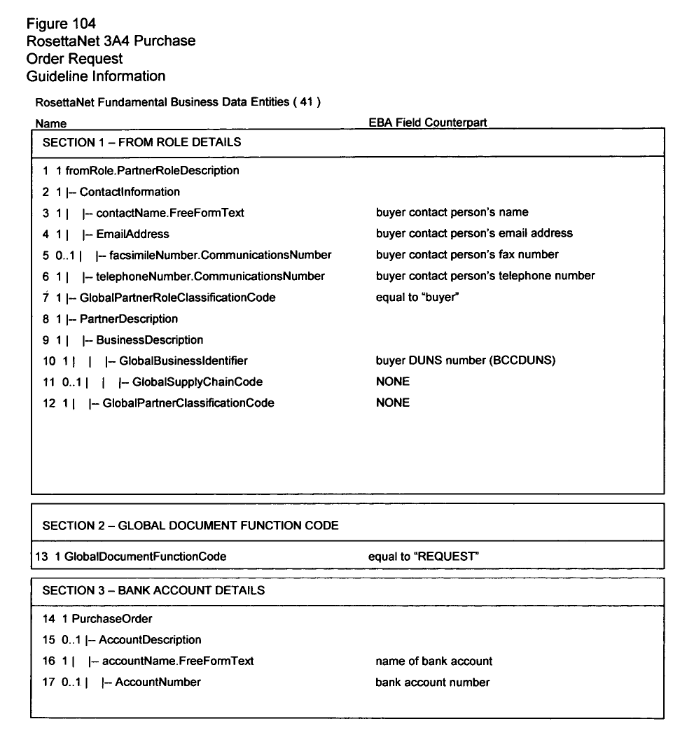

RosettaNet PIP 3A4 Purchase Order Request is the standard to be used by the invention for Purchase Order Request. FIGS. 104-129 provide a listing of RosettaNet's PIP 3A4 Purchase Order Request with corresponding EBA field counterpart.

FIG. 104 illustrates RosettaNet's 3A4 Purchase Order Request covering SECTION 1—From Role Details, SECTION 2—Global Document Function Code and SECTION 3—Bank Account Details. Corresponding generic EBA field counterparts are provided. CLAIMs C and D are applied to SECTION 1.

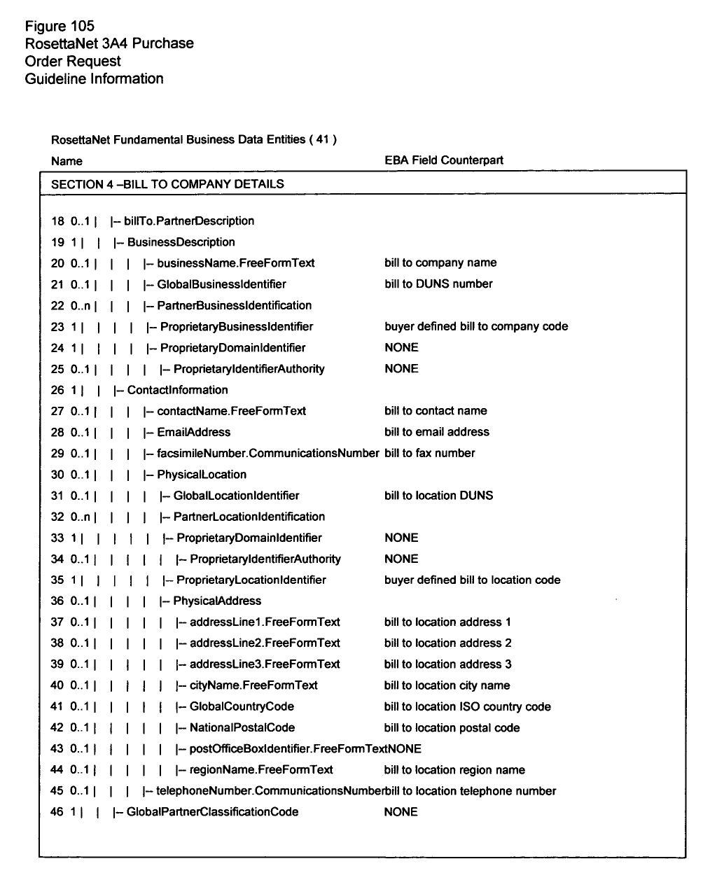

FIG. 105 illustrates RosettaNet's 3A4 Purchase Order Request covering SECTION 4—Bill To Company Details. Corresponding generic EBA field counterparts are provided. CLAIMs A, B and D are applied to SECTION 4.

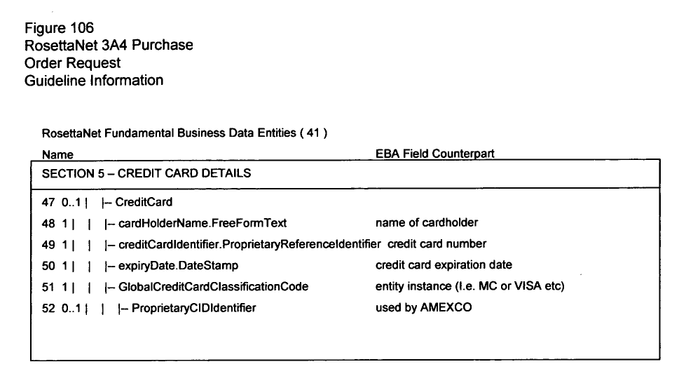

FIG. 106 illustrates RosettaNet's 3A4 Purchase Order Request covering SECTION 5—Credit Card Details. Corresponding generic EBA field counterparts are provided.

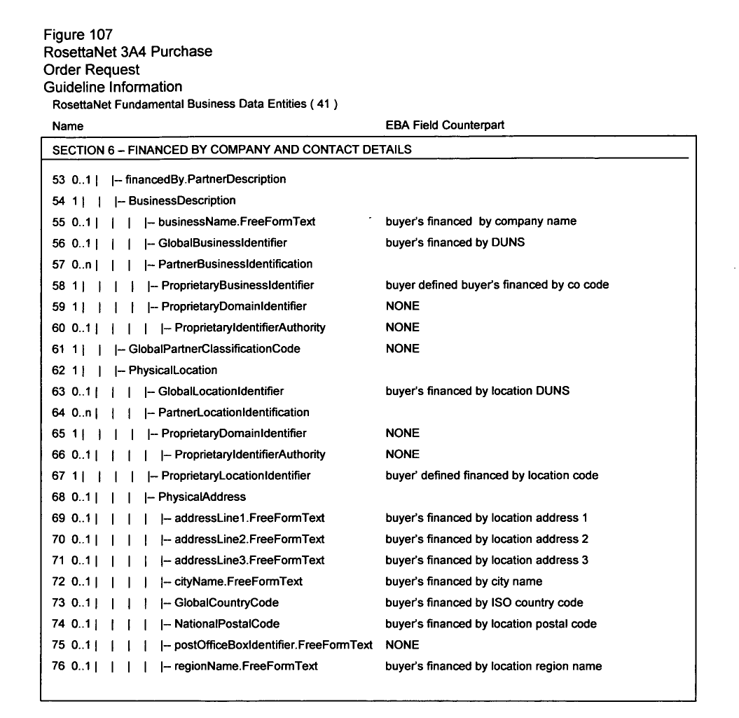

FIG. 107 illustrates RosettaNet's 3A4 Purchase Order Request covering SECTION 7—Financed By Company and Contact Details. Corresponding generic EBA field counterparts are provided. CLAIMs A, B and D are applied to SECTION 7.

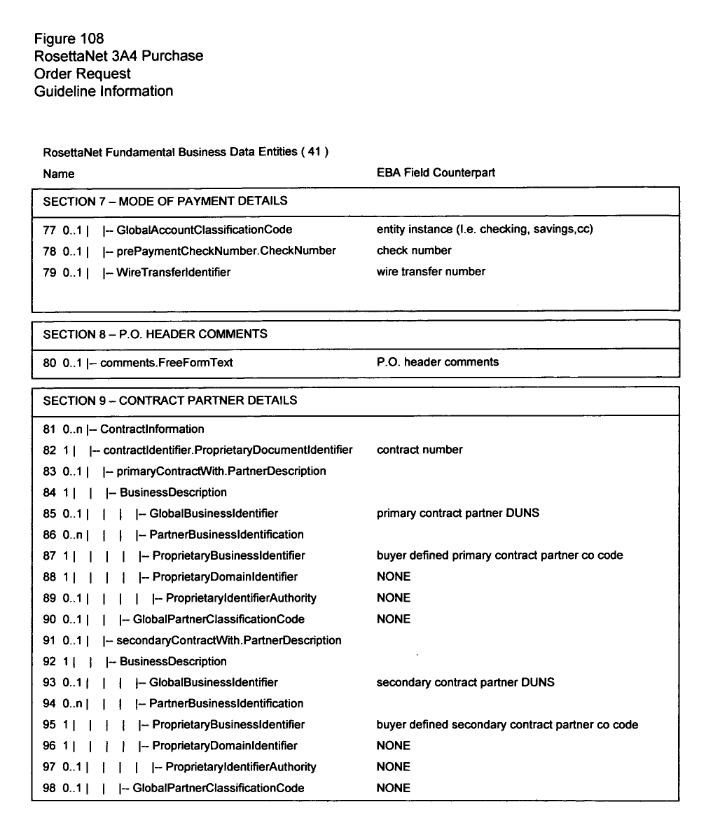

FIG. 108 illustrates RosettaNet's 3A4 Purchase Order Request covering SECTION 7—Mode of Payment Details, SECTION 8—P.O. Header Comments and SECTION 9—Contract Partner Details. Corresponding generic EBA field counterparts are provided. CLAIM D is applied to SECTION 9.

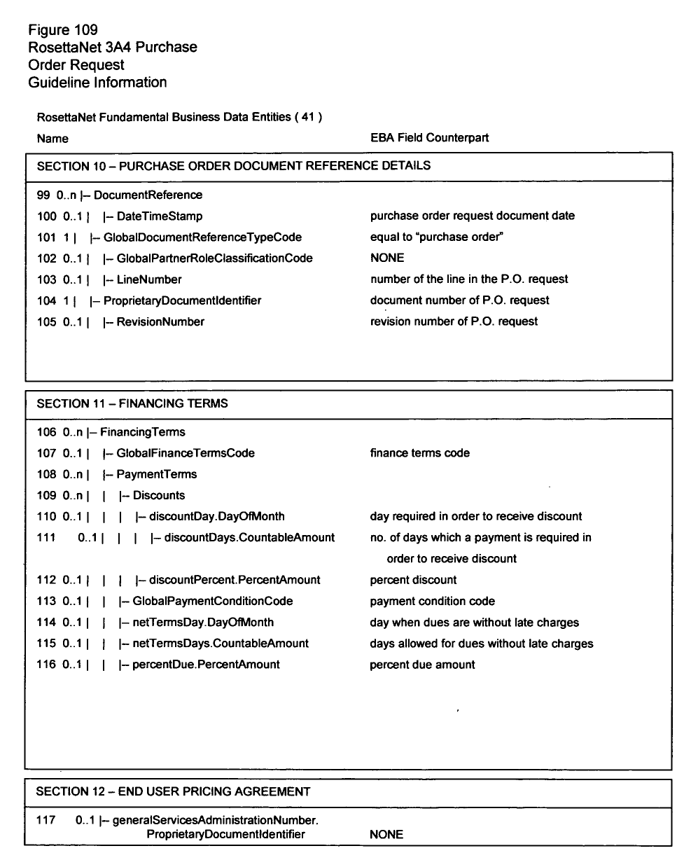

FIG. 109 illustrates RosettaNet's 3A4 Purchase Order Request covering SECTION 10—Purchase Order Document Reference Details, SECTION 11—Financing Terms and SECTION 12—End User Pricing Agreement. Corresponding generic EBA field counterparts are provided.

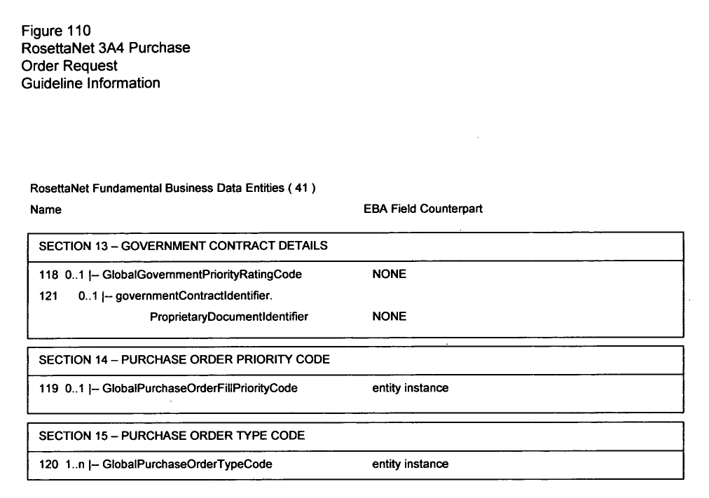

FIG. 110 illustrates RosettaNet's 3A4 Purchase Order Request covering SECTION 13—Government Contract Details, SECTION 14—Purchase Order Priority Code and SECTION 15—Purchase Order Type Code. Corresponding generic EBA field counterparts are provided.

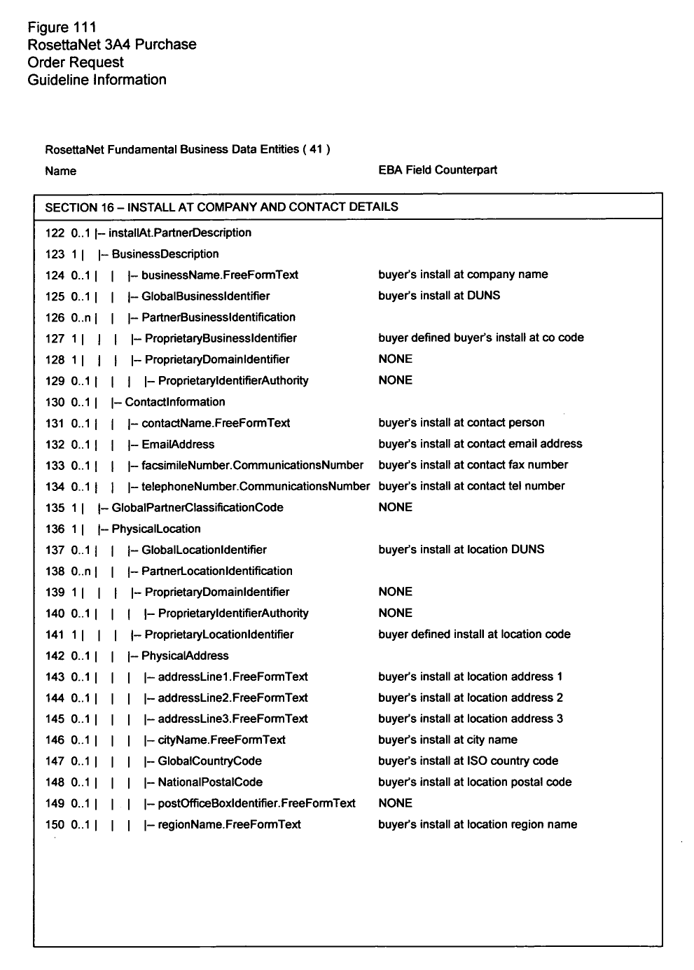

FIG. 111 illustrates RosettaNet's 3A4 Purchase Order Request covering SECTION 16—Install At Company and Contact Details. Corresponding generic EBA field counterparts are provided. CLAIMs A, B and D are applied to SECTION 16.

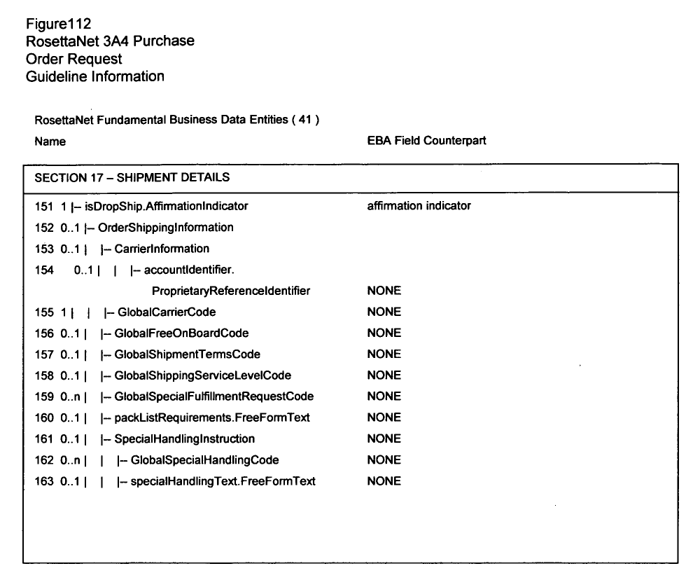

FIG. 112 illustrates RosettaNet's 3A4 Purchase Order Request covering SECTION 17—Shipment Details. Corresponding generic EBA field counterparts are provided.

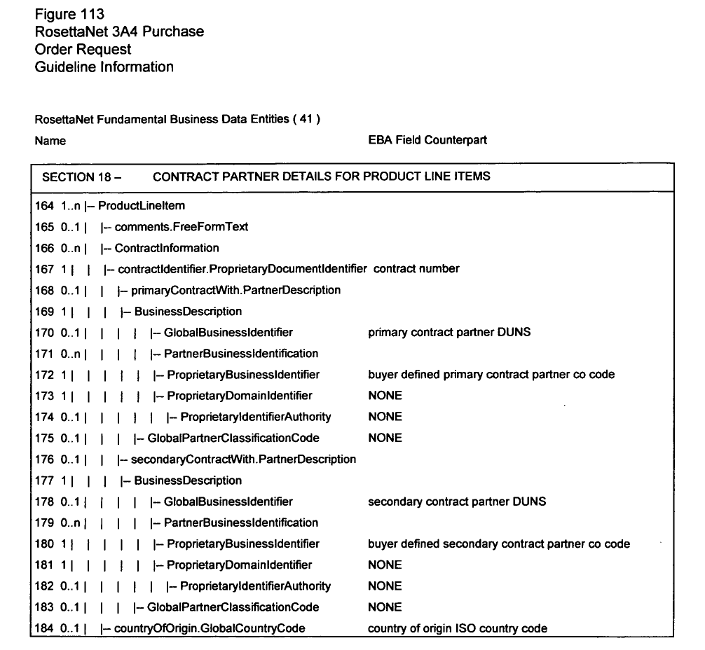

FIG. 113 illustrates RosettaNet's 3A4 Purchase Order Request covering SECTION 18—Contract Partner Details for Product Line Items. Corresponding generic EBA field counterparts are provided. CLAIM D is applied to SECTION 18.

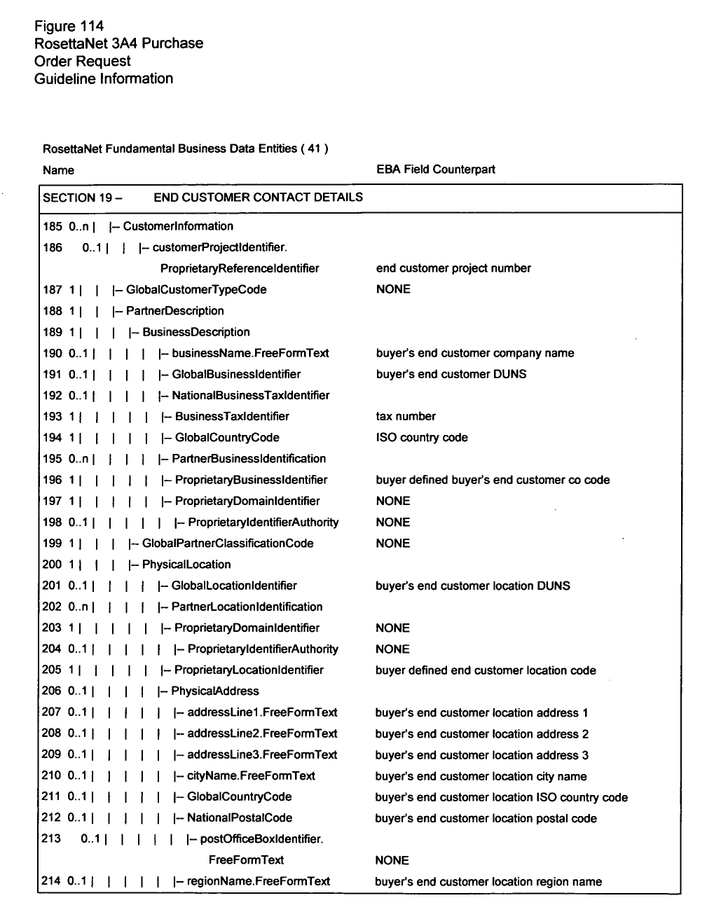

FIG. 114 illustrates RosettaNet's 3A4 Purchase Order Request covering SECTION 19—End Customer Contact Details. Corresponding generic EBA field counterparts are provided. CLAIMs A, B and D are applied to SECTION 19.

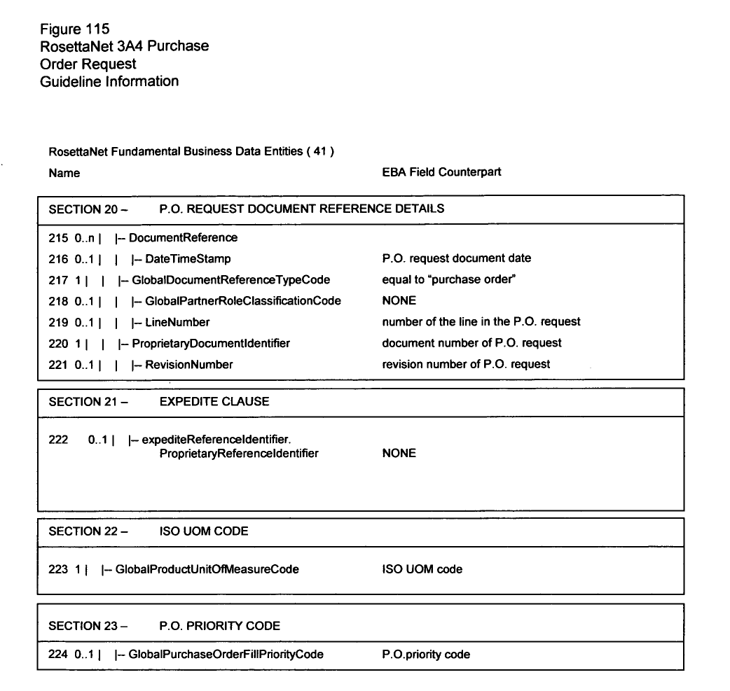

FIG. 115 illustrates RosettaNet's 3A4 Purchase Order Request covering SECTION 20—P.O. Request Document Reference Details, SECTION 21—Expedite Clause, SECTION 22—ISO UOM Code and SECTION 23—P.O. Priority Code. Corresponding generic EBA field counterparts are provided. CLAIM F is applied to SECTION 22.

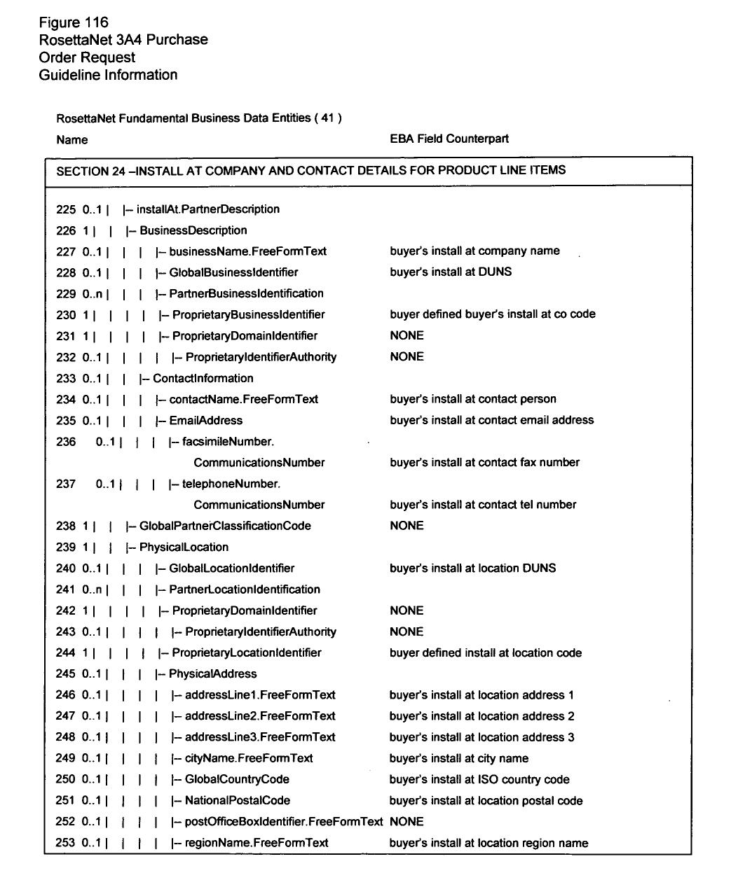

FIG. 116 illustrates RosettaNet's 3A4 Purchase Order Request covering SECTION 24—Install At Company and Contact Details for Product Line Items. Corresponding generic EBA field counterparts are provided. CLAIMs A, B and D are applied to SECTION 24.

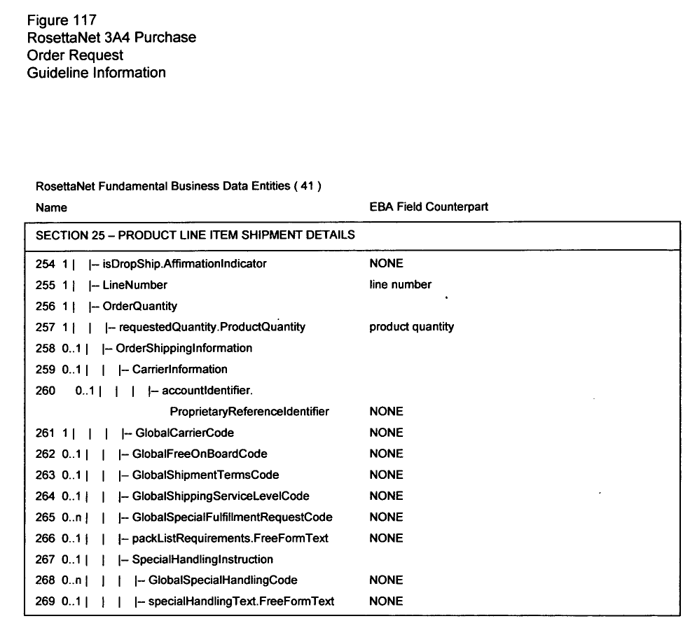

FIG. 117 illustrates RosettaNet's 3A4 Purchase Order Request covering SECTION 25—Product Line Item Shipment Details. Corresponding generic EBA field counterparts are provided.

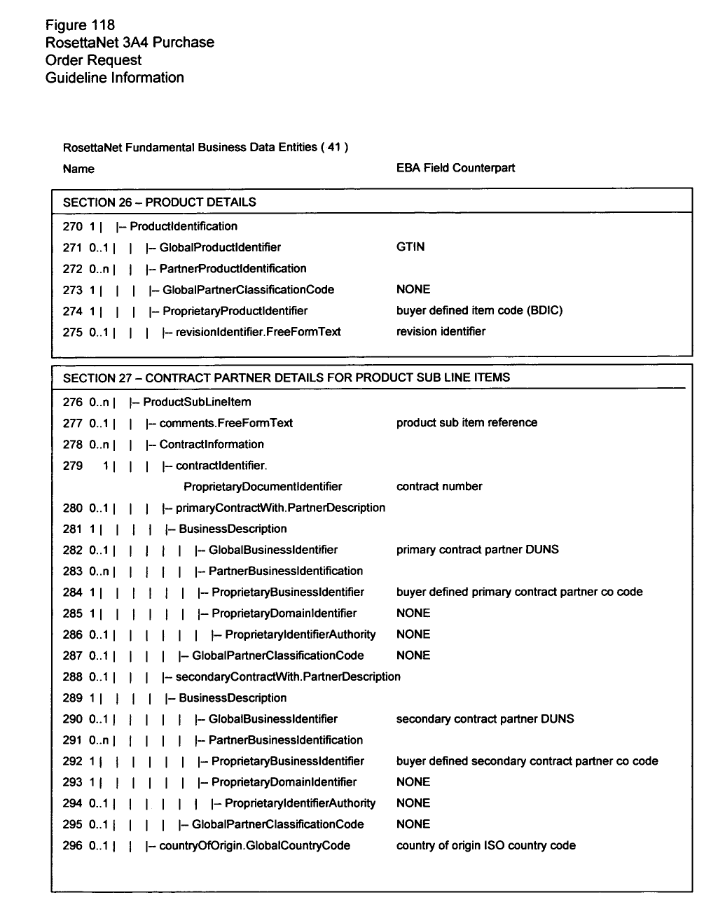

FIG. 118 illustrates RosettaNet's 3A4 Purchase Order Request covering SECTION 26—Product Details and SECTION 27—Contract Partner Details for Product Sub Line Items. Corresponding generic EBA field counterparts are provided. CLAIM G is applied to SECTION 26. CLAIMs B and D are applied to SECTION 27.

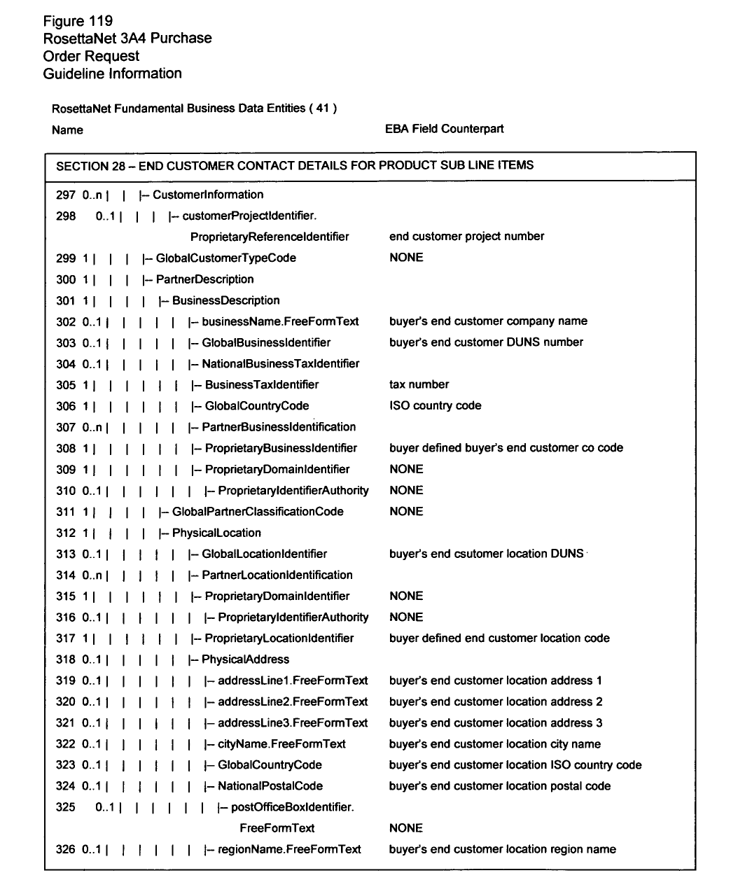

FIG. 119 illustrates RosettaNet's 3A4 Purchase Order Request covering SECTION 28—End Customer Contact Details for Product Sub Line Items. Corresponding generic EBA field counterparts are provided. CLAIMs A, B and D are applied to SECTION 28.

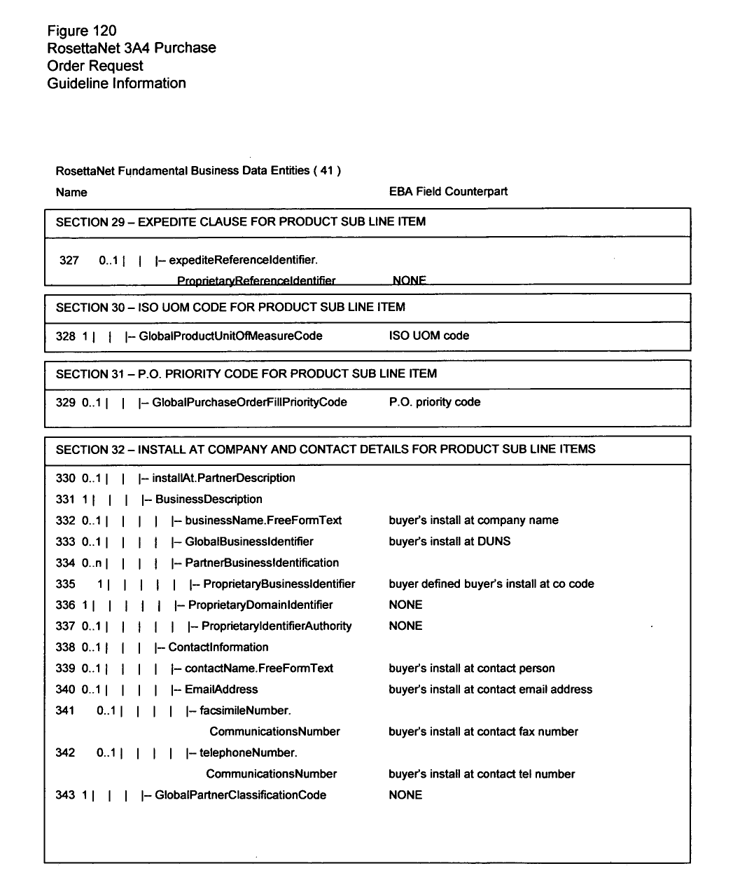

FIG. 120 illustrates RosettaNet's 3A4 Purchase Order Request covering SECTION 29—Expedite Clause for Product Sub Line Item, SECTION 30—ISO UOM code for Product Sub Line Item, SECTION 31—P.O. Priority Code for Product Sub Line Item and SECTION 32—Install At Company and Contact Details for Product Sub Line Items. Corresponding generic EBA field counterparts are provided. CLAIM F is applied to SECTION 30. CLAIM D is applied to SECTION 32.

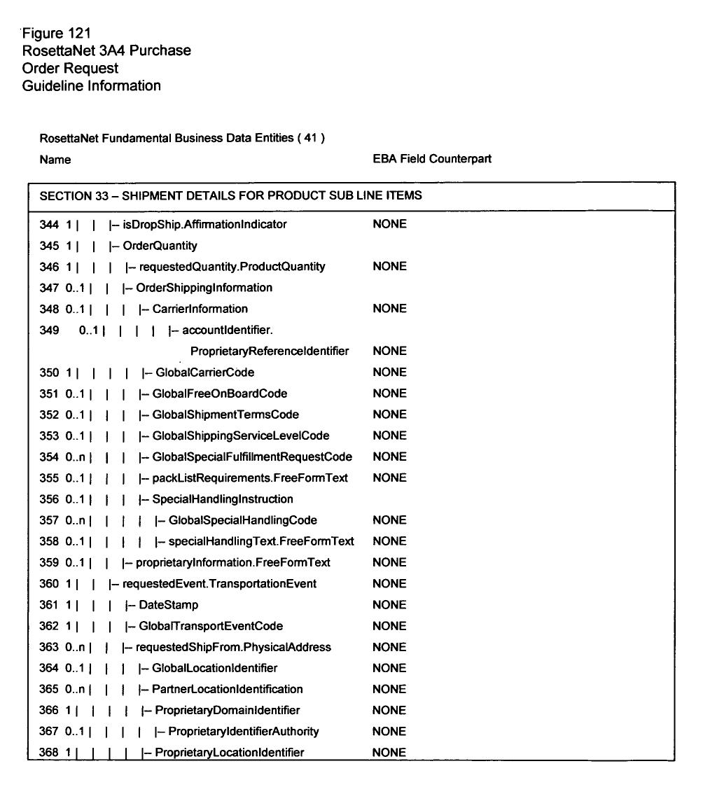

FIG. 121 illustrates RosettaNet's 3A4 Purchase Order Request covering SECTION 33—Shipment Details for Product Sub Line Items. Corresponding generic EBA field counterparts are provided. CLAIM A is applied to SECTION 33.

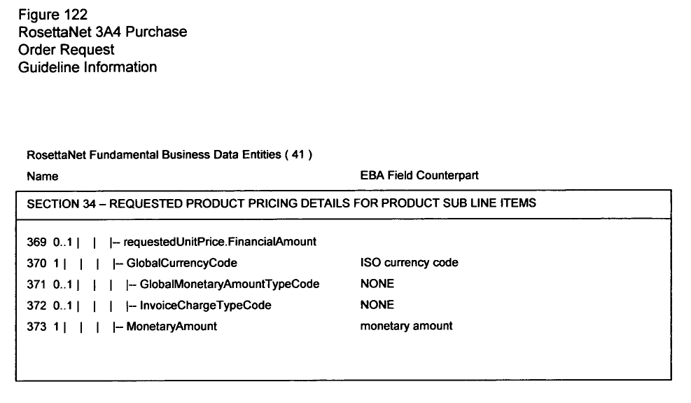

FIG. 122 illustrates RosettaNet's 3A4 Purchase Order Request covering SECTION 34—Requested Product Pricing Details for Product Sub Line Items. Corresponding generic EBA field counterparts are provided. CLAIM E is applied to SECTION 34.

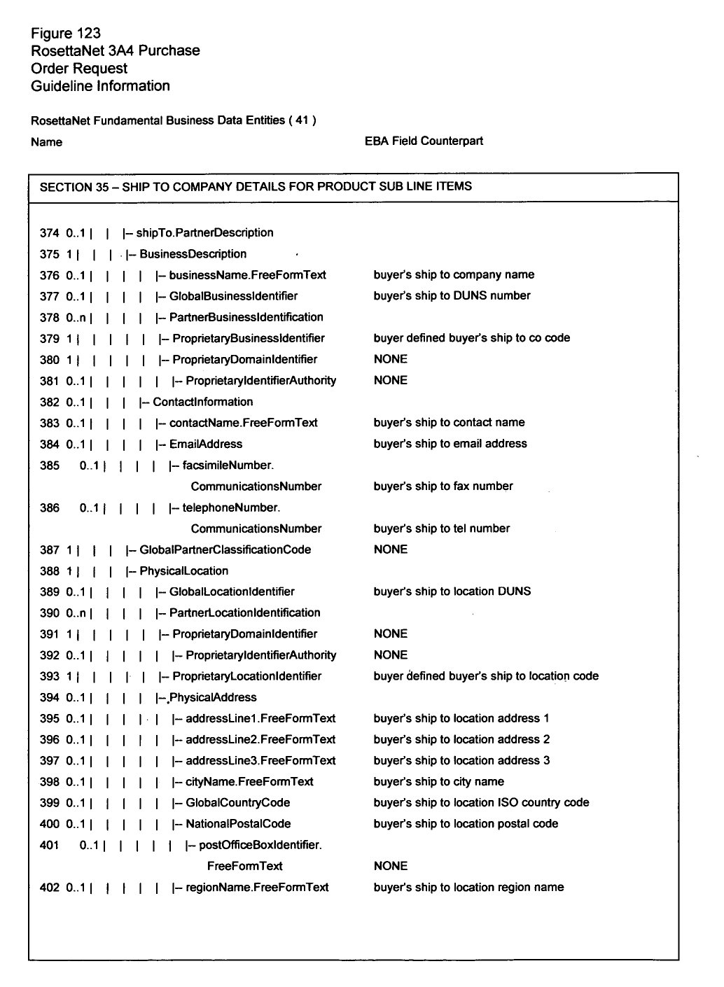

FIG. 123 illustrates RosettaNet's 3A4 Purchase Order Request covering SECTION 35—Ship To Company Details for Product Sub Line Items. Corresponding generic EBA field counterparts are provided. CLAIMs A, B and D are applied to SECTION 35.

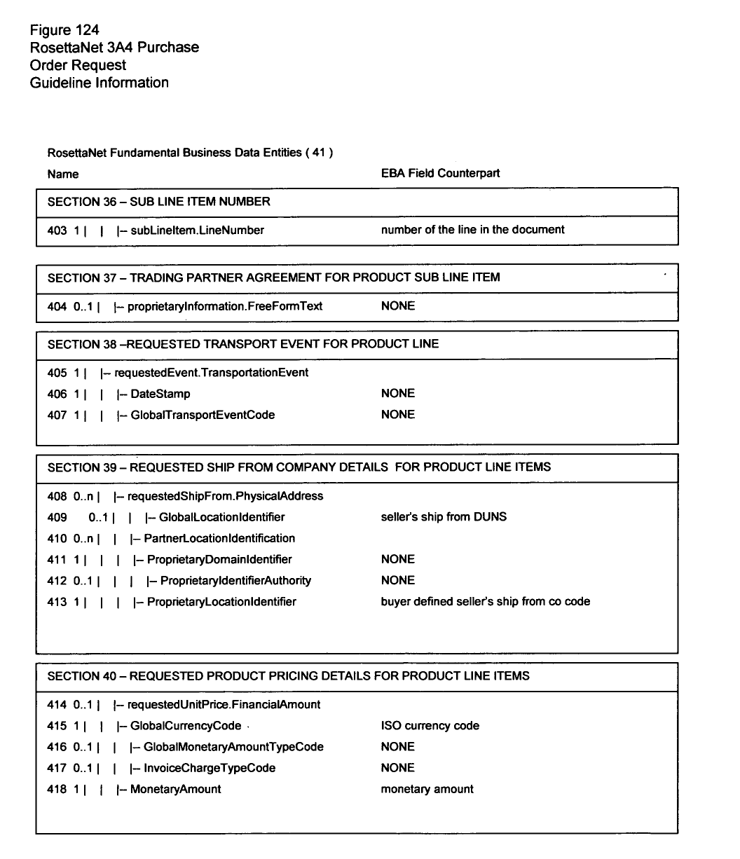

FIG. 124 illustrates RosettaNet's 3A4 Purchase Order Request covering SECTION 36—Sub Line Item Number, SECTION 37—Trading Partner Agreement for Product Sub Line Item, SECTION 38—Requested Transport Event for Product Line, SECTION 39—Requested Ship From Company Details for Product Line Items and SECTION 40—Requested Product Pricing Details for Product Line Items. Corresponding generic EBA field counterparts are provided. CLAIM A is applied to SECTION 39. CLAIM E is applied to SECTION 40.

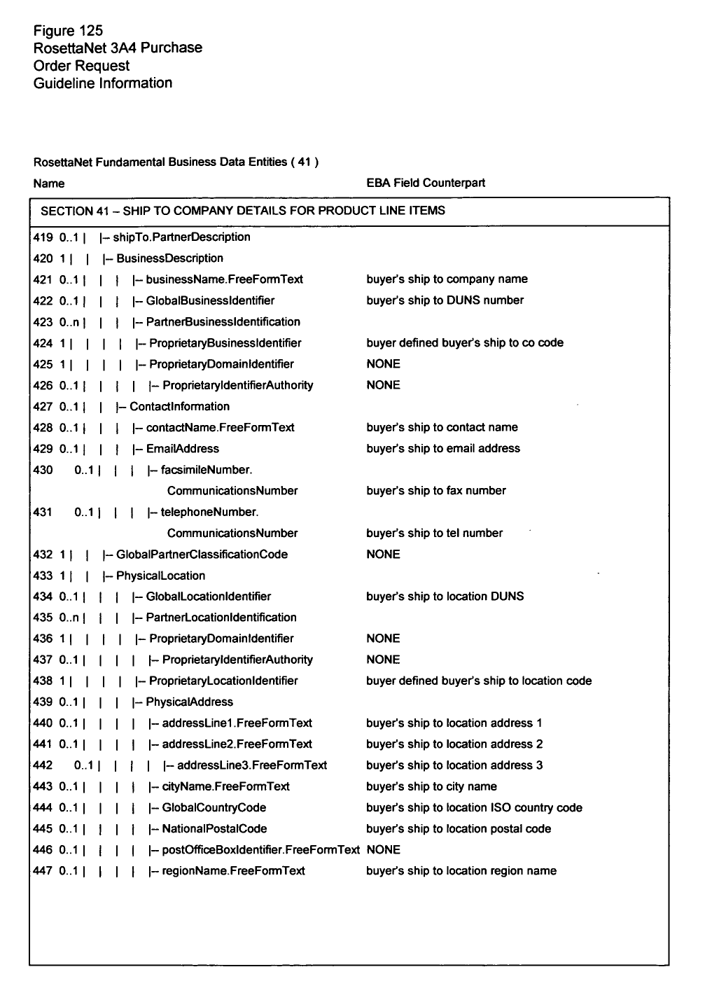

FIG. 125 illustrates RosettaNet's 3A4 Purchase Order Request covering SECTION 41—Ship To Company Details for Product Line Items. CLAIMs A, B and D are applied to SECTION 41.

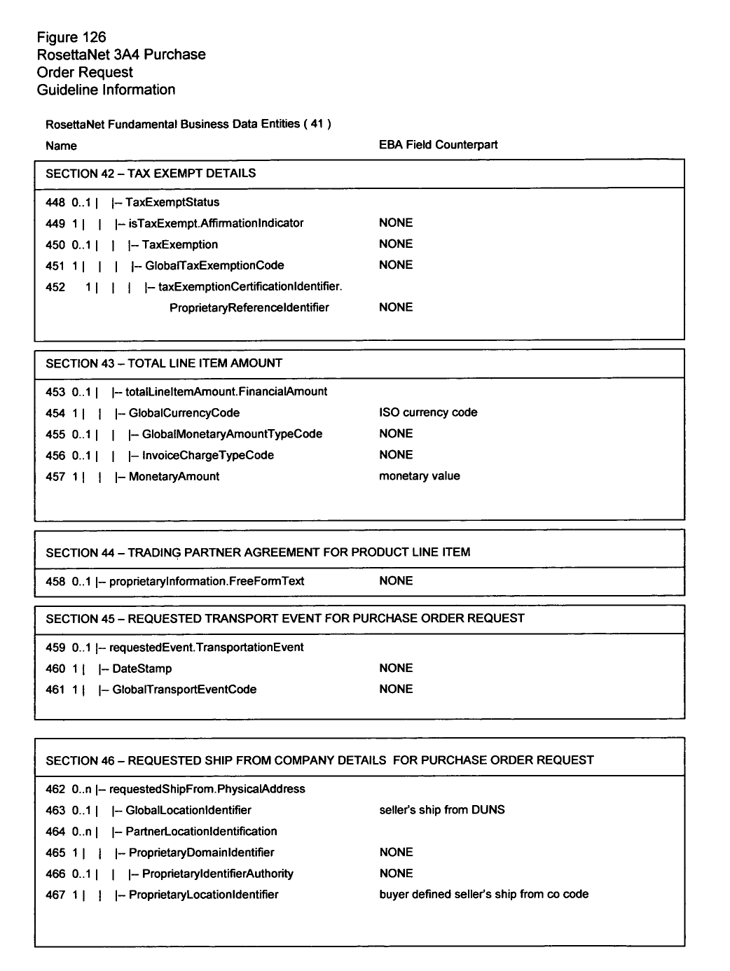

FIG. 126 illustrates RosettaNet's 3A4 Purchase Order Request covering SECTION 42—Tax Exempt Details, SECTION 43—Total Line Item Amount, SECTION 44—Trading Partner Agreement for Product Line Item, SECTION 45—Requested Transport Event for Purchase Order Request and SECTION 46—Requested Ship From Company Details for Purchase Order Request. Corresponding generic EBA field counterparts are provided. CLAIM E is applied to SECTION 43. CLAIM A is applied to SECTION 46.

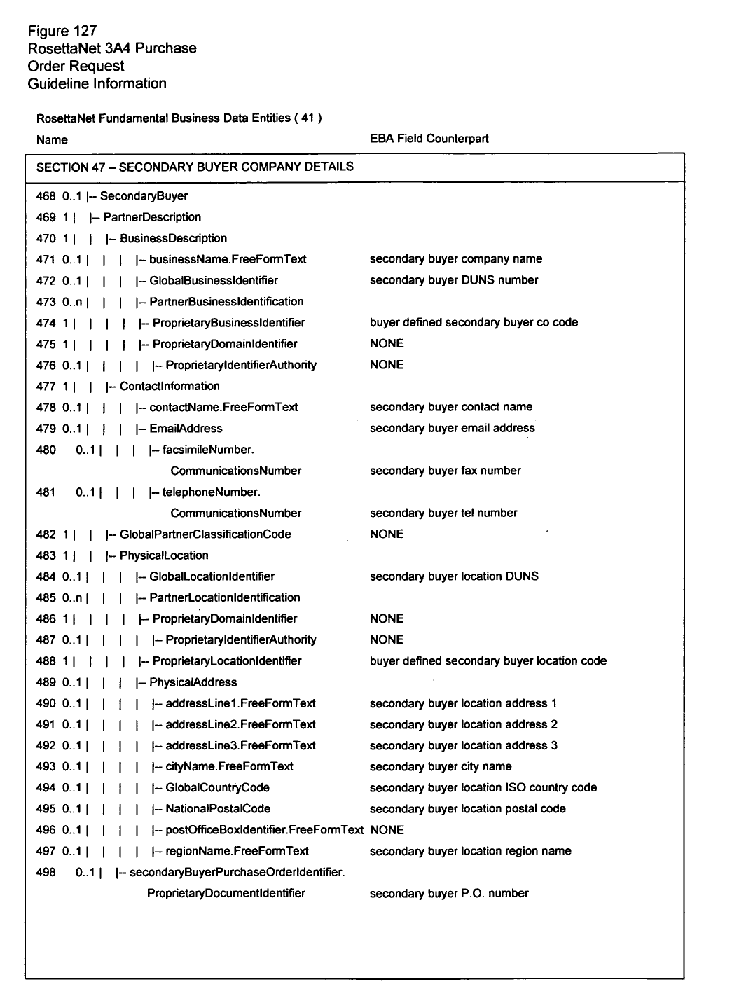

FIG. 127 illustrates RosettaNet's 3A4 Purchase Order Request covering SECTION 47—Secondary Buyer Company Details. Corresponding generic EBA field counterparts are provided. CLAIMs A, B and D are applied to SECTION 47.

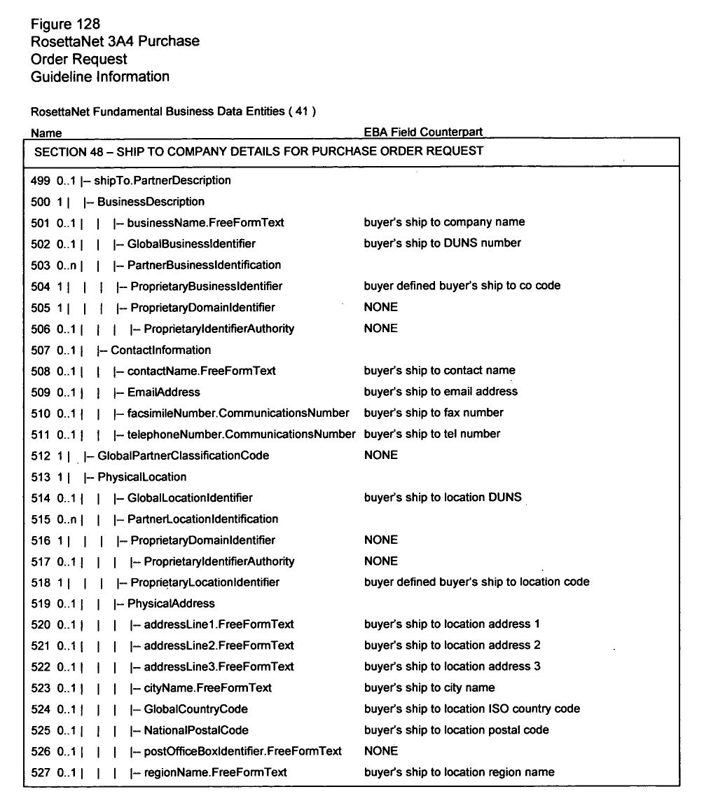

FIG. 128 illustrates RosettaNet's 3A4 Purchase Order Request covering SECTION 48—Ship To Company Details for Purchase Order Request. Corresponding generic EBA field counterparts are provided. CLAIMs A, B and D are applied to SECTION 48.

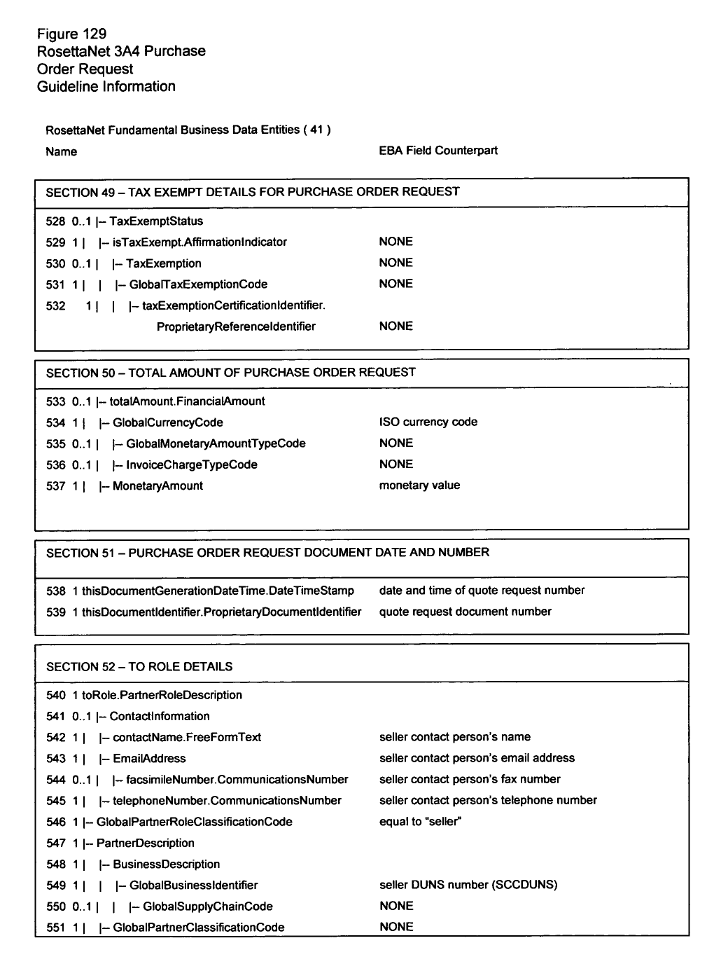

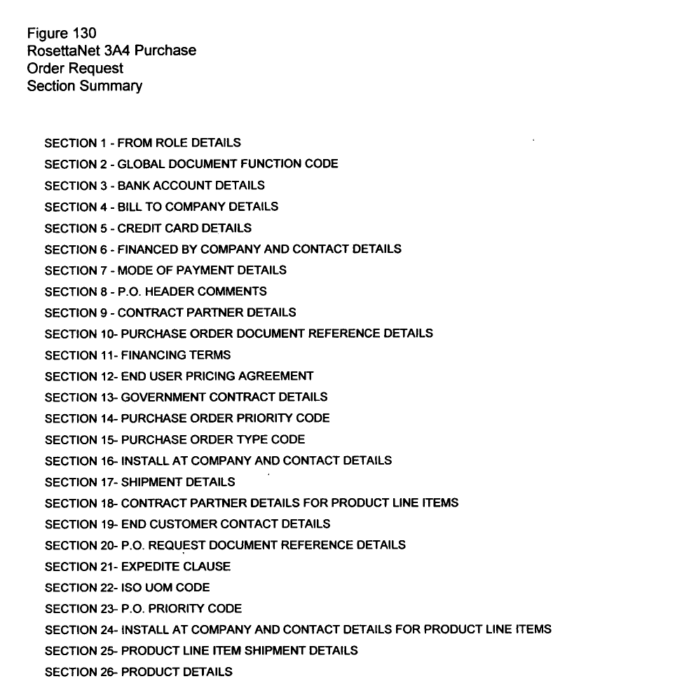

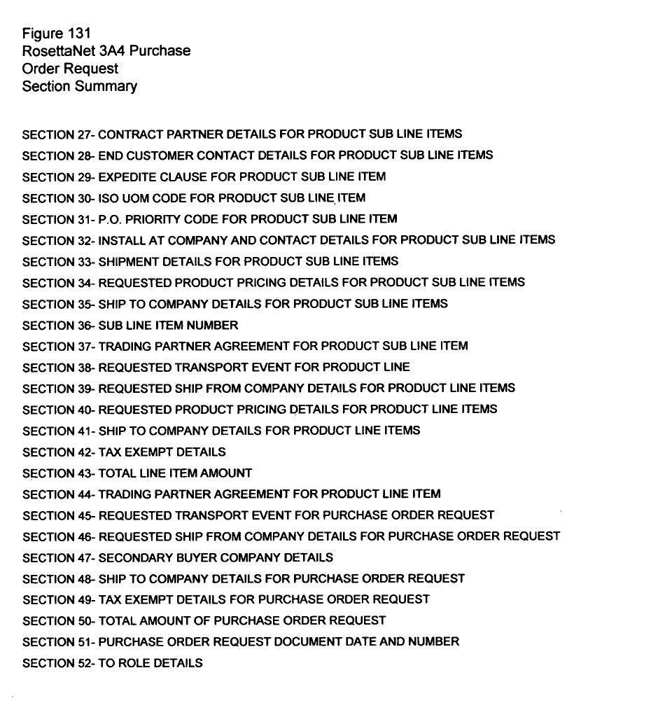

FIG. 129 illustrates RosettaNet's 3A4 Purchase Order Request covering SECTION 49—Tax Exempt Details for Purchase Order Request, SECTION 50—Total Amount of Purchase Order Request, SECTION 51—Purchase Order Request Document Data and Number and SECTION 52—To Role Details. Corresponding generic EBA field counterparts are provided. CLAIM E is applied to SECTION 50. CLAIMs C and D are applied to SECTION 52.

This purchase order request is sent buy the buyer and received by seller via the invention, which is interfaced to their EBAs. The mode of transmission is electronic via internet using XML technology.

2.4. Purchase Order Confirmation

The process starts when the seller receives the purchase order request. Seller fills up the purchase order request. The process ends when the seller returns the purchase order confirmation via the invention to the buyer.

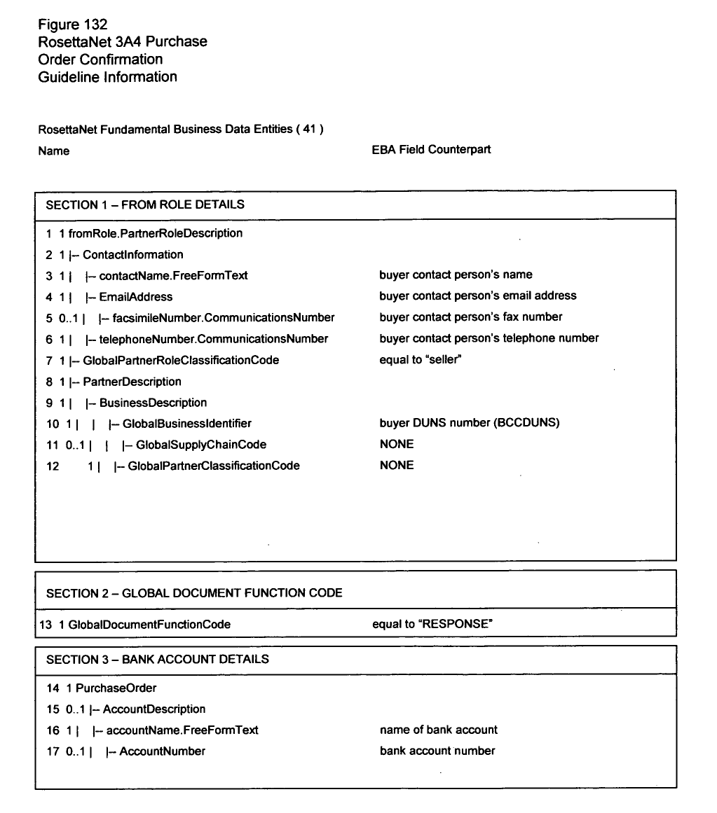

RosettaNet PIP 3A4 Purchase Order Confirmation is the standard to be used by the invention for Quote Confirmation. FIGS. 132-166 provide a listing of RosettaNet's PIP 3A4 Purchase Order Confirmation with corresponding EBA field counterpart.

FIG. 132 illustrates RosettaNet's 3A4 Purchase Order Confirmation covering SECTION 1—From Role Details, SECTION 2—Global Document Function Code and SECTION 3—Bank Account Details. Corresponding generic EBA field counterparts are provided. CLAIMs C and D are applied to SECTION 1.

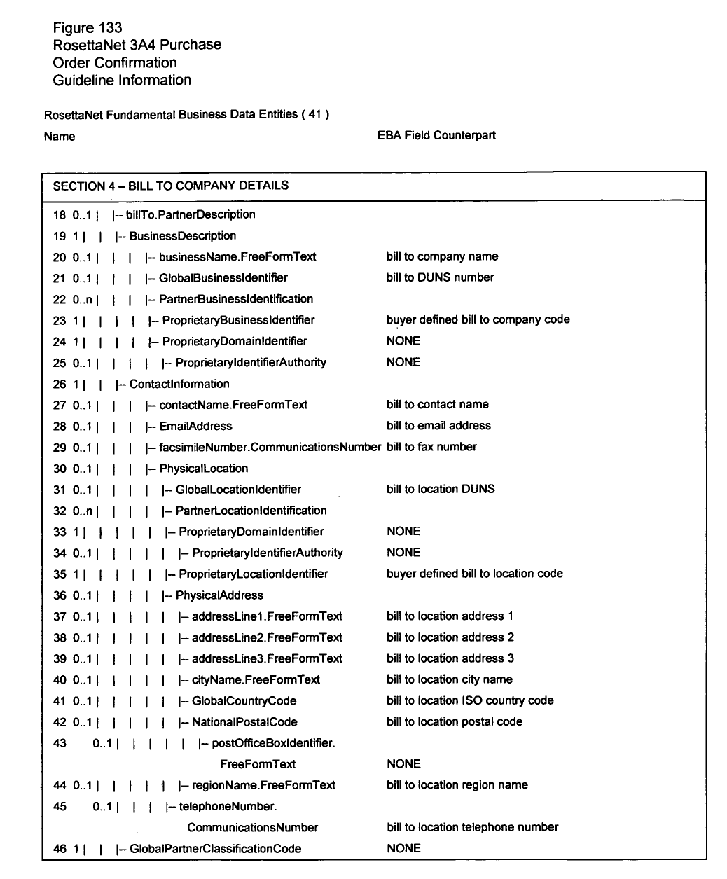

FIG. 133 illustrates RosettaNet's 3A4 Purchase Order Confirmation covering SECTION 4—Bill To Company Details. Corresponding generic EBA field counterparts are provided. CLAIMs A, B and D are applied to SECTION 4.

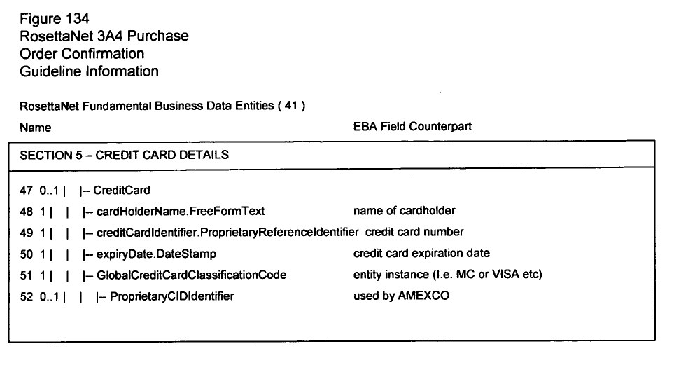

FIG. 134 illustrates RosettaNet's 3A4 Purchase Order Confirmation covering SECTION 5—Credit Card Details. Corresponding generic EBA field counterparts are provided.

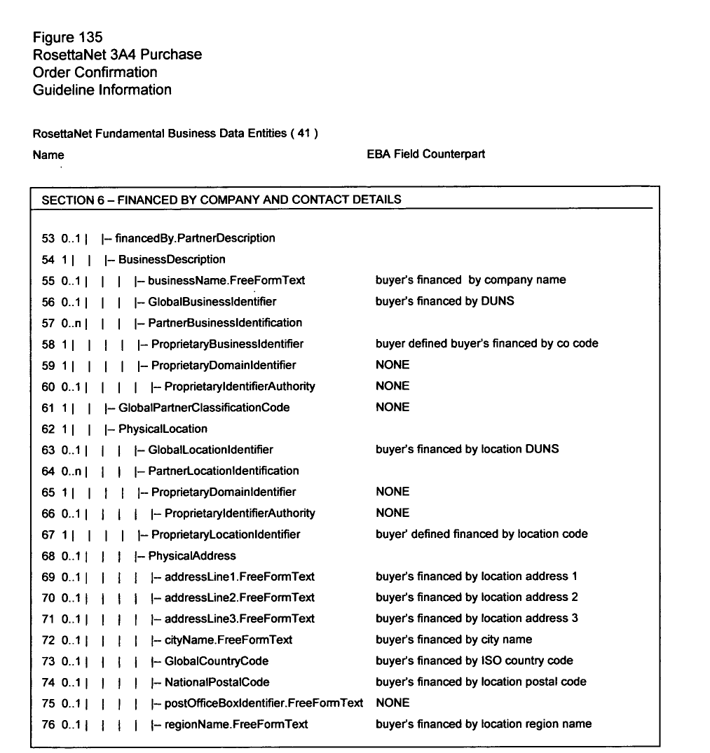

FIG. 135 illustrates RosettaNet's 3A4 Purchase Order Confirmation covering SECTION 6—Financed By Company and Contact Details. Corresponding generic EBA field counterparts are provided. CLAIM A, B and D are applied to SECTION 6.

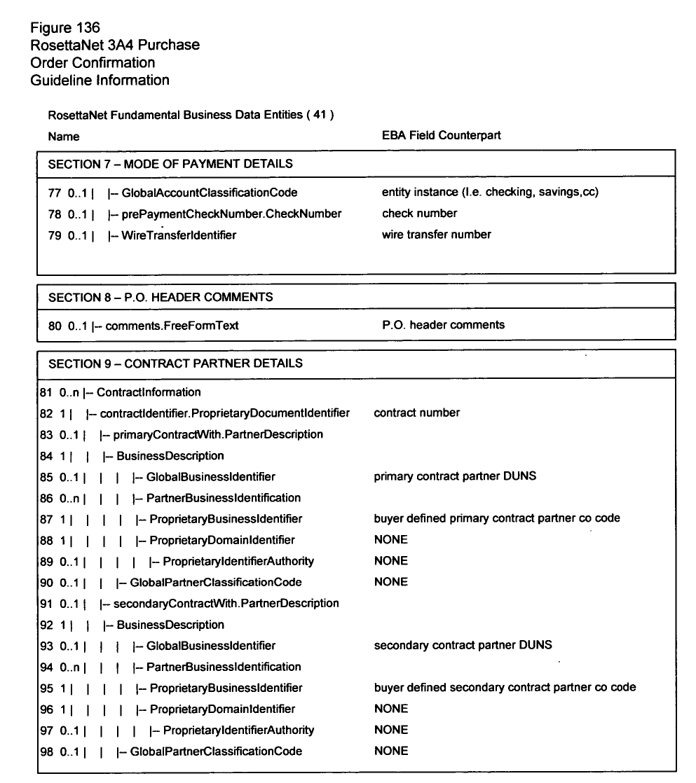

FIG. 136 illustrates RosettaNet's 3A4 Purchase Order Confirmation covering SECTION 7—Mode of Payment Details, SECTION 8—P.O. Header Comments and SECTION 9—Contract Partner Details. Corresponding generic EBA field counterparts are provided. CLAIM D is applied to SECTION 9.

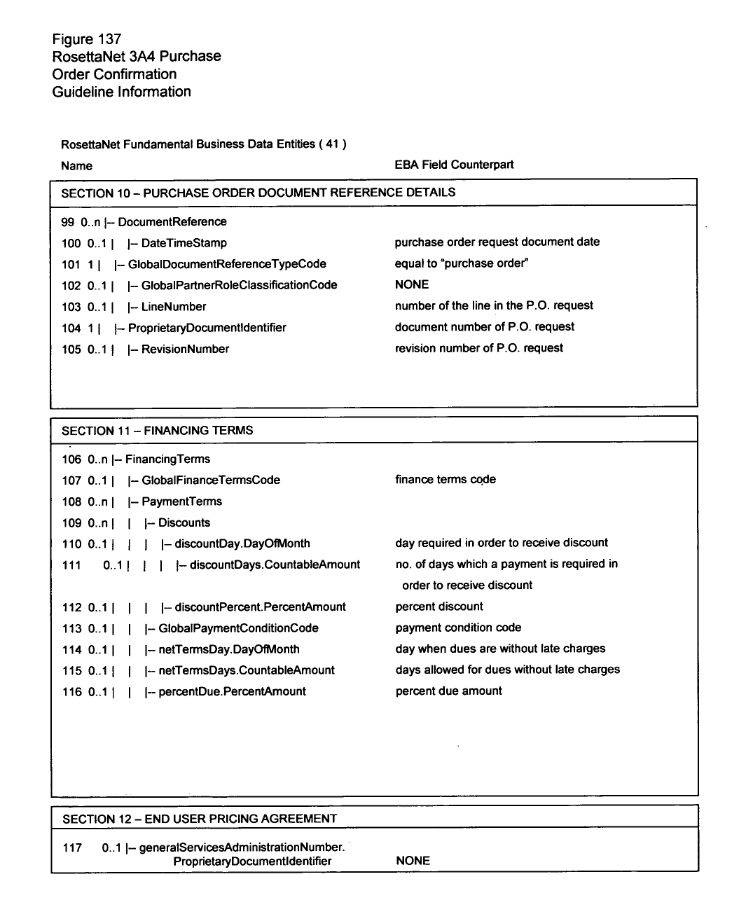

FIG. 137 illustrates RosettaNet's 3A4 Purchase Order Confirmation covering SECTION 10—Purchase Order Document Reference Details, SECTION 11—Financing Terms and SECTION 12—End User Pricing Agreement. Corresponding generic EBA field counterparts are provided.

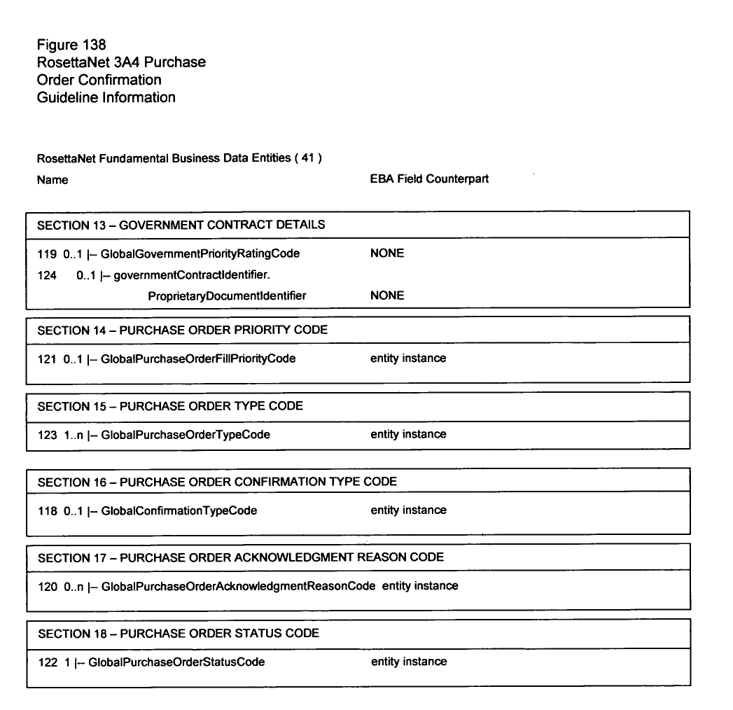

FIG. 138 illustrates RosettaNet's 3A4 Purchase Order Confirmation covering SECTION 13—Government Contract Details, SECTION 14—Purchase Order Priority Code, SECTION 15—Purchase Order Type Code, SECTION 16—Purchase Order Confirmation Type Code, SECTION 17—Purchase Order Acknowledgment Reason Code and SECTION 18—Purchase Order Status Code. Corresponding generic EBA field counterparts are provided.

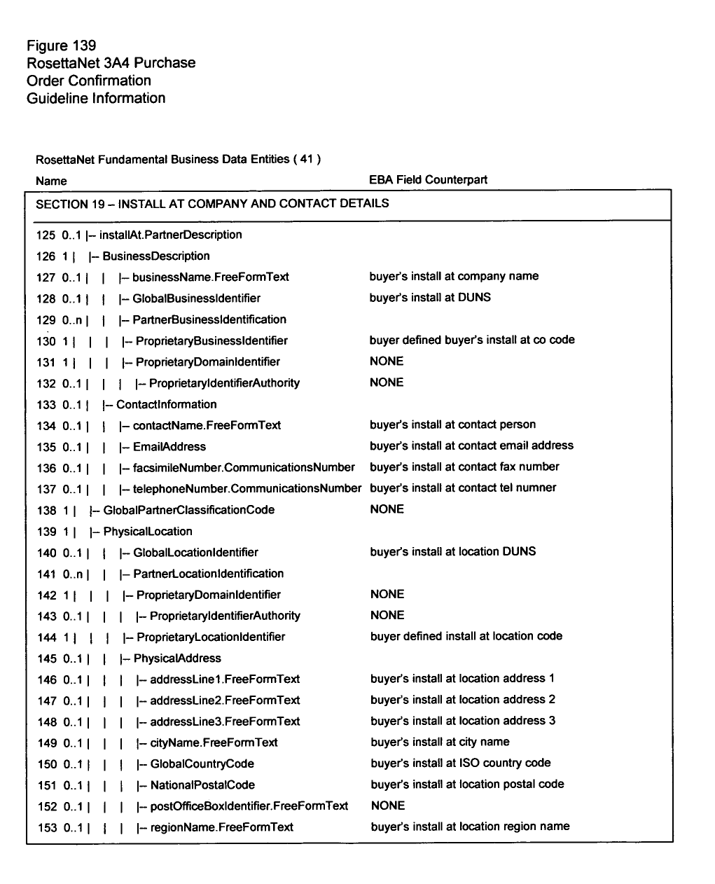

FIG. 139 illustrates RosettaNet's 3A4 Purchase Order Confirmation covering SECTION 19—Install At Company and Contact Details. Corresponding generic EBA field counterparts are provided. CLAIM A, B and D are applied to SECTION 19.

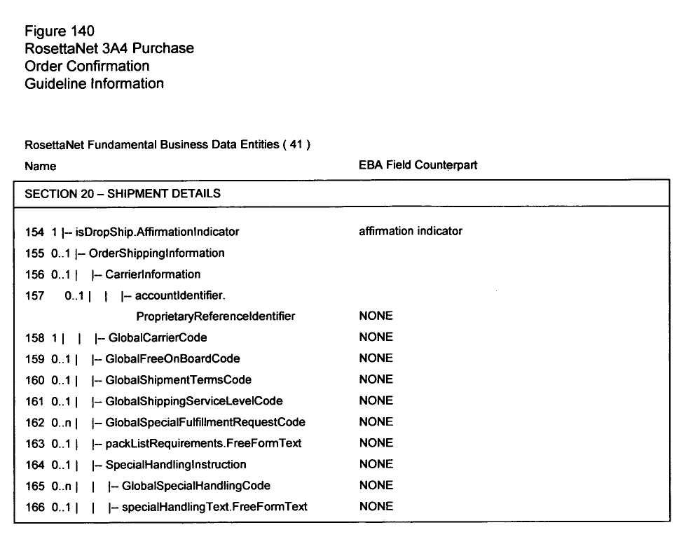

FIG. 140 illustrates RosettaNet's 3A4 Purchase Order Confirmation covering SECTION 20—Shipment Details. Corresponding generic EBA field counterparts are provided.

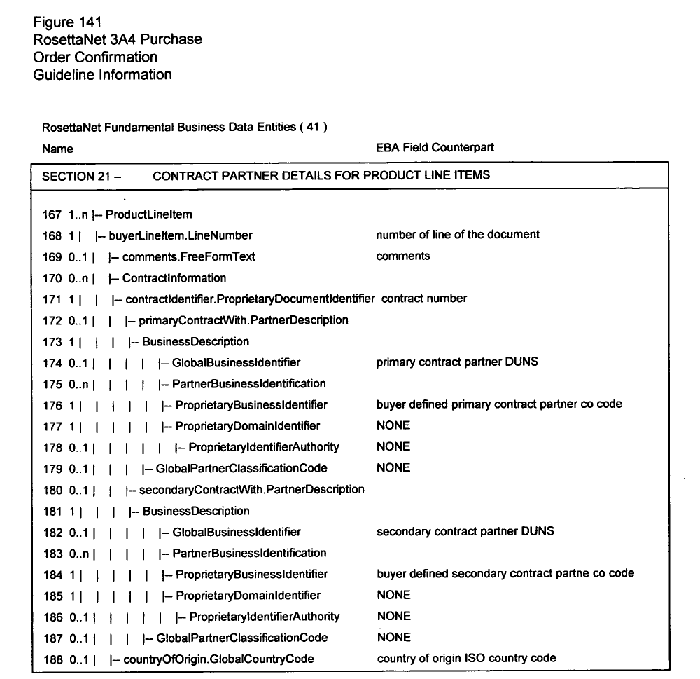

FIG. 141 illustrates RosettaNet's 3A4 Purchase Order Confirmation covering SECTION 21—Contract Partner Details for Product Line Items. Corresponding generic EBA field counterparts are provided. CLAIMs B and D are applied to SECTION 21.

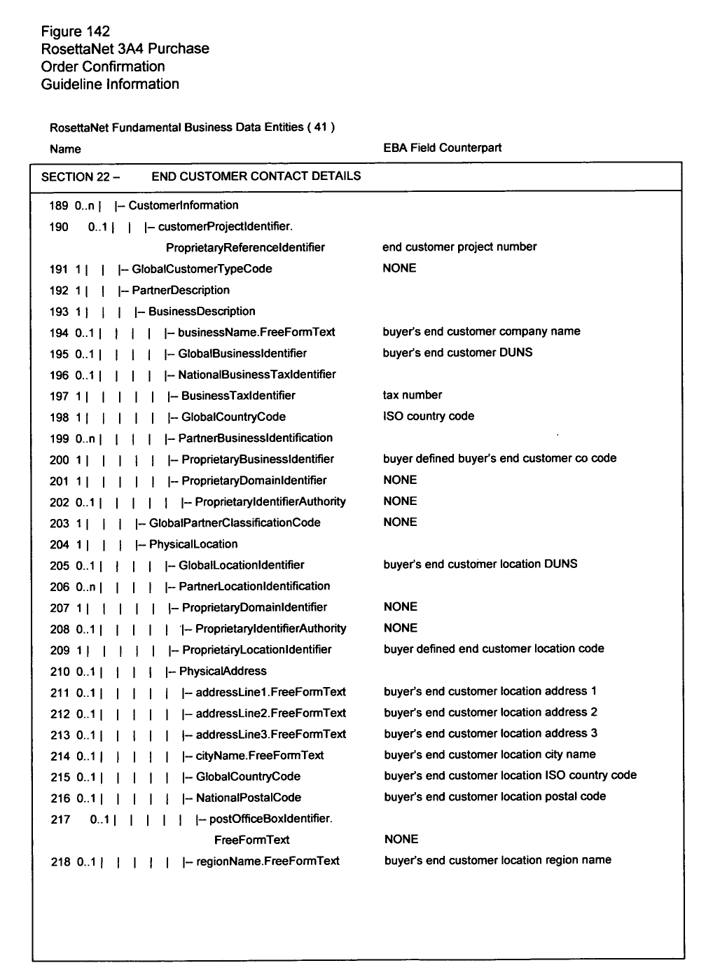

FIG. 142 illustrates RosettaNet's 3A4 Purchase Order Confirmation covering SECTION 22—End Customer Contact Details. Corresponding generic EBA field counterparts are provided. CLAIMs A, B and D are applied to SECTION 22.

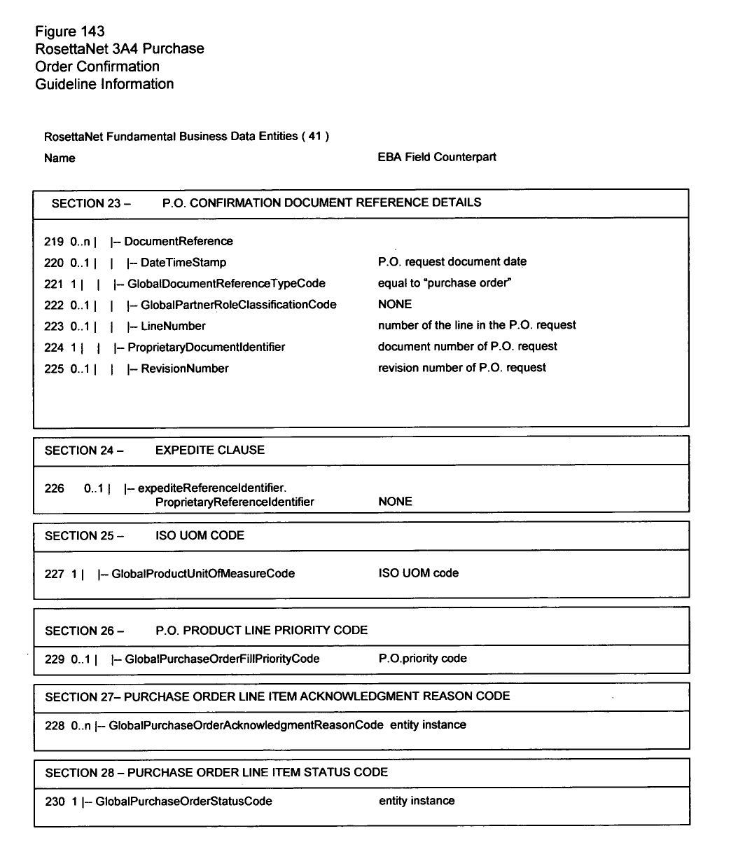

FIG. 143 illustrates RosettaNet's 3A4 Purchase Order Confirmation covering SECTION 23—Product Line Item P.O. Confirmation Document Reference Details, SECTION 24—Expedite Clause, SECTION 25—ISO UOM Code, SECTION 26—P.O. Product Line Priority Code, SECTION 27—Purchase Order Line Item Acknowledgment Reason Code and SECTION 28—Purchase Order Line Item Status Code. Corresponding generic EBA field counterparts are provided. CLAIM F is applied to SECTION 25.

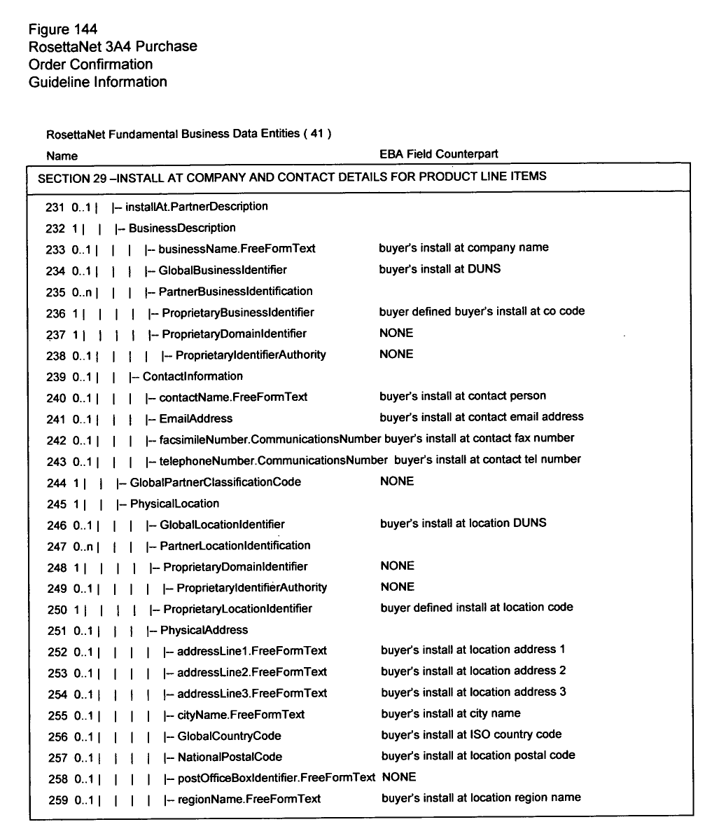

FIG. 144 illustrates RosettaNet's 3A4 Purchase Order Confirmation covering SECTION 29—Install At Company And Contact Details For Product Line Items. Corresponding generic EBA field counterparts are provided. CLAIM A, B and D are applied to SECTION 29.

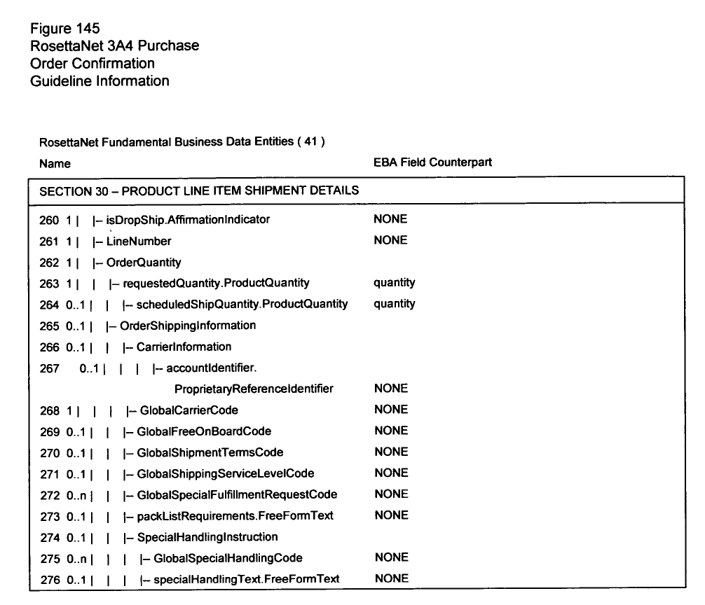

FIG. 145 illustrates RosettaNet's 3A4 Purchase Order Confirmation covering SECTION 30—Product Line Item Shipment Details. Corresponding generic EBA field counterparts are provided.

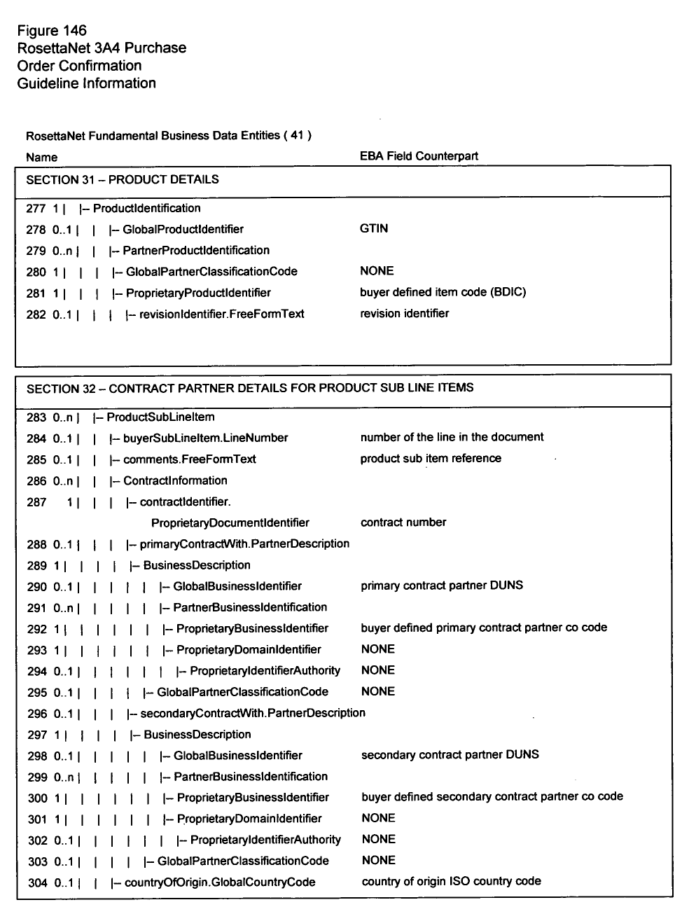

FIG. 146 illustrates RosettaNet's 3A4 Purchase Order Confirmation covering SECTION 31—Product Details and SECTION 32—Contract Partner Details for Product Sub Line Items. Corresponding generic EBA field counterparts are provided. CLAIM G is applied to SECTION 31. CLAIM B and D are applied to SECTION 32.

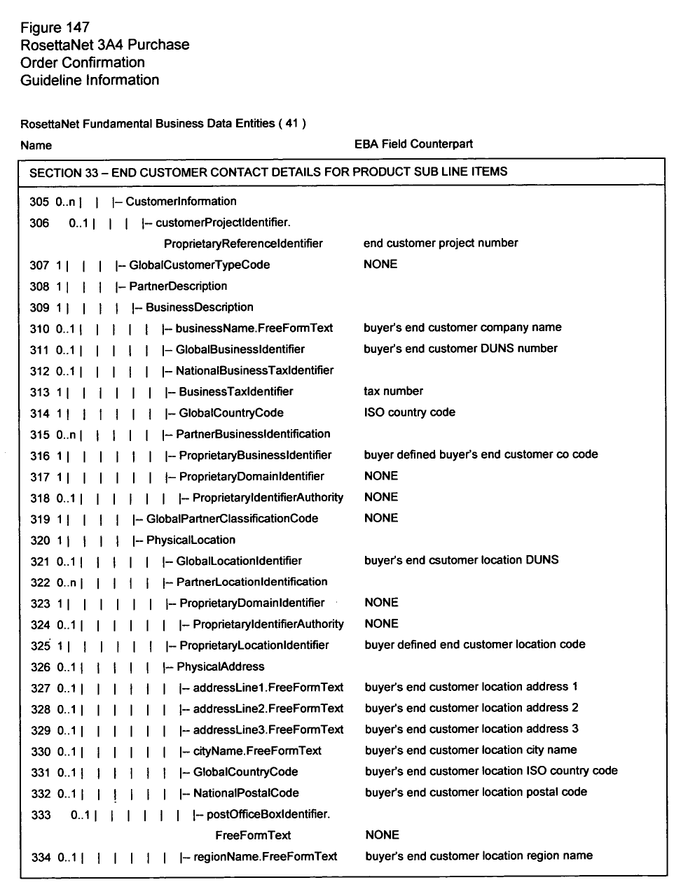

FIG. 147 illustrates RosettaNet's 3A4 Purchase Order Confirmation covering SECTION 33—End Customer Contact Details for Product Sub Line Items. Corresponding generic EBA field counterparts are provided. CLAIM A, B and D are applied to SECTION 33.

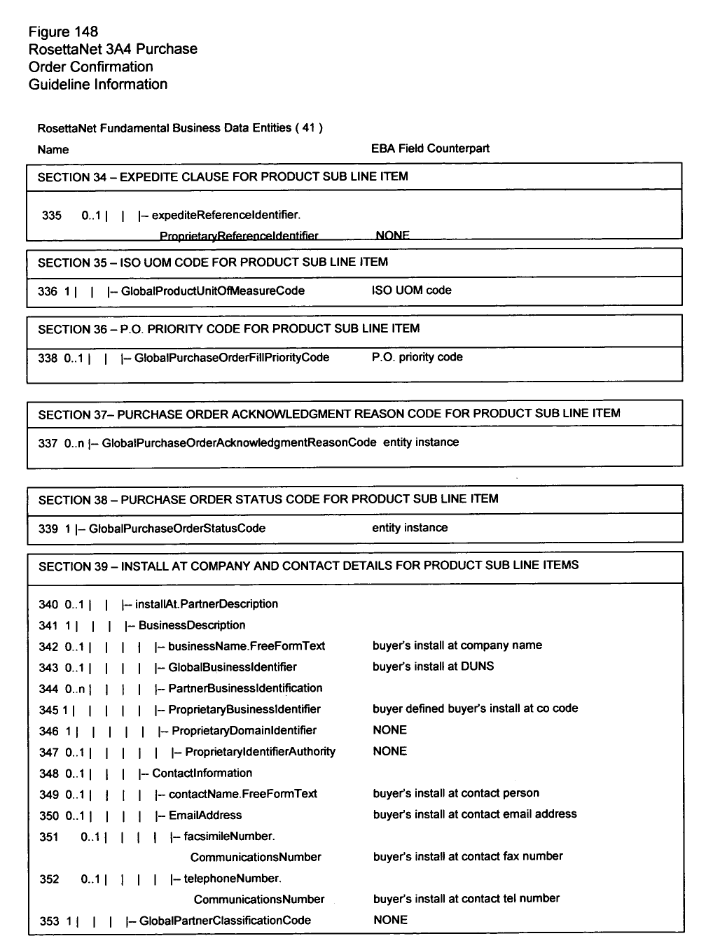

FIG. 148 illustrates RosettaNet's 3A4 Purchase Order Confirmation covering SECTION 34—Expedite Clause for Product Sub Line Item, SECTION 35—ISO UOM Code for Product Sub Line Item, SECTION 36—P.O. Priority Code for Product Sub Line Item, SECTION 37—Purchase Order Acknowledgment Reason Code for Product Sub Line Item, SECTION 38—Purchase Order Status Code for Product Sub Line Item and SECTION 39—Install At Company and Contact Details for Product Sub Line Items. Corresponding generic EBA field counterparts are provided. CLAIM F is applied to SECTION 35. CLAIM D is applied to SECTION 39.

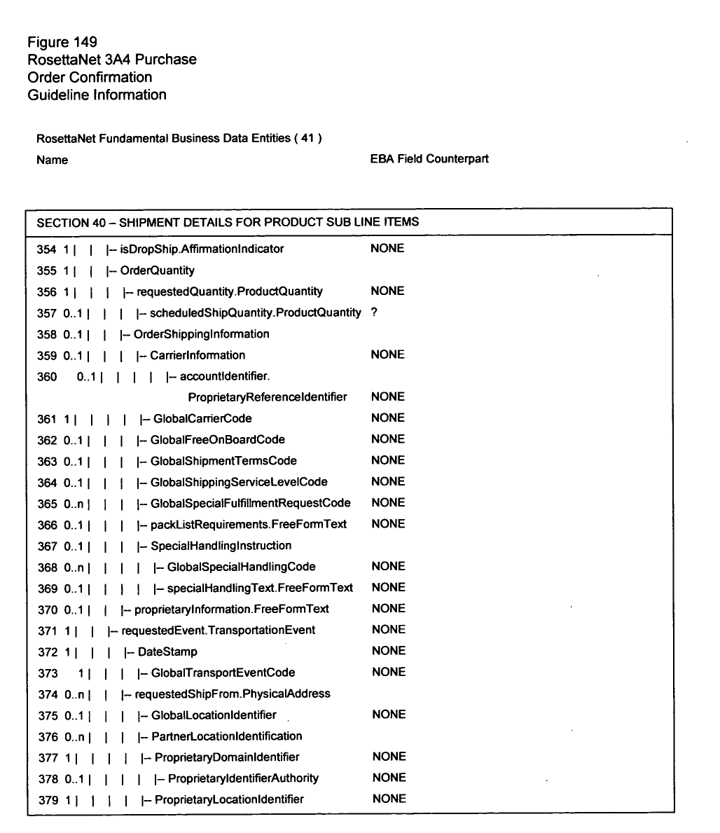

FIG. 149 illustrates RosettaNet's 3A4 Purchase Order Confirmation covering SECTION 40—Shipment Details for Product Sub Line Items. Corresponding generic EBA field counterparts are provided. CLAIM A is applied to SECTION 40.

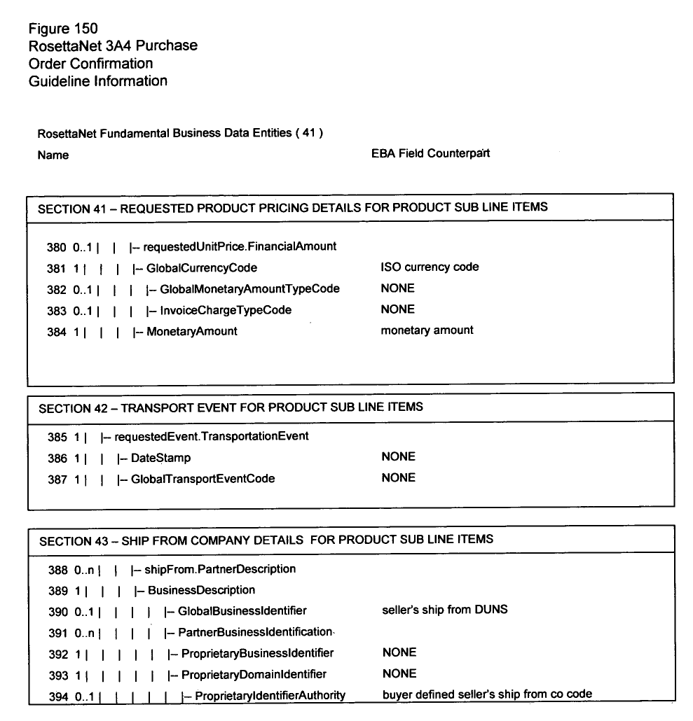

FIG. 150 illustrates RosettaNet's 3A4 Purchase Order Confirmation covering SECTION 41—Requested Product Pricing Details for Product Sub Line Items, SECTION 42—Transport Event for Product Sub Line Items and SECTION 43—Ship From Company Details for Product Sub Line Items. Corresponding generic EBA field counterparts are provided. CLAIM E is applied to SECTION 41. CLAIM D is applied to SECTION 43.

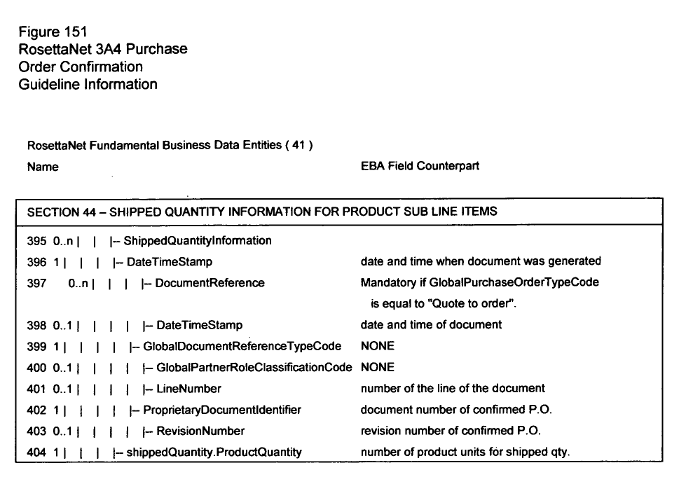

FIG. 151 illustrates RosettaNet's 3A4 Purchase Order Confirmation covering SECTION 44—Shipped Quantity Information for Product Sub Line Items. Corresponding generic EBA field counterparts are provided.

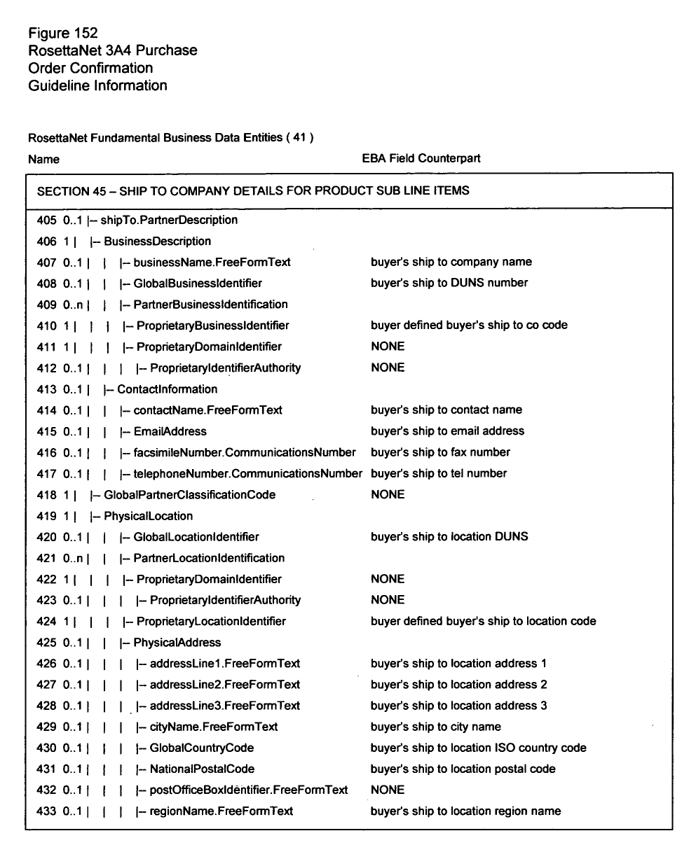

FIG. 152 illustrates RosettaNet's 3A4 Purchase Order Confirmation covering SECTION 45—Ship To Company Details for Product Sub Line Items. Corresponding generic EBA field counterparts are provided. CLAIM A, B and D are applied to SECTION 45.

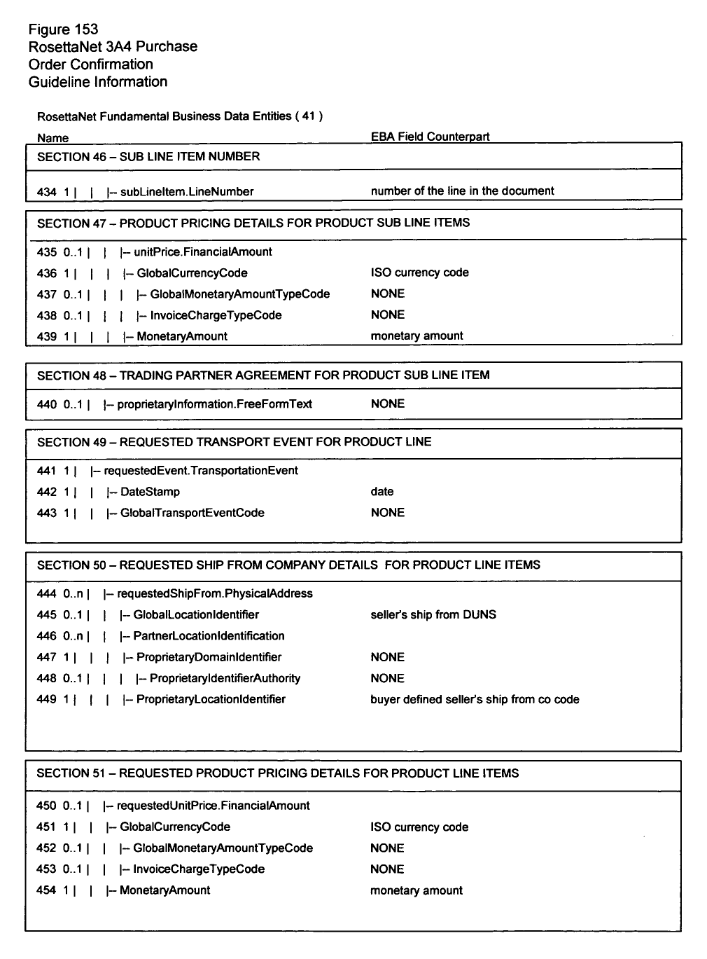

FIG. 153 illustrates RosettaNet's 3A4 Purchase Order Confirmation covering SECTION 46—Sub Line Item Number, SECTION 47—Product Pricing Details for Product Sub Line Items, SECTION 48—Trading Partner Agreement for Product Sub Line Item, SECTION 49—Requested Transport Event for Product Line SECTION 50—Requested Ship From Company Details for Product Line Items and SECTION 51—Requested Product Pricing Details for Product Line Items. Corresponding generic EBA field counterparts are provided. CLAIM E is applied to SECTION 47 and 51. CLAIM A is applied to SECTION 50.

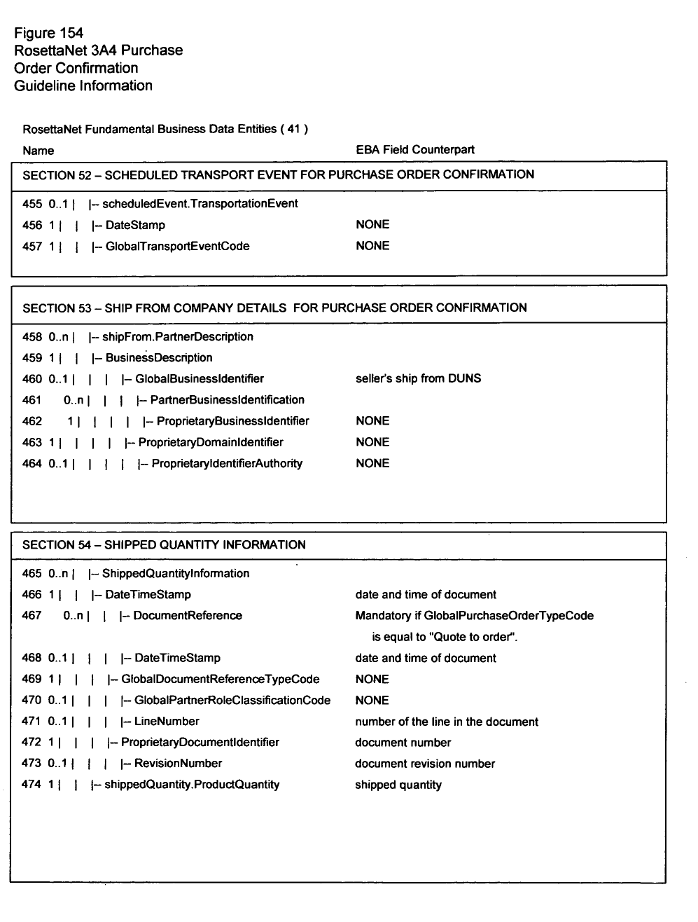

FIG. 154 illustrates RosettaNet's 3A4 Purchase Order Confirmation covering SECTION 52—Scheduled Transport Event for Purchase Order Confirmation, SECTION 53—Ship From Company Details for Purchase Order Confirmation and SECTION 54—Shipped Quantity Information. Corresponding generic EBA field counterparts are provided. CLAIM D is applied to SECTION 53.

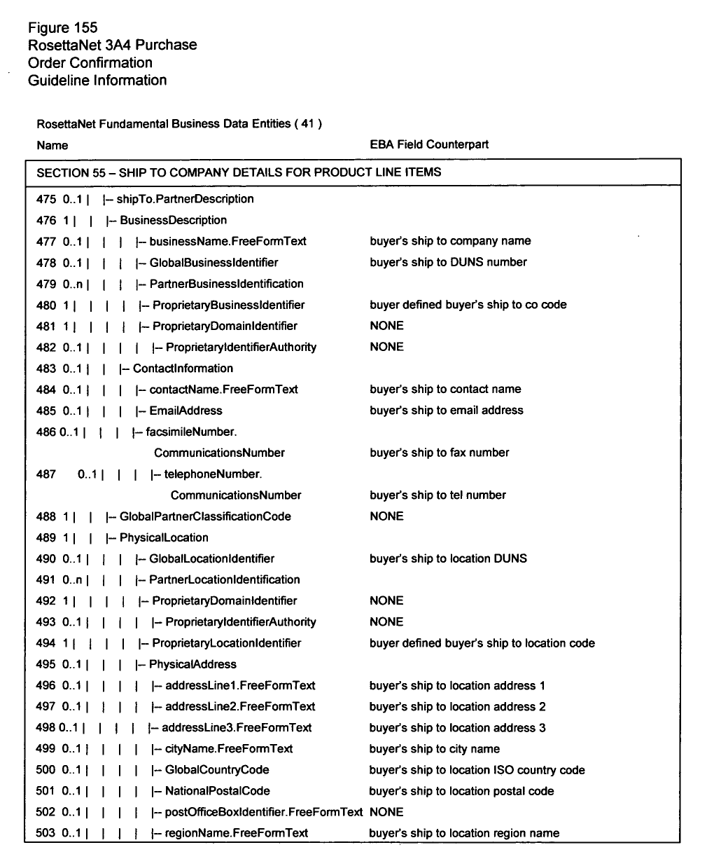

FIG. 155 illustrates RosettaNet's 3A4 Purchase Order Confirmation covering SECTION 55—Ship To Company Details for Product Line Items. Corresponding generic EBA field counterparts are provided. CLAIM A, B and D are applied to SECTION 55.

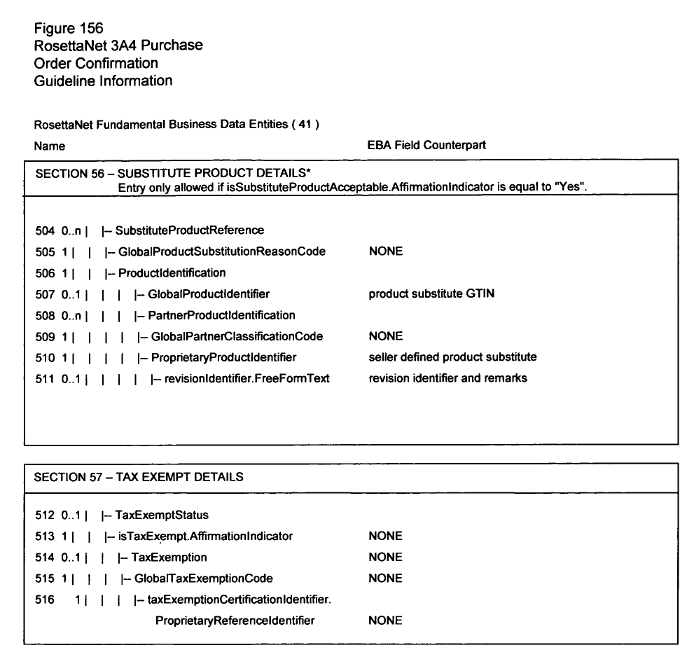

FIG. 156 illustrates RosettaNet's 3A4 Purchase Order Confirmation covering SECTION 56—Substitute Product Details and SECTION 57—Tax Exempt Details. Corresponding generic EBA field counterparts are provided. CLAIM G is applied to SECTION 57.

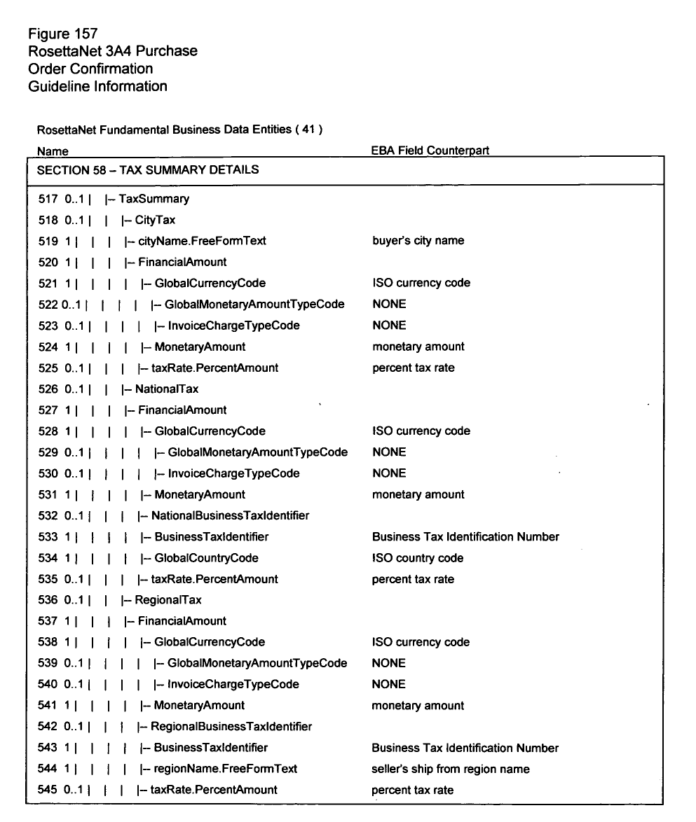

FIG. 157 illustrates RosettaNet's 3A4 Purchase Order Confirmation covering SECTION 58—Tax Summary Details. Corresponding generic EBA field counterparts are provided. CLAIMs B and E are applied to SECTION 58.

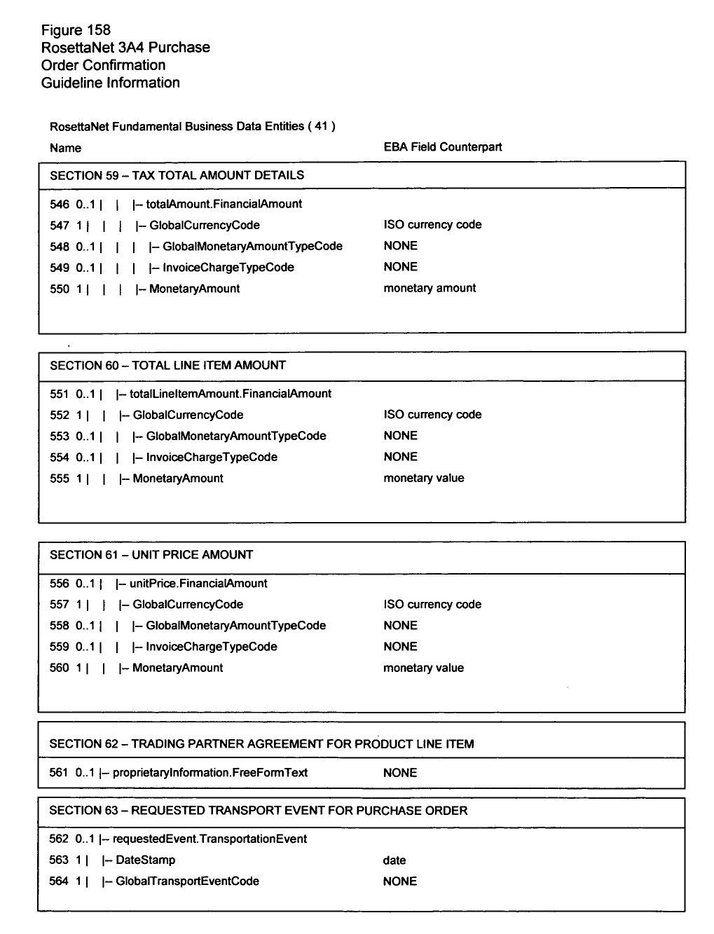

FIG. 158 illustrates RosettaNet's 3A4 Purchase Order Confirmation covering SECTION 59—Tax Total Amount Details, SECTION 60—Total Line Item Amount, SECTION 61—Unit Price Amount, SECTION 62—Trading Partner Agreement for Product Line Item and SECTION 63—Requested Transport Event for Purchase Order. Corresponding generic EBA field counterparts are provided. CLAIM E is applied to SECTION 59, 60 and 61.

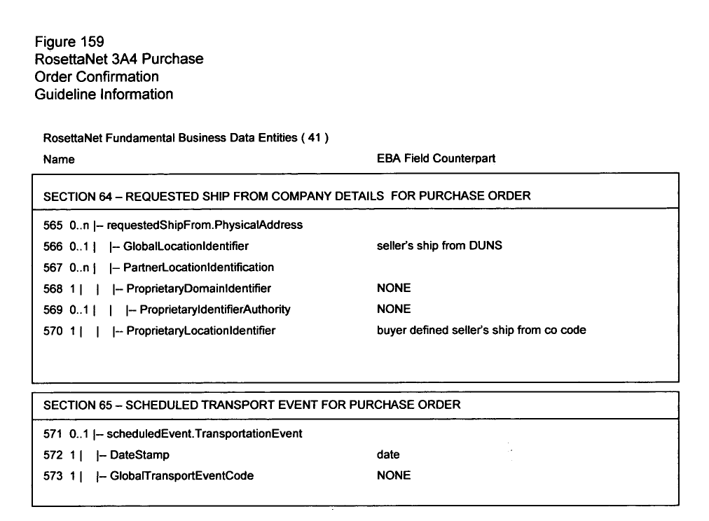

FIG. 159 illustrates RosettaNet's 3A4 Purchase Order Confirmation covering SECTION 64—Requested Ship From Company Details for Purchase Order and SECTION 65—Scheduled Transport Event for Purchase Order. Corresponding generic EBA field counterparts are provided. CLAIM A is applied to SECTION 64.

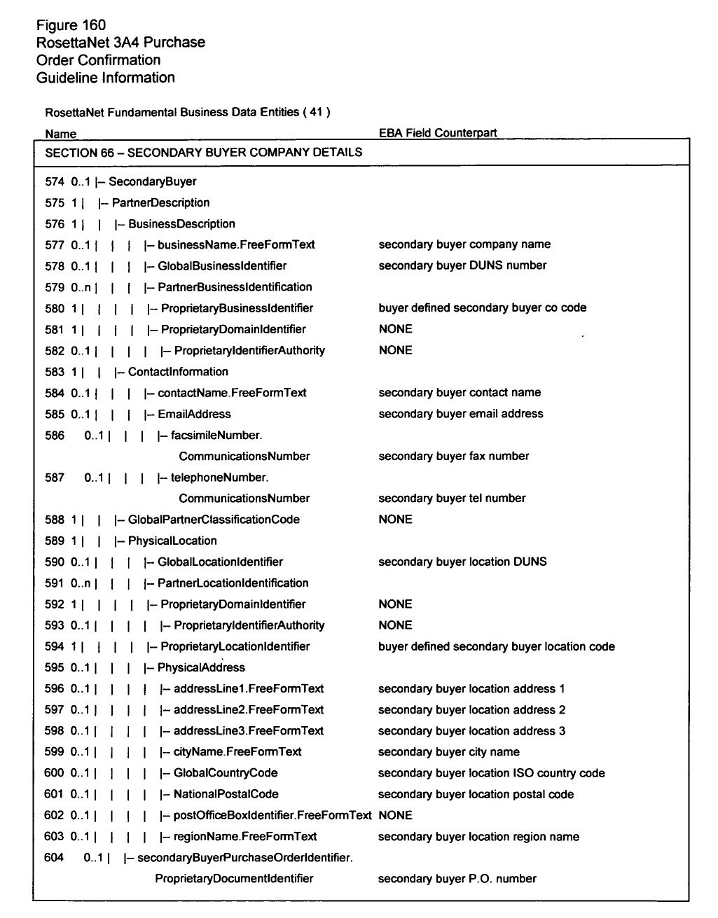

FIG. 160 illustrates RosettaNet's 3A4 Purchase Order Confirmation covering SECTION 66—Secondary Buyer Company Details. Corresponding generic EBA field counterparts are provided. CLAIMs A, B and D are applied to SECTION 66.

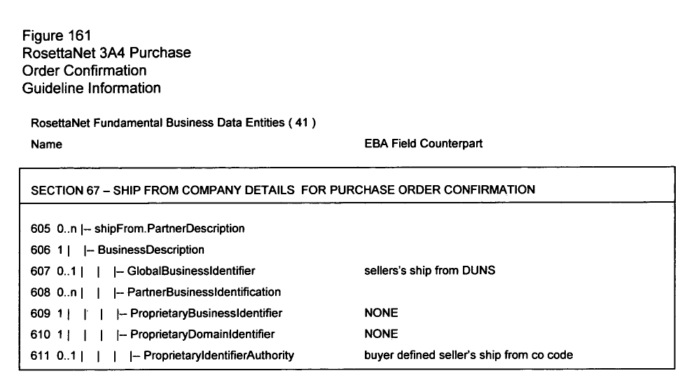

FIG. 161 illustrates RosettaNet's 3A4 Purchase Order Confirmation covering SECTION 67—Ship From Company Details for Purchase Order Confirmation. Corresponding generic EBA field counterparts are provided. CLAIM D is applied to SECTION 67.

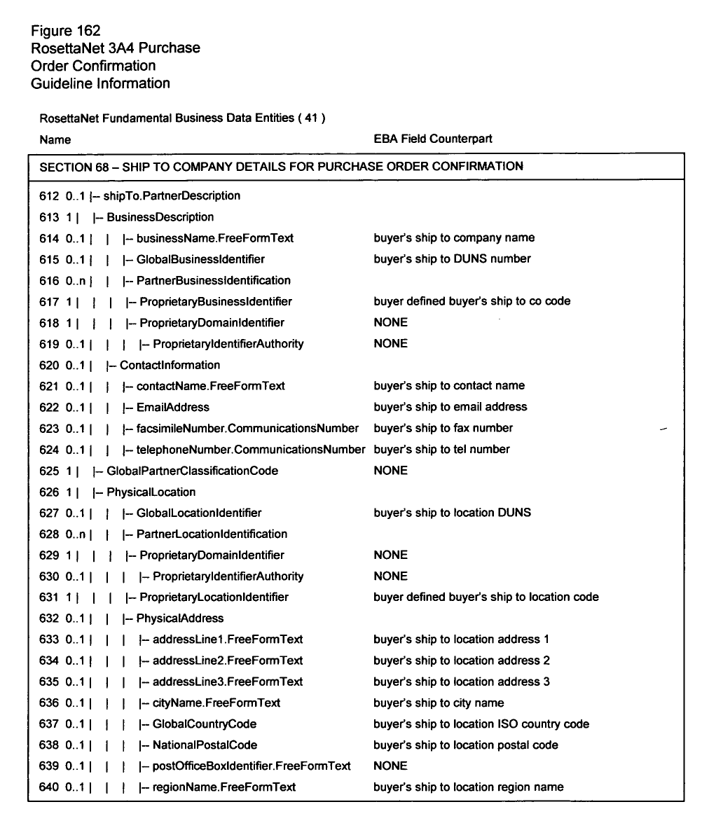

FIG. 162 illustrates RosettaNet's 3A4 Purchase Order Confirmation covering SECTION 68—Ship To Company Details for Purchase Order Confirmation. Corresponding generic EBA field counterparts are provided. CLAIMs A, B and D are applied to SECTION 68.

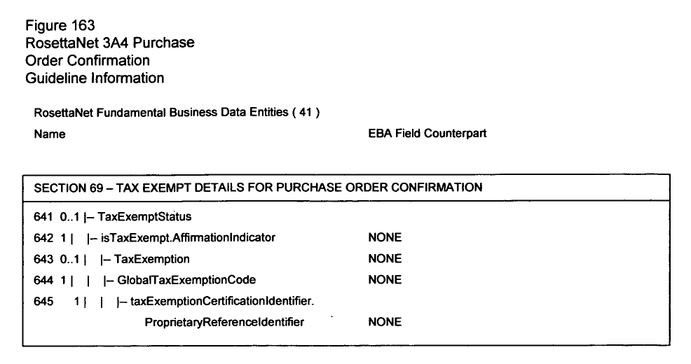

FIG. 163 illustrates RosettaNet's 3A4 Purchase Order Confirmation covering SECTION 69—Tax Exempt Details for Purchase Order Confirmation. Corresponding generic EBA field counterparts are provided.

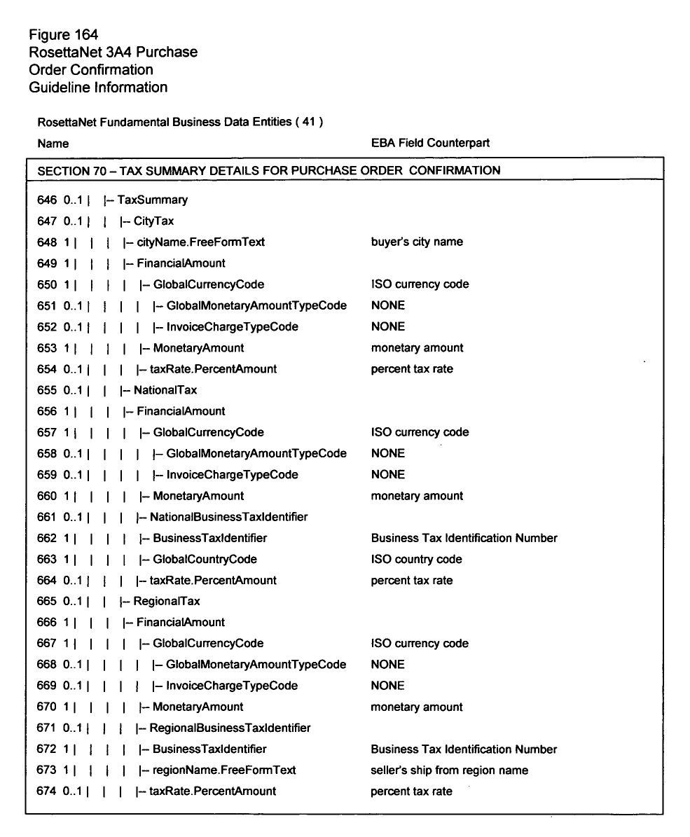

FIG. 164 illustrates RosettaNet's 3A4 Purchase Order Confirmation covering SECTION 70—Tax Summary Details for Purchase Order Confirmation. Corresponding generic EBA field counterparts are provided. CLAIMs B and E are applied to SECTION 70.

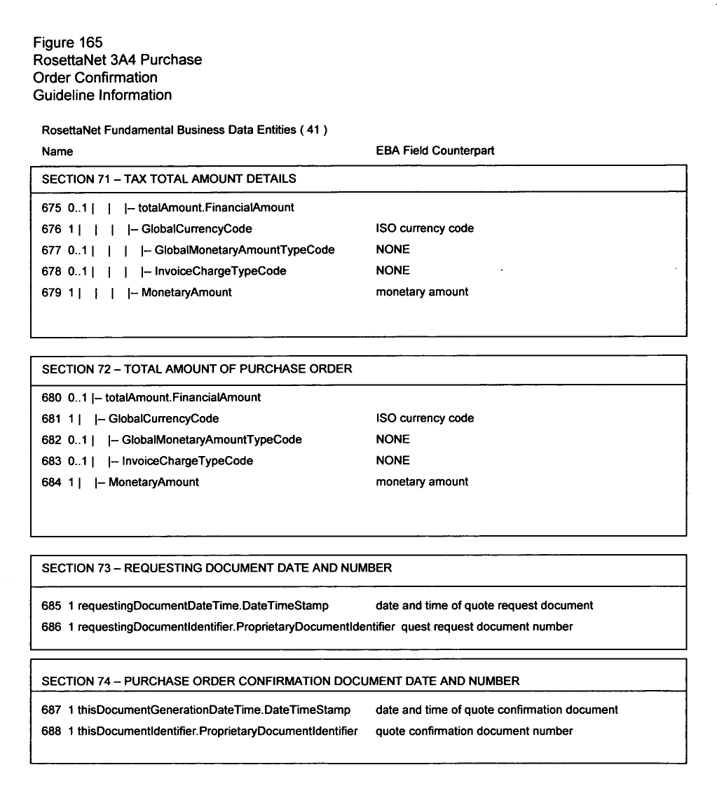

FIG. 165 illustrates RosettaNet's 3A4 Purchase Order Confirmation covering SECTION 71—Tax Total Amount Details, SECTION 72—Total Amount of Purchase Order, SECTION 73—Requesting Document Date and Number and SECTION 74—Purchase Order Confirmation Document Date and Number. Corresponding generic EBA field counterparts are provided. CLAIM E is applied to SECTION 71 and 72.

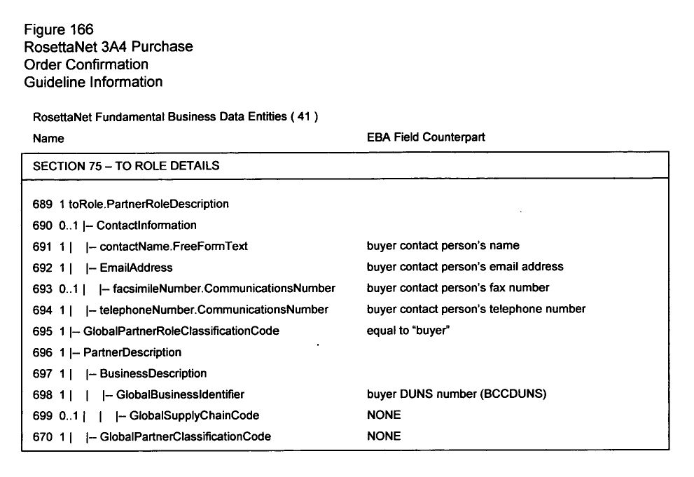

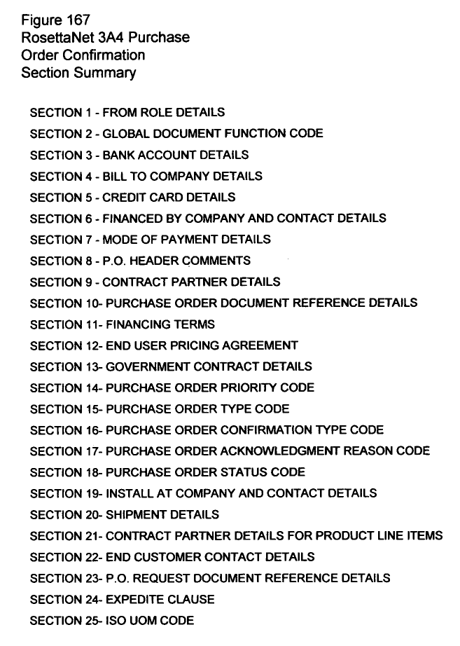

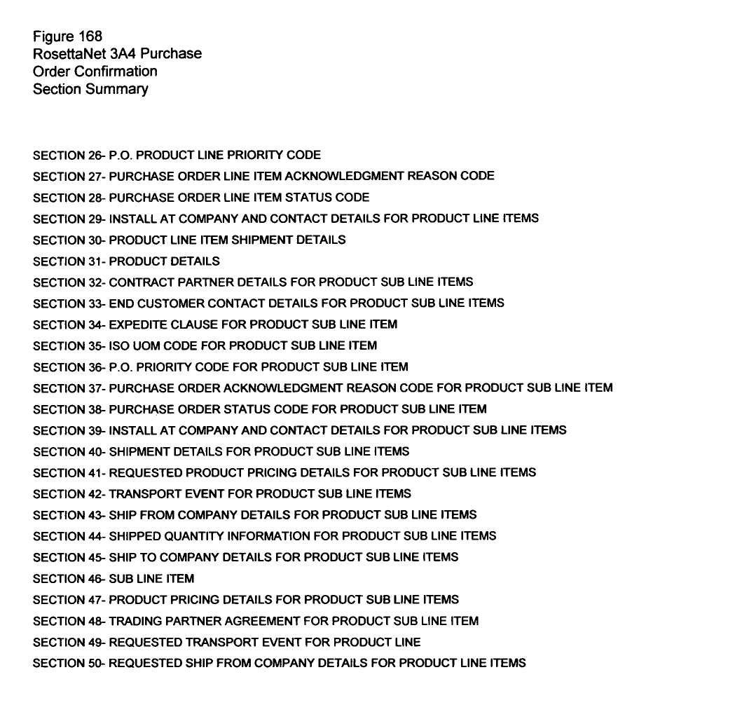

FIG. 166 illustrates RosettaNet's 3A4 Purchase Order Confirmation covering SECTION 75—To Role Details. Corresponding generic EBA field counterparts are provided. CLAIMs C and D are applied to SECTION 75.

2.5. Purchase Order Change/Cancellation/Acknowledgment

RosettaNet PIP 3A7 Notify of Purchase Order Update, 3A8 Request Purchase Order Change, 3A9 Request Purchase Order Cancellation and 3A10 Notify of Quote Acknowledgment are the standards used under this section.

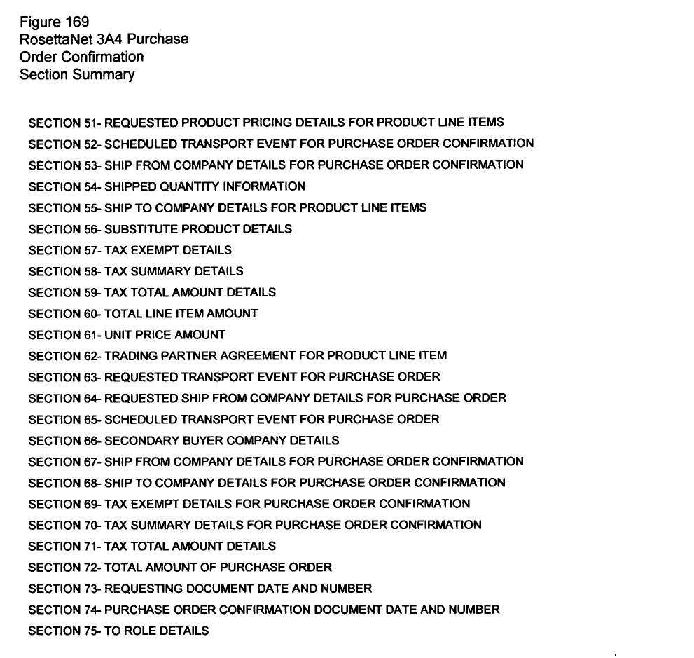

The primary intent of providing figures (FIGS. 47 to 169) for the previous PIPs (PIP 1A1,3A1 ands 3A4) is to let the Reviewer understand on how these claims (CLAIMS A, B, C, D, E, F and G) are applied to Rosettanet's PIPs. CLAIMS A, B, C, D, E, F and G are applied to these PIPs under this section. These claims are applied in the same way in other Rosettanet PIPs. These Rosettanet PIPs are downloadable via www.rosettanet.org.

2.6. Shipment Processing

RosettaNet PIP 3B1 Distribute Transportation Projection, 3B2 Notify of Advance Shipment, 3B3 Distribute Shipment Status, 3B4 Query Shipment Status, 3B5 Request Shipment Change, 3B6 Notify of Shipments Tendered, 3B11 Notify of Shipping Order, 3B12 Request Shipping Order, 3B13 Notify of Shipping Order, 3B14 Request Shipping Order Cancellation and 3B18 Notify of Shipping Documentation are standards under this section. CLAIMS A, B, C, D, E, F and G are applied to these PIPs under this section. These Rosettanet PIPs are downloadable via www.rosettanet.org.

2.7. Invoice Processing

RosettaNet PIP 3C1 Return Product, 3C3 Notify of Invoice, 3C4 Notify of Invoice Reject, 3C5 Notify of Billing Statement, 3C6 Notify of Remittance Advice and 3C7 Notify of Self-Billing Invoice are standards under this section. CLAIMS A, B, C, D, E, F and G are applied to these PIPs under this section. These Rosettanet PIPs are downloadable via www.rosettanet.org.

3. Matching of Codes:

Most EBAs with RosettaNet-XML support require a work around to handle the storage of these RosettaNet Building Blocks.

Again, these are the building blocks required as fundamental business data entities in Rosettanet's PIP. These are:
GlobalCountryCode—Two character country code specified in ISO 3166-1993
GlobalLocationIdentifier—Location uniquely identified by the DUNS+4 Number.
GlobalBusinessIdentifier—A unique business identifier in DUNS number.
GlobalCurrencyCode—Three character currency code specified in ISO 4217-1995.
GlobalProductUnitOfMeasureCode Code identifying a product unit of measure.
GlobalProductIdentifier—Global unique product identifier. RosettaNet has adopted the Global Trade Identification Number (GTIN).

These are mandated by Rosettanet PIPs that's why companies do a lot of modifications in their EBAs to comply. The invention acts as an intermediary so that these building blocks are declared optional for companies who wanted to implement Rosettanet and yet their system is not Rosettanet compliant. In previous sections, we were able to discuss the introduction of new fundamental business data entities that allow the extraction and storage of proprietary codes (i.e. item codes, company codes, unit of measure code, currency code, etc.) to let companies take advantage of using the proprietary codes they currently use instead of letting these Rosettanet non-compliant companies to modify their existing EBAs to comply. The invention takes care of code matching for these companies whether they are compliant or non-compliant to Rosettanet's building blocks.

For the business partner registration, the first requirement by the invention is to register and synchronize these business partner company codes.

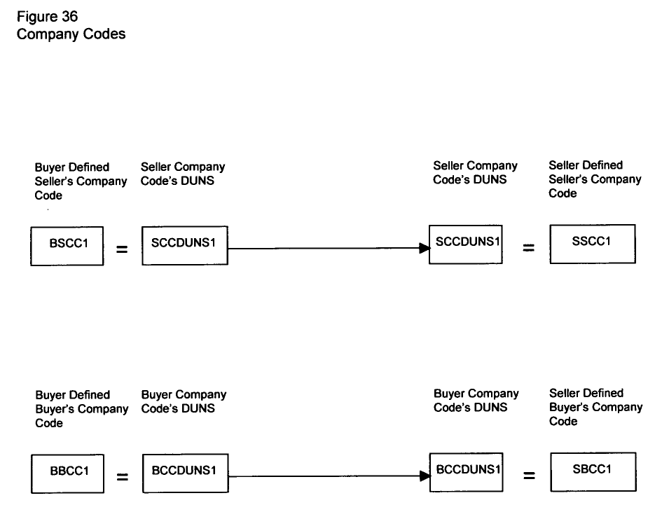

FIG. 36 illustrates the matching of company codes so that the invention will know that these company codes refer to the business partner. This is a vital requirement so that electronic exchange of business transactions and documents are made possible. The invention will easily determine if business transactions are referring to the same company regardless of company codes internally defined by both buyers and sellers.

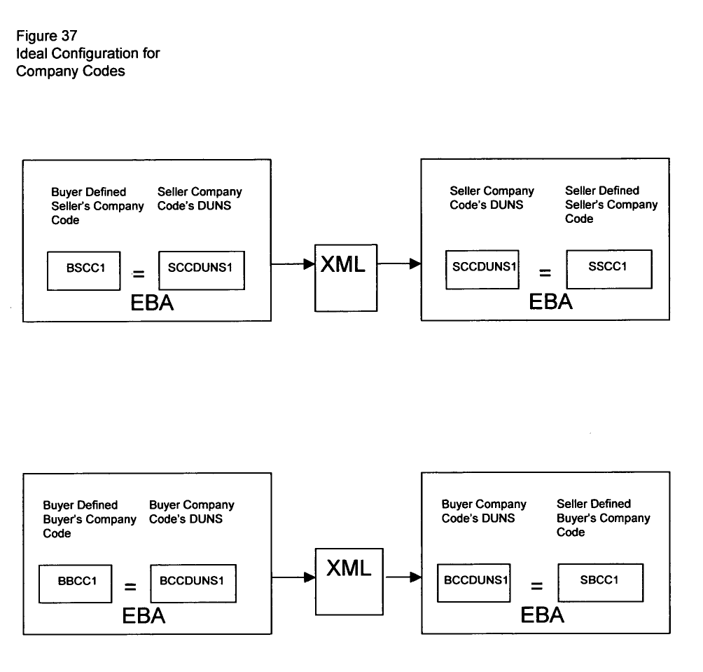

The ideal configuration for EBA supporting RosettaNet as illustrated in FIG. 37 requires that all EBAs must support the match and storage of buyer and seller's company codes respective of their DUNS assignment. This is not a problem for companies who use DUNS as their company code. In this case, there is no need for the matching of codes since there is no buyer-defined buyer's company code (BBCC1). Also, this is not a problem if buyers and sellers define their sellers' and buyer's company codes respectively as DUNS. But all of us agree that this does not happen because almost all companies define their own set of company codes for their trading partners. Also, there is a high likelihood that business partners didn't define their company codes as DUNS.

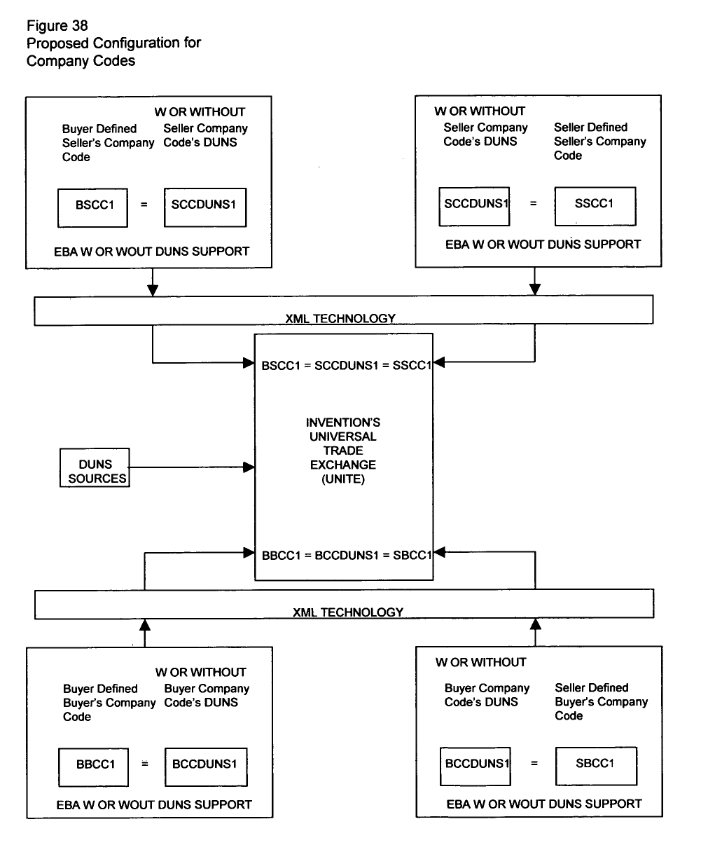

In most cases, EBAs do not even support DUNS storage as illustrated in FIG. 38. These EBAs need to be modified and customized to support this requirement of RosettaNet.

RosettaNet Partner Interface Processes (PIPs) define business processes between supply-chain companies, providing the models and documents for the implementation of standards.

RosettaNet Implementation Framework (RNIF) is an open, common networked-application framework. RNIF provides common exchange protocols that enable the implementation of PIPs.

The invention support the storage, extraction and match of trading partner company codes from EBA regardless on whether these EBAs support directly and indirectly the storage of DUNS.

To address this limitation, the invention extracts the buyer and seller defined company codes (BSCC1, SSCC1, BBCC1, SBCC1) from EBAs' vendor and customer master records whether these support storage of DUNS or not as illustrated in FIG. 38. The invention will do the extraction of DUNS codes from other sources and match these codes to company defined company codes. In this case, the invention will act as the global unifier and repository of codes without the need for EBAs to be modified to comply on DUNS storage required by RosettaNet. Also, the invention is capable of company code match even though there is no DUNS as long as buyer and seller companies supply the proprietary company codes defined for their company and business partners.

In effect, buyer-defined seller's company code (BSCC1) is equal to seller company code's DUNS (SCCDUNS1), which is also equal to the seller-defined seller's company code (SSCC1). Also, the buyer-defined buyer's company code (BBCC1) is equal to buyer company code's DUNS (BCCDUNS1), which is also equal to the seller-defined buyer's company code (SBCC1).

The design of the invention is extensible to cover DUNS+4 and other current and future globally set company code standards.

Now we go to the item code registration. Let us first discuss the seller's side.

Each selling organization maintains its own set of item codes for items being bought by customers or buyers. Therefore, each seller defined item code corresponds to multiple buyer defined item codes.

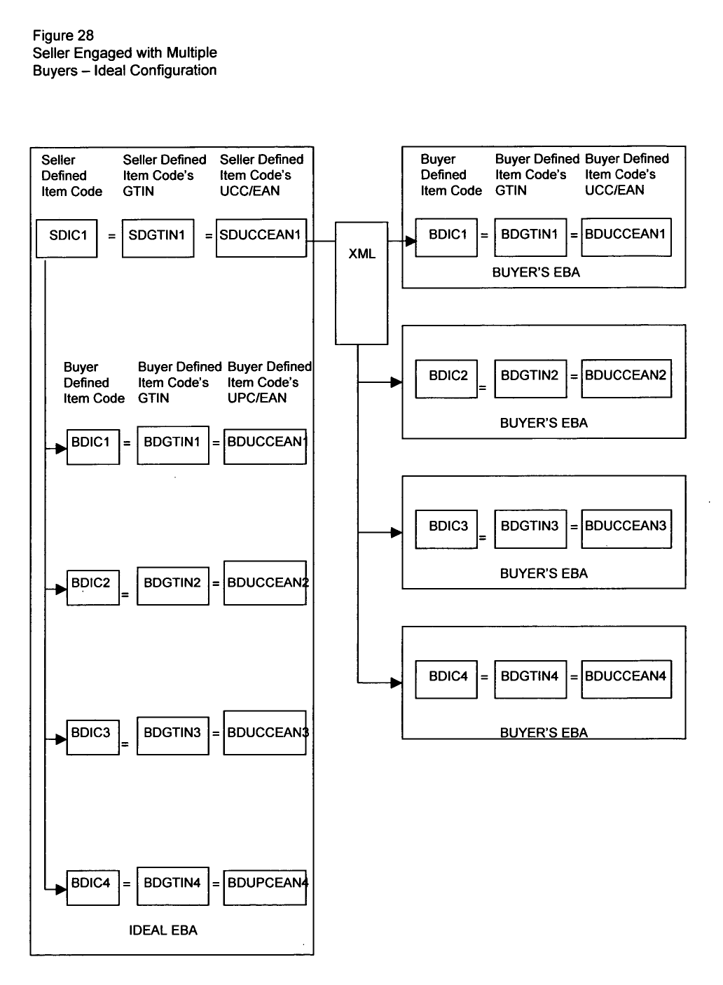

FIG. 28 represents the ideal design of seller's EBA where all item codes are being maintained in the system. FIG. 28 represents item codes defined by seller either on their own or via the global set item code standards (GTIN or UPC/EAN). This is ideal only if the seller wanted an easy adaptation to RosettaNet requirements. But this is disadvantageous also because sellers' EBA will require a huge database to maintain all of these codes. We haven't included yet the buyer defined item codes (BDIC) that need to be matched to these seller defined item codes (SDIC). Imagine the magnitude of the database required to support these buyer and seller defined item codes every time that a new buyer has been identified.

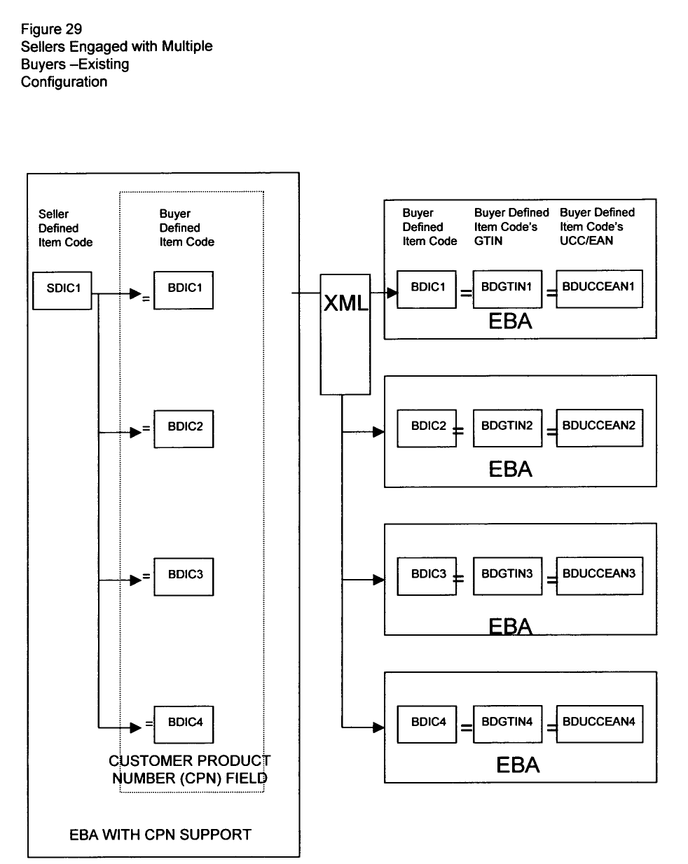

The most advanced seller's EBA has a feature where seller defined item codes (SDIC) are matched to customer product number (CPNs) or buyer defined item codes (BDIC) as illustrated on FIG. 29. Majority of sellers' EBA with CPN support were able to maintain the assignment of seller defined item codes (SDIC) to the buyer defined item codes (BDIC) or customer product numbers. Most of these buyer defined item codes (BDIC) are not the GTIN or EAN/UPC standard codes. In effect, early adaptors of code assignment to buyer defined item codes will have a problem because there is no more available field to handle the storage and match of GTIN or EAN/UPC standards. The complexity increases when most of their business partners don't even maintain GTIN or EAN/UPC standards.

Companies using EDI do not use GTIN codes. They rely on both the buyer and seller defined item codes as illustrated on FIG. 15.

There are only two ways available for these early adaptors to handle the aforementioned limitation. Its either they introduce another field by customization or substitution so that GTIN or EAN/UPC standards are maintained or they change their CPN data to store GTIN or EAN/UPC codes instead of buyer defined codes (BDIC). These methods require companies to invest heavily on time, effort and investment to make it happen.

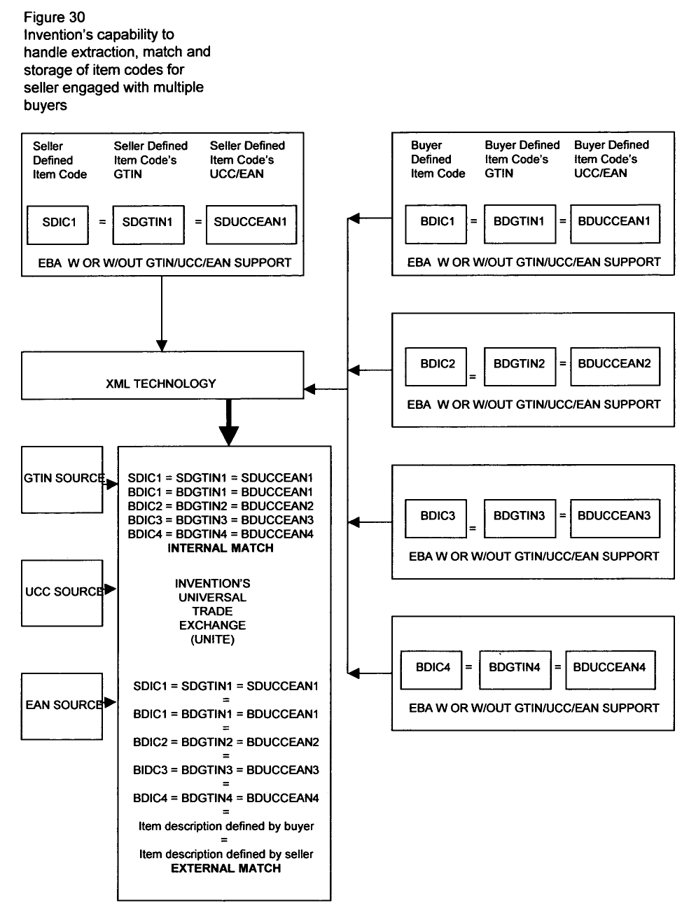

The invention solves this limitation thru its capability to do the extraction, match and storage of these codes regardless on whether these EBAs support the capture of CPN, GTIN, EAN/UPC or other existing or future item codes defined proprietarily or by standards setting bodies. FIG. 30 illustrates the capability of the invention. A manual entry is also possible where business partners can build these item codes in the invention if ever extraction is not possible. If ever these business partners are not registered to be GTIN/EAN/UPC compliant, then their self-defined item codes (proprietary item codes defined by buyer and seller) will be sufficient for matching of item codes.

FIG. 30 describes that GTIN, EAN and UPC based item codes are extracted from EBA. If ever EBAs do not support these codes, the invention will extract these codes from non-EBA sources. The invention covers the tools necessary to extract these codes automatically. A manual entry is also possible where business partners can build these codes in the invention if ever extraction is not possible.

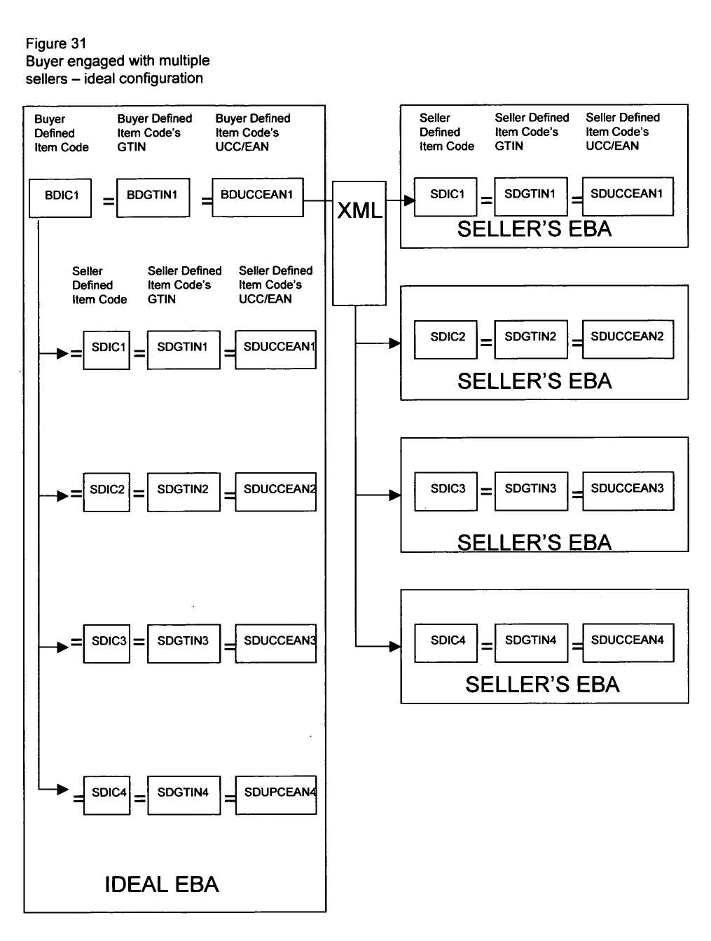

FIG. 31 represents the ideal design of buyer's EBA where all item codes are being maintained in the system. FIG. 31 represents item codes defined by buyer either on their own or via the global set item code standards (GTIN or UPC/EAN). This is ideal only if the buyer wanted an easy adaptation to RosettaNet requirements. But this is disadvantageous also because buyers' EBA will require a huge database to maintain all of these codes. We haven't included yet the seller defined item codes (SDIC) that need to be matched to these buyer defined item codes (BDIC). Imagine the magnitude of the database required to support these buyer and seller defined item codes every time that a new seller has been identified.

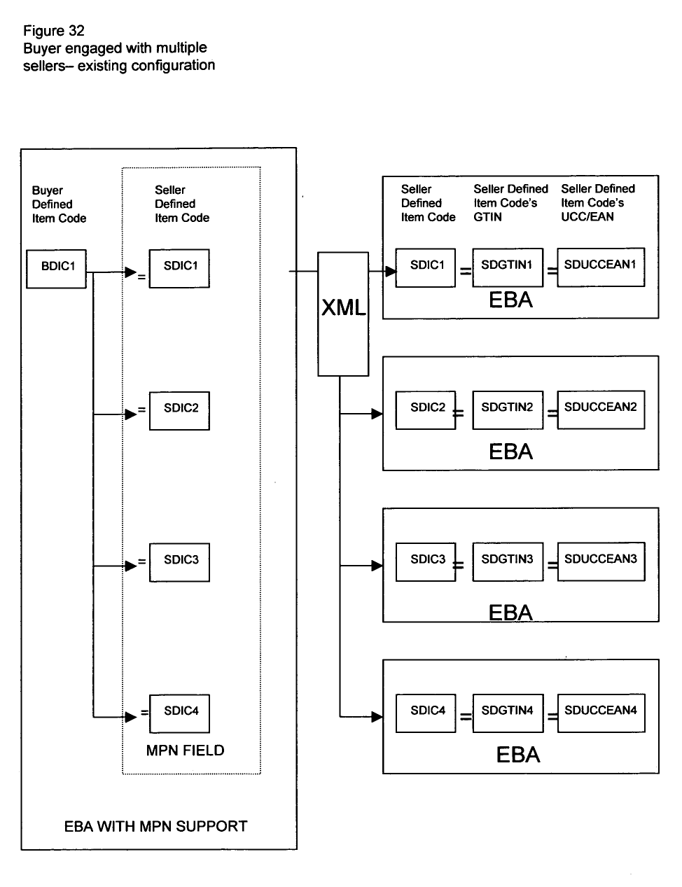

The most advanced buyer's EBA has a feature where buyer defined item codes (BDIC) are matched to manufacturer part number (MPNs) or seller defined item codes (SDIC) as illustrated on FIG. 32. Majority of buyers' EBA with MPN support were able to maintain the assignment of buyer defined item codes (BDIC) to the seller defined item codes (SDIC) or manufacturer part numbers. Most of these seller defined item codes (SDIC) are not the GTIN or EAN/UPC standard codes. In effect, early adaptors of code assignment to seller defined item codes will have a problem because there is no more available field to handle the storage and match of GTIN or EAN/UPC standards. The complexity increases when most of their business partners don't even maintain GTIN or EAN/UPC standards.

There are only two ways available for these early adaptors to handle the aforementioned limitation. Its either they introduce another field by customization or substitution so that GTIN or EAN/UPC standards are maintained or they change their CPN data to store GTIN or EAN/UPC codes instead of buyer defined codes (BDIC). These methods require companies to invest heavily on time, effort and investment to make it happen.

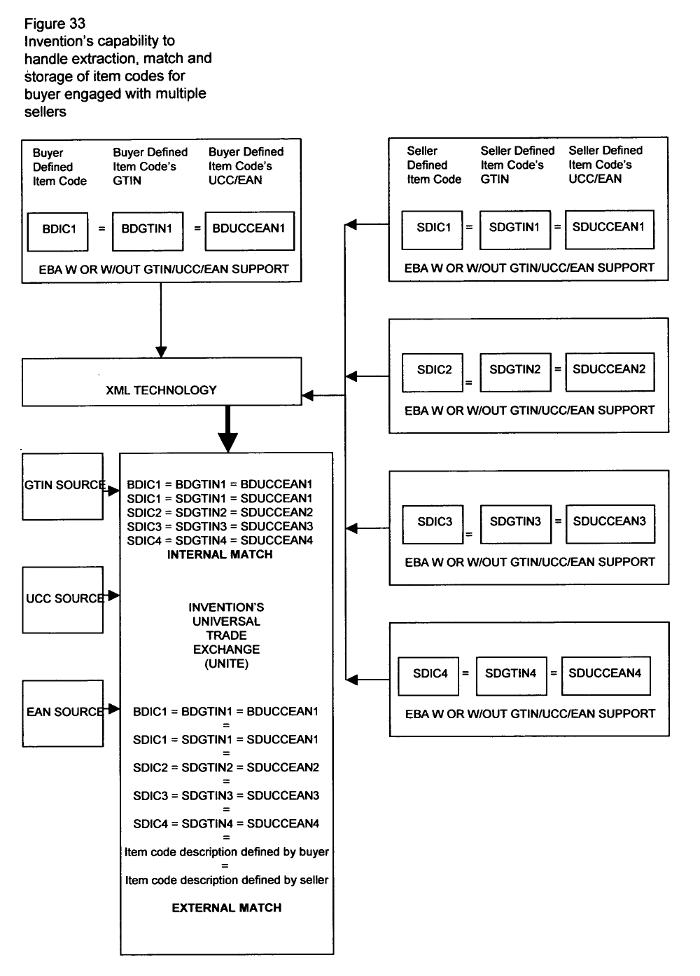

The invention solves this limitation thru its capability to do the extraction, match and storage of these codes regardless on whether these EBAs support the capture of CPN, GTIN, EAN/UPC or other existing or future item codes defined proprietarily or by standards setting bodies. FIG. 33 illustrates the capability of the invention. A manual entry is also possible where business partners can build these item codes in the invention if ever extraction is not possible. If ever these business partners are not registered to be GTIN/EAN/UPC compliant, then their self-defined item codes (proprietary item codes defined by buyer and seller) will be sufficient for matching of item codes.

FIG. 33 describes that GTIN, EAN and UPC based item codes are extracted from EBA. If ever EBAs do not support these codes, the invention will extract these codes from non-EBA sources. The invention covers the tools necessary to extract these codes automatically. A manual entry is also possible where business partners can build these codes in the invention if ever extraction is not possible.

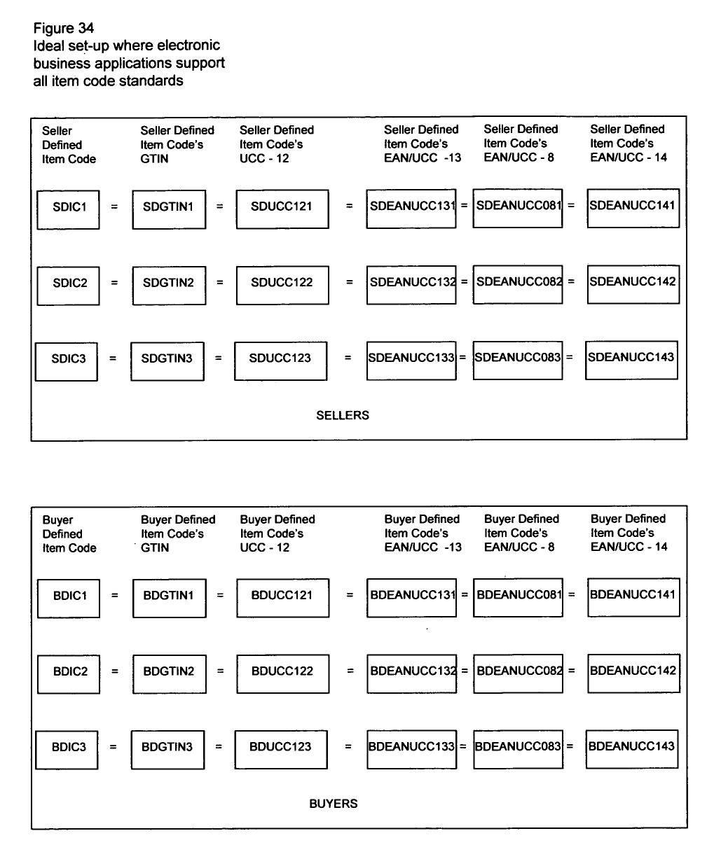

Item code maintenance becomes complex when other buyer and seller EBAs maintain other item code standards. FIG. 34 illustrates this complexity where the ideal EBA set up requires the maintenance of other EAN/UCC coding standards. There is no EBA in the market that supports the maintenance of all these codes.

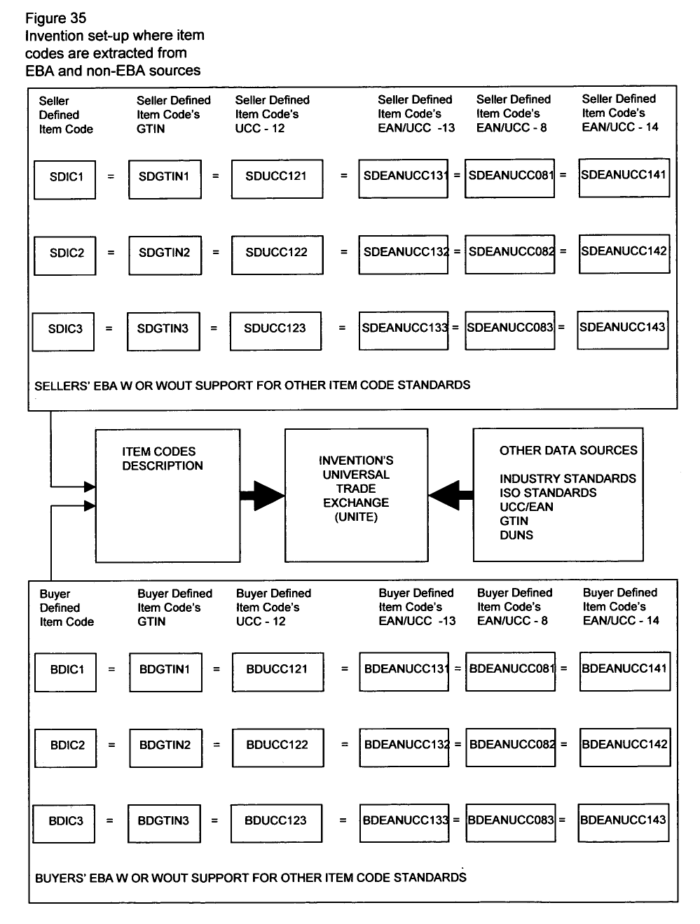

The invention as illustrated on FIG. 35 provides a capability to extract these item codes from EBA or non-EBA sources. The invention covers the tools necessary to extract these codes automatically. A manual entry is also possible where business partners can build these codes in the invention if ever extraction is not possible.

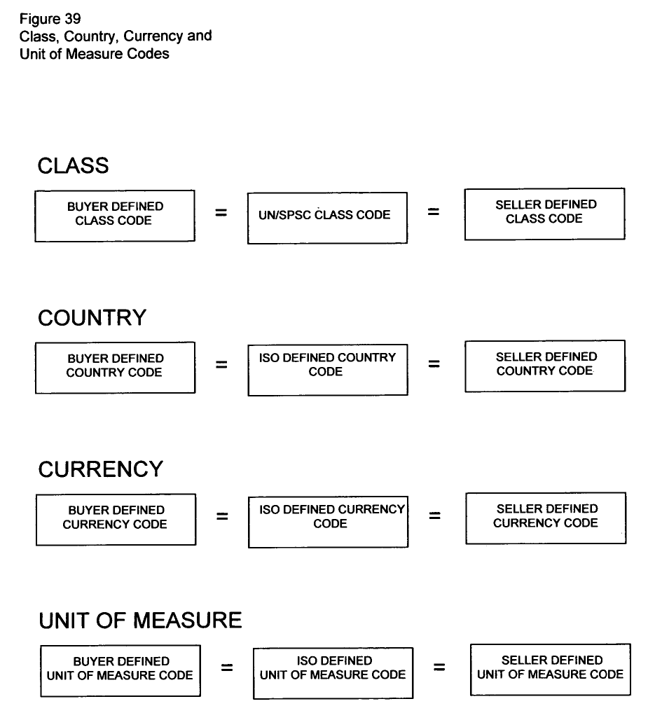

FIG. 39 illustrates the globally defined standards for class, country, currency and unit of measure codes to be matched to seller and buyer defined codes. This is another vital requirement so that electronic exchange of business transactions and documents are made possible. The invention will easily determine if business transactions are referring to the same class, country, currency and unit of measure codes regardless of codes internally defined by both buyers and sellers.

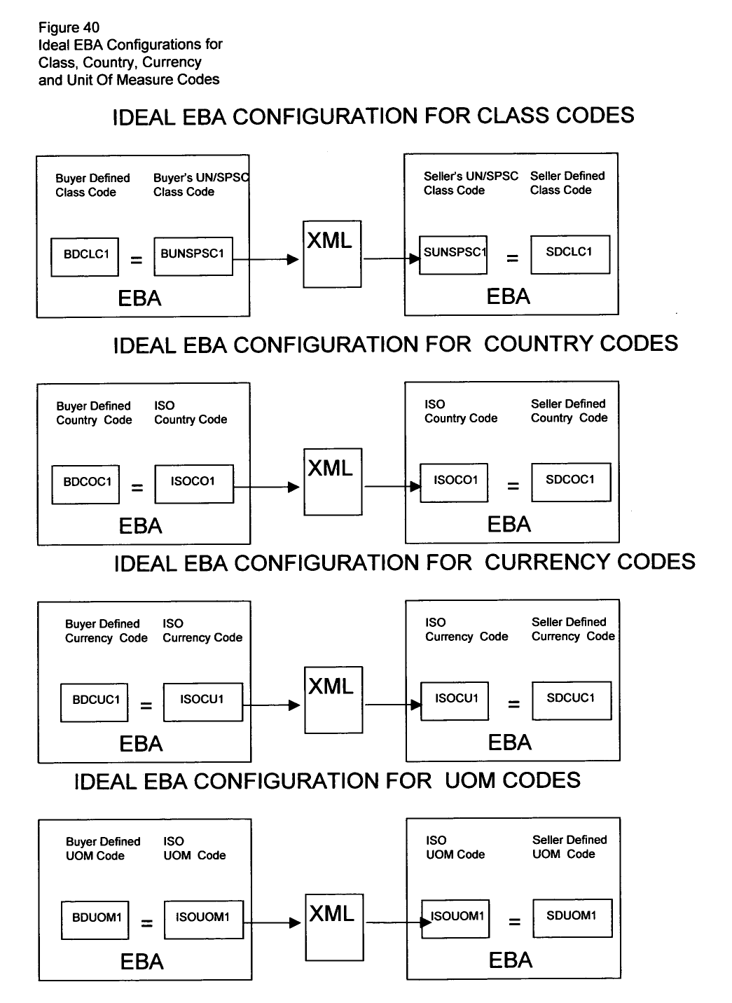

The ideal requirement for EBAs is to support the maintenance and storage of UN/SPSC and ISO codes that are not available in current EBAs. The ideal EBA requirement is illustrated in FIG. 40. Usage of UN/SPSC and ISO codes is required to comply with RosettaNet's PIP and RNIF.

Because of the limitation of existing EBAs, a work around was introduced. Its either they introduced another field by customization or substitution so that UN/SPSC and ISO codes are maintained or they change their internally defined class, country, currency and unit of measure into UN/SPSC and ISO defined codes which are both high risk options and require huge investment on time, money and effort.

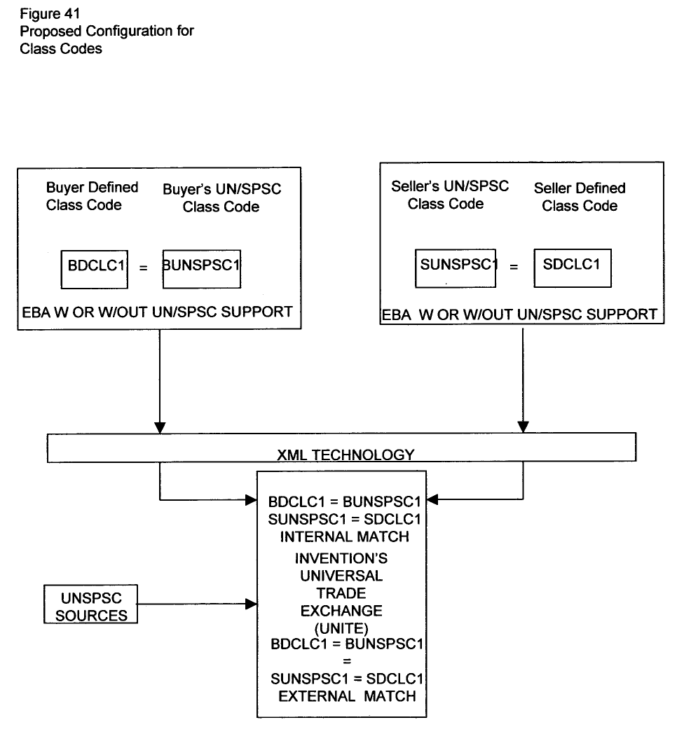

FIG. 41 displays the invention's configuration for handling of class codes. It illustrates the capability of the invention to extract business partner internally defined class code and match with UN/SPSC defined codes. These UN/SPSC defined codes can be extracted from EBA and non-EBA sources. The invention covers the tools necessary to extract these codes automatically. A manual entry is also possible where business partners can build these codes in the invention if ever extraction is not possible.

UN/SPSC code acts as the unifying code to match buyer-defined class code with seller-defined class code. The invention uses the UN/SPSC codes to comply with Rosettanet technology. Also, the invention is flexible to allow proprietary class codes being defined by these business partners.

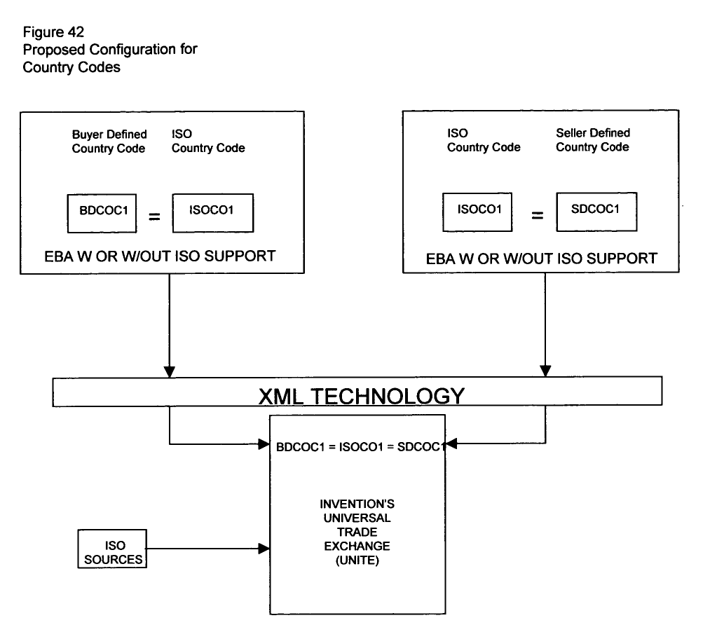

FIG. 42 displays the invention's configuration for handling of country codes. It illustrates the capability of the invention to extract business partner internally defined country code and match with ISO defined codes. These ISO defined codes can be extracted from EBA and non-EBA sources. The invention covers the tools necessary to extract these codes automatically. A manual entry is also possible where business partners can build these codes in the invention if ever extraction is not possible. The invention has the capability to automatically convert the internally defined country codes into ISO defined codes and will not alter the configuration of business partners' EBAs.

ISO country code acts as the unifying code to match buyer-defined country code with seller-defined country code. The invention uses the ISO country code to comply with Rosettanet technology. Also, the invention is flexible to allow proprietary country codes being defined by these business partners who are not using the ISO country code. This capability of the invention was discussed previously where a fundamental business data entity was introduced to capture the proprietary country code.

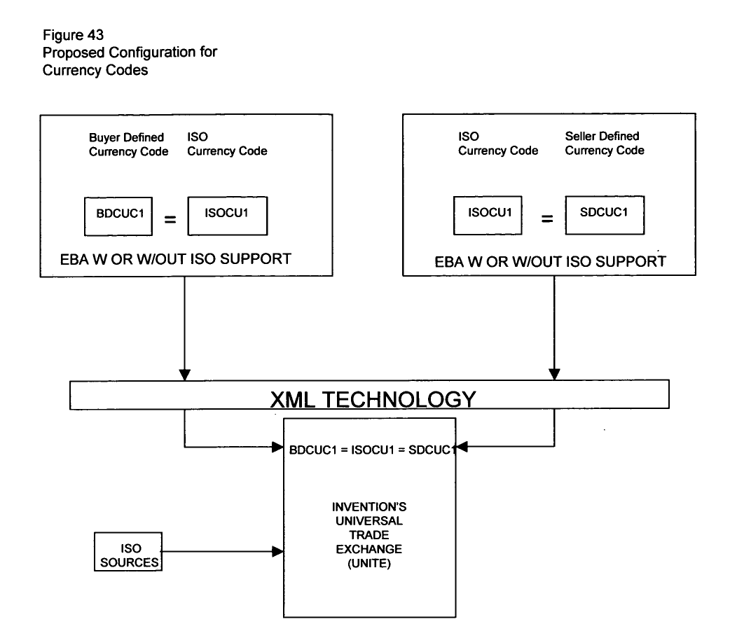

FIG. 43 displays the invention's configuration for handling of currency codes. It illustrates the capability of the invention to extract business partner internally defined currency code and match with ISO defined codes. These ISO defined codes can be extracted from EBA and non-EBA sources. The invention covers the tools necessary to extract these codes automatically. A manual entry is also possible where business partners can build these codes in the invention if ever extraction is not possible. The invention has the capability to automatically convert the internally defined currency codes into ISO defined codes and will not alter the configuration of business partners' EBAs.

ISO currency code acts as the unifying code to match buyer-defined currency code with seller-defined currency code. The invention uses the ISO currency code to comply with Rosettanet technology. Also, the invention is flexible to allow proprietary currency codes being defined by these business partners who are not using the ISO currency code. This capability of the invention was discussed previously where a fundamental business data entity was introduced to capture the proprietary currency code.

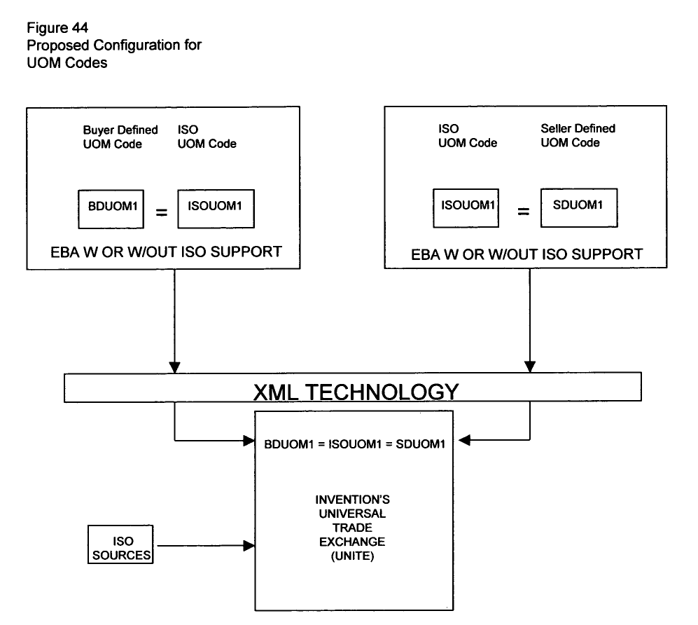

FIG. 44 displays the invention's configuration for handling of unit of measure (UOM) codes. It illustrates the capability of the invention to extract business partner internally defined unit of measure code and match with ISO defined codes. These ISO defined codes can be extracted from EBA and non-EBA sources. The invention covers the tools necessary to extract these codes automatically. A manual entry is also possible where business partners can build these codes in the invention if ever extraction is not possible. The invention has the capability to automatically convert the internally defined unit of measure codes into ISO defined codes and will not alter the configuration of business partners' EBAs.

ISO unit of measure code acts as the unifying code to match buyer-defined currency code with seller-defined unit of measure code. The invention uses the ISO unit of measure code to comply with Rosettanet technology. Also, the invention is flexible to allow proprietary unit of measure codes being defined by these business partners who are not using the ISO UOM code. This capability of the invention was discussed previously where a fundamental business data entity was introduced to capture the proprietary unit of measure code.

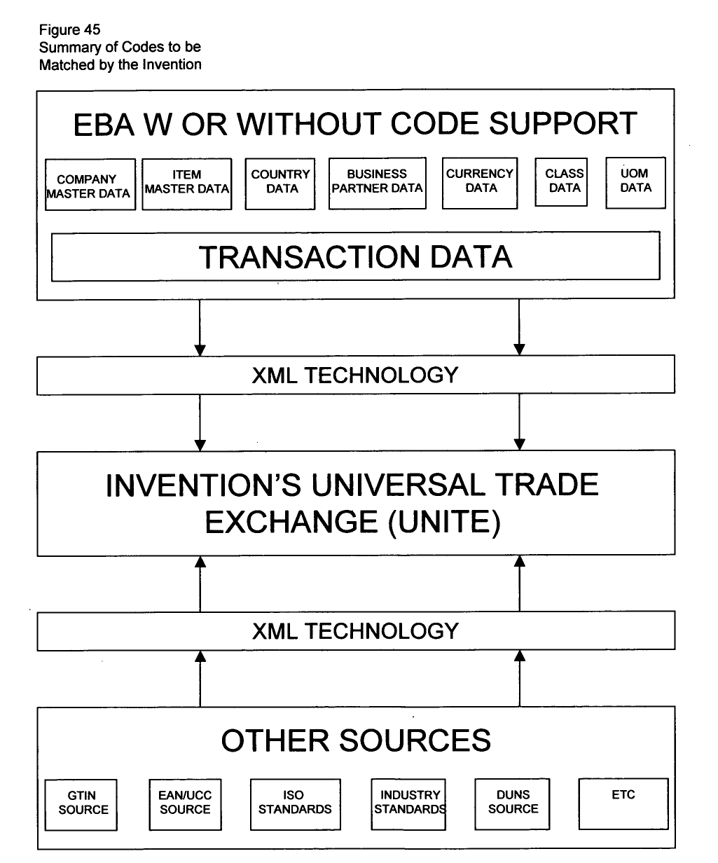

FIG. 45 provides a summary of all codes to be extracted, matched and stored by the invention from EBA and non-EBA sources. Also, manual entry of these codes is possible if ever extraction is not available.

4. Conversion of EDI-XML Transactions

EDI: 840 Request for Quotation

RosettaNet: 3A1 Quote Request

The invention classifies the company code found on. Line 10—GlobalBusinessIdentifier as part of the buyer listing when it finds Line 7—GlobalPartnerClassificationRole as equal to buyer.

The invention provides an enhancement where the GlobalDocumentFunctionCode will contain an entity instance. Such entity instance includes but not limited to Quote Request, Quote Confirmation, Purchase Order, Purchase Order Confirmation, Purchase Order Acknowledge, Ship Notice, Purchase Order Change, Purchase Order Change Acknowledgment, Purchase Order Cancellation Request, Purchase Order Cancellation Confirmation, Invoice and Payment Order. The entity instance is automatically determined and assigned during the extraction of data from EBA and EDI data.

The invention classifies the document as part of the RFQ request list when it finds that Line 13—GlobalDocumentFunctionCode as equal to Quote request. The invention determines the most recent and updated quote request based on Line 49—RevisionNumber. All revisions with updates/changes are stored by the invention for listing and report purpose.

The invention uses Line 113—isSubstituteProductAcceptable.AffirmationIndicator as a flag to determine if product substitution is allowed in the quote response.

The invention stores competitor's details found on Line 121-163. The invention stores data found on Line 152—GlobalProductIdentifier and Line 155—ProprietaryProductIdentifier and match this with Line 116—GlobalProductIdentifier, Line 119—ProprietaryProductIdentifier and xxx—ProprietaryProductIdentifier2 (enhancement introduced by the invention). This is the key that allows the invention to know which products/services are similar when potential buyers are looking for alternate sources. The invention stores competitor's product price details found on 162—MonetaryAmount with the currency under Line 159—GlobalCurrencyCode. If ever the competitor is not yet registered in the invention, an email is sent to them using Line 132—Email Address and addressed to Line 131—contactName.FreeFormText or fax letter using Line 133—facsimileNumber.CommunicationsNumber.

The invention will classifies Line 327—GlobalBusinessIdentifier as part of the seller listing when it finds Line 324—GlobalPartnerClassificationRole as equal to seller.

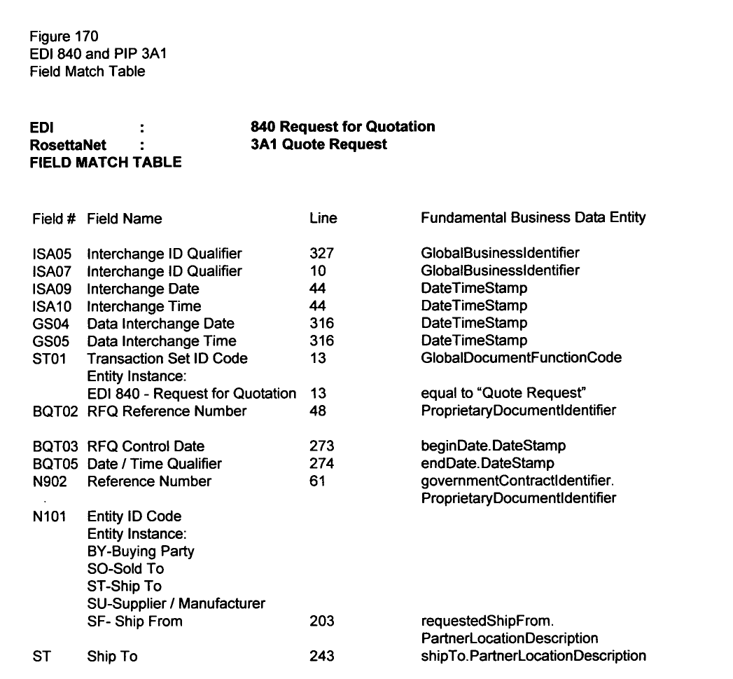

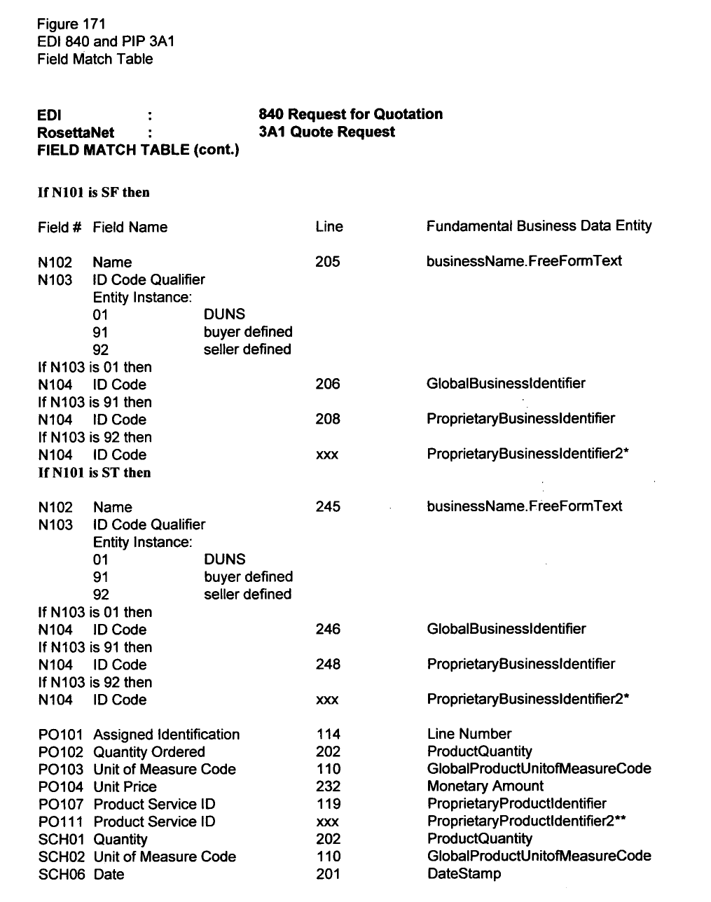

One of the major capabilities of the invention is to match EDI fields with RosettaNet's fundamental business data entity as provided in FIGS. 170 and 171. Therefore, this translates the EDI data into Rosettanet data if ever companies want to convert their EDI transactions into Rosettanet based transaction.

*The seller defined company code found on N104—id code is stored in the ProprietaryBusinessIdentifier2 that was defined and claimed by the invention in the previous section as an additional fundamental business data entity in the Rosettanet PIP.

**The seller defined item code found on P0111—Product Service ID is stored in the ProprietaryProductIdentifier2 that was defined and claimed by the invention as an additional fundamental business data entity in the Rosettanet PIP.

The invention provides a tool to match codes if there is inconsistency between P0103—Unit of Measure Code, SCH02—Unit of Measure Code and 110—GlobalProductUnitofMeasureCode. The GlobalProductUnitofMeasureCode extracts the entity instance from a predefined list of unit of measure codes found, maintained, stored and updated in the invention's database.

EDI 843: Response to RFQ

RosettaNet: 3A1 Quote Confirm

The invention classifies Line 10—GlobalBusinessIdentifier as part of the seller listing when it finds Line 7—GlobalPartnerClassificationRole as equal to seller.

The invention provides an enhancement where the GlobalDocumentFunctionCode will contain an entity instance. Such entity instance includes but not limited to Quote Request, Quote Confirmation, Purchase Order, Purchase Order Confirmation, Purchase Order Acknowledge, Ship Notice, Purchase Order Change, Purchase Order Change Acknowledgment, Purchase Order Cancellation Request, Purchase Order Cancellation Confirmation, Invoice and Payment Order. The entity instance is automatically determined and assigned during the extraction of data from EBA and EDI data.

The invention classifies the document as part of the RFQ Confirm list when it finds that Line 13—GlobalDocumentFunctionCode as equal to Quote confirmation.

The invention determines the most recent and updated quote request based on Line 49—RevisionNumber. All revisions with updates/changes are stored by the invention for listing and report purpose.

The invention uses Line 75—isPendingItemsExist.AffimrationIndicator as a flag to determine if there are still pending items not included in the quote response.

The invention allows data entry on Line 341-348 of 3A1 Quote Response if a “yes” Indicator was reflected on Line 113—isSubstituteProductAcceptable.AffirmationIndicator of 3A1 Quote Response. The invention stores data found on Line 344—GlobalProductIdentifier and Line 347—ProprietaryProductIdentifier and match this with Line 144—GlobalProductIdentifier, Line 147—ProprietaryProductIdentifier and xxx—ProprietaryProductIdentifier (enhancement introduced by the invention). This is the key that will allow the invention to know which products/services are similar when potential buyers are looking for substitute products/services.

The invention classifies Line 485—GlobalBusinessIdentifier as part of the buyer listing when it finds Line 482—GlobalPartnerClassificationRole as equal to buyer.

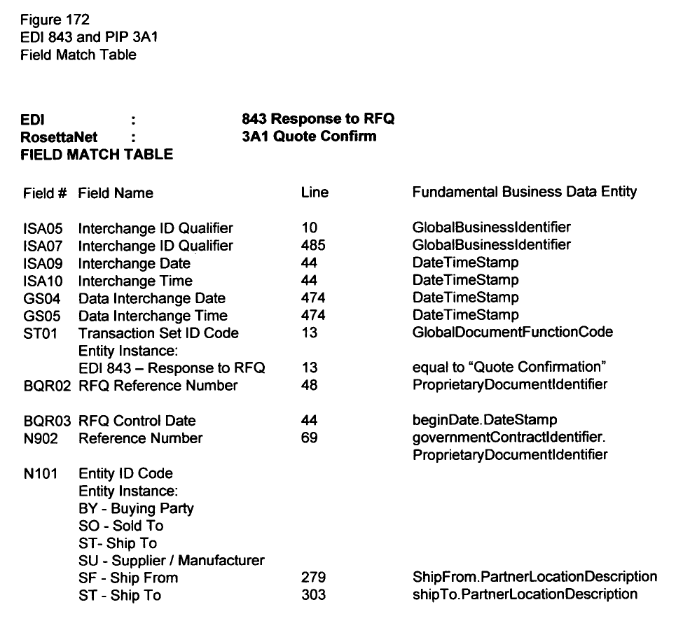

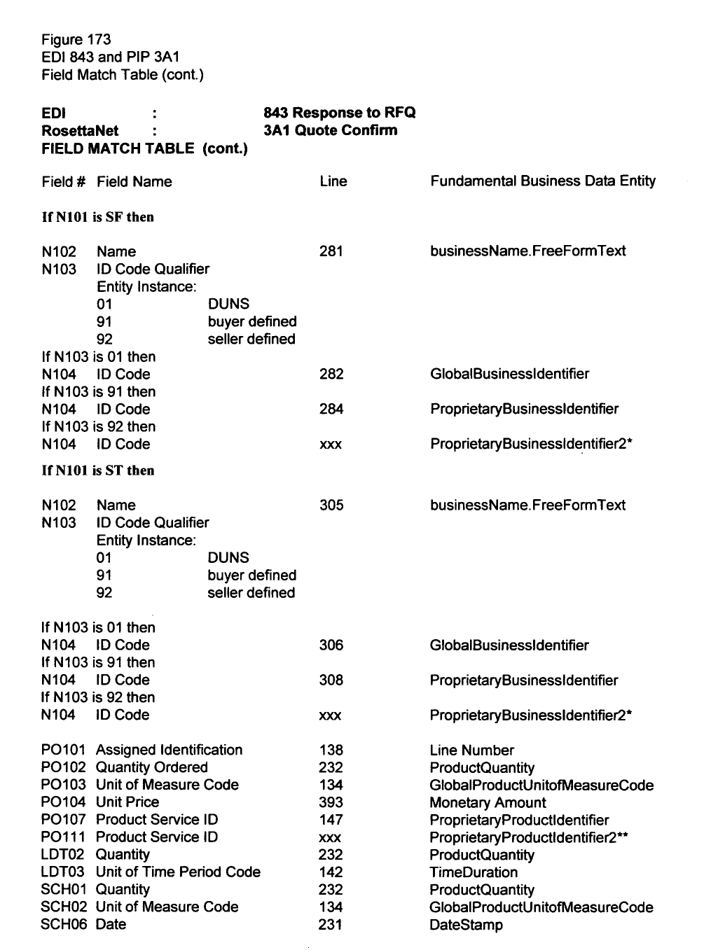

One of the major capabilities of the invention is to match EDI fields with RosettaNet's fundamental business data entity as provided in FIGS. 172 and 173. Therefore, this translates the EDI data into Rosettanet data if ever companies want to convert their EDI transactions into Rosettanet based transaction.

*The seller defined company code found on N104—id code is stored in the ProprietaryBusinessIdentifier2 that was defined and claimed by the invention as an additional fundamental business data entity in the Rosettanet PIP.

**The seller defined item code found on P0111—Product Service ID is stored in the ProprietaryProductIdentifier2 that was defined and claimed by the invention as an additional fundamental business data entity in the Rosettanet PIP.

The invention provides a tool to match codes if there is inconsistency between P0103—Unit of Measure Code, SCH02—Unit of Measure Code and 134—GlobalProductUnitofMeasureCode. The GlobalProductUnitofMeasureCode extracts the entity instance from a predefined list of unit of measure codes found, maintained, stored and updated in the invention's database.

EDI: 850 Purchase Order

RosettaNet: 3A4 Purchase Order Request

The invention classifies Line 10—GlobalBusinessIdentifier as part of the buyer listing when it finds Line 7—GlobalPartnerClassificationRole is equal to buyer.

The invention provides an enhancement where the GlobalDocumentFunctionCode will contain an entity instance. Such entity instance includes but not limited to Quote Request, Quote Confirmation, Purchase Order, Purchase Order Confirmation, Purchase Order Acknowledge, Ship Notice, Purchase Order Change, Purchase Order Change Acknowledgment, Purchase Order Cancellation Request, Purchase Order Cancellation Confirmation, Invoice and Payment Order. The entity instance is automatically determined and assigned during the extraction of data from EBA and EDI data.

The invention classifies the document as part of the Purchase Order list when it finds that Line 13—GlobalDocumentFunctionCode is equal to Purchase Order.

The invention determines the most recent and updated quote request based on Line 105—RevisionNumber. All revisions with updates/changes will be stored by the invention for listing and report purpose.

The invention classifies Line 549—GlobalBusinessIdentifier as part of the seller listing when it finds Line 546—GlobalPartnerClassificationRole as equal to seller.

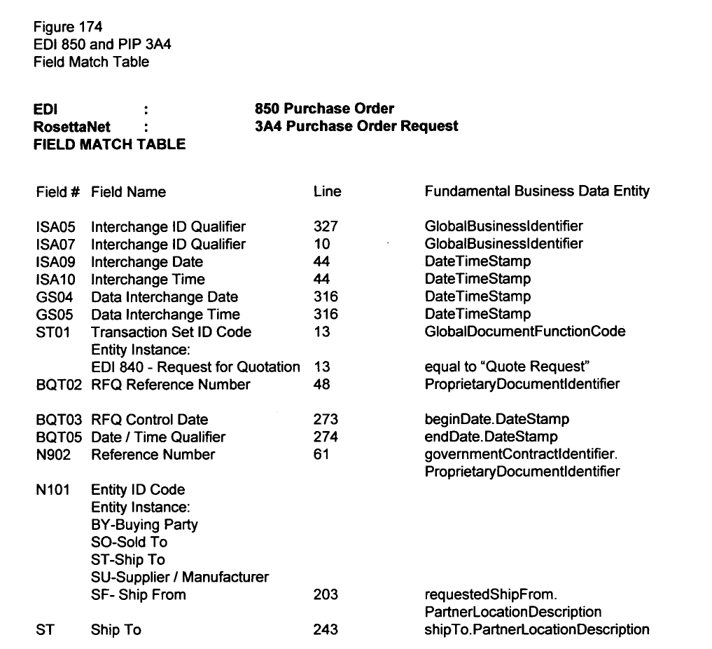

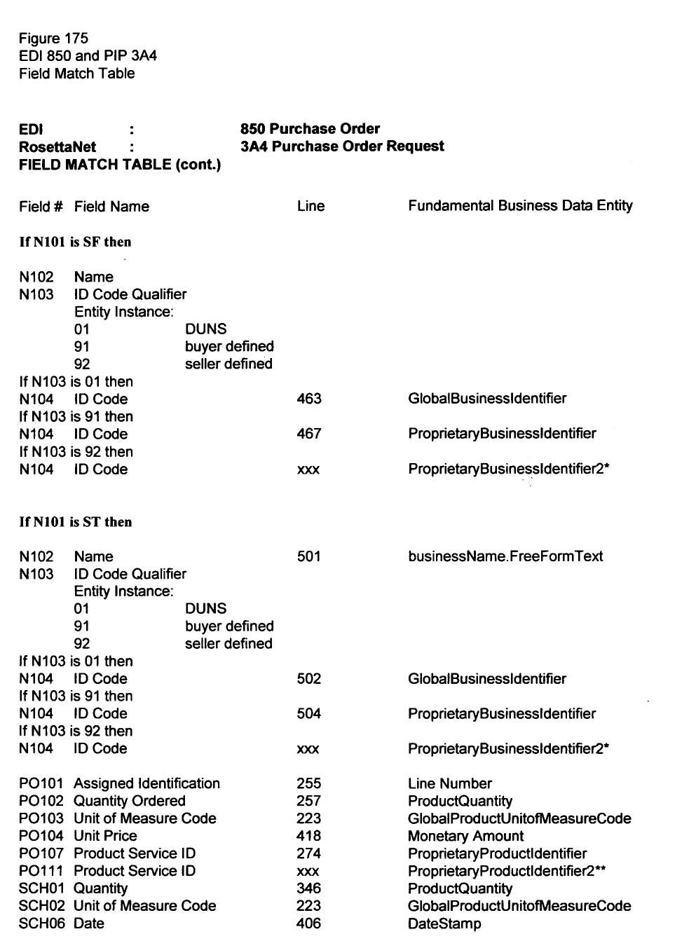

One of the major capabilities of the invention is to match EDI fields with RosettaNet's fundamental business data entity as provided in FIGS. 174-175. Therefore, this translates the EDI data into Rosettanet data if ever companies want to convert their EDI transactions into Rosettanet based transaction.

*The seller defined company code found on N104—id code is stored in the ProprietaryBusinessIdentifier2 that was defined and claimed by the invention as an additional fundamental business data entity in the Rosettanet PIP.

**The seller defined item code found on P0111—Product Service ID is stored in the ProprietaryProductIdentifier2 that was defined and claimed by the invention as an additional fundamental business data entity in the Rosettanet PIP.

The invention provides a tool to match codes if there is inconsistency between P0103—Unit of Measure Code, SCH02—Unit of Measure Code and 223—GlobalProductUnitofMeasureCode. The GlobalProductUnitofMeasureCode extracts the entity instance from a predefined list of unit of measure codes found, maintained, stored and updated in the invention's database.

EDI 855: Purchase Order Acknowledgment

RosettaNet: 3A4 Purchase Order Confirmation

The invention classifies Line 10—GlobalBusinessIdentifier as part of the seller listing when it finds Line 7—GlobalPartnerClassificationRole is equal to seller.

The invention provides an enhancement where the GlobalDocumentFunctionCode will contain an entity instance. Such entity instance includes but not limited to Quote Request, Quote Confirmation, Purchase Order, Purchase Order Confirmation, Purchase Order Acknowledge, Ship Notice, Purchase Order Change, Purchase Order Change Acknowledgment, Purchase Order Cancellation Request, Purchase Order Cancellation Confirmation, Invoice and Payment Order. The entity instance is automatically determined and assigned during the extraction of data from EBA and EDI data.

The invention classifies the document as part of the Purchase Order Confirmation list when it finds that Line 13—GlobalDocumentFunctionCode is equal to Purchase Order Acknowledge.

The invention determines the most recent and updated quote request based on Line 105—RevisionNumber. All revisions with updates/changes will be stored by the invention for listing and report purpose.

The invention allows data entry on Line 504-511 of 3A4 Purchase Order Quote Acknowledge if a “yes” Indicator was reflected on Line 113—isSubstituteProductAcceptable.AffirmationIndicator of 3A1 Quote Response. The invention stores data found on Line 507—GlobalProductIdentifier and Line 510—ProprietaryProductIdentifier and match this with Line 278—GlobalProductIdentifier, Line 281—ProprietaryProductIdentifier and xxx—ProprietaryProductIdentifier (enhancement introduced by the invention). This is the key that allows the invention to know which products/services are similar when potential buyers are looking for substitute products/services.

The invention classifies Line 898—GlobalBusinessIdentifier as part of the buyer listing when it finds Line 895—GlobalPartnerClassificationRole as equal to buyer.

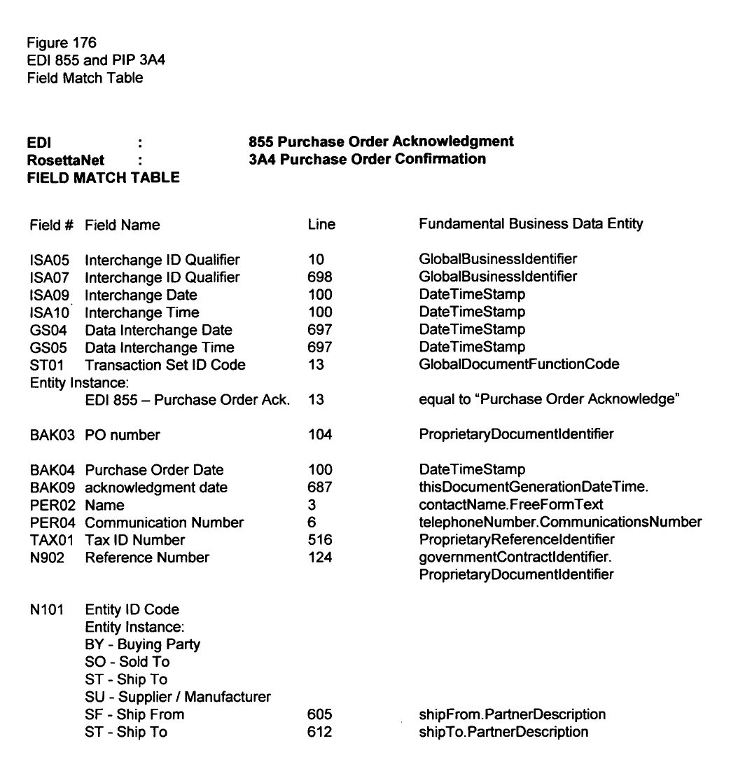

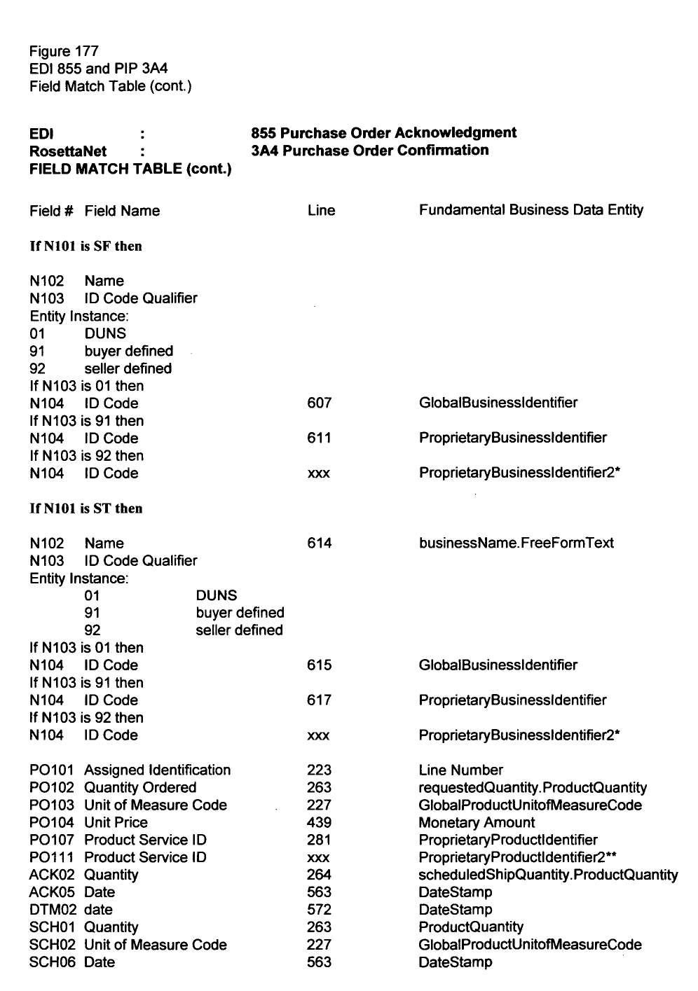

One of the major capabilities of the invention is to match EDI fields with RosettaNet's fundamental business data entity as provided in FIGS. 176 and 177. Therefore, this translates the EDI data into Rosettanet data if ever companies want to convert their EDI transactions into Rosettanet based transaction.

*The seller defined code found on N104—id code is stored in the ProprietaryBusinessIdentifier2 that was defined and claimed by the invention as an additional fundamental business data entity in the Rosettanet PIP.

**The seller defined item code found on P0111—Product Service ID is stored in the ProprietaryProductIdentifier2 that was defined and claimed by the invention as an additional fundamental business data entity in the Rosettanet PIP.

The invention provides a tool to match codes if there is inconsistency between P0103—Unit of Measure Code, SCH02—Unit of Measure Code and 227—GlobalProductUnitofMeasureCode. The GlobalProductUnitofMeasureCode extracts the entity instance from a predefined list of unit of measure codes found, maintained, stored and updated in the invention's database.

EDI: 860 Purchase Order Change

RosettaNet: 3A8 Purchase Order Change Request

The invention classifies Line 10—GlobalBusinessIdentifier as part of the buyer listing when it finds Line 7—GlobalPartnerClassificationRole is equal to buyer.

The invention provides an enhancement wherein the GlobalDocumentFunctionCode will contain an entity instance. Such entity instance includes but not limited to Quote Request, Quote Confirmation, Purchase Order, Purchase Order Confirmation, Purchase Order Acknowledge, Ship Notice, Purchase Order Change, Purchase Order Change Acknowledgment, Purchase Order Cancellation Request, Purchase Order Cancellation Confirmation, Invoice and Payment Order. The entity instance is automatically determined and assigned during the extraction of data from EBA and EDI data.

The invention classifies the document as part of the Purchase Order Change list when it finds that Line 13—GlobalDocumentFunctionCode is equal to Purchase Order Change.

The invention determines the most recent and updated quote request based on Line 105—RevisionNumber. All revisions with updates/changes are stored by the invention for listing and report purpose.

The invention classifies Line 607—GlobalBusinessIdentifier as part of the seller listing when it finds Line 604—GlobalPartnerClassificationRole as equal to seller.

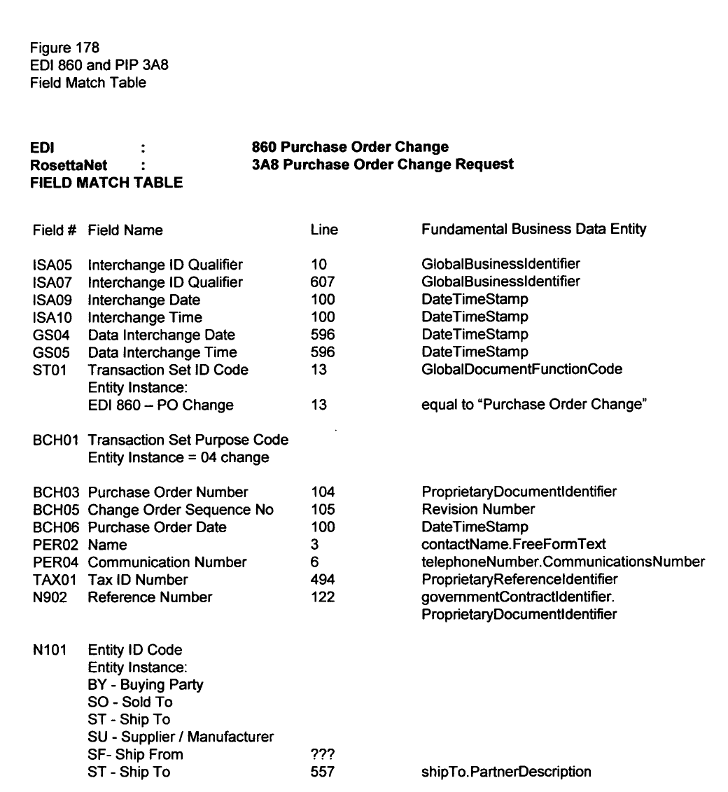

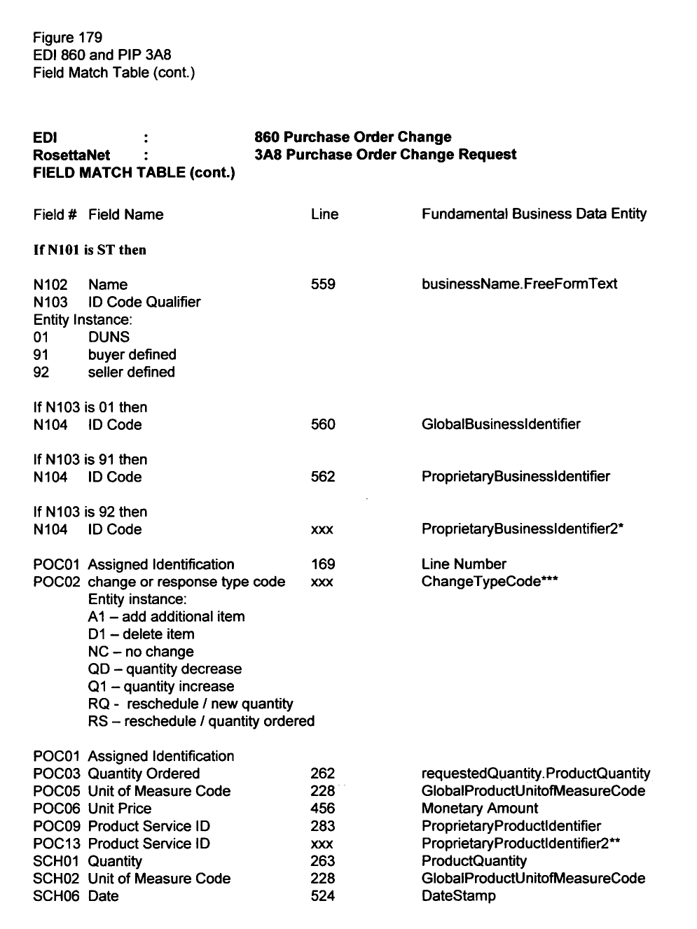

One of the major capabilities of the invention is to match EDI fields with RosettaNet's fundamental business data entity as provided in FIGS. 178 and 179. Therefore, this translates the EDI data into Rosettanet data if ever companies want to convert their EDI transactions into Rosettanet based transaction.

The invention automatically selects 3A8 Purchase Order Change when the BCH01 flag is set to 04 Change as the entity instance. If the entity instance is 01—Cancellation then 3A9 Request Purchase Order Cancellation is selected.

*The seller defined company code found on N104—id code is stored in the ProprietaryBusinessIdentifier2 that was defined and claimed by the invention as an additional fundamental business data entity in the Rosettanet PIP.

**The seller defined item code found on POC13—Product Service ID is stored in the ProprietaryProductIdentifier2 that was defined and claimed by the invention as an additional fundamental business data entity in the Rosettanet PIP.

***The invention provides an enhancement to include a ChangeTypeCode fundamental business data entity as part of 3A8 Purchase Order Change Request. This fundamental business data entry provides a predefined list similar to the list provided by POC02 field of EDI 860 Purchase Order Change.

The invention provides a tool to match codes if there is inconsistency between POC05—Unit of Measure Code, SCH02—Unit of Measure Code and 228—GlobalProductUnitofMeasureCode. The GlobalProductUnitofMeasureCode extracts the entity instance from a predefined list of unit of measure codes found, maintained, stored and updated in the invention's database.

EDI 865: PO Change Acknowledgment

RosettaNet: 3A8 Purchase Order Change Confirmation

The invention classifies Line 10—GlobalBusinessIdentifier as part of the seller listing when it finds Line 7—GlobalPartnerClassificationRole is equal to seller.

The invention provides an enhancement where the GlobalDocumentFunctionCode contains an entity instance. Such entity instance includes but not limited to Quote Request, Quote Confirmation, Purchase Order, Purchase Order Confirmation, Purchase Order Acknowledge, Ship Notice, Purchase Order Change, Purchase Order Change Acknowledgment, Purchase Order Cancellation Request, Purchase Order Cancellation Confirmation, Invoice and Payment Order. The entity instance is automatically determined and assigned during the extraction of data from EBA and EDI data.

The invention classifies the document as part of the Purchase Order Change Confirmation list when it finds that Line 13—GlobalDocumentFunctionCode is equal to Purchase Order Change Acknowledgment.

The invention determines the most recent and updated quote request based on Line 105—RevisionNumber. All revisions with updates/changes are stored by the invention for listing and report purpose.

The invention classifies Line 723—GlobalBusinessIdentifier as part of the buyer listing when it finds Line 720—GlobalPartnerClassificationRole as equal to buyer.

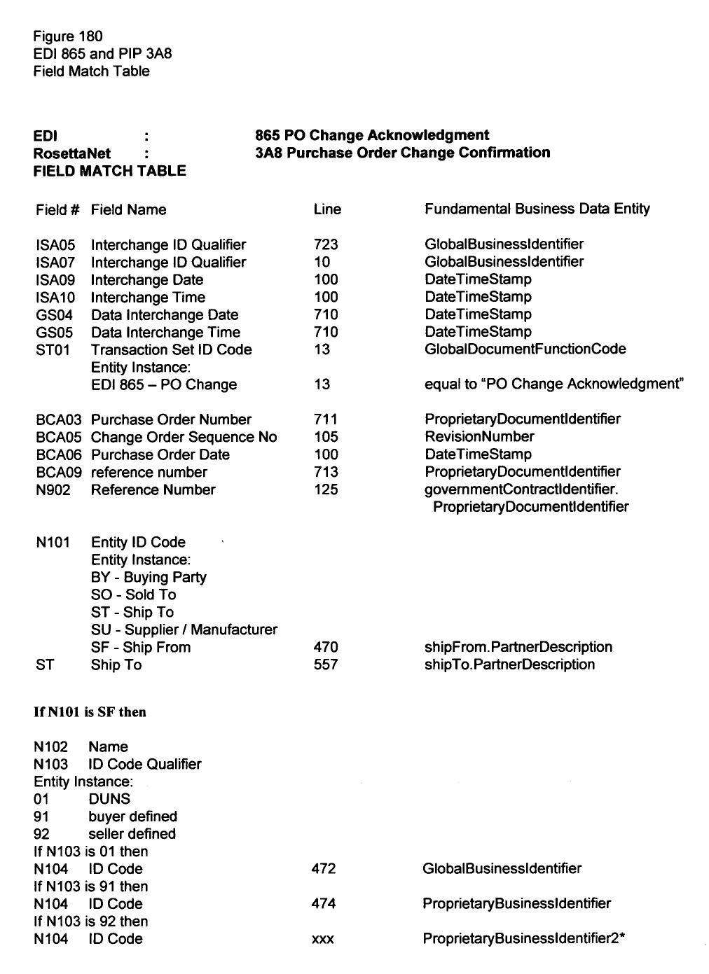

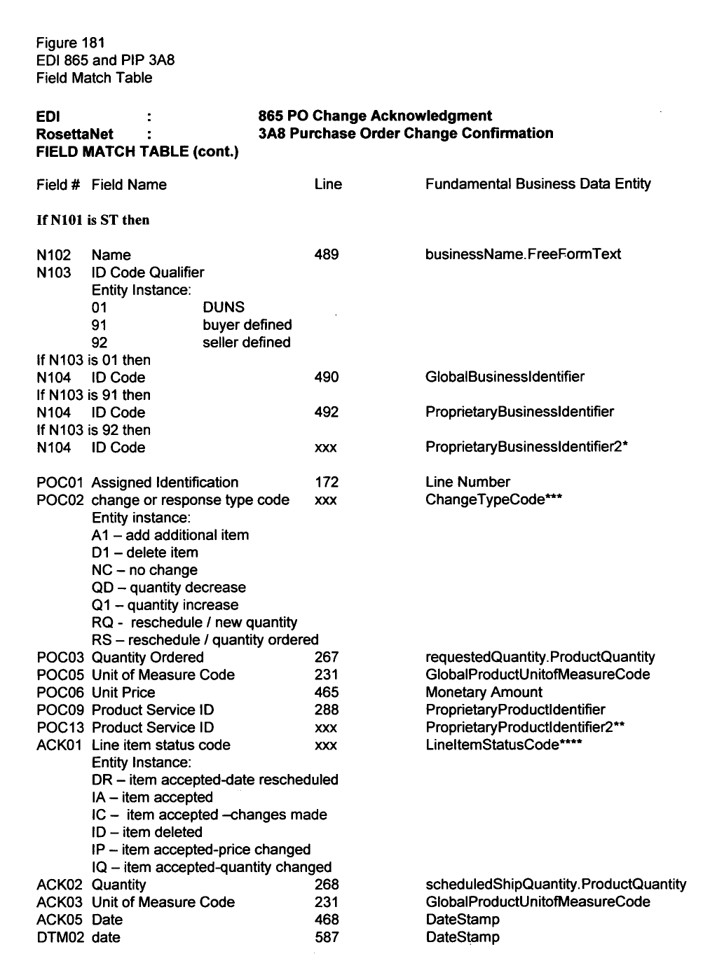

One of the major capabilities of the invention is to match EDI fields with RosettaNet's fundamental business data entity as provided in FIGS. 180 and 181. Therefore, this translates the EDI data into Rosettanet data if ever companies want to convert their EDI transactions into Rosettanet based transaction.

*The seller defined company code found on N104—id code is stored in the ProprietaryBusinessIdentifier2 that was defined and claimed by the invention as an additional fundamental business data entity in the Rosettanet PIP.

**The seller defined item code found on POC13—Product Service ID is stored in the ProprietaryProductIdentifier2 that was defined and claimed by the invention as an additional fundamental business data entity in the Rosettanet PIP.

***The invention provides an enhancement to include a ChangeTypeCode fundamental business data entity as part of 3A8 Purchase Order Change Confirmation. This will follow the same entity instance provided by POC02. This fundamental business data entry provides a predefined list similar to the list provided by POC02 field of EDI 865 Purchase Order Acknowledgment.

****The invention provides an enhancement to include a LineItemStatusCode fundamental business data entity as part of 3A8 Purchase Order Change Confirmation. This will follow the same entity instance provided by ACK01.

The invention provides a tool to match codes if there is inconsistency between POC05—Unit of Measure Code and 231—GlobalProductUnitofMeasureCode. The GlobalProductUnitofMeasureCode extracts the entity instance from a predefined list of unit of measure codes found, maintained, stored and updated in the invention's database.

EDI: 860 Purchase Order Change

RosettaNet: 3A9 Purchase Order Cancellation Request

The invention provides an enhancement where the GlobalDocumentFunctionCode contains an entity instance. Such entity instance includes but not limited to Quote Request, Quote Confirmation, Purchase Order, Purchase Order Confirmation, Purchase Order Acknowledge, Ship Notice, Purchase Order Change, Purchase Order Change Acknowledgment, Purchase Order Cancellation Request, Purchase Order Cancellation Confirmation, Invoice and Payment Order. The entity instance is automatically determined and assigned during the extraction of data from EBA and EDI data.

The invention classifies the document as part of the Purchase Order Cancellation Request list when it finds that Line 13—GlobalDocumentFunctionCode is equal to Purchase Order Cancellation Request.

The invention determines the most recent and updated quote request based on Line 17—RevisionNumber. All revisions with updates/changes will be stored by the invention for listing and report purpose.

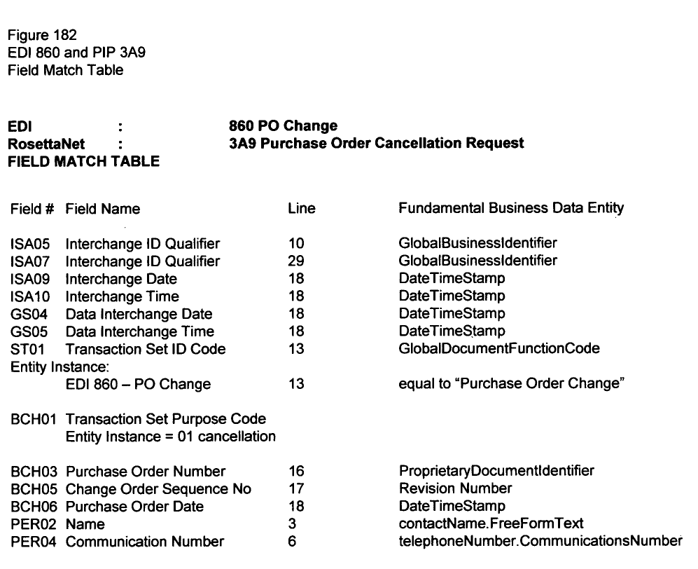

One of the major capabilities of the invention is to match EDI fields with RosettaNet's fundamental business data entity as provided in FIG. 182. Therefore, this translates the EDI data into Rosettanet data if ever companies want to convert their EDI transactions into Rosettanet based transaction.

The invention automatically selects 3A9 Purchase Order Cancellation Request when the BCH01 flag is set to 01—cancellation as the entity instance.

EDI: 860 Purchase Order Change

RosettaNet: 3A9 Purchase Order Cancellation Confirmation

The invention provides an enhancement wherein the GlobalDocumentFunctionCode will contain an entity instance. Such entity instance includes but not limited to Quote Request, Quote Confirmation, Purchase Order, Purchase Order Confirmation, Purchase Order Acknowledge, Ship Notice, Purchase Order Change, Purchase Order Change Acknowledgment, Purchase Order Cancellation Request, Purchase Order Cancellation Confirmation, Invoice and Payment Order. The entity instance is automatically determined and assigned during the extraction of data from EBA and EDI data.

The invention classifies the document as part of the Purchase Order Cancellation Confirmation list when it finds that Line 13—GlobalDocumentFunctionCode is equal to Purchase Order Cancellation Confirmation.

The invention determines the most recent and updated quote request based on Line 18—RevisionNumber. All revisions with updates/changes will be stored by the invention for listing and report purpose.

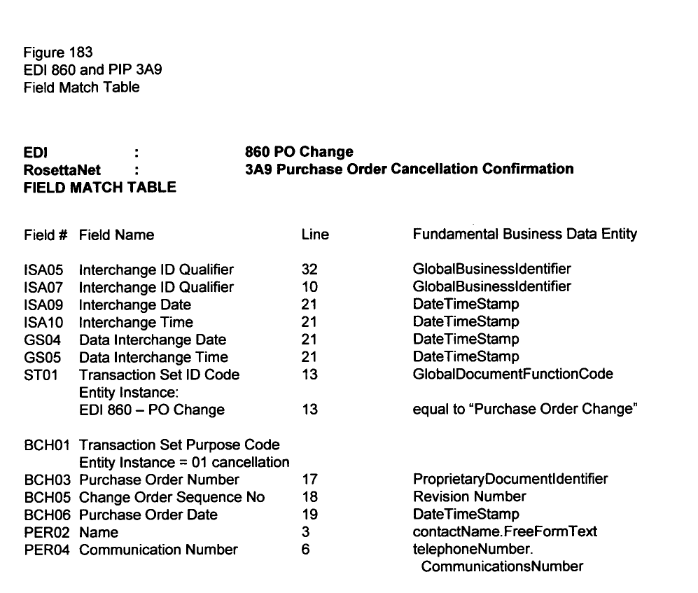

One of the major capabilities of the invention is to match EDI fields with RosettaNet's fundamental business data entity as provided in FIG. 183. Therefore, this translates the EDI data into Rosettanet data if ever companies want to convert their EDI transactions into Rosettanet based transaction.

The invention will automatically select 3A9 Purchase Order Cancellation Request when the BCH01 flag is set to 01—cancellation as the entity instance.

EDI: 856 Ship Notice

RosettaNet: 3B2 Advance Shipment Notification

The invention provides an enhancement where the GlobalDocumentFunctionCode contains an entity instance. Such entity instance includes but not limited to Quote Request, Quote Confirmation, Purchase Order, Purchase Order Confirmation, Purchase Order Acknowledge, Ship Notice, Purchase Order Change, Purchase Order Change Acknowledgment, Purchase Order Cancellation Request, Purchase Order Cancellation Confirmation, Invoice and Payment Order. The entity instance is automatically determined and assigned during the extraction of data from EBA and EDI data.

The invention classifies the document as part of the Ship Notice when it finds that Line 239—GlobalDocumentFunctionCode is equal to Ship Notice.

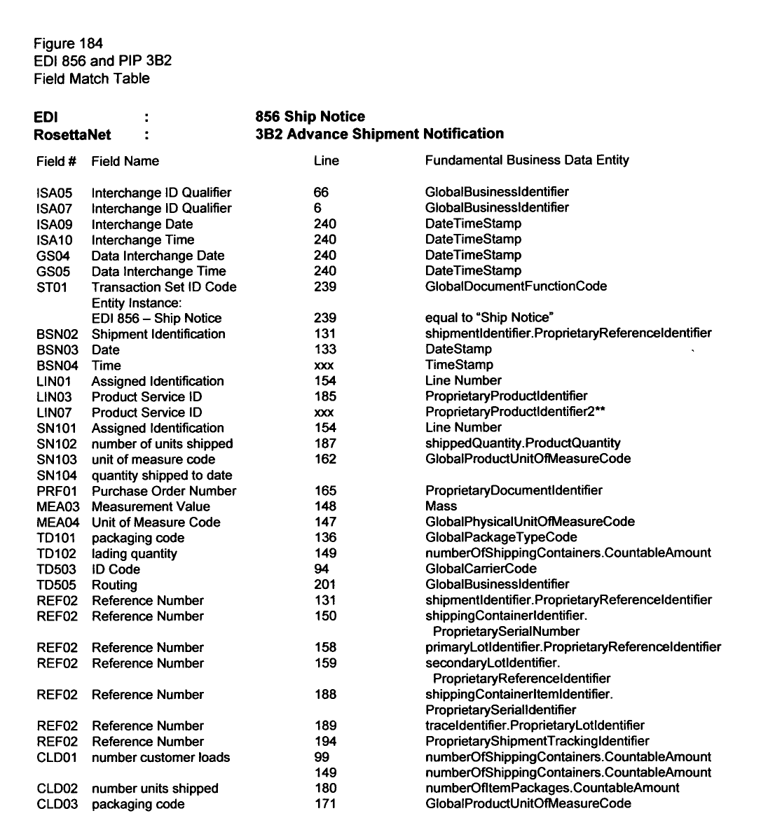

One of the major capabilities of the invention is to match EDI fields with RosettaNet's fundamental business data entity as provided in FIG. 184. Therefore, this translates the EDI data into Rosettanet data if ever companies want to convert their EDI transactions into Rosettanet based transaction.

**The seller defined item code found on LIN07—Product Service ID is stored in the ProprietaryProductIdentifier2 that was defined and claimed by the invention as an additional fundamental business data entity in the Rosettanet PIP.

EDI: 810 Invoice

RosettaNet: 3C3 Invoice Notification

The invention provides an enhancement where the GlobalDocumentFunctionCode contains an entity instance. Such entity instance includes but not limited to Quote Request, Quote Confirmation, Purchase Order, Purchase Order Confirmation, Purchase Order Acknowledge, Ship Notice, Purchase Order Change, Purchase Order Change Acknowledgment, Purchase Order Cancellation Request, Purchase Order Cancellation Confirmation, Invoice and Payment Order. The entity instance is automatically determined and assigned during the extraction of data from EBA and EDI data.

The invention classifies the document as part of the Invoice list when it finds at Line 13—GlobalDocumentFunctionCode is equal to Invoice.

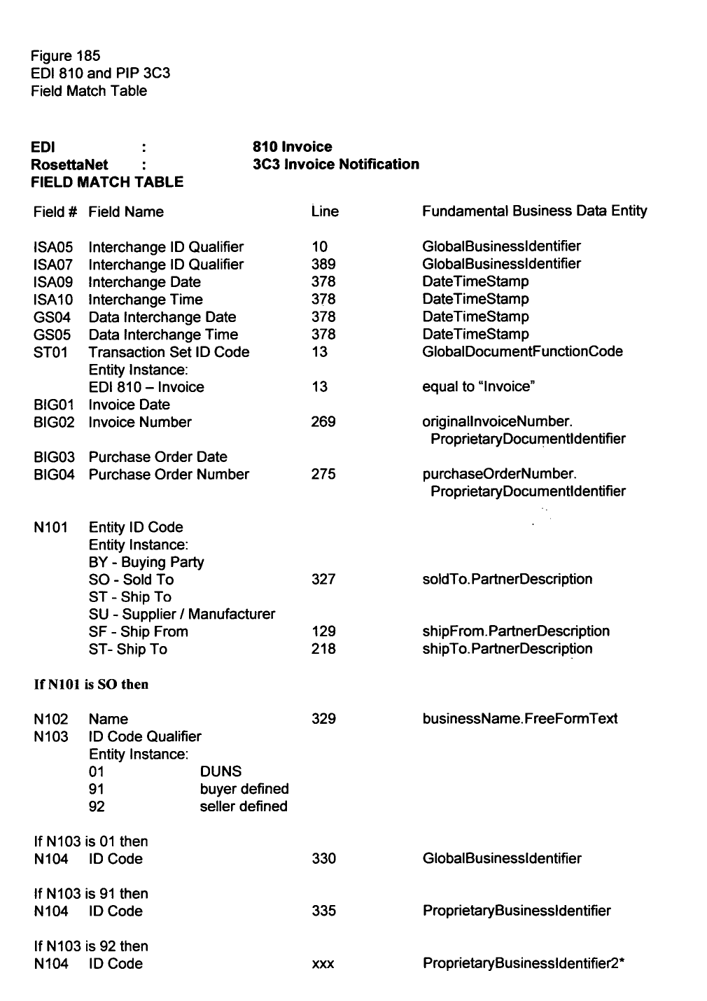

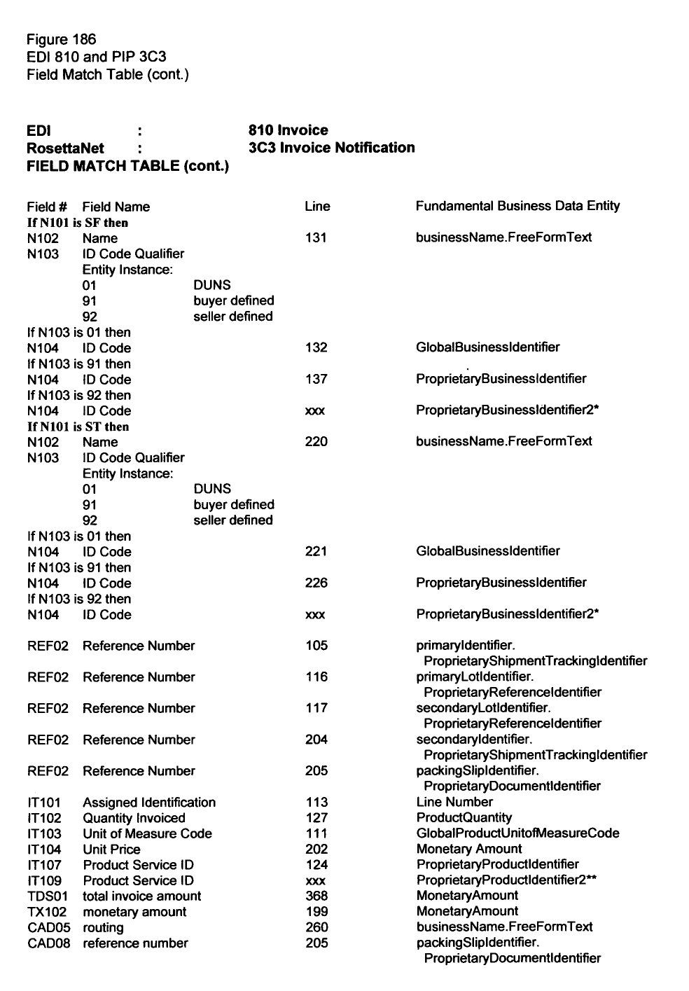

One of the major capabilities of the invention is to match EDI fields with RosettaNet's fundamental business data entity as provided in FIGS. 185 and 186. Therefore, this translates the EDI data into Rosettanet data if ever companies want to convert their EDI transactions into Rosettanet based transaction.

*The seller defined company code found on N104—id code is stored in the ProprietaryBusinessIdentifier2 that was defined and claimed by the invention as an additional fundamental business data entity in the Rosettanet PIP.

**The seller defined item code found on IT109—Product Service ID is stored in the ProprietaryProductIdentifier2 that was defined and claimed by the invention as an additional fundamental business data entity in the Rosettanet PIP.

EDI: 820 Payment Order

RosettaNet: 3C6 Remittance Advice Notification

The invention provides an enhancement where the GlobalDocumentFunctionCode contains an entity instance. Such entity instance includes but not limited to Quote Request, Quote Confirmation, Purchase Order, Purchase Order Confirmation, Purchase Order Acknowledge, Ship Notice, Purchase Order Change, Purchase Order Change Acknowledgment, Purchase Order Cancellation Request, Purchase Order Cancellation Confirmation, Invoice and Payment Order. The entity instance is automatically determined and assigned during the extraction of data from EBA and EDI data.

The invention classifies the document as part of the Payment Order list when it finds that Line 13—GlobalDocumentFunctionCode is equal to Payment Order.

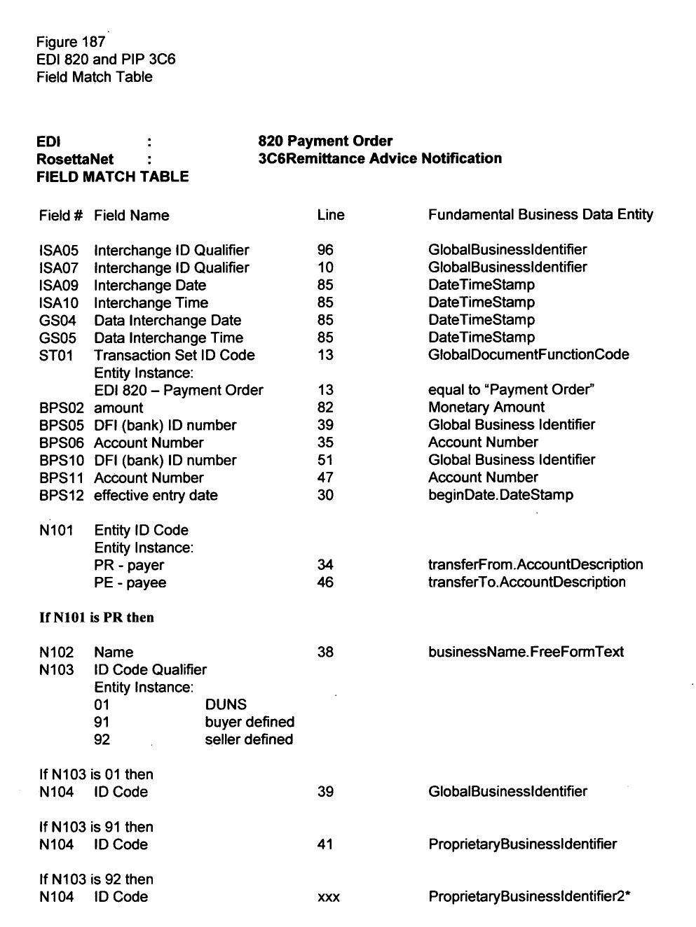

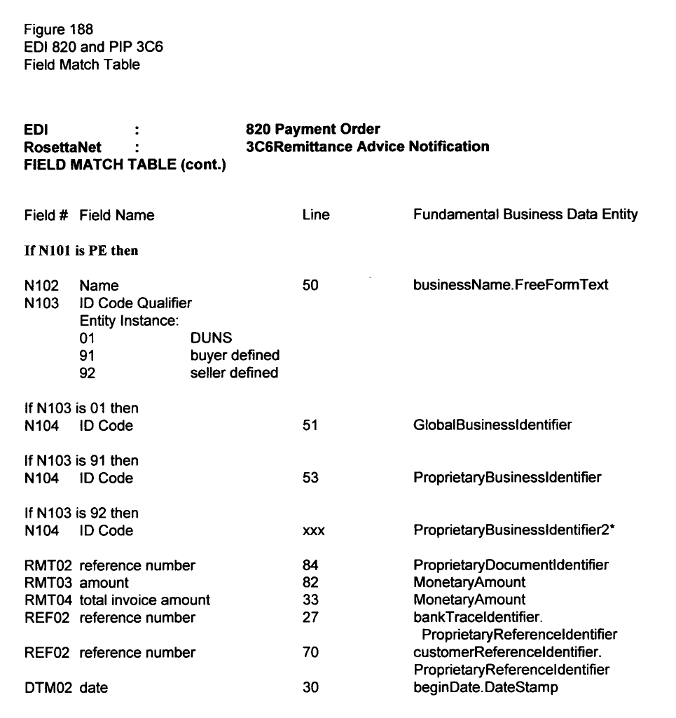

One of the major capabilities of the invention is to match EDI fields with RosettaNet's fundamental business data entity as provided in FIGS. 187 and 188. Therefore, this translates the EDI data into Rosettanet data if ever companies want to convert their EDI transactions into Rosettanet based transaction.

*The seller defined company code found on N104—id code is stored in the ProprietaryBusinessIdentifier2 that was defined and claimed by the invention as an additional fundamental business data entity in the Rosettanet PIP.

5. Sourcing/Offering of Products/Services

Sourcing and buying processes are captured by RFQ and Response to RFQ documents. Therefore, we will limit our discussion on how existing EBAs handle these RFQ related processes and the improvements to be provided by the invention.

A simple buyer's EBA (without MPN support) can prepare a request for quotation by simply selecting sources of supply. If there are existing suppliers, the buyer creates an RFQ and the EBA automatically suggest sources of supply from its supplier database. The buyer selects from this list. The RFQ captures all selected suppliers. This simple EBA prints an RFQ with the buyer defined supplier code on the RFQ header and the buyer defined item codes on the RFQ details.

The potential supplier receives the RFQ. The potential supplier's first task is to match the buyer defined item codes with their (supplier) defined item codes. Afterwards, the supplier prints and sends their response (accomplished RFQ) back to the buyer.

It is impossible to electronic transmit these documents if the supplier and buyer EBAs are not capable of supporting alternate item code definitions. There is no way that these simple EBAs can automatically say that this buyer defined item code is same as the supplier defined item code. At the very least, buyer's EBA should support the manufacturer part number (MPN) maintenance. If not, at least the seller's EBA should support the customer part number (CPN) maintenance.

Also, it will be impossible to electronically transmit these documents if both EBAs are not capable of matching the buyer defined and seller defined buyer and seller company codes.

The invention addresses this limitation by providing a functionality to store and match these item codes and company codes within the invention's engine. These codes are electronically sent and stored in the invention via XML over Internet.

A detailed explanation on the invention's capability to address these limitations is covered in SECTION 3 of the detailed description of the invention.

Because of the invention's capability to match these codes, it is now possible for the invention to provide the functionality where electronic RFQ and response documents are transmitted electronically via XML over Internet in a seamless and bidirectional fashion. Also, the electronic transmission can be expanded to cover one buyer to one seller, one buyer to multiple sellers, one seller to multiple buyer and multiple buyers to multiple sellers. The invention covers point-to-point and many-to-many business partner and document related transactions. Also, the process of electronic sourcing and offering of products and services in a seamless and bidirectional fashion is made possible by the invention. This will be discussed below.

Every time that a buyer's EBA (with or without MPN support) prepares an RFQ and sends it via the invention, the invention extracts all item codes and company codes and stores this in the invention. For buyer's EBA without MPN support, the invention gets the buyer defined item code with the item code description. The invention detects if the receiving party or the potential seller's EBA has a CPN support or not. If there is no CPN support, the matching is done via the invention. The invention extracts all seller defined item codes with corresponding descriptions during the registration process and stores it in the invention. The invention provides an intelligent search capability where item descriptions of buyer and seller defined item codes is matched. The result is a list of item codes with descriptions. This list is ranked based on the closest match. The seller selects and confirms the match by flagging with a check mark via the invention. Therefore, the seller is not required to enhance its EBA to include CPN support because the invention provides this functionality.

This process is simplified if either the buyer's EBA supports manufacturer part numbers (MPN) or the seller's EBA supports customer part number (CPN). If this is the case; the invention extracts the MPN and buyer defined code for buyer's EBA with MPN support and considers these codes as matched. Likewise, the invention extracts CPN and seller defined item code for seller's EBA with CPN support and considers these codes as matched. These codes are stored in the invention.

The invention provides the functionality to match company codes so that electronic transmission is possible. This was discussed in detail under SECTION 3 of the detailed description of the invention.

Now it is already dear on how these codes are matched and stored in the invention. We can already discuss how strategic sourcing and offering of products and services are done electronically using the invention. But before we discuss the invention's capability, let's take a look on the limitations of existing systems.

During the last 5 years, companies saw the need to use Internet as a medium to conduct business due to the success of business to consumer (B2C) catalogue and auction sites such as amazon.com, ebay.com and thousands of other similar sites. Technology companies saw the opportunity to provide an Internet based business-to-business (B2B) software so that companies can conduct business over the Internet. These softwares were implemented to become either a digital or electronic marketplaces, web based electronic auction systems or electronic catalogues. The objective of these companies using these technologies was to conduct business-to-business transactions over the Internet.

We saw a gap in the existing technology and on how these companies use this technology. The existing technology is not capable of matching item codes, which is a main requirement to allow the seamless and bidirectional transmission of electronic documents. That's why these businesses focused on maintenance, repair and operating (MRO) items or simply called expense items. Why? It is because MRO items are maintained in EBAs as expense items and do not require item code matching and maintenance on the buyer's perspective. There was no development to improve this thru matching of codes.

Companies also saw the opportunity for strategic sourcing of direct materials over the Internet because they believe that the Internet can be a good medium to invite as a many suppliers as it can. Existing technology provided an Internet based auction and reverse auction engines where buyers and sellers can conduct business. Again, this technology is not capable of matching item codes which is a main requirement to allow the seamless and bidirectional transmission of electronic documents.

Lastly, suppliers created Internet based catalog engines where potential buyers can view and buy their offerings. Again, this technology is not capable of matching item codes, which is a main requirement to allow the seamless and bidirectional transmission of electronic documents.

In summary, the essence of the business process was business to business in nature but the existing Internet based technology was still business to consumer in nature. We believe that existing technology can be classified as business to business in nature if it is capable of transmitting electronic documents in a seamless and bidirectional fashion with item codes, company codes and other proprietary codes being matched as the key to make it possible. The invention addresses this limitation.

As discussed, all item codes and company codes defined by buyers and sellers are matched and stored in the invention. GTIN and DUNS are also extracted, matched and stored by the invention as explained in SECTION 3 under the detail description of the invention.

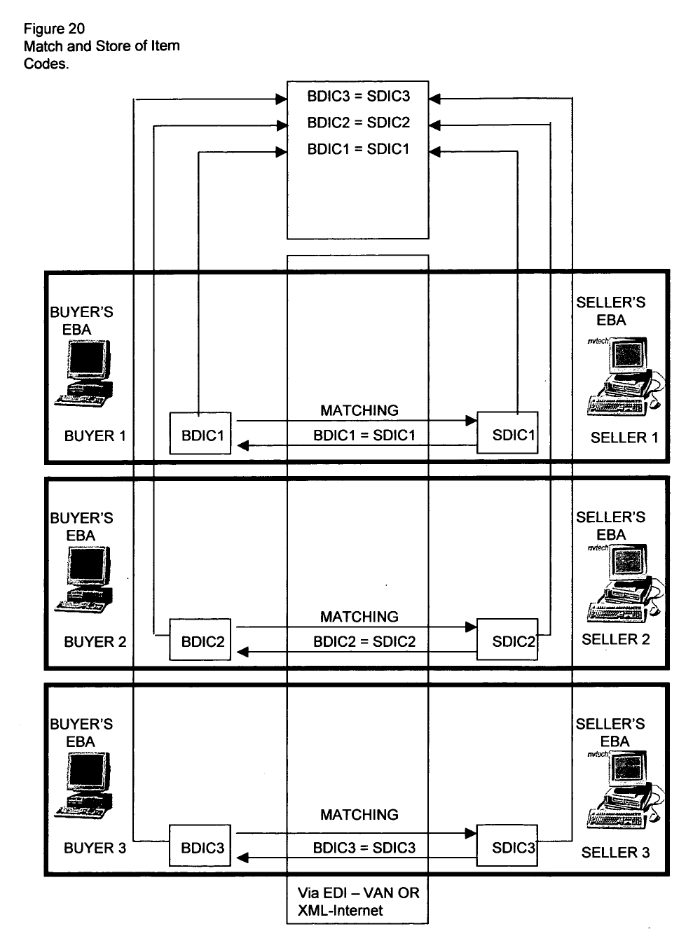

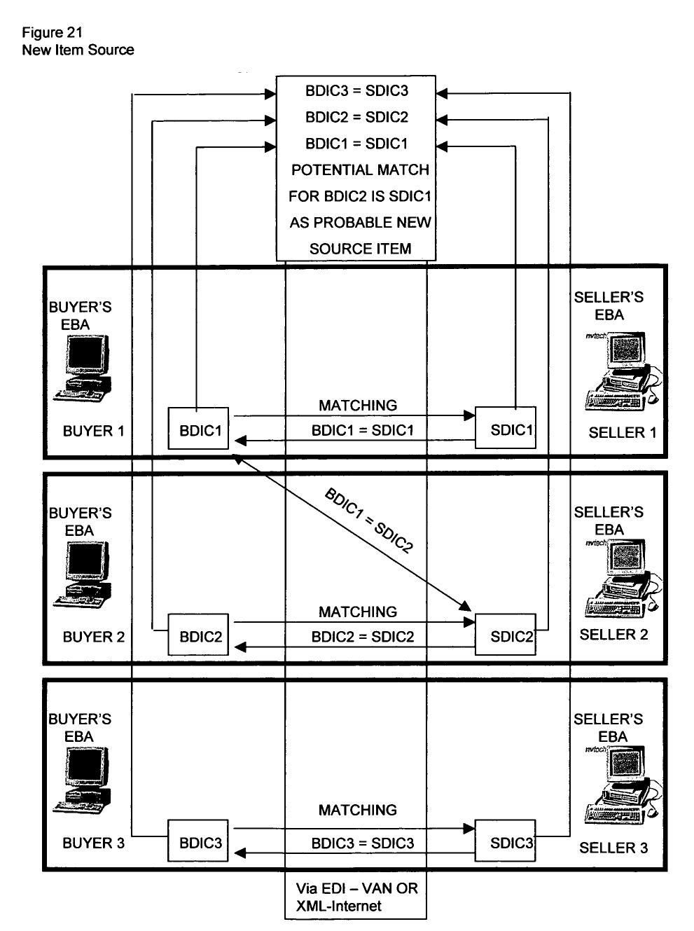

FIGS. 20 and 30 represent the figures on how item codes are matched and stored in the invention. FIG. 21 shows a scenario where the buyer1 defined item code 1 (BDIC1) is equal to seller1 defined item code 1 (SDIC1), buyer2 defined item code 2 (BDIC2) is equal to seller2 defined item code 2 (SDIC2) and buyer3 defined item code 3 (BDIC3) is equal to seller3 defined item code 3 (SDIC3). This is the scenario every time the buyer and seller conduct their business via the invention. These codes are extracted and stored by the invention during the registration and RFQ process. Due to the invention's capability to conduct one-to-many and many-to-many transactions, there is a high likelihood that a buyer gets its source from multiple suppliers. For example, buyer1 defined item code 1 (BDIC1) was found out be sourcing this item from another supplier which is seller 2 with seller2 defined item code 2 (SDIC2). Every time that the invention encounters this scenario, it will detect a possible match where there is a high likelihood that buyer2 defined item code 2 (BDIC2) can have seller1 defined item code 1 (SDIC1) as a potential supplier. The invention uses a simple mathematical formula to convert SDIC1 as potential source item for BDIC2. This will be stored in the invention. If the buyer wants a new source of supply, the invention retrieves this data and provides a listing of all candidates with their respective item codes and descriptions. The invention provides an accreditation process for all of these suppliers and only accredited and registered suppliers are listed. Otherwise, supplier offerings are flagged not to be included in the list. Also, the invention provides this functionality where buyers and suppliers are asked if they wanted to participate and register to avail this strategic sourcing/offering functionality.

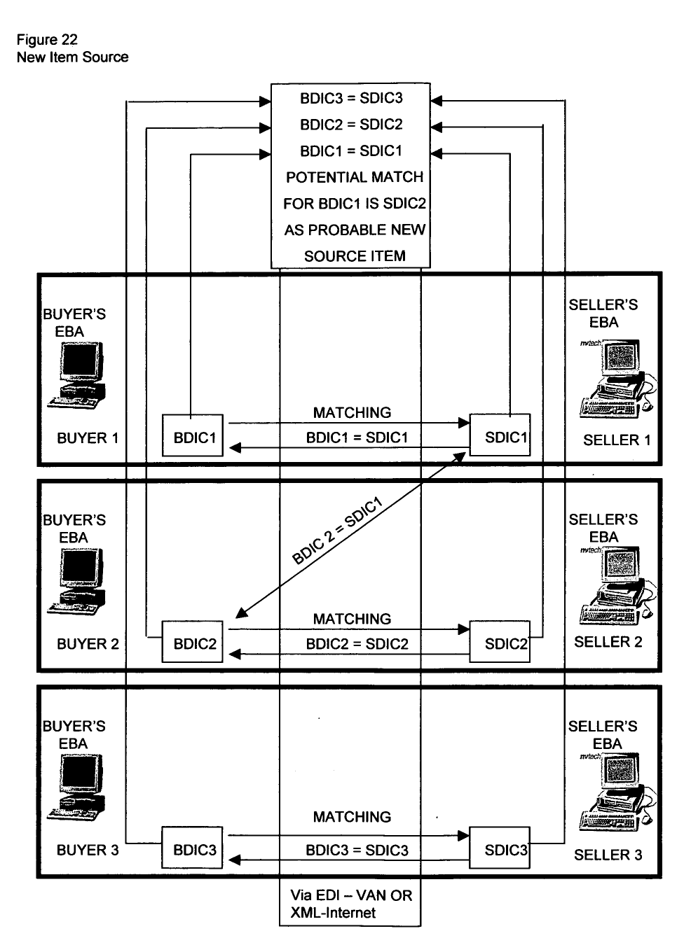

The same logic found on FIG. 21 is applied on FIG. 22.

The invention also asks the potential buyer if they will allow substitute products. If yes, the supplier is allowed to send a quotation with a different item code. This will be stored as a substitute product in the invention if the buyer accepts the quote with the substitute product.

The invention provides a prompt screen for the potential buyers if they want to include other supplier candidates. If yes, the list of suppliers with similar item codes and descriptions are provided. If marked yes by the potential buyer, a request for quotation is generated and transmitted to these suppliers via the invention.

The same is applicable to suppliers, the invention provides a prompt screen for sellers if they want to see all potential buyers whether these buyers are previous customers or not. If yes, a list of potential buyers with similar item codes and descriptions are provided. If marked yes by the supplier, a sales quote is generated and transmitted to these potential buyers via the invention.

The invention provides a functionality to activate and disabled this. The potential buyer has an option to selectively block a list of suppliers they don't want, block a list of suppliers without accreditation, block a list of suppliers within the blacklist or simply block all suppliers if not part of source of supply.

Likewise, the supplier has an option not to send a sales quote to buyers with bad history (delayed payments, etc.).

Because of this functionality, the invention can now provide an unlimited access to multiple buyers and sellers for strategic sourcing and offering of multiple products and services over the Internet where electronic documents are transmitted in a seamless and bidirectional fashion.

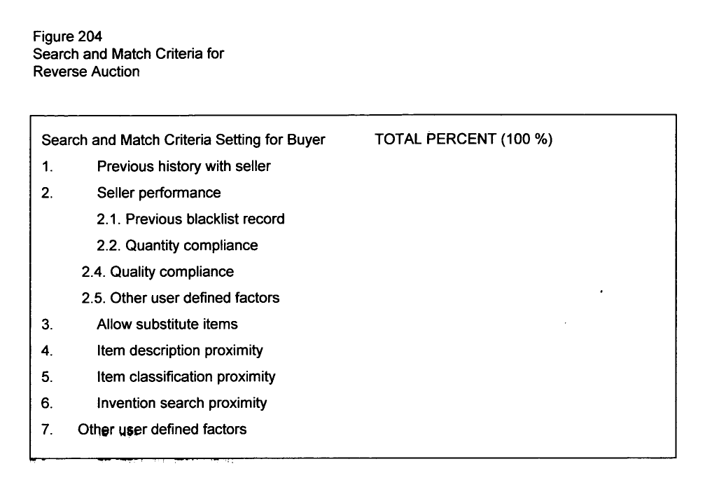

If the buyer wanted to see list of potential suppliers, the invention will list all potential suppliers with item offerings based on search and match criterions listed on FIG. 204. These criterions and percent allocation are configurable and predefined by the buyer.

The first criterion found on FIG. 204 determines if there is already an existing or previous history between the buyer and seller. Of course, if the buyer prefers suppliers with previous business engagement, there is a high likelihood that they will make this as one of the major factors by increasing the percent allocation. If buyers prefer new sources, they can modify the percent allocation to be lesser that the previously defined percent allocation.

The second criterion determines the supplier performance. This factor is the equalizer for the first criterion. Suppliers with poor performance are negated by this criterion. If buyers wanted to filter all non-performing suppliers, they will increase the percent allocation of this one. Some EBAs have the capability to automatically compute the supplier performance. The invention provides a conversion mechanism to allow these supplier performance data to be extracted from the buyers EBA. The invention allows these converted data to be purely extracted without modification or allow extracted data to be edited, calculated or processed further by the invention.

The third criterion determines the percent weight of substitution items. This is a simple defined criterion. If the buyer is having difficulty in finding a perfect item, then they will increase the percent allocation of this criterion. Also, the invention will mandate this criterion if it detects a yes in “isSubstituteProductAcceptable.AffirmationIndicator”, a fundamental business data entity that is described in the previous section of this detailed description of the invention. If this is detected as no, then the default percent is 0% in this criterion.

The fourth criterion determines the item description proximity. The invention will conduct an extensive search of items based on description and will list all items based on proximity of descriptions. The technology to be used here is similar to current search engines available over the Internet. The invention will not make a claim on this search methodology but will make a claim on the usage of this technology for application to the strategic sourcing functionality.

The fifth criterion detects the similarity on classification. The fourth criterion depends on this so that searching of results for the fourth criterion is limited to the items based on proximity of classification.

The sixth criterion detects similarly offered/sourced products. This criterion is based on the concept we defined on FIGS. 21 and 22 and as discussed in the earlier portion of this section. This is one of the main highlights of the invention.

The seventh portion allows the buyer to select a criterion based on a predefined list provided by the invention. Also, the invention provides a prompt to allow users to introduce new criterions as well if they see that the existing list is not sufficient.

The authorized buyer predefines the percent allocation for all of these criterions.

The invention provides a prompt if the potential buyer wanted their items (to be procured) to be published in the private and public reverse auction area of the invention. This process happens before a request for quotation (RFQ) can be issued since there is no defined and confirmed supplier yet when the buyer published their requirements via the reverse auction area of the invention. If flagged yes in the private reverse auction area, all registered suppliers in the invention are allowed to view the private reverse auction area. If flagged yes in the public reverse auction area, all registered and non-registered suppliers are allowed access to the item.

This works in the same way for suppliers/sellers if they wanted to list their offerings via the private and public auction area of the invention. This process happens before a sales quote (SQ) can be issued since there is no confirmed interested buyer yet when the supplier or seller published their requirements via the auction area of the invention. The invention provides a prompt if the supplier or seller wanted their items (to be offered) to be published in the private and public auction area of the invention. If flagged yes in the private auction area, all registered buyers in the invention are allowed to view this private auction area. If flagged yes in the public auction area, all registered and non-registered buyers are allowed access to the item.

The invention provides functionality where the buyer can search candidate suppliers for the item they intend to buy before they process the item to take part in the reverse auction. The same criterion found on FIG. 204 is applied.

This works in the same manner for sellers. The invention provides functionality where the seller can search candidate buyers for the item they intend to sell before they process the item to take part in the auction. The same criterion found on FIG. 204 is applied.

If it is a new item to be offered by the supplier, the invention will conduct a search of all items from all potential buyers based on criterions found on FIG. 204. If it is time based, it will list the items based on urgency of requirement. In short, items that are currently sourced by buyers are listed on top of priority. Items without any pending or current requirements are listed as non-priority sources. The list will be displayed to the supplier for flagging. If the seller flag yes, a sales quote is generated and sent to the potential buyer if there is a current requirement. If there is no current requirement, the invention will just store the match for future activation if the invention sees that the buyer is triggering an urgent requirement to source this item via RFQ or reverse auction. The potential buyer has an option to activate this functionality where it will suggest the source list where sellers triggered a match for these items without any pending or current requirements to be included in the RFQ supplier candidate listing on top of the source of supply listing. Also, the potential buyer has an option to activate this functionality where the invention will suggest potential sources before it conducts a reverse auction. If no, there will be no activity.

These processes are applicable to EDI and EBA based systems with or without Rosettanet support.

6. Electronic Documents Processing

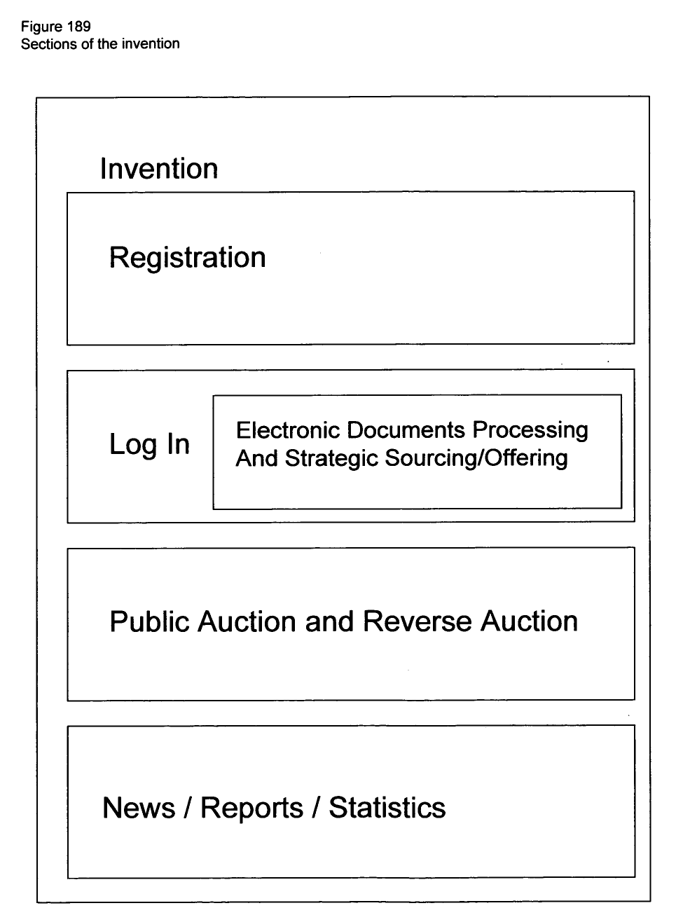

The invention provides an Internet site where it is composed of four major sections which are: 1) registration, 2) log in area, 3) public auction and reverse auction and 4) news/reports/statistics. This is illustrated in FIG. 189.

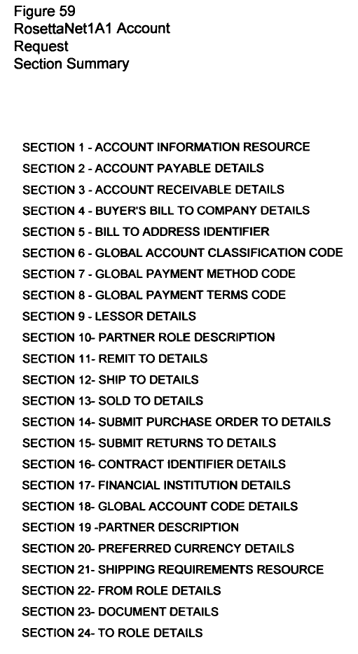

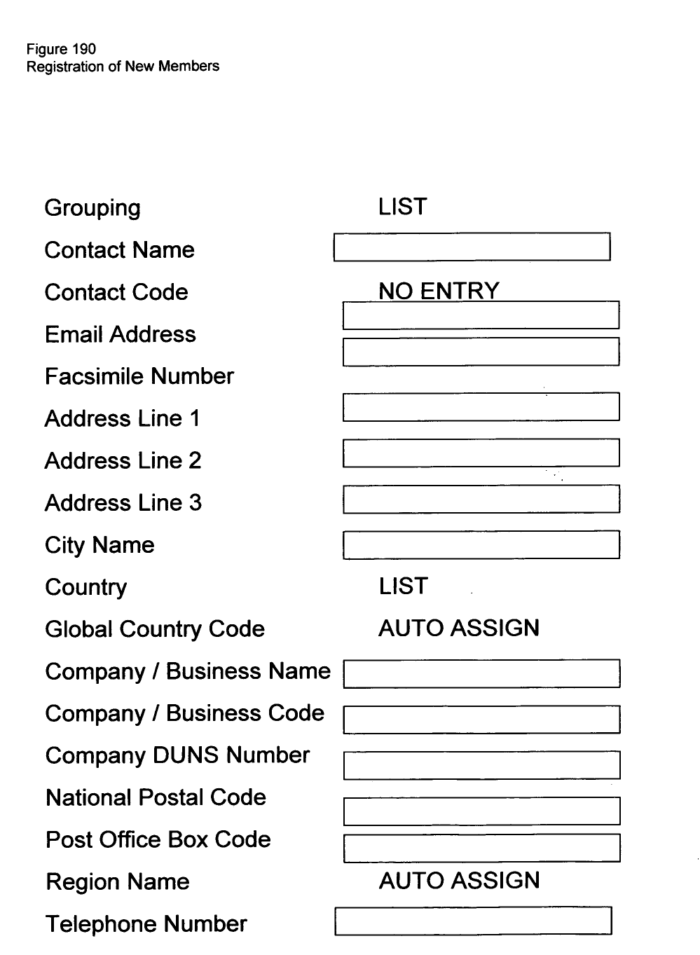

The registration area is where new members fill up a registration form. This is where simple to a complex registration process is conducted. The simple registration allows the new members to simply gain access to the invention without the need to interface their EBAs to the invention. The registration data as provided in FIG. 190 must be completed. Take note that the invention disallows any entry on the contact code. This will be activated if the invention is interfaced to the user's EBA. If the invention is interfaced on EBA, the registration will extract the relevant registration data found on FIG. 190 using Rosettanet's PIP 1A1—Account Set up as defined in FIGS. 47-59. The grouping field found on FIG. 190 provides a list of user classification. If the new member enters an “administrator” grouping code, then a second is screen is provided to the new administrator.

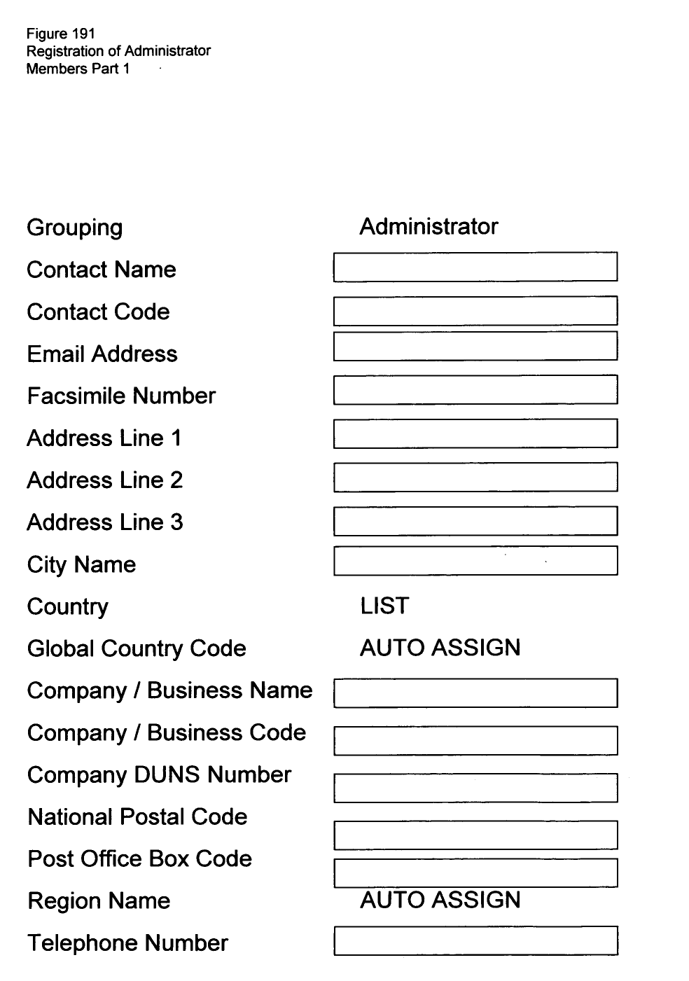

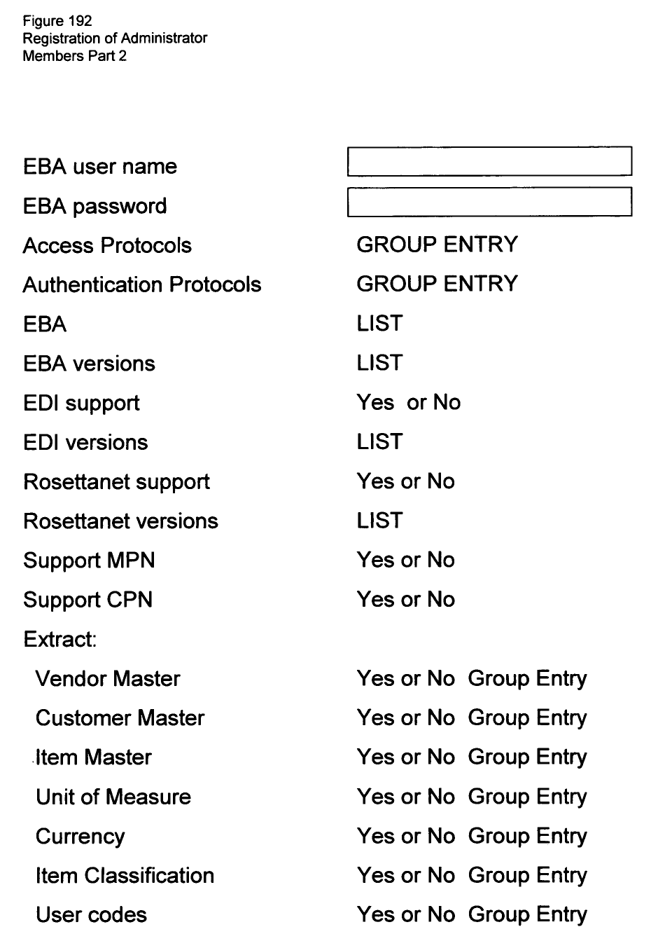

FIGS. 191 and 192 provide the registration screen where the administrator is required to accomplish. FIG. 192 represents the additional data required from the administrator. The invention provides a prompt where the administrator enters the user name and password required as a first step to gain access to the EBA to be interfaced. Access and authentication protocols are required so that the EBA can be readily interfaced to the invention. The invention provides a predefined screen for the set up of these protocols. The administrator is also asked to select the suitable EBA name and EBA versions. The administrator needs to answer whether their EBA support MPN, CPN, Rosettanet or EDI. These questions determine the code to be activated by the invention for the extraction process.

On the EBA side, the invention also provides an interface software program where the administrator is also required to fill up the access and authentication protocols of the invention. At this point, both the invention and EBA access and authentication protocols are addressed therefore both systems are ready to talk or transmit data in a bidirectional way. Also, there is a prompt screen where the administrator is required to answer if it will allow their EBA to include the invention as another alternative for output media. Current output media includes: 1) local and network printing, 2) fax, 3) email or via 4) EDI. The prompt will allow the inclusion of the invention's internet site address as another alternative for electronic sending of business documents. For Request for Quotation (RFQ) and Sales Quote (SQ), there is an additional prompt where the user is asked if it will allow the sending of these documents on the public portion of the invention's auction and reverse auction area. If yes, it will display the RFQ and SQ product data on the invention's auction and reverse auction area where members and non-members are allowed to view and respond. This will allow the sending of RFQ and SQ product data without “send to business partner” details.

Afterwards, extraction of master records is already possible. Such master records include vendor master, customer master, item master, unit of measure, currency, company code, item classification and user codes. The administrator is allowed to extract: 1) all, 2) based on a time period when these records are created or 3) update records (records that are new or modified).

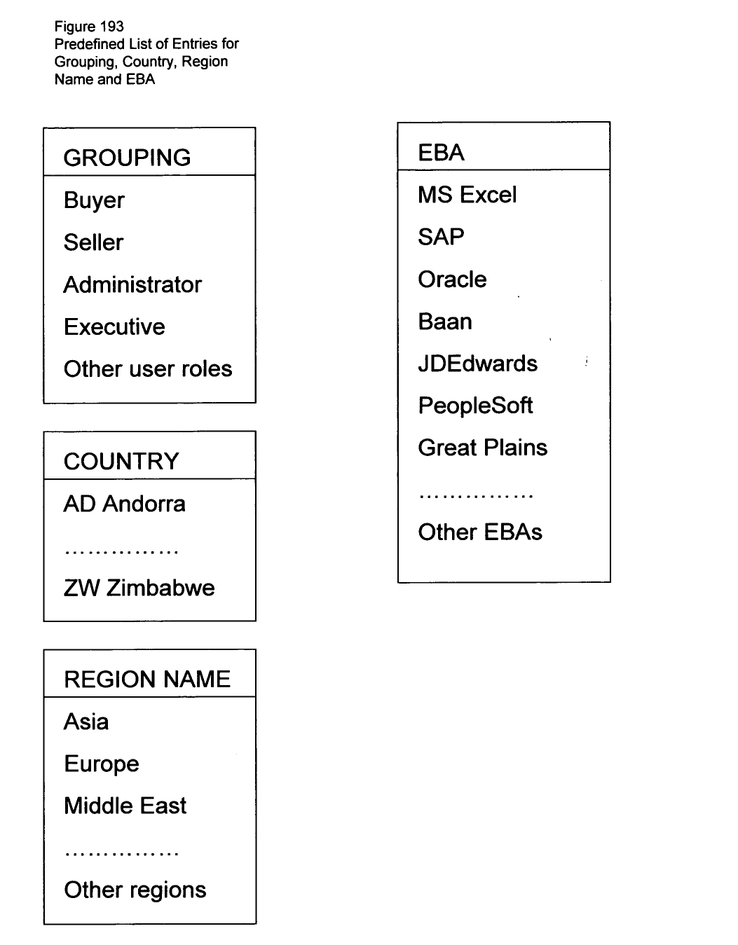

A sample list is provided in FIG. 193 where the user selects an entry from this predefined list.

The contact code found on the registration screen is activated when the invention detects that the administrator allowed the extraction of user codes. If this happens, the new users are allowed to encode their user code and password. Other data found on the registration form is filled up automatically by the invention.

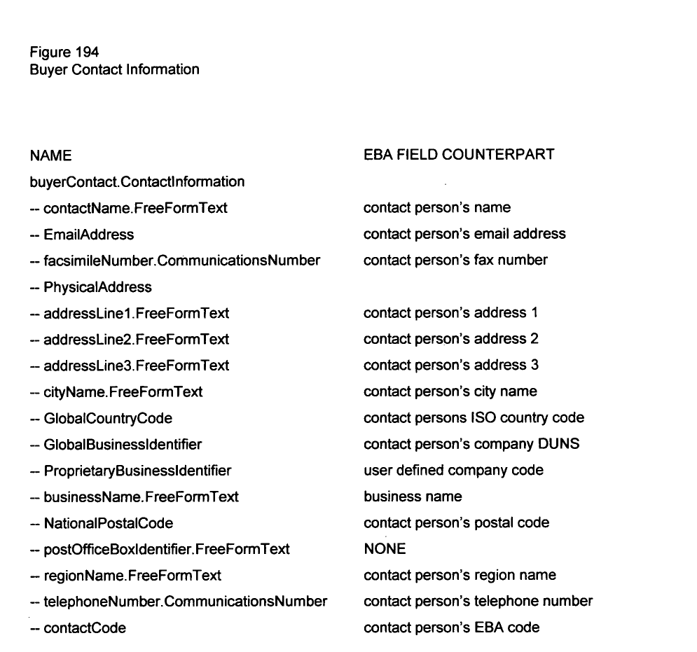

FIG. 194 represents the code to be used to extract EBA information on buyer contact details. These data are extracted via XML and captured by the invention on the buyer's registration information.

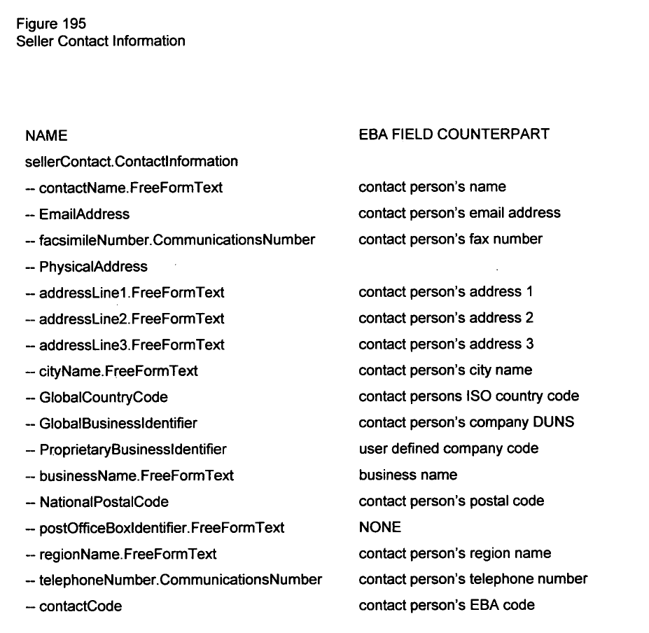

FIG. 195 represents the code to be used to extract EBA information on seller contact details. These data are extracted via XML and captured by the invention on the seller's registration information.

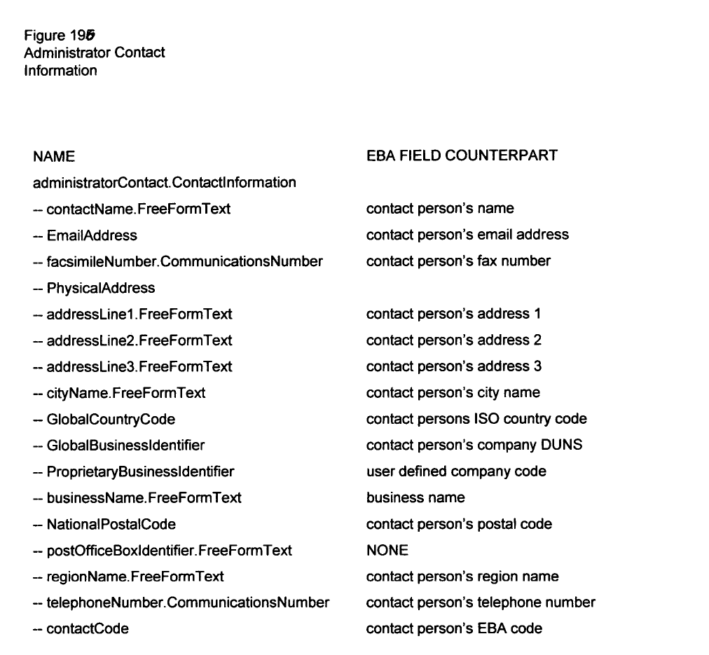

FIG. 196 represents the code to be used to extract EBA information on administrator contact details. These data are extracted via XML and captured by the invention on the administrator's registration information.

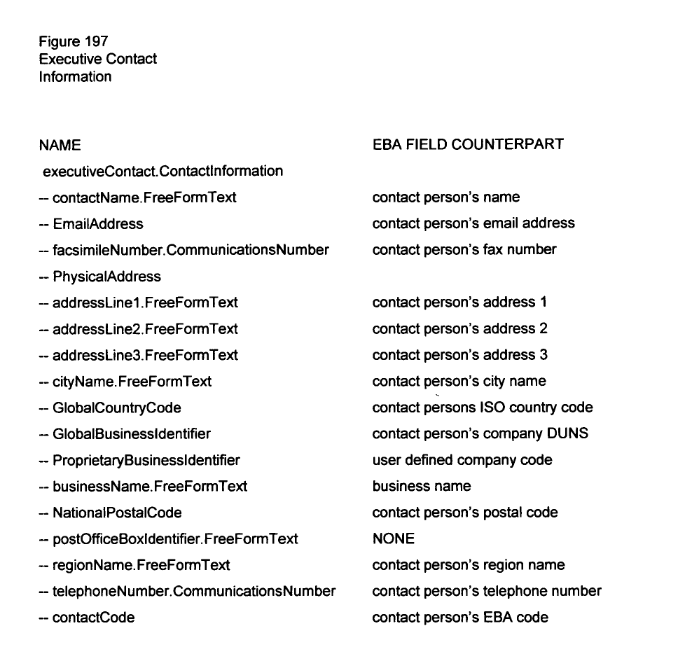

FIG. 197 represents the code to be used to extract EBA information on executive contact details. These data are extracted via XML and captured by the invention on the executive's registration information.

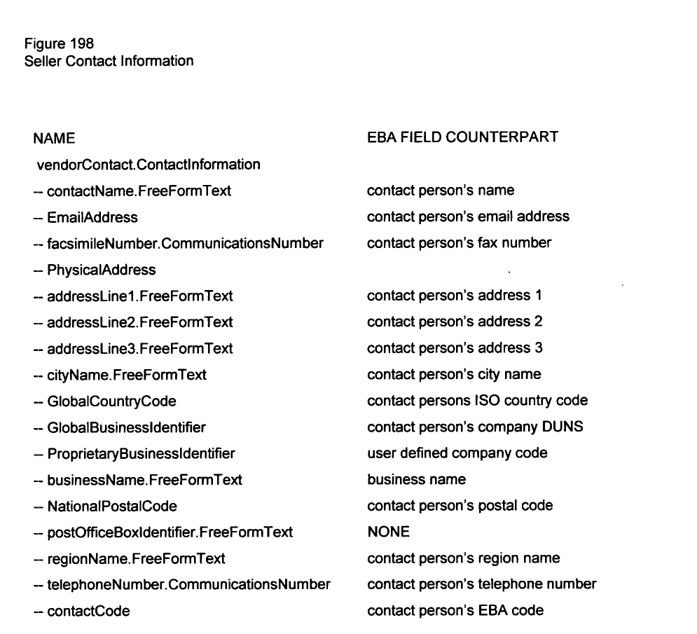

FIG. 198 represents the code to be used to extract EBA information on vendor contact details. These data are extracted via XML, captured by the invention and stored on vendor master records.

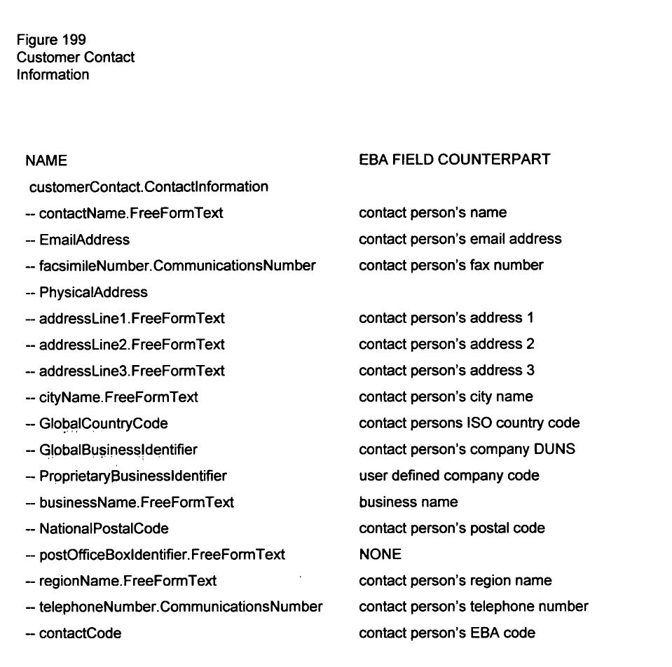

FIG. 199 represents the code to be used to extract EBA information on customer contact details. These data are extracted via XML, captured by the invention and stored on customer master records.

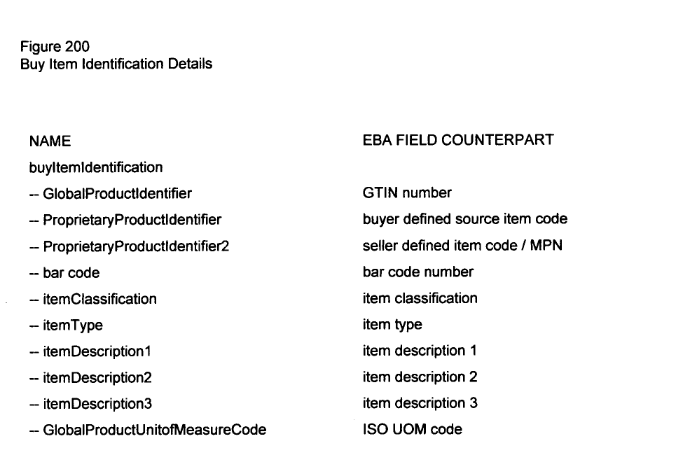

FIG. 200 represents the code to be used to extract EBA information on item master records for products and services to be bought by the company. These data are extracted via XML, captured by the invention and stored on buy item master records.

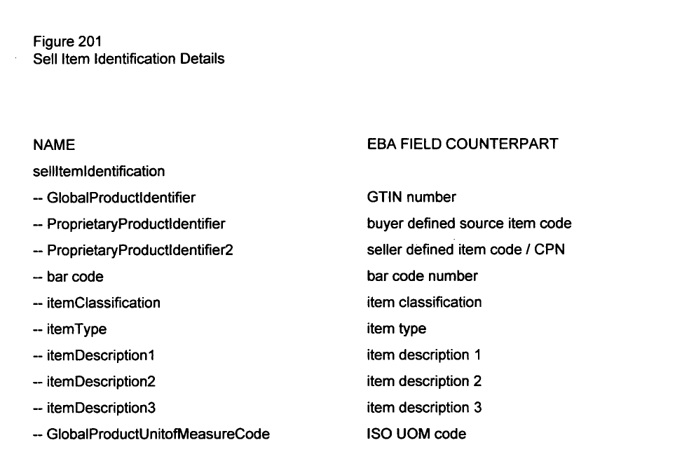

FIG. 201 represents the code to be used to extract EBA information on item master records for products and services to be sold by the company. These data are extracted via XML, captured by the invention and stored on sell item master records.

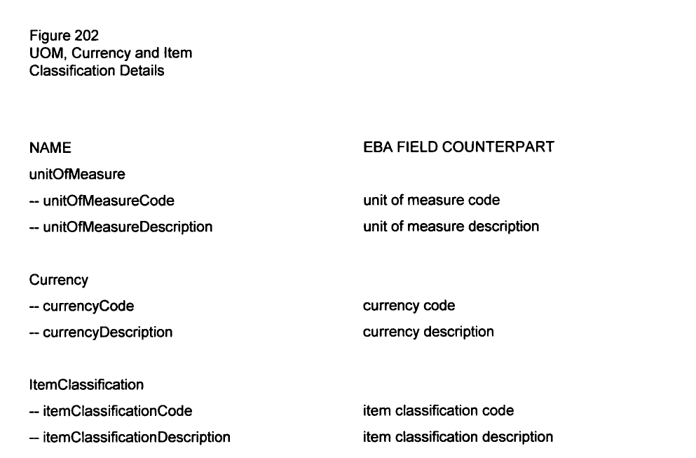

FIG. 202 represents the code to be used to extract EBA information on unit of measure, currency and item classification records. These data are extracted via XML, captured by the invention and stored on unit of measure, currency and item classification records.

These aforementioned extraction processes are based on batch uploads of EBA data during the registration process. These data are updated during transactional processing of the EBA with the invention.

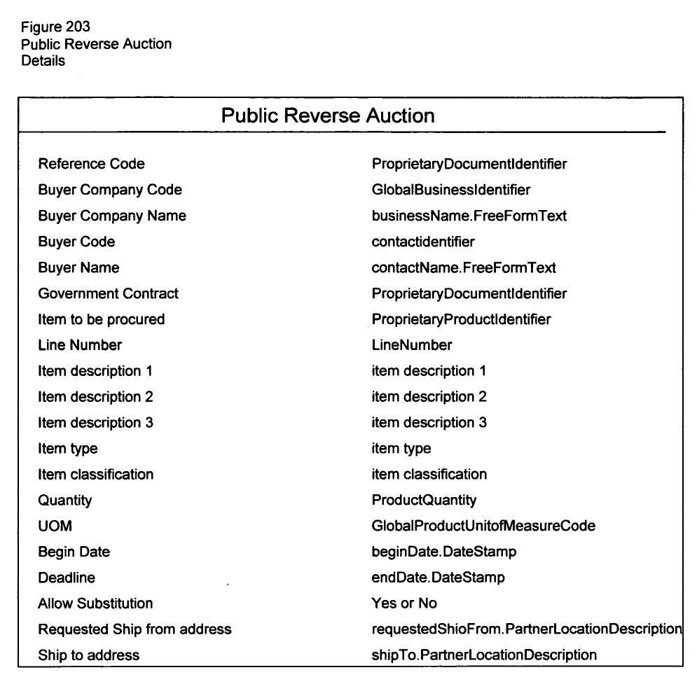

FIG. 203 represents the area where the approved for public listing via public reverse auction for request for quotations (RFQ) are published. These kinds of RFQs are declared valid for public reverse auction listing when the buyers prompt the invention to allow RFQs (without send to details) to be published on this reverse auction area. Member and non-member sellers can view this. The invention provides a prompt to buyers if they want to limit the viewing of their requirements to registered buyers of the invention or registered buyers allowed by the buying company instead of public viewing.

Potential sellers can search items requested by buyers listed on the reverse auction area of the invention in any field combination they prefer. There is also a key where the seller can confirm the search for possible matches. The calculation formulation for search proximity is based on the search and match criterions previously defined by buyers as illustrated on FIG. 204. The result includes a list of potential items to be supplied with corresponding search proximity in percent. Criterion 1 and 2 found on FIG. 204 can be derived from extracted data of EBAs supporting supplier performance evaluation. The invention allows mapping and extraction of these data from EBA into the invention. Criterion 1 and 2 are both activated for suppliers with previous business engagements with the buyer.

Criterion 3 is the determinant for the invention to allow the search of items based on criterion 4—item description search and criterion 5—item classification search. This can be viewed and ranked based on highest to lowest percent proximity. The invention will ask the potential sellers to confirm each product match. Upon confirmation, the proximity data is sent to the potential buyer. The search proximity based on criterion 4 and 5 is disabled for sellers or suppliers without sell item records uploaded in the invention.

Non-member companies are required register at the very least in the invention where contact details are entered.

Field details can be viewed using drill down functionality of the invention.

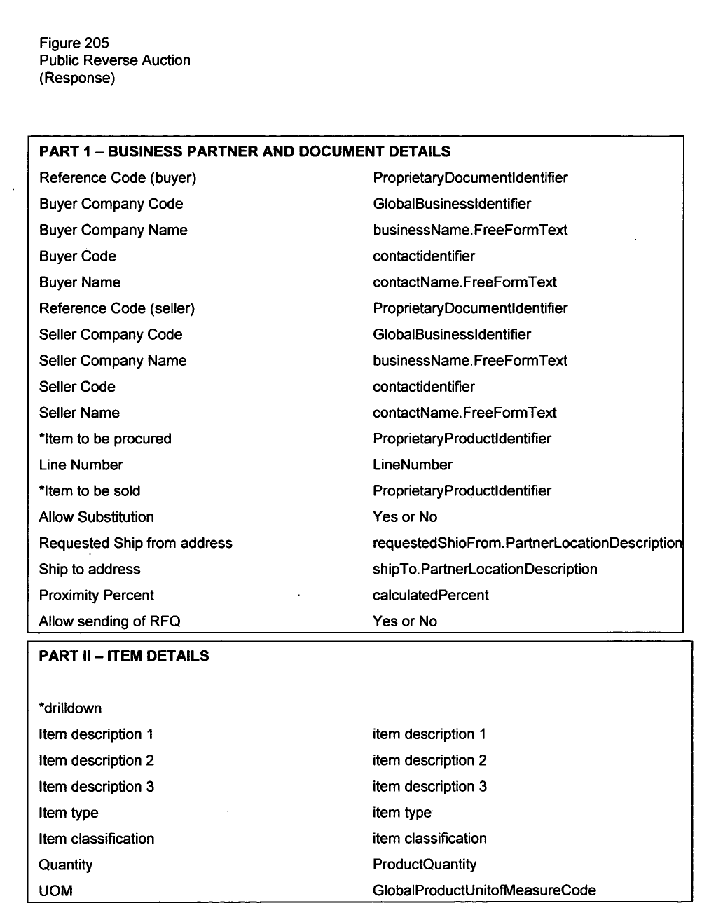

The potential buyer retrieves the proximity information for all responses. This can be sorted in any field that the potential buyer wish to sort. FIG. 205 illustrates the response. This can be best viewed when sorted on proximity percent where the highest proximity match is listed as number one. The proximity percent can be viewed in detail by double clicking it. After double clicking, the user can now see the detailed evaluation based on criteria found on FIG. 204. The user also has an option to simulate and modify the evaluation criteria based on the user's preference. Modifications are allowed such as revising the percent allocation, percent actual and introducing new criteria factors. These factors can be retrieved from a predefined list provided by the invention or the user can simply make a new criteria. After modifications, the user has an option to view the modified ranking list.

Most fields found on FIG. 205 are required to be filled up manually for non-member companies. At the very least, they should register their contact information. Item master upload is optional. If there is no item master data uploaded, these newly registered member companies are required to manually encode on the items to be procured and its *drilldown details.

Only the buyer is allowed access on the “allow sending of RFQ”. There is a yes/no radio button where the user is asked if it will allow sending of RFQ. If yes, EBAs are prompt to create RFQs for these suppliers. Afterwards, it will prompt the output media to be used. A prompt is already required on whether the buyer will close the public reverse auction or not. If not, then the cycle of selecting potential supplier based on proximity match repeats. If yes, it will not display the item in the public reverse auction. * represents the drilldown capability of the invention where details of item to be procured/sold are viewed.

The only difference between the public and the private reverse auction portion of the invention is that member companies are allowed to view and process their transactions via the private reverse auction portion while member and non-member companies are allowed to view and process their transactions via the public reverse auction area.

These reverse auction converted RFQs will be stored and viewed in the private access area of each buyer in the invention's internet site. All RFQs will have its respective RFQ number and seller code with seller description. These RFQ will be listed in the invention and transmitted electronically in the invention if the buyer selects the output media to be “via the invention”. The default status of the RFQ is “pending”. Sellers can view these RFQs limited only to those assigned to them.

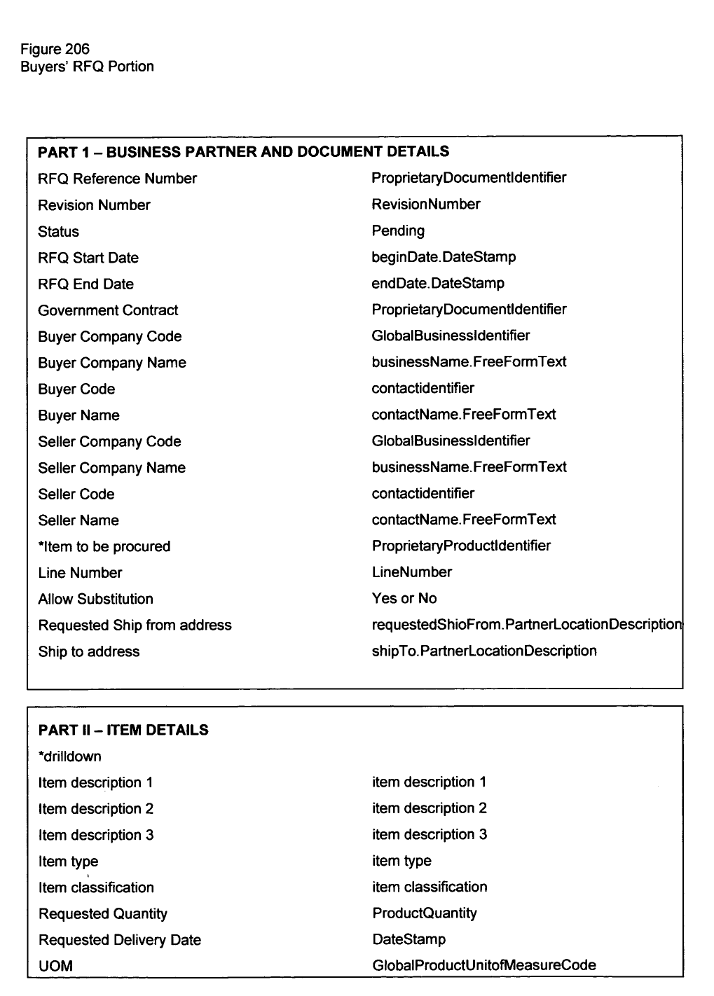

RFQs are listed on the buyer's private area for RFQs in the invention if RFQs are generated by the EBA using “via the invention” as the output media. FIG. 206 illustrates the fields displayed on the buyers' RFQ portion. This view is limited only to buyers assigned to process the RFQ. The buyer code is the validating field for the restricted view.

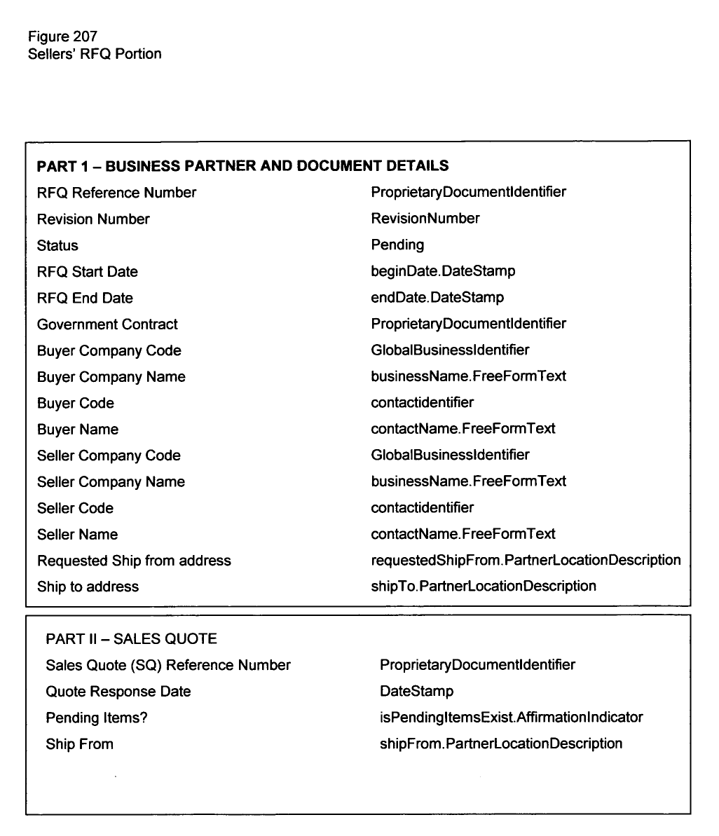

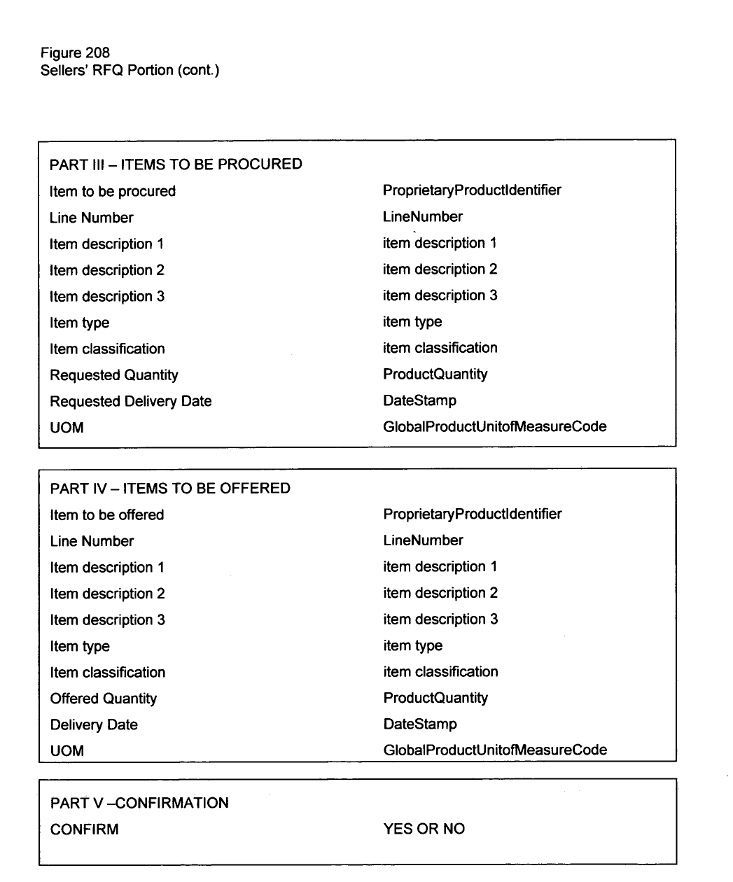

FIGS. 207 and 208 are the default RFQ logical screens for potential sellers. This view is limited to sellers assigned to process the RFQ. The seller code is the validating field for the restricted view.

PART 1 of FIG. 207 reflects data from buyer's RFQ. PART II of FIG. 207 and PART IV of FIG. 208 reflect data to be extracted from seller's RFQ. This is blank by default until the seller confirms the “allow extraction” to yes. If yes, buyer's RFQ data are transferred to seller's EBA. It will be processed into the EBA's Sales Quotation. Data from the accomplished sales quotation is transmitted to PART II and PART IV portion when seller defines the output media to “via the invention”.

PART III and IV of FIG. 208 reflect the item to be procured and offered compared side by side. Part IV—items to be offered of FIG. 208 will be automatically extracted from the Sales Quote (SQ) of seller's EBA. An internal validation mechanism is provided by the invention to check the item code match between “item to be procured” and “item to be offered”. Item descriptions are extracted from the invention's database since there is already a preestablished match between these items due to previous registration and history of business engagements. If the internal validation mechanism is disabled, it will still conduct the item code match between “item to be procured” and “item to be offered” since there is a high likelihood that seller will offer its items with previous transactions with the buyer on top of its capability to allow items without previous match or previous business transactions with the buyer. This therefore is classified as a substitute product by the invention. It will only become a classified product match if buyer confirms the quote and sends a purchase order to the seller. If it is a substitute product, the invention will extract the item descriptions from the sellers EBA and this is temporarily stored in the invention. It becomes part of the database when buyer confirms by sending a purchase order to the seller providing the substitute product.

FIG. 208 provides the extended view where item details are reflected. For RFQs with established suppliers/sellers, it will automatically match and extract the item codes with previous historical match. It will allow matching of other item codes if the buyer will flag the isSubstituteProductAcceptable.AffirmationIndicator as “yes”. If no, the item code is restricted for historically matched items.

PART V of FIG. 208 represents the confirmation area. If yes, the confirmation is sent to the buyer. This changes the RFQ status from “pending” to “responded”.

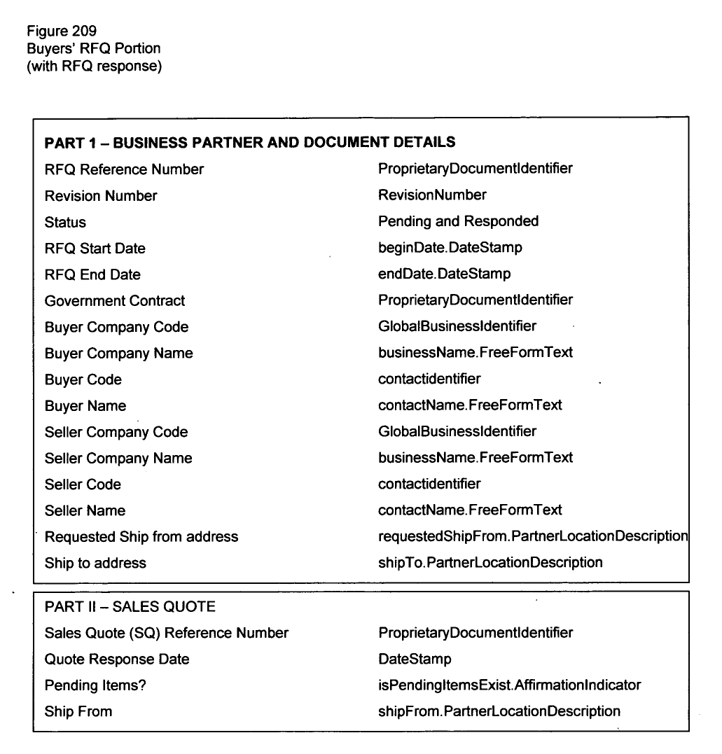

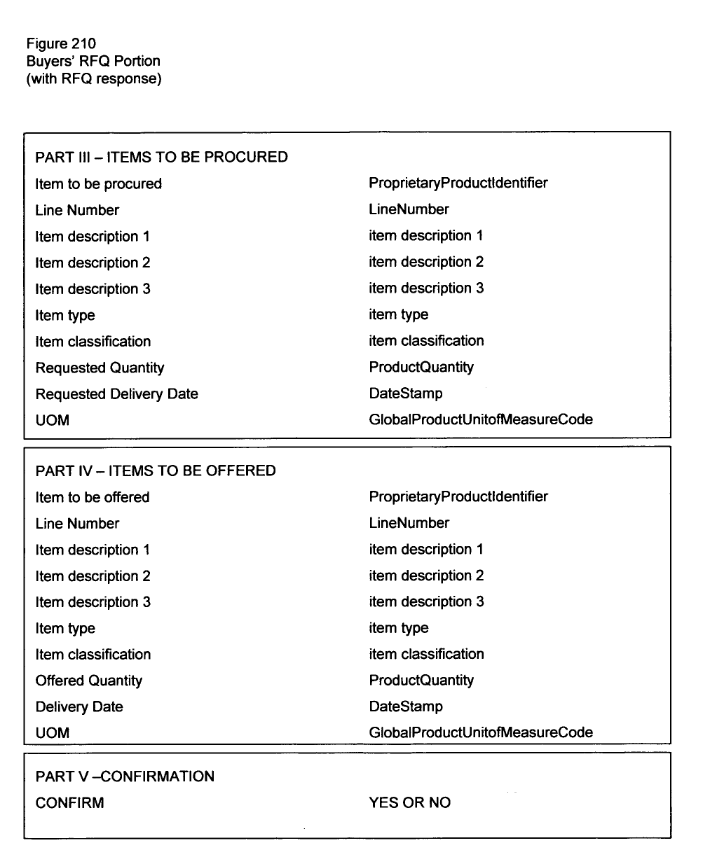

FIGS. 209 and 210 represent the buyers' RFQ portion where supplier responded RFQs are reflected. PART V provides a confirmation button where the buyer confirms yes if they are confirming their business engagement with the supplier. If yes, RFQ response transmitted via the invention will be transmitted to the RFQ confirm portion of the buyer's EBA. There are only two criteria that will be used by the invention to validate and close the RFQ. First, if the deadline expires. Modifying the deadline on the RFQ can extend the deadline. Second, if the buyer confirms the RFQ via the EBA, which means it, will award the purchase order to the winning supplier/seller. Current EBA converts the winning RFQ into a purchase order. Therefore, it will provide a “close” status on the RFQ item data found in the invention. The close status on the total RFQ will be reflected on the RFQ header if all items are converted into PO or if pending items are cancelled on the RFQ. There is a prompt where the buyer is asked if it will confirm the item code match during or after the RFQ has been confirmed. If yes, the invention will do an item code match and store the match for future usage.

There will be five status codes for RFQ. These are: 1) pending—RFQ without supplier response seen on both the buyer and seller's RFQ portion of the invention, 2) responded—RFQ with at least one response from supplier seen on both the buyer and seller's RFQ portion of the invention, 3) win—response to winning supplier reflected on seller's RFQ portion of the invention, 4) lose—response to losing supplier reflected on seller's RFQ portion of the invention and 5) closed—status reflected on buyer's RFQ view.

RFQ revision number will be determined based on the number of responses made by the supplier on the particular RFQ number.

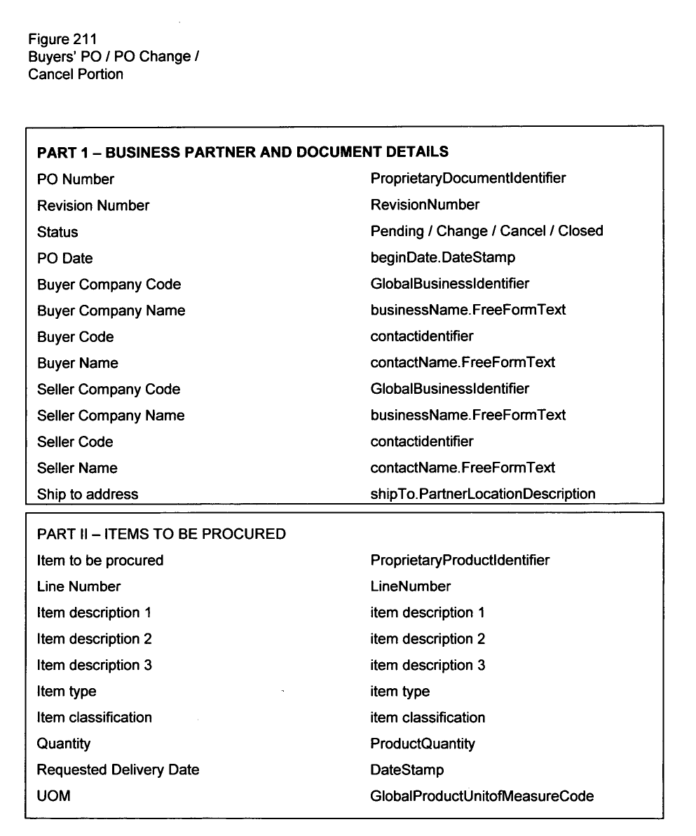

Confirmed RFQs are converted into purchase orders (PO) by the buyers EBA. This converts the status of the RFQ into closed, triggers closing of RFQ in the invention's list of pending RFQ and sends email to winning and losing sellers. The invention provides a mechanism on the buyers' EBAs where it will prompt for sending of the electronic PO via the invention as the output media. If yes, the PO is electronically transferred on the invention where it is electronically retrieved by the winning seller's EBA. FIG. 211 represents the data extracted from buyer's EBA and stored in the invention. This is applied to purchase orders (POs), PO changes, PO cancellation and PO closing.

On the seller's EBA, the invention provides a mechanism where the sales quote detects if it becomes the winning sales quote. Afterwards, the seller's EBA converts the sales quote into a sales order.

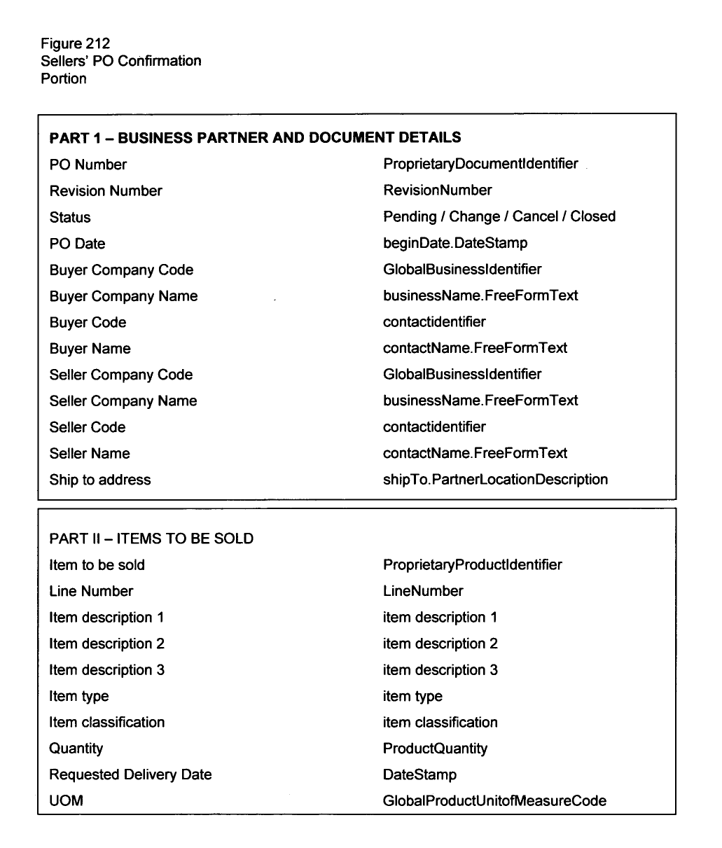

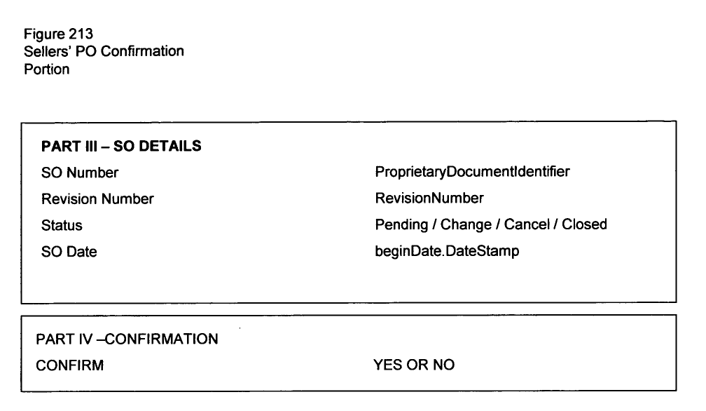

The invention provides a validating mechanism to check and validate the accuracy of the buyer's purchase order with the seller's sales order. This happens when the purchase order is electronically sent via the invention and detected by the seller's EBA. FIG. 212 represents the data extracted from buyer's EBA and stored in the invention. This is counterchecked versus the extracted data from the sales order of seller's EBA. Sales Order details found on FIG. 213 are reflected on the invention if SO details are matched equally against the buyer's PO. If not, an error message is encountered. Seller confirms the sales order if everything is in order. This is applied to all purchase order confirmation, PO change confirmation and PO cancellation confirmation.

Actual deliveries are made the seller. At this point, buyer and seller's EBA takes care of the transaction processing. The invention will handle the purchase order (PO) and sales order (SO) quantity updates based on updated data found on the buyer and seller's EBA. The status of these documents will be determined by the invention based on status found on buyer and seller's EBA.

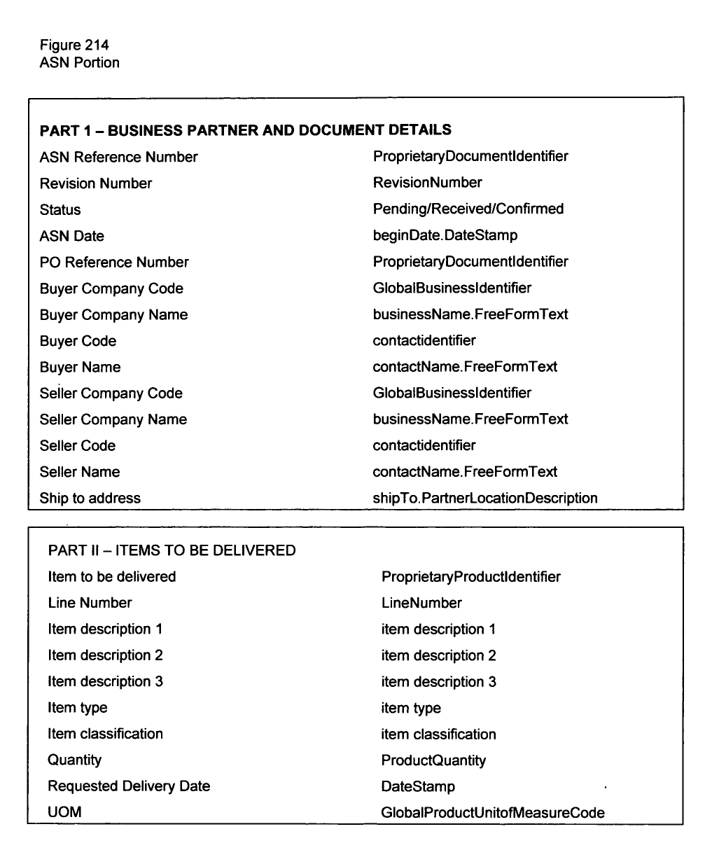

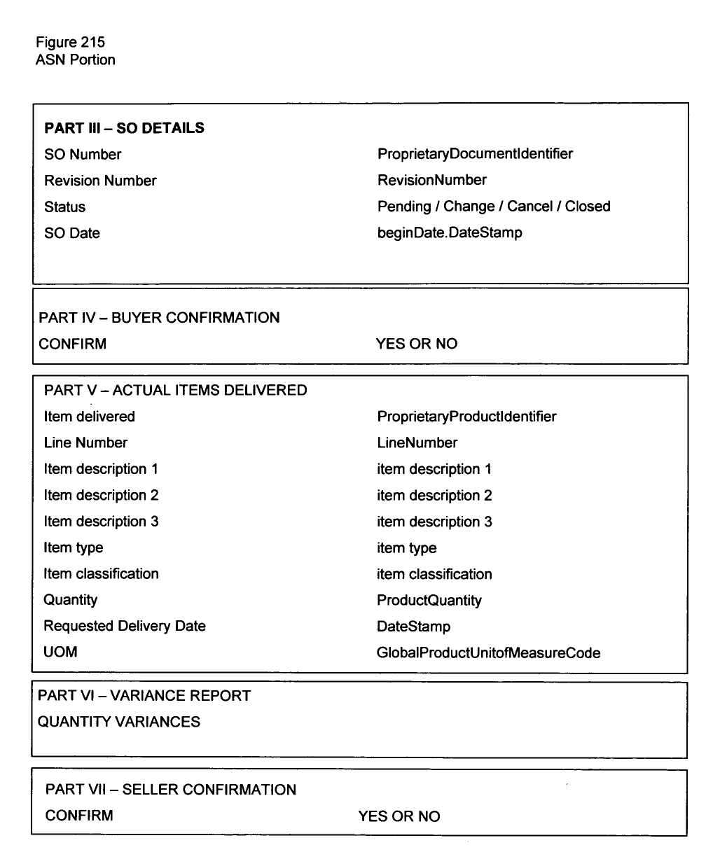

FIGS. 214 and 215 represent the advance shipment notification data extracted from seller's EBA and transmitted electronically to the receiving module of buyer's EBA. These data are found on buyer and seller access of the invention except for PART IV—CONFIRMATION where this is limited to the buyer only. Upon confirmation, the ASN data is electronically transmitted to the buyer's EBA. The status is changed from pending into confirmed.

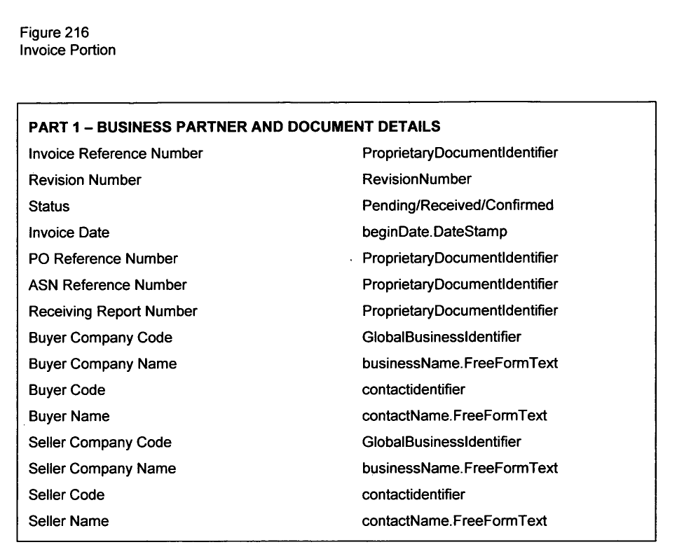

Upon receipt of actual deliveries, receiving personnel of the buyer company updates the actual receipt quantities of the ASN in the EBA. Extracted data is reflected on PART V of FIG. 215. If there are variances, the invention provides a variance report on the difference between actual delivered quantities versus ASN quantities as reflected on PART VI of FIG. 215. Part VI portion of FIG. 215 provides a variance report in detail of items shipped versus items received. Seller confirms this variance using PART VII of FIG. 216. Upon confirmation, the invention provides a mechanism where seller's EBA accepts the confirmation from the invention thus triggering an invoice. This provides a continuous iteration process until both buyer and seller acknowledge the variance.

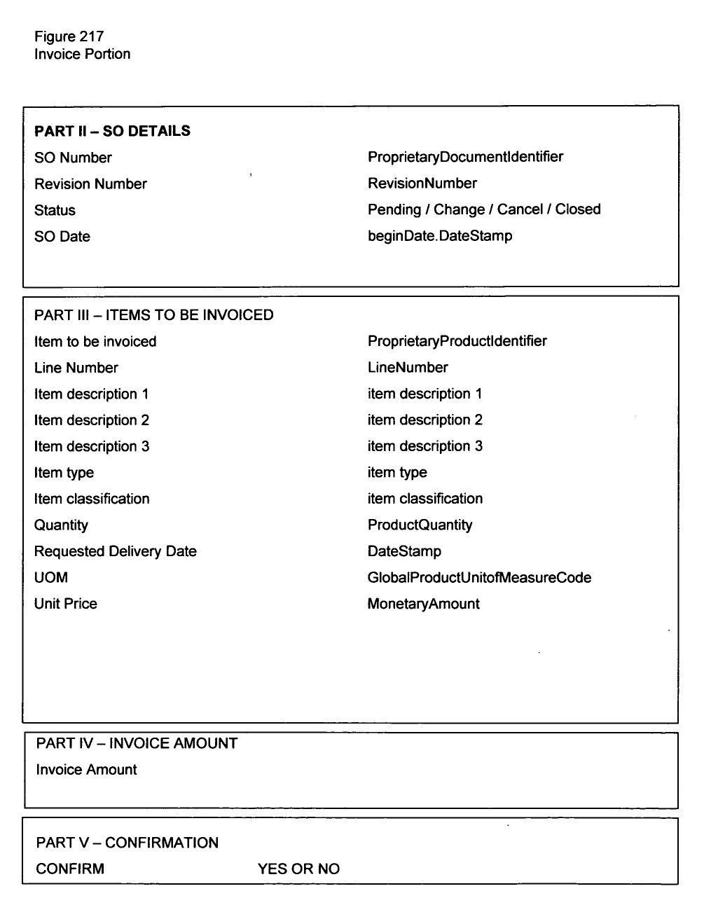

FIGS. 216 and 217 represent the invoice data extracted from the seller's EBA and transmitted electronically to the buyer's EBA via the invention. These data are found on buyer and seller access of the invention except for PART V—CONFIRMATION where this is limited to the buyer only. Upon confirmation, the invoice data is electronically transmitted to the buyer's EBA. The status is changed from pending into confirmed.

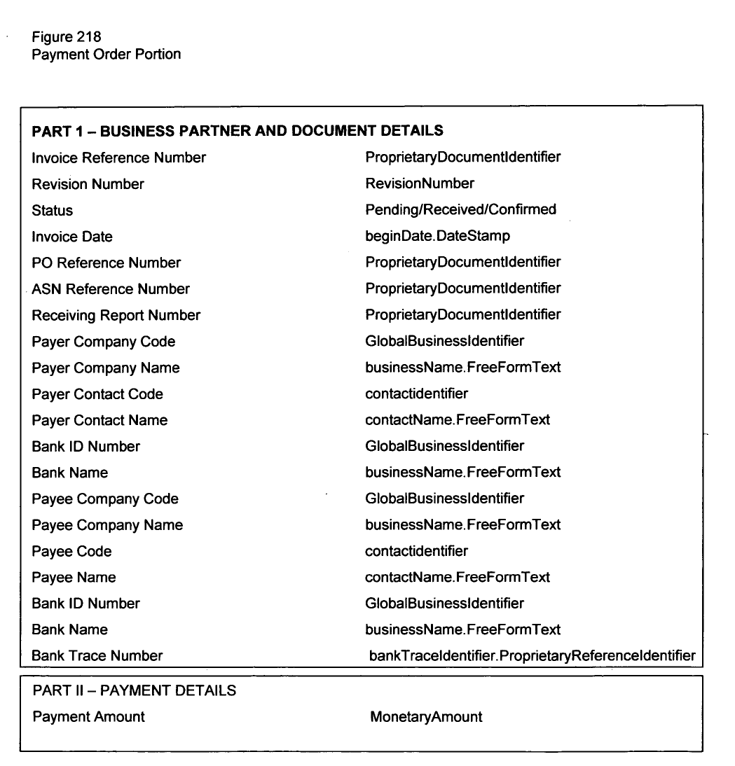

Buyer's EBA receives the invoice and converts this into payment order. FIG. 218 represents the payment order data extracted from the buyer's EBA and transmitted electronically to the seller's EBA via the invention. These data are found on buyer and seller access of the invention.

If there is no existing EBAs on buyer and seller side, the invention provides a hosted EBA with predefined user roles where users are allowed to select and register. The invention allows a simplified manually maintained system to allow users that do not want any EBA interface or subscription to the hosted EBA of the invention. If this is the case, these kinds of users are also limited for access on the invention's other functionalities.

The invention provides a workflow capability where electronic signatures and security access codes are needed. This is an option that can be activated during the registration process.

1. a system and method for a business-to-business buying, selling, sourcing and matching of products and services across multiple business partners over the Internet. (INDEPENDENT CLAIM 1)

2. a system according to claim 1 that supports: 1) business partner registration, 2) buying and selling processing, 3) matching of codes, 4) conversion of EDI transactions, 5) sourcing/offering of products/services and 6) electronic documents processing.

3. a system according to claim 1 that covers an infrastructure that includes computer hardware, computer software, interfaces, translators, connectors, programs, development tools, hosted applications, database, networks and standards to connect electronic business applications (EBAs).

4. a system according to claim 1 that covers the hosting and interfacing of various electronic business applications (EBAs). Such EBAs include enterprise resource planning (ERP) systems, customer relationship management (CRM) software, online stores, desktops based applications, legacy systems, electronic marketplaces, supply chain systems, e-procurement and other buying and selling applications.

5. a system according to claim 4 that supports EBAs with or without support on EDI and Rosettanet technology.

6. a system according to claim 4 that converts EBA based data into Rosettanet compliant data.

7. a system according to claim 1 that provides enhancements on Rosettanet standards to support EBAs that are not Rosettanet compliant.

8. a system according to claim 4 that extracts EBA based codes (i.e. item codes, company codes, unit of measure codes, currency, class codes and country codes) whether these codes are proprietarily defined or defined by global standards defining entities.

9. a system according to claim 8 that matches and stores these codes for use in the seamless electronic business documents transmission.

10. a system according to claim 4 that supports extraction, match and storage of EBA data that are using DUNS, EAN/UPC, ISO, GTIN, UN/SPSC and other codes set by global standards defining entities.

11. a system according to claim 10 that either does or does not mandate the usage of these codes.

12. a system according to claims 8, 9 and 10 that uses a software program to convert these EBA based codes to comply with corresponding Rosettanet PIPs and its fundamental business data entities.

13. a system according to claims 8, 9 and 10 that uses a software program to convert EDI extracted EBA data to comply with corresponding Rosettanet PIPs and its fundamental business data entities.

14. a system according to claim 4 that supports EBAs with or without support on customer part number (CPN) and manufacturer part number (MPN) maintenance. In the totality of the invention, the customer part number (CPN) is referred to as the buyer defined item code (BDIC) and manufacturer part number (MPN) as the seller defined item code (SDIC) of which both codes are proprietary defined codes.

15. a system according to claim 1 that is deployed on a global scale involving interconnection between various electronic business applications (EBAs) over the Internet.

16. a system according to claim 1 that provides a functionality to allow electronic posting of products and services by companies on the internet based public and private auctions and reverse auctions area of the invention.

17. a system according to claims 4 and 15 that extracts EBA based request for quotation (RFQ) data and posts the item, product or service to be sourced in the reverse auction area of the invention.

18. a system according to claims 4 and 15 that extracts EBA base sales quotation (SQ) data and posts the item, product or service to be offered in the auction area of the invention.

19. a system according to claim 15 that restricts non-member companies or business partners to gain access on the public portion of the auction and reverse auction area.

20. a system according to claim 15 that allows member companies to gain access on the public and private portion of the auction and reverse auction area.

21. a system according to claims 18 and 19 that provide security and authorization profiles as defined by the invention.

22. a system according to claim 16 that allows sellers to view, reply and confirm participation for items to be sourced by the buyer.

23. a system according to claim 17 that allows buyers to view, reply and confirm participation for items to be sold by the seller.

24. a system according to claim 21 that allows buyers an option to convert or not the confirmed items for sourcing via the reverse auction into an official request for quotation (RFQ) to be generated by buyer's EBA and transmitted electronically to the seller's EBA via the invention.

25. a system according to claim 22 that allows sellers an option to convert of not the confirmed items to be bought via the auction into an official sales quotation (SQ) to be generated by seller's EBA and transmitted electronically to the buyer's EBA via the invention.

26. a system that extracts EBA based request for quotation (RFQ) data, posts in the invention's reverse auction area as part of the list of items to be sourced, allows confirmation of these “to be sourced” items by member or non-member sellers, allows RFQ conversion by buyers' EBAs of confirmed items found in the reverse auction area and allows electronic transmission of newly generated RFQs (now with “send to” seller details) to the seller's EBA via a method of data conversions to transmit these data using the invention's internet based and EBA compliant technology. (INDEPENDENT CLAIM 2)

27. a system that extracts EBA based sales quote (SQ) data, posts in the invention's auction area as part of the list of items to be offered, allows confirmation of these “to be offered” items by member or non-member buyers, allows SQ conversion by sellers' EBAs of confirmed items found in the auction area and allows electronic transmission of newly generated SQ (now with “send to” buyer details) to the buyer's EBA via a method of data conversions to transmit these data using the invention's internet based and EBA compliant technology. (INDEPENDENT CLAIM 3)

28. a system according to claim 1 that extracts all data found from each kind of EBA, matches these with RosettaNet fields, stores, retrieves, sends, processes all necessary data needed by business partners to complete business transactions.

29. a system according to claim 7 that introduces an enhanced code to include ProprietaryLocationIdentifier and ProprietaryLocationIdentifier2 as additional fundamental business data entities under all Rosettanet PIPs. If the GlobalLocationIdentifier is a source entity location, then the source entity defined source entity location code will be extracted from source entity EBA and matched to ProprietaryLocationIdentifer. The destination entity defined source entity location code will be extracted from the destination entity EBA and matched to ProprietaryLocationIdentifier2.
If the GlobalLocationIdentifier is a destination entity location, then the destination entity defined destination entity location code will be extracted from destination entity EBA and matched to ProprietaryLocationIdentifer. The source entity defined destination entity location code will be extracted from the source entity EBA and matched to ProprietaryLocationIdentifier2.
In summary, there will be three different kinds of location codes that will be extracted, matched and stored in the invention. These fundamental business data entities are GlobalLocationIdentifier, ProprietaryLocationIdentifier and ProprietaryLocationIdentifier2 where these entities are grouped by the invention. The ProprietaryLocationIdentifier2 is introduced as a new fundamental business data entity by the invention. We will call this as CLAIM A for easy reference on other PIPs requiring this CLAIM. This is applied to all RosettaNet's PIP.

30. a system according to claim 7 that introduces an enhanced code to include ProprietaryCountryCode as an additional fundamental business data entity under all Rosettanet PIPs. This will be used to store the company defined country code if ever they didn't comply with the ISO country code. The invention will extract this company defined country code, store it under the ProprietaryCountryCode fundamental business data entity and match it with the ISO country code stored as a database in the invention. This will be applied to all RosettaNet's PIP. We will call this as CLAIM B for easy reference on other PIPs requiring this CLAIM.

31. a system according to claim 7 that limits the entity instance of GlobalPartnerClassificationCode to buyer or seller for selected LINES (described in the details of the invention) instead of using the predefined list set forth by Rosettanet PIPs. We will call this as CLAIM C for easy reference on other PIPs requiring this CLAIM.

32. a system according to claim 7 that introduces an enhanced code to include ProprietaryBusinessIdentifier and ProprietaryBusinessIdentifier2 as additional fundamental business data entities under all Rosettanet PIPs.
The source and destination entities will use these fundamental business data entities to store their company defined business or company code if ever they didn't comply with the DUNS company code. The invention will extract these proprietary company codes from source and destination entities' EBAs and match it with the DUNS company code stored as a database in the invention. If ever the company has not applied for a DUNS code, the invention will allow no entry of data on the GlobalBusinessIdentifier. It will leave this blank to be filled up later on if ever the company will apply for a DUNS code in the future.
The source entity defined source entity company code (ie. source=buyer) will be extracted from source entity EBA and matched to ProprietaryBusinessIdentifier. The destination entity (i.e. destination=seller) defined source entity company code will be extracted from the destination entity EBA and matched to ProprietaryCountryCode2. There is a high likelihood that one source entity defined source entity company code will be matched and assigned to multiple destination entity defined source entity company code since each entity or participating company defines their own set of company codes for their business partners. This is one of the invention's capability where it can allow the matching of one source entity defined source entity company code equal to one DUNS company code which can be both equal to multiple destination entity defined source entity company codes.
The source entity defined source entity company code can be equated to the buyer defined buyer company code. If the source entity is the buyer then the destination entity is the seller for the naming convention being used in FIGS. 13, 14 and 16.
The same is true for the destination entity defined destination entity code where it can be assigned to one DUNS defined company code of which both are assigned to multiple source entity defined destination entity codes thru the usage of these three kinds of company codes represented as fundamental business data entities entitled ProprietaryBusinessIdentifier, GlobalBusinessIdentifier and ProprietaryBusinessIdentifier2. We will call this as CLAIM D for easy reference on other PIPs requiring this CLAIM. This is applied to all RosettaNet's PIP.

33. a system according to claim 7 that introduces an enhanced code to include ProprietaryCurrencyCode as additional fundamental business data entities under all Rosettanet PIPs. This will be used to store the company defined currency code if ever they didn't comply with the ISO currency code. The invention will extract this company defined currency code, store it under the ProprietaryCurrencyCode fundamental business data entity and match it with the ISO currency code stored as a database in the invention. This will be applied to all RosettaNet's PIP. We will call this as CLAIM E for easy reference on other PIPs requiring this CLAIM.

34. a system according to claim 7 that introduces an enhanced code to include ProprietaryProductUnitofMeasureCode as an additional fundamental business data entity under all Rosettanet PIPs. This will be used to store the company defined product unit of measure code if ever they didn't comply with the entity instances found under the GlobalProductUnitofMeasureCode. The invention will extract the company defined unit of measure code, store it under the ProprietaryProductUnitofMeasureCode and match it with the corresponding entity instance of GlobalProductUnitofMeasureCode stored as a database in the invention. This will be applied to all RosettaNet's PIP. We will call this as CLAIM F for easy reference on other PIPs requiring this CLAIM.

35. a system according to claim 7 that introduces an enhanced code to include ProprietaryProductIdentifier2 as an additional fundamental business data entity under all Rosettanet PIPs where the seller defined item code will be stored. There are certain buyer EBAs that support the maintenance of seller defined item codes via the manufacturer part number (MPN) field. If the seller defined item code is available in the MPN, then the invention will extract this and store it under ProprietaryProductIdentifer2. If not available, it will be left blank to be filled up by the seller during the completion of the quote confirmation. Also, certain sellers EBAs support the maintenance of buyer defined item codes via the customer part number (CPN) field. If the buyer defined item code is available in the CPN, then the invention will extract this and store it under ProprietaryProductIdentifer. We call this as CLAIM G for easy reference on other PIPs requiring this claim.

36. a system according to claim 1 that converts EDI based transactions to comply with the enhanced Rosettanet technology.

37. a system that converts EDI based transactions to comply with the enhanced Rosettanet technology. (INDEPENDENT CLAIM 4)

38. a system according to claim 7 that provides an enhancement on all Rosettanet PIPs where the GlobalDocumentFunctionCode will contain an entity instance. Such entity instance includes but not limited to Quote Request, Quote Confirmation, Purchase Order, Purchase Order Confirmation, Purchase Order Acknowledge, Ship Notice, Purchase Order Change, Purchase Order Change Acknowledgment, Purchase Order Cancellation Request, Purchase Order Cancellation Confirmation, Invoice and Payment Order. The entity instance is automatically determined and assigned during the extraction of data from EBA and EDI data.

39. a system according to claim 38 that classifies the document as part of the document listing in the invention based on the entries found on GlobalDocumentFunctionCode entity instance of all Rosettanet PIPs.

40. a system according to claim 7 that extracts competitor company and product data found on all Rosettanet PIPs and stores these data as a possible alternate sources of supply.

41. a system according to claim 7 that sends invitation to customers and competitors to participate in the invention.

42. a system according to claim 41 that sends invitation via the communication details (i.e. fax number, email address, etc.) extracted from customer and competitor details found in the Rosettanet PIPs.

43. a system according to claim 1 that determines possible sources of supply based on the scenario discussed below.
FIGS. 20, 30, 33 and 35 represent the figures on how item codes are matched and stored in the invention. FIG. 21 shows a scenario where the buyer1 defined item code 1 (BDIC1) is equal to seller1 defined item code 1 (SDIC1), buyer2 defined item code 2 (BDIC2) is equal to seller2 defined item code 2 (SDIC2) and buyer3 defined item code 3 (BDIC3) is equal to seller3 defined item code 3 (SDIC3). This is the scenario every time the buyer and seller conduct their business via the invention. These codes are extracted and stored by the invention during the registration and RFQ process. Due to the invention's capability to conduct one-to-many and many-to-many transactions, there is a high likelihood that a buyer gets its source from multiple suppliers. For example, buyer1 defined item code 1 (BDIC1) was found out be sourcing this item from another supplier which is seller 2 with seller2 defined item code 2 (SDIC2). Every time that the invention encounters this scenario, it will detect a possible match where there is a high likelihood that buyer2 defined item code 2 (BDIC2) can have seller1 defined item code 1 (SDIC1) as a potential supplier. The invention uses a simple mathematical formula to convert SDIC1 as potential source item for BDIC2. This will be stored in the invention. If the buyer wants a new source of supply, the invention retrieves this data and provides a listing of all candidates with their respective item codes and descriptions.
The same logic found on FIG. 21 is applied on FIG. 22.

44. a system that determines possible sources of supply based on the scenario discussed below.
FIGS. 20, 30, 33 and 35 represent the figures on how item codes are matched and stored in the invention. FIG. 21 shows a scenario where the buyer1 defined item code 1 (BDIC1) is equal to seller1 defined item code 1 (SDIC1), buyer2 defined item code 2 (BDIC2) is equal to seller2 defined item code 2 (SDIC2) and buyer3 defined item code 3 (BDIC3) is equal to seller3 defined item code 3 (SDIC3). This is the scenario every time the buyer and seller conduct their business via the invention. These codes are extracted and stored by the invention during the registration and RFQ process. Due to the invention's capability to conduct one-to-many and many-to-many transactions, there is a high likelihood that a buyer gets its source from multiple suppliers. For example, buyer1 defined item code 1 (BDIC1) was found out be sourcing this item from another supplier which is seller 2 with seller2 defined item code 2 (SDIC2). Every time that the invention encounters this scenario, it will detect a possible match where there is a high likelihood that buyer2 defined item code 2 (BDIC2) can have seller1 defined item code 1 (SDIC1) as a potential supplier. The invention uses a simple mathematical formula to convert SDIC1 as potential source item for BDIC2. This will be stored in the invention. If the buyer wants a new source of supply, the invention retrieves this data and provides a listing of all candidates with their respective item codes and descriptions.
The same logic found on FIG. 21 is applied on FIG. 22. (INDEPENDENT CLAIM 5)

45. a system according to claim 1 where it provides an accreditation process for all of these suppliers and only accredited and registered suppliers are listed.

46. a system according to claim 1 where buyers and suppliers are asked if they wanted to participate and register to avail this strategic sourcing/offering functionality.

47. a system according to claim 43 and 44 that match proprietary defined (buyer and seller defined) item codes to GTIN, EAN/UPC or other globally set standards for item codes as illustrated in FIG. 35.

48. a system according to claim 47 that accumulates and stores all of these matched item codes for usage in the seamless electronic transmission and conversion of business documents.

49. a system according to claim 1 that allows substitute products.

50. a system according to claim 49 that allows suppliers to send quote confirmations containing a substitute product.

51. a system according to claim 50 where the item is stored as a substitute product in the invention if the buyer accepts the quote with the substitute product.

52. a system according to claims 43 and 44 that provides a prompt screen for the potential buyers if they want to include other supplier candidates. If yes, the list of suppliers with similar item codes and descriptions are provided.

53. a system according to claims 43 and 44 that provides a prompt screen for sellers if they want to see all potential buyers whether these buyers are previous customers or not. If yes, a list of potential buyers with similar item codes and descriptions are provided.

54. a system according to claim 1 that provides a functionality allowing buyers to selectively block a list of suppliers they don't want, block a list of suppliers without accreditation, block a list of suppliers within the blacklist or simply block all suppliers if not part of source of supply.

55. a system according to claim 1 that allows suppliers not to send a sales quote to buyers with bad history (delayed payments, etc.).

56. a system according to claim 1 that provides access to multiple buyers and sellers for strategic sourcing and offering of multiple products and services over the Internet where electronic documents are transmitted in a seamless and bidirectional fashion.

57. a system according to claim 1 the allows the buyer to see the list of potential suppliers, with item offerings based on search and match criterions listed on FIG. 204.

58. a system according to claim 57 that allows these criterions and percent allocation to be configured and predefined by the buyer.

59. a system according to claim 57 that allow EBA data to be extracted as a direct or modifiable input for criterions found on FIG. 204.

60. a system according to claim 59 that allows the first criterion found on FIG. 204 to determine if there is already an existing or previous history between the buyer and seller. Of course, if the buyer prefers suppliers with previous business engagement, there is a high likelihood that they will make this as one of the major factors by increasing the percent allocation. If buyers prefer new sources, they can modify the percent allocation to be lesser that the previously defined percent allocation.

61. a system according to claim 59 that allows the second criterion to determine the supplier performance. This factor is the equalizer for the first criterion. Suppliers with poor performance are negated by this criterion. If buyers wanted to filter all non-performing suppliers, they will increase the percent allocation of this one. Some EBAs have the capability to automatically compute the supplier performance. The invention provides a conversion mechanism to allow these supplier performance data to be extracted from the buyer's EBA. The invention allows these converted data to be purely extracted without modification or allow extracted data to be edited, calculated or processed further by the invention.

62. a system according to claim 59 that allows the third criterion to determine the percent weight of substitution items. This is a simple defined criterion. If the buyer is having difficulty in finding a perfect item, then they will increase the percent allocation of this criterion. Also, the invention will mandate this criterion if it detects a yes in “isSubstituteProductAcceptable.AffirmationIndicator”, a fundamental business data entity that is described in the previous section of this detailed description of the invention. If this is detected as no, then the default percent is 0% in this criterion.

63. a system according to claim 59 that allows the fourth criterion to determine the item description proximity. The invention will conduct an extensive search of items stored in the invention (to be sourced or offered) based on description and will list all items based on proximity of descriptions.

64. a system according to claim 59 that allows the fifth criterion to detect the similarity on classification. The fourth criterion depends on this so that searching of results for the fourth criterion is limited to the items based on proximity of classification.

65. a system according to claims 43, 44 and 59 that allows the sixth criterion to detect the similarly offered/sourced products.

66. a system according to claim 59 that allows the buyer to select a criterion based on a predefined list provided by the invention or allow users to introduce new criterions as well if they see that the existing list is not sufficient.

67. a system according to claim 59 that allows the authorized buyer to predefine the percent allocation for all of these criterions.

68. a system according to claim 1 that provides a prompt if the potential buyer wanted their items (to be procured) to be published in the private and public reverse auction area of the invention. This process happens before a request for quotation (RFQ) can be issued since there is no defined and confirmed supplier yet when the buyer published their requirements via the reverse auction area of the invention. If flagged yes in the private reverse auction area, all registered suppliers in the invention are allowed to view the private reverse auction area. If flagged yes in the public reverse auction area, all registered and non-registered suppliers are allowed access to the item.

69. a system according to claim 1 that provides a prompt if the supplier/seller wanted to list their offerings via the private and public auction area of the invention. This process happens before a sales quote (SQ) can be issued since there is no confirmed interested buyer yet when the supplier or seller published their requirements via the auction area of the invention. The invention provides a prompt if the supplier or seller wanted their items (to be offered) to be published in the private and public auction area of the invention. If flagged yes in the private auction area, all registered buyers in the invention are allowed to view this private auction area. If flagged yes in the public auction area, all registered and non-registered buyers are allowed access to the item.

70. a system according to claim 1 and 65 that provides functionality where the buyer can search candidate suppliers for the item they intend to buy before they process the item to take part in the reverse auction. The same criterion found on FIG. 204 is applied.

71. a system according to claim 1 and 65 that provides functionality where the seller can search candidate buyers for the item they intend to sell before they process the item to take part in the auction. The same criterion found on FIG. 204 is applied.

72. a system according to claim 1 that provides a functionality to conduct a search of all items from all potential buyers based on criterions found on FIG. 204. If it is time based, it will list the items based on urgency of requirement. In short, items that are currently sourced by buyers are listed on top of priority. Items without any pending or current requirements are listed as non-priority sources. The list will be displayed to the supplier for flagging. If the seller flag yes, a sales quote is generated and sent to the potential buyer if there is a current requirement. If there is no current requirement, the invention will just store the match for future activation if the invention sees that the buyer is triggering an urgent requirement to source this item via RFQ or reverse auction. The potential buyer has an option to activate this functionality where it will suggest the source list where sellers triggered a match for these items without any pending or current requirements to be included in the RFQ supplier candidate listing on top of the source of supply listing. Also, the potential buyer has an option to activate this functionality where the invention will suggest potential sources before it conducts a reverse auction. If no, there will be no activity.

73. a system according to claim 1 that provides an Internet site where it is composed of four major sections which are: 1) registration, 2) log in area, 3) public auction and reverse auction and 4) news/reports/statistics. This is illustrated in FIG. 189.

74. a system according to claim 73 where new members fill up a registration form on the registration area. This is where simple to a complex registration process is conducted. The simple registration allows the new members to simply gain access to the invention without the need to interface their EBAs to the invention. The registration data as provided in FIG. 190 must be completed. Take note that the invention disallows any entry on the contact code. This will be activated if the invention is interfaced to the user's EBA. If the invention is interfaced on EBA, the registration will extract the relevant registration data found on FIG. 190 using Rosettanet's PIP 1A1—Account Set up as defined in FIGS. 47-59. The grouping field found on FIG. 190 provides a list of user classification. If the new member enters an “administrator” grouping code, then a second is screen is provided to the new administrator.

75. a system according to claim 73 where the administrator is required to accomplish the data found on FIGS. 191 and 192. FIG. 192 represents the additional data required from the administrator. The invention provides a prompt where the administrator enters the user name and password required as a first step to gain access to the EBA to be interfaced. Access and authentication protocols are required so that the EBA can be readily interfaced to the invention. The invention provides a predefined screen for the set up of these protocols. The administrator is also: asked to select the suitable EBA name and EBA versions. The administrator needs to answer whether their EBA support MPN, CPN, Rosettanet or EDI. These questions determine the code to be activated by the invention for the extraction process.

76. a system according to claim 73 where the administrator is required to fill up the access and authentication protocols of the invention. At this point, both the invention and EBA access and authentication protocols are addressed therefore both systems are ready to talk or transmit data in a bidirectional way. Also, there is a prompt screen where the administrator is required to answer if it will allow their EBA to include the invention as another alternative for output media. Current output media includes: 1) local and network printing, 2) fax, 3) email or via 4) EDI. The prompt will allow the inclusion of the invention's internet site address as another alternative for electronic sending of business documents. For Request for Quotation (RFQ) and Sales Quote (SQ), there is an additional prompt where the user is asked if it will allow the sending of these documents on the public portion of the invention's auction and reverse auction area. If yes, it will display the RFQ and SQ product data on the invention's auction and reverse auction area where members and non-members are allowed to view and respond. This will allow the sending of RFQ and SQ product data without “send to business partner” details.

77. a system according to claim 73 where the master records are extracted from EBA and stored in the invention. Such master records include vendor master, customer master, item master, unit of measure, currency, company code, item classification and user codes. The administrator is allowed to extract: 1) all, 2) based on a time period when these records are created or 3) update records (records that are new or modified).
A sample list is provided in FIG. 193 where the user selects an entry from this predefined list.

78. a system according to claim 73 where FIG. 203 represents the area where the approved for public listing via public reverse auction for request for quotations (RFQ) are published. These kinds of RFQs are declared valid for public reverse auction listing when the buyers prompt the invention to allow RFQs (without send to details) to be published on this reverse auction area. Member and non-member sellers can view this. The invention provides a prompt to buyers if they want to limit the viewing of their requirements to registered buyers of the invention or registered buyers allowed by the buying company instead of public viewing.

79. a system according to claim 73 that allows potential sellers to search items requested by buyers listed on the reverse auction area of the invention in any field combination they prefer. There is also a key where the seller can confirm the search for possible matches. The calculation formulation for search proximity is based on the search and match criterions previously defined by buyers as illustrated on FIG. 204. The result includes a list of potential items to be supplied with corresponding search proximity in percent. Criterion 1 and 2 found on FIG. 204 can be derived from extracted data of EBAs supporting supplier performance evaluation. The invention allows mapping and extraction of these data from EBA into the invention. Criterion 1 and 2 are both activated for suppliers with previous business engagements with the buyer.

80. a system according to claim 73 that allows criterion 3 as the determinant for the invention to allow the search of items based on criterion 4—item description search and criterion 5—item classification search. This can be viewed and ranked based on highest to lowest percent proximity. The invention will ask the potential sellers to confirm each product match. Upon confirmation, the proximity data is sent to the potential buyer. The search proximity based on criterion 4 and 5 is disabled for sellers or suppliers without sell item records uploaded in the invention.

81. a system according to claim 73 that requires non-member companies to register at the very least in the invention where contact details are entered.

82. a system according to claim 1 that provides drill down functionality for details.

83. a system according to claim 73 that allows the potential buyer to retrieve the proximity information for all responses. This can be sorted in any field that the potential buyer wish to sort. FIG. 205 illustrates the response. This can be best viewed when sorted on proximity percent where the highest proximity match is listed as number one. The proximity percent can be viewed in detail by double clicking it. After double clicking, the user can now see the detailed evaluation based on criteria found on FIG. 204. The user also has an option to simulate and modify the evaluation criteria based on the user's preference. Modifications are allowed such as revising the percent allocation, percent actual and introducing new criteria factors. These factors can be retrieved from a predefined list provided by the invention or the user can simply make a new criteria. After modifications, the user has an option to view the modified ranking list.

84. a system according to claim 73 that requires non-member company to fill up most fields found on FIG. 205. At the very least, they should register their contact information. Item master upload is optional. If there is no item master data uploaded, these newly registered member companies are required to manually encode on the items to be procured and its *drilldown details.

85. a system according to claim 73 where only the buyer is allowed access on the “allow sending of RFQ”. There is a yes/no radio button where the user is asked if it will allow sending of RFQ. If yes, EBAs are prompt to create RFQs for these suppliers. Afterwards, it will prompt the output media to be used. A prompt is already required on whether the buyer will close the public reverse auction or not. If not, then the cycle of selecting potential supplier based on proximity match repeats. If yes, it will not display the item in the public reverse auction. * represents the drilldown capability of the invention where details of item to be procured/sold are viewed.

86. a system according to claim 73 where member companies are allowed to view and process their transactions via the private reverse auction portion while member and non-member companies are allowed to view and process their transactions via the public reverse auction area.
These reverse auction converted RFQs will be stored and viewed in the private access area of each buyer in the invention's internet site. All RFQs will have its respective RFQ number and seller code with seller description. These RFQ will be listed in the invention and transmitted electronically in the invention if the buyer selects the output media to be “via the invention”. The default status of the RFQ is “pending”. Sellers can view these RFQs limited only to those assigned to them.

87. a system according to claim 73 that lists RFQs on the buyer's private area for RFQs in the invention if RFQs are generated by the EBA using “via the invention” as the output media.

88. a system according to claim 73 that allows display of fields on the buyers' RFQ portion as illustrated on FIG. 206. This view is limited only to buyers assigned to process the RFQ. The buyer code is the validating field for the restricted view.

89. a system according to claim 73 that provides the default RFQ logical screens for potential sellers as listed on FIGS. 207 and 208. The seller code is the validating field for the restricted view.

90. a system according to claim 73 that provides the logical screens illustrated on PART 1 of FIG. 207 reflecting data from buyer's RFQ. PART II of FIG. 207 and PART IV of FIG. 208 reflecting data to be extracted from seller's RFQ. This is blank by default until the seller confirms the “allow extraction” to yes. If yes, buyer's RFQ data are transferred to seller's EBA. It will be processed into the EBA's Sales Quotation. Data from the accomplished sales quotation is transmitted to PART II and PART IV portion when seller defines the output media to “via the invention”.

91. a system according to claim 73 that provides the logical screens illustrated on PART III and IV of FIG. 208 reflecting the item to be procured and offered compared side by side. Part IV—items to be offered of FIG. 208 will be automatically extracted from the Sales Quote (SQ) of seller's EBA. An internal validation mechanism is provided by the invention to check the item code match between “item to be procured” and “item to be offered”. Item descriptions are extracted from the invention's database since there is already a pre-established match between these items due to previous registration and history of business engagements. If the internal validation mechanism is disabled, it will still conduct the item code match between “item to be procured” and “item to be offered” since there is a high likelihood that seller will offer its items with previous transactions with the buyer on top of its capability to allow items without previous match or previous business transactions with the buyer. This therefore is classified as a substitute product by the invention. It will only become a classified product match if buyer confirms the quote and sends a purchase order to the seller. If it is a substitute product, the invention will extract the item descriptions from the sellers EBA and this is temporarily stored in the invention. It becomes part of the database when buyer confirms by sending a purchase order to the seller providing the substitute product.

92. a system according to claim 73 that provides logical screens illustrated on FIG. 208 where the extended view of item details are reflected. For RFQs with established suppliers/sellers, it will automatically match and extract the item codes with previous historical match. It will allow matching of other item codes if the buyer will flag the isSubstituteProductAcceptable.AffirmationIndicator as “yes”. If no, the item code is restricted for historically matched items.

93. a system according to claim 73 that provides logical screens illustrated on PART V of FIG. 208 representing the confirmation area. If yes, the confirmation is sent to the buyer. This changes the RFQ status from “pending” to “responded”.

94. a system according to claim 73 that provides logical screens illustrated on FIGS. 209 and 210 representing the buyers' RFQ portion where supplier responded RFQs are reflected. PART V provides a confirmation button where the buyer confirms yes if they are confirming their business engagement with the supplier. If yes, RFQ response transmitted via the invention will be transmitted to the RFQ confirm portion of the buyer's EBA. There are only two criteria that will be used by the invention to validate and close the RFQ. First, if the deadline expires. Modifying the deadline on the RFQ can extend the deadline. Second, if the buyer confirms the RFQ via the EBA, which means it, will award the purchase order to the winning supplier/seller. Current EBA converts the winning RFQ into a purchase order. Therefore, it will provide a “close” status on the RFQ item data found in the invention. The close status on the total RFQ will be reflected on the RFQ header if all items are converted into PO or if pending items are cancelled on the RFQ. There is a prompt where the buyer is asked if it will confirm the item code match during or after the RFQ has been confirmed. If yes, the invention will do an item code match and store the match for future usage.

95. a system according to claim 73 where five status codes for RFQ are recognized. These are: 1) pending—RFQ without supplier response seen on both the buyer and seller's RFQ portion of the invention, 2) responded—RFQ with at least one response from supplier seen on both the buyer and seller's RFQ portion of the invention, 3) win—response to winning supplier reflected on seller's RFQ portion of the invention, 4) lose—response to losing supplier reflected on seller's RFQ portion of the invention and 5) closed—status reflected on buyer's RFQ view.

96. a system according to claim 73 where RFQ revision number will be determined based on the number of responses made by the supplier on the particular RFQ number.

97. a system according to claim 73 where confirmed RFQs are converted into purchase orders (PO) by the buyer's EBA. This converts the status of the RFQ into closed, triggers closing of RFQ in the invention's list of pending RFQ and sends email to winning and losing sellers. The invention provides a mechanism on the buyers' EBAs where it will prompt for sending of the electronic PO via the invention as the output media. If yes, the PO is electronically transferred on the invention where it is electronically retrieved by the winning seller's EBA. FIG. 211 represents the data extracted from buyer's EBA and stored in the invention. This is applied to purchase orders (POs), PO changes, PO cancellation and PO closing.

98. a system according to claim 73 where the invention provides a validating mechanism to check and validate the accuracy of the buyer's purchase order with the seller's sales order. This happens when the purchase order is electronically sent via the invention and detected by the seller's EBA. FIG. 212 represents the data extracted from buyer's EBA and stored in the invention. This is counterchecked versus the extracted data from the sales order of seller's EBA. Sales Order details found on FIG. 213 are reflected on the invention if SO details are matched equally against the buyer's PO. If not, an error message is encountered. Seller confirms the sales order if everything is in order. This is applied to all purchase order confirmation, PO change confirmation and PO cancellation confirmation.

99. a system according to claim 73 where FIGS. 214 and 215 represent the advance shipment notification data extracted from seller's EBA and transmitted electronically to the receiving module of buyer's EBA. These data are found on buyer and seller access of the invention except for PART IV—CONFIRMATION where this is limited to the buyer only. Upon confirmation, the ASN data is electronically transmitted to the buyer's EBA. The status is changed from pending into confirmed.

100. a system according to claim 73 where extracted data is reflected on PART V of FIG. 215. If there are variances, the invention provides a variance report on the difference between actual delivered quantities versus ASN quantities as reflected on PART VI of FIG. 215. Part VI portion of FIG. 215 provides a variance report in detail of items shipped versus items received. Seller confirms this variance using PART VII of FIG. 216. Upon confirmation, the invention provides a mechanism where seller's EBA accepts the confirmation from the invention thus triggering an invoice. This provides a continuous iteration process until both buyer and seller acknowledge the variance.

101. a system according to claim 73 where FIGS. 216 and 217 represent the invoice data extracted from the seller's EBA and transmitted electronically to the buyer's EBA via the invention. These data are found on buyer and seller access of the invention except for PART V—CONFIRMATION where this is limited to the buyer only. Upon confirmation, the invoice data is electronically transmitted to the buyer's EBA. The status is changed from pending into confirmed.

102. a system according to claim 73 where FIG. 218 represents the payment order data extracted from the buyer's EBA and transmitted electronically to the seller's EBA via the invention. These data are found on buyer and seller access of the invention.

103. a system according to claim 1 that provides a hosted EBA with predefined user roles where users are allowed to select and register. The invention allows a simplified manually maintained system to allow users that do not want any EBA interface or subscription to the hosted EBA of the invention. If this is the case, these kinds of users are also limited for access on the invention's other functionalities.

104. a system according to claim 1 that provides a workflow capability where electronic signatures and security access codes are needed. This is an option that can be activated during the registration process.

105. a system that extracts codes (i.e. item codes, company codes, unit of measure codes, currency code, country code and class codes) whether these codes are proprietary defined (i.e. buyer or seller defined) or standards entity defined (i.e. GTIN, DUNS, EAN/UPC, ISO, UN/SPSC or other current and future defined codes defined by global standards defining entity) from electronic business applications (whether these EBAs support customer part number [CPN] and manufacturer part number [MPN] maintenance or not, EDI compliant or not, Rosettanet compliant or not) and non-EBA sources, matches these codes, stores these codes in the internet engine of the invention for usage in electronic business documents transmission. (INDEPENDENT CLAIM 6)
